(19) United States
(12) Patent Application Publication
(10) Pub. No.: US 2005/0058149 A1
(43) Pub. Date: Mar. 17, 2005

(54) Time-scheduled and time-reservation packet switching

(76) Inventor: Wayne Richard Howe, Irvine, CA (US)

Correspondence Address: Wayne Richard Howe, 7 Pintail St., Irvine, CA, 92604, US

(21) Appl. No.: 10/947,487

(22) Filed: Sep. 22, 2004

Related U.S. Application Data
(63) Continuation-in-part of application No. 10/412,784, filed on Apr. 11, 2003.
Application No. 10/412,784 is a division of application No. 09/375,135, filed on Aug. 16, 1999, now Pat. No. 6,611,519.
(60) Provisional application No. 60/097,138, filed on Aug. 19, 1998.
(60) Provisional application No. 60/097,138, filed on Aug. 19, 1998.

(51) Int. Cl. H04Q 11/00

(52) U.S. Cl. 370/428; 370/412

(57) ABSTRACT

Systems, methods, devices, processes, procedures, algorithms, networks, and network elements are described for time-scheduled and/or time-reserved dat networks. Invention provides capabilities for synchronizing data networks and/or data network links; for establishing time-schedules, time-reservations, time-schedule reservations, and/or reservation time-slots for packets, cells, frames, and/or datagrams; and for transferring, transmitting, switching, routing, and/or receiving time-sensitive, high-reliability, urgent, and/or other time-scheduled, time-reserved, time-allocated, and/or time-scheduled-reservation packets, cells, frames, and/or datagrams, such as real-time and high-priority messages over these networks. The invention(s) enables packet-, cell-, datagram- and/or frame-based networks to thereby efficiently, reliably, and in guaranteed real-time, to switch and/or route data such as voice, video, streaming, and other real-time, high-priority, high-reliability, and/or expedited data with guaranteed delivery and guaranteed quality of service. Networks may be fixed, point-to-point, mobile, ad-hoc, optical, electrical, and/or wireless.

### CROSS-REFERENCE TO RELATED APPLICATIONS

This application is a Continuation-In-Part of U.S. patent application Ser. No. 10/412,784 entitled “Layer One Switching in a Packet, Cell, or Frame-based Network,” filed Apr. 11, 2003, hereby incorporated by reference; which is a divisional of the parent U.S. patent application Ser. No. 09/375,135 entitled “Layer One Switching in a Packet, Cell, or Frame-based Network,” filed Aug. 16, 1999, which is hereby incorporated by reference; which is based upon U.S. Provisional Patent Application No. 60/097,138 entitled “Layer one Switching in a Packet, Cell, or Frame-based Network,” filed on Aug. 19, 1998, which is hereby incorporated by reference.

This application is a Continuation-In-Part of U.S. Pat. No. 6,611,519 entitled “Layer one Switching in a Packet, Cell, or Frame-based Network,” issued on Dec. 31, 2003, which is hereby incorporated by reference.

This application claims the benefit of United States Patent and Trademark Office patent application Ser. No. 09/375,135 entitled “Layer One Switching in a Packet, Cell, or Frame-based Network,” filed Aug. 16, 1999, which is hereby incorporated by reference.

This application claims the benefit of U.S. Provisional Patent Application No. 60/097,138 entitled “Layer one Switching in a Packet, Cell, or Frame-based Network,” filed on Aug. 19, 1998, which is hereby incorporated by reference.

### FIELD OF THE INVENTION

The present invention relates in general to network communications, packet switching, cell switching, frame switching, datagram switching, message unit switching, datagram or equivalent transmission, datagram or equivalent transfer, datagram or equivalent reception, network devices, architectures, and timing. More particularly, it relates to time scheduling and/or time reservations of packets, cells, datagrams, and/or frames in data transfer methods, mechanisms, devices, switches, network elements, network architectures, and/or network systems; as well as the means and methods which use time-oriented reservations and/or time-based scheduling to transfer data at layer one, layer two, layer three, layer four, higher layers, and/or any combination of these layers. The present invention operates in the areas of mobile, ad-hoc, wireless, land-based, space-based, wired, optical, fibered, and/or discrete components such as integrated circuits.

From a data transfer mechanism, routing device, switching mechanism, network element, and/or network system perspective, timed data transfer comprises mechanisms, means, and methods for transmitting, receiving, switching, storing, replicating, reproducing, re-transmitting, and/or otherwise enabling the movement of data such as packets, frames, and/or cells in a timed, scheduled, and/or reservation-oriented manner.

The present invention comprises means, methods, mechanisms, end-user devices, network elements, switches, routers, network architectures, and/or network systems either individually or in combination for: timed data transfer; scheduled data transfer; reserved data transfer; time-scheduled data transfer, time-reserved data transfer, path switching transfer; circuit switching transfer of packets, cells, frames, fixed-size slots, and/or variable-size slots; hybrid data-circuit transfer; hybrid data-path transfer; hybrid circuit-path transfer; and/or hybrid data-circuit-path transfer.

The present invention also comprises means, methods, mechanisms, end-user devices, network elements, switches, routers, network architectures, and/or network systems for timed data transfer using: timed data bypass mechanisms; timed data cut-through mechanisms; timed data tunneling mechanisms; single switching fabrics; multiple switching fabrics; shared switching fabrics; multistage switching fabrics; shared memory switching fabrics; distributed shared memory switching; crossbar switching; matrix switching; space switching; electrical switching; optical switching; MEMs (Micro-Electro-Mechanical) based switching; hybrid electrical/optical switching; optical to electrical conversion; electrical to optical conversion; shared internal data paths; and separate internal data paths.

### BACKGROUND OF THE INVENTION

General Background

Currently there are financial and technical reasons to converge circuit switched voice networks; packet-, cell-, and/or frame-switched/routed data networks; and video networks into a single network. Unfortunately, each network was designed specifically to route its own kind of data, not to carry the other networks' type of data. The result has been an industry acknowledgement that real-time data (voice, video, and other high-priority data) should be converged onto data networks. However, the practical reality is that network convergence has not worked well. This is especially true in the area of guaranteed real-time services for mobile ad-hoc (MANET) networks, which have special needs to overcome low bandwidth, wireless, and mobility issues.

The Problems in Converging Data and Real-time

Current packet-switching, cell-switching, frame-switching, store-and-forward, and/or other types of data communication networks were designed to provide high-efficiency routing and switching capability for bursty, non-periodic, non-predictable, non-time-sensitive data traffic. However, when attempting to deliver continuous, periodic, predictable, time-sensitive, or urgent information, the data switch/router style architecture is by its nature, ill-suited to efficiently or effectively perform the task.

This is because data network architectures, by their innate design, 1) first store the data in input buffers, 2) then examine the header for addressing and priority information, 3) then switch and route the data based on address and priority, 4) then store the data again in various output priority queues, 5) then wait for the output line to be free, and 6) then transmit the data to the next switch where the process is repeated. Each of these steps are subject to varying slowdowns and delays based on continuously varying, unpredictable network load congestion.

On the other hand, by its very different nature, continuous, periodic, predictable, time-sensitive, real-time and high-priority information require immediate switch-through with no delays. Thus, the characteristics which make data switching technologies so efficient for bursty, non-periodic, non-predictable, non-time-sensitive data, are the exact opposite of what is needed for continuous, periodic, predictable, time-sensitive, real-time, or high-priority information.

Current Inadequate Solutions to Problem

As a result of this dilemma, various complicated schemes have been devised in an attempt to compensate for and circumvent these underlying data network characteristics. Examples of these schemes include, but are not limited to prioritization or quality of service (QoS) schemes; priority queuing mechanisms; traffic management schemes; policing schemes; traffic shaping and/or smoothing; ATM (asynchronous transfer mode); constant and variable bit rates; guaranteed and peak bit rates; layer two switching/routing and cut-through techniques; layer two tag switching or multi-protocol layer switching (MPLS); layer three switching/routing and cut-through techniques; Diffserv (Differentiated Services); guaranteed throughput schemes; so-called wire-speed schemes; faster routing and switching; higher bandwidth; Gigabit routing/switching; etc.

Yet each of these attempts to speed up the basic data switching network architecture still remains solidly built upon the fundamental data switching architecture with its built-in FIFO (First-in-First-Out) internal buffers, lookup mechanisms, switching contentions, output queues, and output line contentions—all of which are subject to uncontrolled delay and jitter. Thus the result of these attempts to resolve the problem is a combination of solutions with complicated protocols, complex implementation schemes, and/or inefficient use of network resources. In spite of these attempts, data networks can still overload, congest, delay, and discard packets, thus destroying any real absolute guarantees on the timely delivery of real-time data.

The explosion of bursty, non-periodic, non-predictable, non-time-sensitive data traffic coupled with converging high-bandwidth, real-time applications over these packet, cell, and/or frame-based networks inevitably results in network congestion, delays, inconsistent delivery, jitter, packet loss, quality of service degradation, and/or inefficient networks. The applications most noticeably affected are real-time applications, such as VoIP (voice over IP) and/or video over IP, and/or other high-priority information.

Definitions of Real-Time and High-Priority Data

Real-time applications are defined as applications where the end user experiences the information in real-time as it flows over the network. Examples of real-time applications are telephony, Internet phone, packet phone video conferencing, video streaming, audio streaming, broadcast, multicast, and any other multimedia streaming applications. Real-time applications may be periodic, predictable, or time-sensitive.

High-priority information is defined as information that must be delivered more quickly, more reliably, more accurately, and ahead of other lower-priority information in the network. Examples of high-priority information include, but are not limited to emergency messages, time-sensitive or time-dependent information, network control messages, guaranteed delivery messages, or any other information deemed more important or more urgent for various reasons.

Factors Causing Problems

Several factors can cause real-time applications (such as VoIP, Internet phone, Internet Video phone, Internet Video Conferencing, Internet Streaming Audio, Internet Streaming Video, and other real-time applications) and even non-real-time applications, to suffer in both quality and time delays over packet-, cell-, or frame-oriented data networks. Among them are:
Packet, cell, and frame discard due to a congested switch, which in turn results in dropout glitches (poor quality) and/or increased delay time to retransmit missing packets, cells, or frames.
Packet loss due to alternate routing, which in turn results in dropout glitches (poor quality) and increased processing time to recover from and reconstruct missing packets.
Waiting for alternate path packets to arrive, resulting in time delays.
Reordering of packets that arrive out-of-order, resulting in time delays.
Higher layer processing (layers 2-4) of packets, cells, frames at each router/switch before routing the packets on to the next destination, resulting in time delays.
Input buffer delays, head-of-line blocking, round robin queuing and switching delays, address lookup time, output buffer delays, and output line contention delays.
Loaded/congested networks which slow down packet, cell, or frame delivery, resulting in random, non-predictable time delays.
Collisions and/or contention in shared transmission media environments such as CSMA/CD, Ethernet, Token-Ring, Aloha, CSMA/CA, shared media wireless systems (e.g., shared media 802.xxx-based systems), shared local area network (LAN) systems, or any other shared media contention which may cause congestion or delays, etc.
loading, congestion, and/or contention for resources inside a switch, router, or any other communications device, including but not limited to: input lines, input queues, priority queues, address lookup mechanisms, priority lookup mechanisms, switching fabrics, output queues, output lines, or any other resource sharing mechanisms in data switching or routing.
   Factors are Innate in Data Switches

Some combination or all of these problems are innate in packet, cell, and frame-oriented networks, their architectures, switches, and protocols. This includes older systems as well as the newer standards like TCP/IP version 6, Frame Relay, and ATM. Newer protocols and systems such as Resource Reservation Protocol (RSVP), DiffServ, IntServ, Bit Stream Reservation Techniques, layer two Switching, layer three Switching, Cut-though switching, Flow Switching and other techniques have been designed in an attempt to reduce these problems for real-time or high-priority information.

However, none of these efforts have been able to completely eliminate a fundamental architectural tenet of packet-, cell-, and frame-based switching—i.e., when network buffers get overloaded, these systems must drop packets and slow down to “decongest.” This can affect and slow down real-time applications and high-priority information. For example, in some of these efforts, once a real-time packet is in the input buffer, it can be routed through even a congested switch with a higher priority. However, if the input or output high-priority buffers are full, the real-time application may not be able to get its packet in to be recognized as a high-priority packet. Even if the input and output high-priority buffers are not full, real-time or other high-priority packets must wait behind each other to transmit out on the output line.

On the other hand, efforts to overcome this problem by reserving bandwidth capacity on the switch means the switch will, in effect, limit its efficiency or throughput to reserve capacity for guaranteed applications, thus resulting in greater inefficiencies for the data switch.

Circuit Switching vs. Data Switching

Generally speaking, there are two types of networks currently in use:
1. Circuit switched networks, such as those used in the current telephone network, which was designed specifically for real-time voice. Circuit switching includes the characteristics of dedicated channels, a call setup process to reserve and guarantee delivery, extremely low delay times (network latency) and low jitter, low bandwidth, fixed slot sizes, inefficiency in switching data, plus inefficiencies for silence intervals. Circuit switching may also be used in some situations for high-bandwidth video.
2. Data networks, such as the Internet, which were designed to transfer large blocks of non-real-time data between computers.
   Circuit Switching

Circuit switching—The most important positive aspects of circuit switching are its low delay (network latency) and jitter. This is achieved primarily because a) circuit switches are synchronized at the bit and/or frame level such that their small fixed-size slot positions can be identified between the circuit switches; and b) circuit switching exclusively reserves, assigns, and/or schedules these fixed-size slots in advance to a specific session or call using a Call Setup Process. In the Call Setup Process, the caller dials the phone, which reserves an 8 bit slotted “circuit” across the entire network for the duration of the call. Once the call is established, each voice switch along the path of the voice route knows in advance, exactly when to switch each incoming voice slot into each input buffer, exactly when to switch the data through the switch and into the output buffer, and then exactly when to switch the data out of the output buffer and into the output slot. Since the switch knows in advance exactly when and where to switch each slot of data, the switch doesn't need to look at the data itself to determine what to do. In addition, the reservation of circuit switching enables circuit switching to avoid the FIFO variable delays and packet loss of data networks.

Deterministic Switching and Deterministic Networks

A deterministic system is defined as a system that knows in advance what it's next state will be. Since this is true of circuit switching, this means that circuit switching is deterministic. Further, when a system knows exactly at what time it will switch to its known next state, it is called “time determinism.” Since circuit switching knows precisely the next state and the time to switch to that next state, circuit switching is “time deterministic.”

Because of its “time determinism”, which is established and scheduled during the call setup process, circuit switched voice information doesn't collide with other voice information on the network. Once a call is established, there is neither voice congestion nor varying delay in the delivery of the voice information. Thus, circuit switched networks typically have the following characteristics, including but not limited to:
the network elements are synchronized in a relative manner;
the sessions or calls take place in real-time;
there is usually a call setup process which may take place immediately prior to the call (a switched circuit or connection) or may be set up significantly in advance (a permanent circuit or connection);
there is input and output buffering at each node, but it is prescheduled, short, and of fixed duration, typically no more than a maximum of two frame sizes of approximately 125 microseconds each;
there are generally no “headers” with routing information as part of the data, so there is no header lookup at each network element;
the information is carried in very small-size, fixed-length slots (generally 8 bits);
the slots have fixed-positions in each frame so it is easy to identify and switch specific call time slots;
switching occurs at a layer one and/or physical level;
consequently circuit switching can switch real-time data very quickly through the network.
   Unfortunately, because of the small fixed-size slots, and the total dedication of each slot to a single call, circuit switching is very inefficient and slow for large amounts of data. Thus the need for data switching.
   Data Switching

Data Switching—Data networks are generally networks oriented around transporting information in packets, cells, or frames. When data networks were first developed, response time was not a critical issue for computer data. At the time, the most important aspect of data networks was its ability to switch large blocks of data relatively cheaply over expensive transmission media. The best way to do this at the time was to use a data switch or “packet switch,” with a data “header” or address attached to the front of the data to tell the data switch where to route the data next. This means that data switches do not know what their next “state” will be until a packet arrives, so data switches are “non-deterministic.”

Non-deterministic data switches typically must examine the incoming data “header” at a layer two or higher layer to determine the destination, quality of service, packet length, etc. Non-deterministic data networks typically have some common characteristics, including but not limited to:
the network elements are generally not synchronized, thus they are “non-time-deterministic”;
they were designed for non-real-time data;
they have no call setup process;
they use input and output buffering at each node, which is unscheduled, and susceptible to extremely long uncontrolled delay times, especially if the network is busy and/or congested;
they have “headers” with routing and other information as part of the data, which must be looked up to determine the next destination, thus causing more delays;
they have variable-sized packets, cells, or frames;
they switch at a layer two level and/or higher layer;
consequently packets, cells, or frames can switch very quickly or slowly through the network depending upon the load, but the delay and jitter can never be completely controlled.
   Today's Solutions
   Overbuild and Run at Low Efficiency—But Still Not Guaranteed

There are several approaches to alleviating the above delay problems, but none of them are ideal, or totally solve the problem. One of today's most commonly used approaches is to overbuild the data network, then run the data network at low efficiency, so it has less probability of congestion, jitter, delay, and packet loss.

Unfortunately, it is impossible to always run the data networks at extremely low efficiencies in order to attempt to guarantee low delay and low jitter. Even lightly loaded networks will occasionally get hit by a huge burst of data. Thus, low delay of real-time data is never guaranteed.

It is also uneconomical to run the data networks at too low an efficiency. Economics will tend to force oversubscription, which loads up the networks and results in congestion, delay, jitter, and packet discard.

ATM Cell Clumping Phenomena

Even a careful examination of ATM and traffic shaping, wherein the network input is smoothly shaped and controlled can still result in cell-clumping, congestion and delay. (see [1] S. J. Golestani. “Congestion-free Communication in High-Speed Packet Networks”. IEEE Transactions on Communications; Vol. 39, No. 12, pp. 1802-1812, December 1991; see also [2] The ATM Forum Technical Committee; Traffic Management Specification, Version 4.1, AF-TM-0121.000, Sect. 4.4.1, pp. 22-23, and Annex B.3, pp. 61-62, March 1999; see also [3] The ATM Forum Technical Committee; Traffic Management Specification, Version 4.1, AF-TM-0121.000, Informative Appendix V: VCC to VPC Multiplexing Effects and VPC Cell Conformance, pp. 96-97, March 1999.

Faster Switching, Faster Lookup Can't Catch up with DWDM

Other approaches begin pursued today are to use faster switching speeds; faster address lookup, e.g., MPLS (Multi-Protocol Label Switching); faster prioritization and Quality of Service (QoS) processing, etc. However, these solutions are limited by their architectural necessity to individually examine each and every packet, cell, or frame to determine its layer two or higher routing requirements, and in many cases to determine and handle its priority (i.e., Quality of Service). This requires enormous and expensive processing power, especially at Terabit and Petabit speeds.

In addition, switching contention, output line contention, and resulting delays also require processing power and memory to store and retrieve data. At terabit and petabit speeds, this becomes an enormous memory and processing expense.

The Bottom Line

Current solutions attempt to use faster data switching technologies, over-engineering, and under-utilization, with complex protocols, priority queuing, and other sophisticated internal mechanisms to try to emulate or simulate the low delay and jitter of “deterministic” systems.

Unfortunately, no matter how fast data switches are designed or how quickly the data is prioritized, it is impossible to get a deterministic output (guaranteed, predictable, circuit-switched quality) from a non-deterministic system (non-guaranteed, non-predictable, congestion-oriented). Since data networks are non-deterministic systems, there is always the possibility of congestion, delay, and drop-out. This is true even with well-engineered, well-managed, low-latency, QoS-oriented, MPLS-implemented, traffic-shaped, input-smoothed, Terabit-speed data networks running at “wire speed.” The truth is, there is no data network in existence today that is efficient scalable, free from congestion, dropout, and delay and can guarantee the on-time delivery of real-time packets. The problem is inherently “designed in” to today's packet, cell, and frame-based data networks. Thus today's non-deterministic data networks can never absolutely guarantee the delivery of real-time data such as voice and video.

Without guaranteed certainty of timely packet delivery, Voice over IP (VoIP) and Video over IP (even with QoS and MPLS), are not reliable enough for Business.

Clear Need

Clearly, there is a need for a way to:
guarantee delivery of selected packets, such as real-time and high-priority packets, like Internet phone, audio and video streaming, video conferencing, and urgent messages.
assure that selected packets, such as real-time and high-priority packets, arrive on time so that large buffers, long start delays, and awkward pauses are reduced or eliminated.
assure that selected packets with higher priority will be delivered more rapidly through the network than lower-priority packets.
overcome or bypass the packet networks' innate characteristic of slowing down the delivery of specific packets when the network gets loaded or congested.
perform the above tasks with a high degree of network efficiency and scalability.
   Some Objectives of the Invention

Real-time applications and high-priority information are dependent upon the rapid, consistent, on-time, non-blocked, non-delayed, non-congested, loss-less, jitter-free, reliable flow of data in real-time. With real-time applications and high-priority information, poor network performance resulting in time delays and quality loss can drastically degrade the quality of the end user experience and the value of the service. At the same time, network operators and administrators would like to avoid network complexities and inefficiencies in delivering real-time applications and high-priority information. These delays, degradation, inefficiencies, and complexities are what this invention seeks to overcome.

There are several needs in the current convergence of telecommunications networks. These needs are:
A converged network
   with lower network costs, less management personnel, and less management complexity;
   which derives the full and best benefits of circuit switching, data switching, and/or path switching without sacrificing flexibility, increasing complexity, and increasing inefficiency.
   which may also provide robust, reliable, efficient, mobile, wireless, and/or ad-hoc means with guaranteed real-time, high-priority capabilities.
Determinism in data networks
   Guaranteed low delay (perhaps even lower than today's circuit switching);
   Guaranteed low jitter;
   Zero congestion/contention for real-time and high priority data;
   Prevention of packet loss, especially from congestion and discard;
   High efficiency;
   High-scalability;
   Variable-size packets.
Less overloaded switches (especially for DWDM and mobile ad-hoc networks)
   Bypass/Cut-through switching equals lowered switch costs, greater throughput, and fewer switches;
   Less or no lookup for addressing and QoS, with consequent lower processing costs;
   Less or no input and output buffering time with lower memory requirements and costs for buffering (especially with DWDM);
Overcoming of lambda or wavelength routing problems
   Scalability;
   Switching all optically in a packet-by-packet manner over a lambda or wavelength;
   Higher efficiency per lambda;
   Guaranteed low delay and low jitter over entire end-to-end path, not just the core.
Guaranteed non-congesting for real-time.
Resiliency, protection switching, detection, and rerouting for path, circuit, or router failure
   Efficient error detection methods;
   Efficient, error rerouting methods.
Less protocol overhead and complexity
   Simpler, protocols and less overhead.
Flexible, intelligent switching and provisioning
   Switching of packets on a wavelength as needed, better than just provisioning a wavelength for a burst, and then it's not needed further.
Network management system
   Methods for network management, billing, and control.

### SUMMARY OF THE INVENTION

The present invention(s) includes but is not limited to new inventive approaches in the areas of timing, time-reservations, time-scheduling, time-reservation-scheduling, scheduled bypass/cut-through queuing/buffering, and/or scheduled bypass/cut-through switching in the many branches of data switching/routing—fixed, ad-hoc, mobile, wireless, optical, and even discrete devices (e.g., integrated circuit datagram/packet communications). The present inventions' devices, network elements, systems, networks, processes and methods generally work by using timing and/or reservation systems, devices, and processes to bypass, cut-through, and/or work-around today's standard data switching, routing, queuing, scheduling, and bandwidth reservation mechanisms (which cause today's variable packet delay, packet loss, and inefficient use of bandwidth).

The present invention(s) provides capabilities to deliver high-priority; high-reliability, time-sensitive, and/or time-critical information through a data network. Various improvements include but are not limited to: clocking, timing, and/or synchronization improvements; switching improvements; buffering and/or queuing improvements; process, method, and/or algorithm improvements; and/or network management, control, billing, and/or MIBs (Management Information Bases) capability.

Note that cross references to the numbered elements in the drawings are provided in Table 1 in the “Detailed Descriptions of the Drawings” section for further definition and clarification.

This application relates in part to and claims the benefit of United States Patent and Trademark Office Disclosure Document No. 431129, entitled “Fast, Guaranteed, On-Time Delivery of Real-Time Streaming Data in a Packet Switching Network”, which was filed in the United States Patent Office on Feb. 9, 1998, and which is hereby incorporated by reference.

This application also claims the benefit of United States Patent and Trademark Office Disclosure Document No. 500305, entitled “Layer One Switching in a Packet, Cell, or Frame-based Network,” which was filed in the United States Patent Office via US Certified Express Mail on Sep. 24, 2001, and received by the USPTO on Sep. 25, 2001. Said Disclosure Document No. 500305 is requested to be retained and referenced to this present Continuation-In-Part application, and is also hereby incorporated by reference.

Time-Scheduled, Time-Reserved, Time-Assigned Datagram/Packet Transfer Mechanisms, Devices, Switches, Network Elements, Means, and Methods

The foregoing problems are solved and a technical advance is achieved in accordance with the principles of this invention(s) as disclosed in multiple structural embodiments and methods of time-scheduled, time-reserved, time-assigned, and/or time-allocated datagram/packet transfer mechanisms, devices, switches, network elements, means, and methods.

These time-scheduled and/or time-reserved datagram/packet transfer mechanisms, devices, switches, network elements, means, and methods comprise:
1) synchronization and/or timing—means and methods for synchronization of clocks and/or other timing mechanisms for determining time-scheduled and/or time-reserved datagram/packet transfer times, arrival times, departure times, and/or other activity times in time-scheduled and/or time-reserved datagram/packet transfer mechanisms, devices, switches, and/or network elements;
2) scheduling—means and methods for scheduling and/or reserving datagram and/or packet times, setting up calls/sessions/reservations, and/or tearing down calls/sessions/reservations for high-priority, real-time, reliable, and/or other time-scheduled and/or time-reserved datagram/packet calls or sessions in time-scheduled and/or time-reserved datagram/packet transfer mechanisms, devices, switches, and/or network elements; and
3) transferring data—means and methods for transferring, transmitting, receiving, switching, storing, retrieving, replicating, reproducing, re-transmitting, and/or obstructively or non-obstructively enabling the movement of data, within and between time-scheduled and/or time-reserved datagram/packet transfer mechanisms, devices, switches, and/or network elements, either solely in a time-scheduled, time-allocated, and/or time-reserved datagram/packet manner or in a hybrid combination of time-scheduled, time-allocated, and/or time-reserved datagram/packet and other non-layer one, non-time-scheduled, non-time-allocated, and/or non-time-reserved datagram/packet techniques.
   Time-Scheduled and/or Time-Reserved Datagram/Packet Transfer Mechanisms, Devices, Switches, and Network Elements

Time-scheduled and/or time-reserved datagram/packet transfer mechanisms, devices, switches, and/or network elements may further comprise:
means and methods for transferring data within and between various time-scheduled and/or time-reserved datagram/packet mechanisms, devices, switches, and/or network element embodiments, using various switching, buffering, and/or allocation approaches, which includes but is not limited to:
   time-scheduled, time-reserved, time-designated, time-assigned, and/or time-allocated datagram/packets;
   integrated devices;
   overlay devices;
   source devices;
   destination devices;
   LANs;
   time deterministic (or time-bounded) time-scheduled and/or time-reserved datagram/packet transfer;
   synchronized data transfer;
   scheduled time transfer;
   scheduled data transfer;
   bypass switches, buffers, and/or transfer;
   cut-through switches, buffers, and/or transfer devices;
   tunneling switches, buffers, and/or transfer devices;
   header-less data transfer devices and/or header-less packet transfer devices;
   path switches and/or transfer devices;
   time-path switches and/or transfer devices;
   circuit switching of packets, or packet-circuit switching and/or transfer devices;
   combinations or hybrids of time-scheduled and/or time-reserved datagram/packet switching with non-layer one, non-time-scheduled, and/or non-time-reserved datagram/packet switching such as layer two and/or higher layer transfer devices, in addition to path-circuit transfer devices, path-data transfer devices, circuit-data transfer devices, and path-circuit-data transfer devices.
means and methods for time-scheduled and/or time-reserved datagram/packet device embodiments comprising variations of input and output line types, including but not limited to: optical, electrical, and/or wireless inputs;
means and methods for time-scheduled and/or time-reserved datagram/packet device embodiments with various optional device components, including but not limited to:
   optional sniffers and/or real-time readers;
   optional timestamp transmitters and/or receivers;
   optional framers and/or deframers;
   optional optical/electrical and/or electrical/optical converters;
   optional input and output buffers with various improvements such as bypass and reservation scheduling mechanisms; and
   various optional input and/or output stage switching configurations supporting various paths through the switching device including completely separate paths or shared paths;
means and methods for time-scheduled and/or time-reserved datagram/packet device embodiments comprising variations of optional switching fabric components, including but not limited to:
   optional single switching fabrics and/or dual switching fabrics;
   optional blocking and/or non-blocking switching fabrics;
   optional delaying and/or non-delaying switching fabrics;
   optional optical, electrical, and/or both optical and electrical switching fabrics;
   optional switching fabrics wherein no speed or bit rate conversions or changes may be required to transfer information through the switch fabric;
   optional switching fabrics which may support point-to-point, point-to-multipoint, multipoint-to-point, and multipoint-to-multipoint connections;
means and methods for time-scheduled and/or time-reserved datagram/packet device embodiments comprising: input edge nodes, internal or middle nodes, output edge nodes, and/or end-user devices;
means and methods for implementing time-scheduled and/or time-reserved datagram/packet specific device embodiments in various types of devices, and/or uses of devices, and/or applications running in devices, comprising:
   telephones; computers; personal computers; host computers; messaging devices; personal digital assistants; packet telephones; IP phones; private branch exchanges (PBXs); web servers; video equipment, video conferencing equipment; web browsers; end-user devices; Local Area Networks (LANs) and devices connected to Local Area Networks; wireless LANs; mobile ad-hoc networks and devices; CSU/DSUs; multiplexers and/or demultiplexers; applications running in computers, host computers, web servers, web browsers, including but not limited to real-time and/or high-priority applications such as:
      voice, video, data, integrated voice and video, video conferencing applications, integrated voice video and/or data, and/or network management and control applications.
         Time-Scheduled and/or Time-Reserved Datagram/Packet Operation Methods

The basic time-scheduled, time-allocated, and/or time-reserved datagram/packet operation comprises:
1) Optional—One or more time-scheduled and/or time-reserved datagram/packet network elements (which may be combined with non-layer one, non-time-scheduled, and/or non-time-reserved datagram/packet network elements) in the network are synchronized such that network elements can determine time-scheduled and/or time-reserved datagram/packet data transfer times, arrival times, and/or departure times (internal and/or external to the network element). Synchronization may occur separately per link or may be coupled to multiple links. Synchronization may occur externally or internally, and with one or more clocks and/or synchronization mechanisms. Synchronization may be controlled externally, internally, dynamically, and/or with a MIB (Management Information Base). Time-scheduled and/or time-reserved datagram/packet network elements and their synchronization systems may be fixed, mobile, wireless, optical, and/or ad-hoc. Synchronization systems may use absolute time; relative time; time relative to one or more signal(s), code(s), heartbeat(s), sync pulse(s), and/or synchronization packets/datagrams; and/or other time scheduling mechanism(s) such as fixed, variable, and/or dynamically variable time-slot mechanisms.
2) A network element, transfer mechanism, device, switch, MIB, and/or other network element, source, destination, or middle node may set up one or more time-schedules, reservation schedules, and/or time-based reservation schedules with one or more time-scheduled and/or time-reserved datagram/packet network devices for transferring (internally or externally) real-time, high-priority, high-reliability, and/or other time-scheduled and/or time-reserved datagram/packet data. Time schedules, reservation schedules, time assignments, and/or time-based reservation schedules may use absolute time; relative time; time relative to one or more signal(s), code(s), heartbeat(s), sync pulse(s); and/or other time scheduling mechanism(s) such as time-slot mechanisms (fixed, variable, and/or dynamically variable). One or more time schedules, reservation schedules, and/or time-based reservation schedules may be kept internally and/or externally in one or more network elements, devices, switches, routers, servers, end-user devices, network controllers, network managers, databases, and/or MIBs. One or more time schedules, reservation schedules, and/or time-based reservation schedules and/or time slots may be defined to carry surplus time-scheduled and/or time-reserved datagrams/packets which may have fallen behind and could not be delivered normally due to time clock slippage, jitter, multiple non-synchronized clock sources, and/or other timing problems.
3) At the time-scheduled and/or time-reserved datagram/packet scheduled time(s), the one or more time-scheduled and/or time-reserved datagram/packet devices switch their appropriate input and/or output lines to enable a time-scheduled and/or time-reserved datagram/packet transfer. Optionally, each of one or more time-scheduled and/or time-reserved datagram/packet devices may or may not buffer the time-scheduled and/or time-reserved datagram/packets in input and/or output queues. Optionally, each of one or more time-scheduled and/or time-reserved datagram/packet devices may or may not use header lookup for the time-scheduled and/or time-reserved datagram/packets in input and/or output queues.
   Networks

The present invention(s) comprises an illustrative standard packet, cell, frame, or other data switching network as shown in FIG. 1, FIG. 2, FIG. 3, and other Figures, comprising:
At least one real-time or non-real-time Data Source 1 such as a streaming audio/video application source or an Internet Phone caller or other source, such data source 1 may or may not be a part of Departure Data Router/Switch/Transmitter/Data transfer device 2;
At least one Departure Data Router/Switch/Transmitter/Data Transfer device 2 which may or may not include the real-time or non-real-time Data Source 1;
Optional Mid-destination Routers/Switches/Data transfer devices as represented by Mid-Destination Router 3;
At least one Final Destination Router/Switch/Receiver/Data transfer device 4, which may or may not include a real-time or non-real-time Data Receiver 5; and
At least one a real-time or non-real-time Data Receiver 5 for the application destination such as a streaming audio/video application destination and/or Internet Phone or Video Conference receiver. Real-time or non-real-time Data Receiver 5 may or may not be included in Final Destination Router/Switch/Receiver/Data transfer device 4. (Note that the concept may be bi-directional and work in reverse for two-way messaging such as Internet Phone or Video Conferencing.)

The time-scheduled and/or time-reserved datagram/packet connection is capable of achieving no delays other than transmission delays, propagation line delays, and time-scheduled and/or time-reserved datagram/packet switch and/or transfer device propagation delays. Alternatively, packets may be scheduled to be buffered and/or stored at various time-scheduled and/or time-reserved datagram/packet transfer devices along the way.

If the time-scheduled and/or time-reserved datagram/packet network elements are combined with standard packet, cell, and/or frame switching/routing/bridge/hub/gateway devices and/or other store-and-forward network elements, the time-scheduled and/or time-reserved datagrams/packets may completely bypass, cut-through, and/or tunnel-through the standard data packet, cell, and/or frame switching/routing/bridge/hub/gateway devices, and/or store-and-forward switches/routers/gateways. In this way, the time-scheduled and/or time-reserved datagrams/packets may completely bypass, cut-through, and/or tunnel through the store-and-forward and/or standard packet, cell, and/or frame switching/routing/bridge/hub/gateway data network with all of its inherent jitter, delays, congestion, discard, and other disadvantages for continuous, periodic, predictable, time-sensitive, or high-priority information. Once the packets have been sent through the device and/or network, and the time-scheduled and/or time-reserved datagram/packet event is over, the devices may switch back to standard packet, cell, and/or frame switching/routing/bridge/hub/gateway data switching for bursty, non-periodic, non-predictable, non-time-sensitive, and non-high-priority information (although they still may use Quality of Service or other prioritization methods for their layer two and/or higher layer switch/routing services). In this way, the system works to optimum advantage and efficiency for each of the two types of data and switching methods.

Alternatively, the time-scheduled and/or time-reserved datagram/packet devices may transmit the non-time-scheduled, and/or non-time-reserved datagram/packets in the time-scheduled timing system as well, such that all datagrams/packets are transferred at fixed, specific, variable, dynamic, and/or predetermined times and/or time slots. The time-scheduled and/or time-reserved datagram/packets may be sent at previously scheduled and/or reserved time slots, whereas the non-layer one, non-time-scheduled, and/or non-time-reserved datagram/packets may be sent at times (e.g., time slots) that have not been previously reserved for them. When a previously scheduled time-scheduled and/or time-reserved datagram/packet is not available for transmission at its scheduled and/or reserved time (e.g., time-slot), then the previously scheduled time (time-slot) may be filled with another packet (either a time-scheduled, time-reserved datagram/packet or a non-time-scheduled, and/or non-time-reserved datagram/packet.

Sequential Switching

Because of transmission propagation delays between transfer nodes in the network, the network path may comprise a sequential opening and closing of time-scheduled and/or time-reserved datagram/packet physical connections at successive transfer nodes in the path, whereby the specific scheduled packets propagate directly through all of the time-scheduled and/or time-reserved datagram/packet switches on the path to the other end of the network, with no delays other than transmission line and time-scheduled and/or time-reserved datagram/packet switch and/or transfer node propagation delays.

Momentary Storage

In addition, because of scheduling conflicts, packets may be scheduled to be momentarily stored at one or more transfer nodes along the path and then transferred further along the path according to the schedule.

Parallel Paths and No Storage

Alternatively, using parallel paths between transfer nodes, such as with Dense Wave Division Multiplexing (DWDM), packets may travel through the path with no storage by scheduling alternative parallel paths when scheduling conflicts arise for the primary path. Examples of parallel paths might be an alternative parallel fiber, an alternative parallel lambda or wavelength, an alternative route through another node entirely which has no scheduling conflicts, or a path through a completely different route and/or a completely different transmission medium.

Other Types of Network Topologies

In addition to a point-to-point multi-hop network topology, a subset of these methods may be utilized in a point-to-point embodiment wherein the time-scheduled and/or time-reserved datagram/packet connection may be a point-to-point scheduled time-scheduled and/or time-reserved datagram/packet connection comprising a single hop between two time-scheduled and/or time-reserved datagram/packet network elements.

Another instance of this method may be a multicast, simulcast, or broadcast embodiment wherein the scheduled time-scheduled and/or time-reserved datagram/packet connection is point-to-multipoint, multipoint-to-point, and/or multipoint-to-multipoint over multiple hops.

Another instance of this method comprises shared-media transmission paths, e.g., local area networks (LANs), or wireless and/or mobile ad-hoc networks using shared Ethernet, shared wireless spectrum, etc., wherein time-scheduled and/or time-reserved datagram/packet connections may be established on a point-to-point, point-to-multipoint, multipoint-to-point, and/or multipoint-to-multipoint basis over shared-media.

Other instances of these methods may comprise methods of accessing a network, and methods for mobile networks and mobile network elements, including pre-scheduled times for specific sessions, packets, flows, transactions, etc., including 802.11 standards and mobile ad-hoc networks.

Network Elements/Devices

Network elements 1, 2, 3, 4, and/or 5 may be stationary and/or mobile devices, and/or any combination of stationary and/or mobile devices, including mobile ground vehicles, satellites, and/or aerial craft. Such network elements 1, 2, 3, 4, and/or 5 may be hardware devices and/or software programs and/or a combination of hardware and/or middleware and/or software, which may be: physically in different geographical locations; in the same location; even located on the same circuit board (e.g., as separate integrated circuits or chips intercommunicating), and/or even as components communicating within a single chip.

Such network elements 1, 2, 3, 4, and/or 5 may have a pre-planned network configuration; it may be configured ad-hoc, e.g., as in a mobile ad-hoc network (MANET); and/or some combination of planned and ad-hoc.

Sniffers

In FIG. 72, attached to input line 40a is a real-time optional sniffer device 37, also variously described as a snooper, input receiver, input monitor, listener, and/or time stamp receiver 37 which is controlled by and sends feedback to controller 120 over control lines 42a. If the input line 40a is optical, then optional sniffer 37 would have a real-time optical-electrical converter. It may then comprise an ASIC, FPGA, shift register, or other input examining and comparing mechanism for determining information about the incoming packet, cell, or frame as it shoots past at a time-scheduled and/or time-reserved datagram/packet level. It is important to note that the sniffer 37 optionally may not be directly in line with the input circuit so it does not cause any delays to the incoming data. It merely “taps” the incoming line such that it can monitor the incoming packet for information which may be of value.

The sniffer 37 can be used in various ways, including but not limited to:
detecting inter-nodal time stamp packets in real-time for precise inter-nodal synchronization using various timestamp methods, such as the two-way time transfer method.
detecting packet arrival time to tighten the timing precision between nodes. * determining information about the packet, such as the packet length or size or DSCP code points, etc., by reading the value in the header.
detecting line breaks if packets do not arrive.
   Data Transfer Paths

The present invention(s) also comprises one or more optional transmission, communication, and/or other data transfer paths 11, 12, 13, and/or 14, as shown in FIG. 1, FIG. 2, FIG. 3, and other Figures. Such data transfer paths 11, 12, 13, and/or 14 may be wired, fibered, optical, wireless, free-space, land-based, space-based (e.g., satellites, airplanes, mobile vehicles), bus-based (e.g., on a circuit board in either single path or multiple line/path configuration), and/or comprise any other transfer media over a network or inside a single device or integrated circuit. Such data transfer paths may or may not be subject to collision, contention, interference, jamming, and/or congestion. For example, such data paths may comprise CSMA/CD (Carrier Sense Multiple Access/Collision Detection), CSMA/CA (Carrier Sense Multiple Access/Collision Avoidance), any other collision media system, or any non-collision system such as a point-to-point wired or optical connection path. The packet, cell, frame, and/or other data switching network data transfer paths may include:
Optional transmission, transfer, signaling, and/or communications path 11 between the real-time or non-real-time Data Source 1 and the Departure Data Router/Switch/Transmitter/Data transfer device 2;
Optional transmission, transfer, signaling, and/or communications path 12 between the Departure Data Router/Switch/Transmitter/Data transfer device 2 and the optional Routers/Switches/Data transfer devices Mid-destination Router 3;
Optional transmission, transfer, signaling, and/or communications path 13 between the optional Routers/Switches/Data transfer devices Mid-destination Router 3 and the Final Destination Router/Switch/Receiver/Data transfer device 4;
Other potential transmission, transfer, signaling, and/or communications paths between Departure Data Router/Switch/Transmitter/Data transfer device 2 and Final Destination Router/Switch/Receiver/Data transfer device 4, such as a multiple hop path or a direct path between Departure Data Router/Switch/Transmitter/Data transfer device 2 and Final Destination Router/Switch/Receiver/Data transfer device 4 (not shown); and
Optional transmission, transfer, signaling, and/or communications path 14 between the Final Destination Router/Switch/Receiver/Data transfer device 4 and the Real-time or non-real-time Data Receiver 5.

Networks and/or network elements may specify predetermined, fixed, data transfer paths (e.g., RSVP-style protocol where the path is fixed in advance); changeable data transfer paths (initially established, but subject to change); and/or non-predetermined transfer paths (the network determines the path based upon its routing tables at the time (e.g., mobile ad-hoc IP networks where link degradation may be continually occurring).

Clock(s)

The present invention(s) also comprises one or more physical and/or virtual timing system(s) 6 (see element 6 in Table 1) (see also FIG. 1 through FIG. 26 and additional Figures), to which the Router/Switch/Transmitter/Receiver/Data transfer devices 2, 3, 4 and potentially end-user devices 1 and 5 are precisely or roughly synchronized through direct and/or indirect timing means 6a, 6b, 6c, 6d, and/or 6e (see FIG. 1 through FIG. 8; FIG. 21 through FIG. 26, and additional Figures). Said Router/Switch/Transmitter/Receiver/Data transfer devices 2, 3, 4 may also include the addition of synchronization mechanisms 22, 23, and 24, which may be attached to and/or integrated with each Router/Switch/Transmitter/Receiver/Data transfer devices 2, 3, 4 and which variously synchronize the Router/Switch/Transmitter/Receiver/Data transfer devices 2, 3, 4 with each other. Upgraded or modified hardware and/or software 32, 33, and 34 may be incorporated with the Router/Switch/Transmitter/Receiver/Data transfer devices 2, 3, 4 and with synchronization mechanisms 22, 23, 24, to facilitate the timed and un-timed transfer of data in the present invention.

Physical and/or virtual timing system(s) 6 may use an external centralized clock for timing and synchronization (see FIG. 4), e.g., one or more Global Positioning Systems (GPS) or any other clock (e.g., atomic clocks) and/or centralized timing synchronization system. Various other alternative direct and/or indirect methods of distributing clocks, timing, and synchronization may also be used by relaying clock information between Router/Switch/Transmitter/Receiver/Data transfer devices 2, 3, 4 (and potentially source and destination elements 1 and 5), either with or without master clocks (see FIG. 1 through FIG. 26).

Using the declassified version of the GPS system, i.e., the Standard Positioning Service (SPS), each router can obtain clock synchronization to within 340 nanoseconds. Using the classified version of the GPS system, i.e., the Precise Positioning Service (PPS) each router can obtain clock synchronization to within 100 nanoseconds or less. This accuracy can be improved even more by the use of Differential Techniques familiar to those skilled in the art. For example, using Common Mode Time Transfer, differential GPS techniques can achieve accuracy of 10 nanoseconds or less over baseline transmissions as much as 2,000 km apart.

In an alternative and/or complementary approach, a clock synchronization scheme could be implemented whereby each router sends its time-stamped clock information to its adjacent router(s) which then immediately sends it back. By comparing these time stamps between routers, relatively high accuracy may be achieved.

Alternatively, or in addition to other methods, the routers may also measure the approximate transmission delay times between themselves on individual links due to propagation delay, processing time, etc., by transmitting their current times and having the adjacent routers compare it to their current times immediately upon receipt.

Alternatively, or in addition, routers/switches/network elements may send clock sync bits and/or other synchronization signals either in-band and/or out-of-band to each other. Multiple, non-synchronized clocks may be used.

Timed Transfer Mechanisms

The hardware/software 32, 33, and 34 on the routers/switches 2, 3, and 4 may include a mechanism to enable a connection to transfer data from one incoming line (say Transmission Path 12) to an outgoing line (say Transmission Path 13) either with or without buffering; through an alternative switching fabric and/or the original router/switch switching fabric; and/or through improved buffering/queuing mechanisms which bound the internal delay time for high-priority, high-reliability, and/or time-crucial time-sensitive traffic. This modification to the router/data transfer devices 2, 3, 4 enables Guaranteed On-Time Delivery packets to bypass the standard queuing mechanisms and cut-through or tunnel straight through the router either buffered or unbuffered. This enables variable delays such as the header lookup delay to be avoided if desired. On the other hand, header lookup may still be performed (e.g., for packet classification) if desired.

Internal and/or External Network Management/Control MIBs

Network elements 1, 2, 3, 4, and/or 5, as well as synchronization mechanisms 22, 23, 24 and/or hardware/software 32, 33, 34, may be controlled by Management Information Bases (MIBs) 209 which comprise internal and/or external network control and/or network management functionality (see FIG. 1, FIG. 2, FIG. 27 through FIG. 31). This internal and/or external Network Control/Management Functionality MIB 209 may reside either within and/or without one or more of said network elements 1, 2, 3, 4, and/or 5; within and/or without synchronization mechanisms 22, 23, and/or 24; and/or within and/or without hardware or software 32, 33, 34 (See FIG. 27, FIG. 28, FIG. 29, FIG. 30, FIG. 31).

Such Management Information Bases (MIBs) 209 may comprise various network management, network control, and/or other network information functions including, but not limited to: timing(s), schedules, routing, paths, configurations, addressing, fault management, accounting, performance management, security, key management, interface management, network intelligence, and/or switch control (See FIG. 27, FIG. 28, FIG. 29, FIG. 30, FIG. 31). Network control functionality MIB 209 may comprise network interface functionality 210, network intelligence/knowledge/routing control functionality 211, and/or switch control functionality 212 (see FIG. 27, FIG. 28, FIG. 29, FIG. 30, FIG. 31), with various MIB network functionality 209 residing either internally or externally to the network elements 1, 2, 3, 4, 5, 22, 23, 24, 32, 33, and/or 34.

Paths 213, 214, and 215 (FIG. 1, FIG. 2, FIG. 27, FIG. 28, FIG. 29, FIG. 30, FIG. 31) illustrate direct, indirect, in-band, out-of-band, physical, and/or virtual communication and/or signaling paths for Network control functionality 209 to intercommunicate with network elements 1, 2, 3, 4, 5, 22, 23, 24, 32, 33, and/or 34.

Timed Transfer Process/Method

Several processes/methods may be used to transfer packets, cells, frames, or other data in accordance with timing, scheduling, and/or reservations. Below is one:
Step 1—Routers/switches 2, 3, and/or 4 (middle node(s) 3 is optional) may synchronize to each other using a physical or virtual timing system 6 to synchronization mechanisms 22, 23, and/or 24 (this may be done with absolute time (e.g., day, hour, minute, second, fraction of second, etc.) and/or with relative time, (i.e., time relative to some synchronization signal, pulse, bit stream, reference, etc.).
Step 2—Routers/switches 2, 3, and/or 4 may schedule absolute and/or relative times for transfer of data in packets (cells or frames) through hardware/software 32, 33, and/or 34. These times may be statically set up in advance or dynamically set up as needed by negotiation between the switches/routers 2, 3, and/or 4 (and possibly the end points 1 and 5). End points 1 and 5 may be incorporated into router/switches 2 and 4, respectively.
Step 3—Packets (frames or cells) scheduled for transmission are transferred at the scheduled times. This may occur from router/switch to router/switch such that packets are guaranteed to be transferred at their scheduled times and hence to arrive at their scheduled times.

Another process to transfer time-scheduled data is (see FIG. 142):
Step 1—(A) Node 1 sends to Node 2 a Request for Time-Scheduled Reservation/Time/Time-Slot in Node 2 (X2); Request may be either with or without data payload; and in one of Node 1's reserved Times/Time-Slots (X1), or in one of Node 1's non-reserved Times/Time-Slots (Request may be sent in-band and/or out-of-band).
Step 2a—(B) If a Time-Scheduled Reservation/Time/Time-Slot (X2) is Available in Node 2, then Node 2:
   Assigns the Time/Time-Slot (X2) in Node 2's Event Schedule Table for this Packet, Session, Source, Application, Session, Transaction, and/or Flow, etc.; and
   (optionally) ACKs (positive acknowledgement) to Node 1 that Time/Time-Slot Reservation info (X2) has been reserved/scheduled for Node 1's Packet(s), Session, Source, Application, Session, Transaction, and/or Flow, etc; and
   (optionally) (A) If this is not the final destination for the Request, then Node 2 may send the same Request message (Step 1 repeat) on to the next appropriate hop. OR
Step 2b—(C) If NO Time-Scheduled Reservation/Time/Time-Slot (X2) is Available in Node 2, then Node 2, then: Node 2:
   (optional) Sends a NACK (Negative Acknowledgement) to Node 1 that Node 2's Time-Reservation Schedules are all reserved; try again later, and/or try another link/path to the final destination.
Step 3a—(D) If Node 1 received an ACK from Node 2, then Node 1:
   Looks at Time/Time-Slot Reservation info (X2) in received ACK; Places (X2) info in Event Schedule, and inserts Time/Time-Slot Reservation info for Node 2 (X2) into the reserved Packets, when transmitting them to Node 2. Node 1 then transmits the scheduled Packet(s) with (X2) info in it to Node 2 at Nodel's Reserved Time Slot (X1). OR
Step 3b—(E) If Node 1 received a NACK from Node 2, then Node 1:
   (optional) Looks at received NACK, and either Waits and retries later; or locates a different next node link and repeats Step 1 to and alternate Node 2.

The process may also transfer packets as follows (see FIG. 143):
Step 1—(G) When Node 2 receives a packet, it looks at the marker information to see if this is a time-scheduled packet. If a Time-Scheduled Reservation/Time/Time-Slot (X2) is marked in the Received Packet, then Node 2:
   Immediately place this packet in Reserved Time-Scheduled Buffer (X2).
   (optionally) Retrieve the Time-Scheduled Reservation/Time-Slot for this packet from the event schedule for the next hop (X3).
   (F) Sends Reserved Packet—Insert Time/Time-Slot Reservation info (X3) for the next hop into the reserved Packets, Sessions, Sources, Applications, and/or Flows. Node 2 transmits this Packet with (X3) info in Node 2's Reserved Time Slot (X2).
   (L) (optional) Node 2 may transmit an ACK with Time/Time-Slot Reservation info (X2) to Node 1 so Node 1 will know that Node 2 is still within range, and that Node 1 may continue transferring Time-Scheduled packets to Node 2.
   (H)—(optional) If no next packet is in Node 2's Reserved Time-Scheduled Buffer (X2) during next occurrence of Time-Slot (X2), then Node 2 may transmit a Non-Time-Scheduled Packet in Time-Slot (X2), in accordance with the Non-Time-Scheduled Scheduling Algorithm (such as Weighted Fair Queuing, etc.) Alternatively, Node 2 may move a time-scheduled packet up from a later time-slot and transfer the time-scheduled packet in Node 2's Time-Slot (X2).
   I)—(Optional) Keep-alive Messages may be sent to Node 1 and received from Node 1 to keep the session active and the Time-Slot reserved. Otherwise a time-out may be used to time-out the session.

The process may also tear down time-scheduled packets/sessions as follows (see FIG. 144):
Step 1—(J) (Optional)—Node 1 (or any nodes) may Send a Teardown Message Packet to next hop(s) (This would usually begin from the source or destination node).—Node 1 includes the Time/Time-Slot Reservation info (X2) in the Teardown message.
If this is a Time-Scheduled Reserved Packet, then Node 1 retrieves the Time/Time-Slot Reservation info (X2) in Node 1's Event Schedule, and inserts Time/Time-Slot Reservation info (X2) into the Teardown Message when transmitted to Node 2. Node 1 may Transmit the Packet with (X2) Teardown info in this Node 1's Reserved Time Slot (X1). OR
(K)—Node 1 may stop sending to Node 2 Session/Flow packets with (X2) information, and/or KeepAlive messages. This lets Node 2's Timeout expire for the session/flow.

The process may also handle signal fade and/or rerouting for time-scheduled packets/sessions as follows (see FIG. 145):
Step 1—; then Node 1 knows that the Scheduled reception of the signal with Time/Time-Slot Reservation info (X2) may not be occurring (not received by Node 2).
Step 2—(M)—If the optional periodic ACK from Node 2 to Node 1 (L) with Time/Time-Slot Reservation info (X2) dies, fades, is jammed, and/or possibly Times Out; then Node 1 knows that Time-Scheduled reception for Time/Time-Slot Reservation info (X2) is not occurring;
OR, if Node 1's Routing/Link Table protocols detect that the link to Node 2 is down (or too weak) or that there is a better path, then Node 1 changes its' Route/Link Table to a better next hop than Node 2,
Then, Node 1 locates a different next node link in its routing table and repeats to the new next node link:
   (A)—New Request for Time-Scheduled Reservation/Time/Time-Slot either with or without data payload.
   [And the process repeats and self-corrects.]

Another alternative recursive Time Scheduled Packet Process follows (see FIG. 146). This approach has no pre-set path; may be non-session-oriented; may have no separate Request/Call Setup and/or Teardown messages; is backward compatible to existing standards (e.g., may use existing packet standards such as DiffServ Code Points—DSCP); and may be used in a network comprised of both time-schedule-enabled nodes and non-time-schedule-enabled nodes. This process works for VoIP (Voice over IP) Voice Calls, Video streams, and other high-priority, high-deliverability, and/or high-time-critical datagrams such as DSCP Expedited Forwarding (EF) Class or AF (Assured Forwarding) Class.
Step 1—The previous hop node (or higher layers in this same node) mark the Datagram is Highest Priority for Time Criticality and/or Assured Forwarding (e.g., DSCP EF (Expedited Forwarding)).
Step 2—the Node Receives the high-priority datagram and examines its priority markings:
   a) If the datagram is Highest Priority for Time Criticality (e.g., DSCP EF (Expedited Forwarding), then the Node looks at the Source, Destination, Session, Application ID, Port #, Flow, and/or other special Identifier in Layers 1 through 7 for Special Identifier(s) that may enable it to uniquely identify packets from this session, etc. The Node then looks up this Special Identifier(s) in Time-Reservation Schedule 129 to see if the Special Identifier has already been assigned/scheduled a Time-Reservation Buffer/Time/Time-Slot (See FIG. 121, FIG. 122, elements 90a-90n).
      If Special Identifier is already assigned/scheduled a Time-Reservation Buffer/Time/Time-Slot (90a-90n) in the Time-Reservation Schedule 129, then put Datagram in assigned Time-Reservation Buffer (90a-90n) or directly into assigned/scheduled Time/Time-Slot. (Optional—may put datagram into next available Time-Slot if that time-slot does not have a Time-Scheduled packet ready to send.) Reset assigned Time-Reservation Buffer Time-To-Kill Expiration Timer 129a.
      If Special Identifier is NOT already assigned a Time-Reservation Buffer/Time/Time-Slot (90a-90n) in Time-Reservation Schedule 129, and Time-Reservation Buffer/Time/Slots are available, then assign packet to an available Time-Reservation Buffer/Time/Time-Slot (90a-90n), put Special Identifier info in Time-Reservation Schedule 129 for that Time-Reservation Buffer/Time/Time-Slot (90a-90n), and mark it unavailable. Put Datagram in assigned Time-Reservation Buffer (90a-90n) or directly into assigned Time/Time-Slot. (Optional—may put datagram into next available Time-Slot if that time-slot does not have a Time-Scheduled packet available.) Reset assigned Time-Reservation Buffer Expiration Timer 129a.
      If Special Identifier is NOT already assigned a Time-Reservation Buffer/Time/Time-Slot (90a-90n), and NO Time-Reservation Buffer/Time/Slots (90a-90n) are available, then (optional) put packet in standard highest-priority Non-time-scheduled queue (89, 89a) for standard high-priority delivery.
   b)—If Datagram is not Highest Priority for Time Criticality (e.g., not DSCP EF (Expedited Forwarding)), then put packet in standard Priority Queues for Non-Time-Scheduled Datagrams (See FIG. 121, FIG. 122, elements 89, 89a-89n) according to standard FIFO priority class, as appropriate.
   c)—Time-Reservation Buffer Expiration Timer(s)/Time to Kill 129a—Set and/or reset Timer 129a for designated Time-Reservation Buffer/Time/Time-Slot (90a-90n) in Time-Reservation Schedule 129 when Time/Time-Slot is initially allocated and/or when a datagram appropriate to a designated Time-Reservation Buffer/Time/Time-Slot (90a-90n) arrives and/or is transmitted.
   When Timer 129a expires (due to non-use/no session traffic, etc.) associated with that Time-Reservation Buffer/Time/Time-Slot (90a-90n), then free up the Time-Reservation Buffer/Time/Time-Slot (90a-90n), and mark it available in the Time-Reservation Schedule 129.

Another timed transfer process/method is as follows:
Step 1—All routers synchronize to each other. This may be with absolute time (e.g., day, hour, minute, second, fraction of second, etc.) and/or with relative time, (i.e., time relative to some synchronization signal, pulse, bit stream, reference, etc.). Once the clocks are directly and/or indirectly synchronized, routers then measure or compute the approximate transmission delay times between themselves and their adjacent routers, as explained above.
Step 2—Real-Time Source 1 sends a notification message to Departure Router 2 that it wants to set up a real-time transmission (i.e., a Guaranteed On-Time Delivery of Real-Time Streaming Data) to Real-Time Receiver 5. This message notifies the Departure Router 2 that this may be the first of a long stream of packets whose delivery is time-dependent and should not be subject to variable router delays, or other packet network delays. Predetermined paths may be specified or non-pre-determined paths may be specified. Included in this notification may be the requested streaming rate for the data.
Step 3—Departure Router 2 looks at the intended destination and requested data rate. Just as it does in standard packet switching, it determines that the next router is Mid-destination Router 3 and the transmission path is Transmission Path 12. Departure Router 2 then looks at Transmission Path 12's data rate and compares it to the requested data rate from Real-Time Source 1. Departure Router 2 then determines how frequently and for what duration it should send packets of data from Real-Time Source 1 over Transmission Path 12 to Mid-destination Router 3. This determination is based upon data rates and pre-existing schedules/reservations that may already be in existence. Based upon this determination, Departure Router 2 reserves/schedules exact times and durations for it to send information over Transmission Path 12 to Mid-destination Router 3. It then sends a notification message to Mid-destination Router 3 telling it that it is requesting to reserve/schedule a real-time transmission, along with the appropriate source address, destination address, its preferred departure times and duration time from Departure Router 2, and its estimated arrival times at Mid-destination Router 3.
Step 4—The Mid-destination Router 3 receives the notification message from Departure Router 2. Router 3 looks at the source, destination, and requested data rate. It determines that the next router is Final Destination Router 4 using Transmission Path 13. It then looks at its own schedule, the transmission delay times, the calculated arrival times and duration time of the data that is to come from Departure Router 2. Mid-destination Router 3 then tries to schedule its switching mechanism to route the stream through to the Final Destination Router 4. If there is a scheduling conflict due to an existing schedule, Mid-destination Router 3 tries to accommodate the data by buffering and delaying it very slightly. If this can't be done with only a slight delay, Mid-Destination Router 3 determines a reservation/schedule that works better for it. It reserves those times and communicates back to Departure Router 2 its suggested changes to the original schedule. It also may at this time notify Final Destination Router 4 what it is trying to do to determine what unreserved/unscheduled time Final Destination Router 4 might have available. This information is passed back to Departure Router 2. In this way the routers negotiate an acceptable reservation/ schedule that works for all of them.
If no schedule is acceptable, then the Departure Router 2 notifies the Real-Time Source 1 that it has been unable to set up a Guaranteed Real-Time reservation. Real-Time Source 1 can then decide if it wants to: (a) use standard packet switching with all of the inherent delays, (b) wait until the reservation/schedule frees up from other sessions which will complete and tear down their reservations/schedules soon, or (c) begin a standard packet switching session with the hope that a Guaranteed Real-Time reservation/schedule will become available during the session as other Real-Time sessions are completed and torn down. In situation (c) a standard packet switching style session can convert to a Guaranteed On-Time Real-Time session once the reservation/scheduling arrangements can be made, even during the course of a session, if desired.
Step 5—Final Destination Router 4 repeats the process described in Step 4, communicating its reservation/schedule back to Departure Router 2 and Mid-destination Router 3 until an acceptable reservation/schedule is set up between them. Final Destination Router 4 then notifies the Real-Time Receiver 5 that a session is being established. In this way the Real-Time Receiver 5 gets ready to accept Real-Time data input.
Step 6—Once the reservation/scheduling is agreed upon, Departure Router 2 notifies Real-Time Source 1 to start shipping data. Departure Router 2 then ships the data to Mid-destination Router 3 over Transmission Path 12 at the agreed upon time. Mid-destination Router 3 is ready and waiting for the data at the calculated arrival time and “hardwire” switches the data (buffered or unbuffered) straight on through to Final Destination Route 4 over Transmission Path 13 at the correct times. Final Destination Route 4 then “hardwire” switches the data (buffered or unbuffered) straight on through to the Real-Time Receiver 5 over Transmission Path 14.
Step 7—When the session has no more data to ship (i.e., the streaming program is completed, or the phone call is “hung up”), then the reservation/schedule for that session needs to be torn down. This event can be triggered by a notification from either of the end routers to the routers along the path. Once a router receives notification that the session is over, it tears down (i.e., frees up its reservation schedule) that session and reverts to standard packet network mode until another Guaranteed Real-Time session is requested and negotiated, which starts the process all over again.

Another approach to clocking/synchronization is as follows:
Step 1—Optionally, synchronize the clocks in the different routers/switches (or synchronize link-to-link) as closely as possible (Step 1—described previously).
Step 2—Optionally, set up Reservation/Scheduling times as closely as possible in the routers/switches (Step 2—described previously).
Step 3—Slightly ahead of the scheduled time that the first packet is supposed to be received by the receiving router, the receiving router begins listening for the first packet to arrive. At the precise moment that the first packet arrives, the receiving router notes its own exact time (say time t₁, using its own clock). The sending router set up the reservation/schedule such that the first stream of packets was sent at time to and the second stream of packets will be sent at time t₀+tₓ (tₓ being the time difference between when the first stream of packets and the second stream of packets is sent). The receiving router knows this reservation/schedule and knows to listen for the second stream of packets at its own time when it received the first packets plus this difference (t₁+tₓ). Thus, once the first stream of packets arrives at a router in the network, the router knows exactly when all the other streams will arrive in a particular session, even if the clocks are not synchronized absolutely precisely.

An approach to the clocking time transfer situation is to send in-band and/or out-of-band synchronization pulses, bits, packets, and/or any other synchronization signal(s) and/or reference marker(s), as shown in FIG. 16 through FIG. 26 and additional Figures:
Step 1—Optionally, synchronize the clocks in the different routers/switches/sources/destinations as closely as possible using periodic and/or non-periodic and/or irregular reference markers 180 and/or floating sync reference markers 180a (Step 1—described previously) see FIG. 16 through FIG. 26 and additional Figures. Such periodic and/or non-periodic and/or irregular reference markers 180 and/or floating sync reference markers 180a may be information packets as well as non-information packets. Such periodic and/or non-periodic and/or irregular reference markers 180 and/or floating sync reference markers 180a may be point-to-point and/or multi-point and/or multi-hop signals. Such periodic and/or non-periodic and/or irregular reference markers 180 and/or floating sync reference markers 180a may be at the beginning and/or ending point of a frame 189 (see FIG. 17) and/or at any point in the frame or multiple frames 189 (see FIG. 18). Such periodic and/or non-periodic and/or irregular reference markers 180 and/or floating sync reference markers 180a may also contain pointers and/or offsets 188 to the beginning and/or end of the frame 189 (see FIG. 17C and FIG. 17D, FIG. 18, FIG. 19, and FIG. 20).
Step 2—Optionally, set up a Reservation/Scheduling time(s) in the routers/switches (Step 2—described previously) for one or more time scheduled packet(s) 181 (see FIG. 18 and FIG. 19). This reservation schedule may be a specific time (for example, hours-minutes-seconds-subseconds using GPS or another clock); and/or a time relative to a reference marker 180 or 180a (using GPS, another clock, and/or any other time reference marker); and/or a prearranged or scheduled offset or pointer 187 or 188 from the beginning of frame 189 or reference marker 180 or 180a; and/or a prearranged or scheduled offset from the pointer beginning point 188 to the time scheduled packet 181 (see FIG. 18 through FIG. 26). Offset or pointer 187 or 188 may be in bits, symbols, time, or any other method.
Step 3—Optionally, the receiving router begins listening for time scheduled packets to arrive at the reserved/scheduled time. At the moment that a scheduled packet 181 (or synchronization marker 180 or 180a) arrives, the receiving router may confirm and optionally reset synchronization time by comparing the time scheduled packet 181 arrival time with the expected/reserved/scheduled arrival time. Note that the time offset 187 or 188 will be the same time differential at the sender as it is at the receiver, even if the sender and/or receiver are in motion (see FIG. 25, FIG. 26). Thus this approach will continue to maintain synchronization to the reservation schedule offset on a point-to-point basis even in a wireless and/or mobile environment.
   Hybrid Operation Between Timed and Non-Timed (Standard) Packets

The routers/switches 2, 3, and/or 4 are not necessarily scheduling or transferring timed, scheduled, and/or time-reservation data at all times on the transmission paths between routers/switches 2, 3, and/or 4. For example, if Transmission Path 12 and Transmission Path 13 operate at T1 speeds (1.5 Megabits per second) and the real or non-real-time source 1 is periodically “broadcasting” time-scheduled real-time packets at 64 Kbps, then Departure Router 2 may schedule certain specific times to pass the periodic packets carrying the 64 Kbps through the 1.5 Mbps pipe. At other non-scheduled times, Departure Router 2 may transfer “bursty” packets over the T1 line just like a standard packet switching system normally does.

This means that the network (and the switch/routers) are operating in a hybrid mode. Part of the time, in timed mode, the router/switches are transferring data in accordance with the timed reservation schedules so that reserved packets are guaranteed to get through the network on time. The rest of the time, in standard packet switching mode, the router/switches are transferring data in standard non-controlled “bursty” mode (See FIG. 24).

Overloaded Scheduled Times May Revert to Standard Mode

Multiple Guaranteed Real-Time sessions can be established in a multi-node network with a high degree of efficiency. However, when too many Guaranteed Real-Time sessions are established and the next session can't achieve a Guaranteed Real-Time schedule, the application could go ahead and start sending in normal packet mode and later switch to Guaranteed Real-Time Mode as older sessions are torn down and more reservation/scheduling time is freed up. The routers may also be set up to report to network managers when no Guaranteed Real-Time paths are available, so that network administrators could at some point increase the capacity of the network.

Buffering or Queuing Time-Scheduled Data

When very few reservations/schedules have been set up, time-scheduled switching/routing can be easily accomplished. However, once a lot of reservations/schedules have been set up in the network; if complete clock sync is not achieved; if packet header lookup is desired; some non-time-schedule-enabled nodes are in the path; and/or other reasons, it's possible that delays between arrival and departure times may need to be accommodated. This means that time-scheduled buffering and delay may need to be implemented. This is acceptable as long as the timing can be kept reasonably under control so that the bits are delivered on time to the final destination. However, the more layers that are processed, the slower and more delayed the overall delivery will be, which is particularly of concern on the interactive-style applications such as Internet Phone Internet Video conferencing.

If the incoming bit rate (say 56 Kbps) is different than the outgoing bit rate (say T1), then buffering is required. This may be acceptable for small time delays, but caution should be exercised in the design so that delays are acceptable to end users.

Scheduled Session Setup and Teardown

The Tear-down process may be detected and initiated in several ways. (a) If it is a “broadcast” or “multicast”-style program where the overall time (start-time, duration, end-time, total bits, etc.) is known, then the final packet's “flight” through each router can be computed and each router can tear down the reservation/schedule after the last packet has gone through without any final notification from the Departure Router 2. (b) If it is a “voice-call”-style session, where the “hang-up” time is unknown, then a “Tear-Down” notification message could be sent to all the other routers by either end router aware of the “hang-up” condition. (c) If the session is either a broadcast or voice-call style session, a notification could be attached to the last packet instructing the router that this is the last packet and to tear down the reservation/schedule.

No Setup and Teardown Possible for Time-Scheduled Packets

It is possible to establish time-scheduled packets without a setup and teardown process (see FIG. 146).

Headerless Packets

One of the efficiencies created is that the packets (frames or cells) can be “header-less” as far as not having source and destination addresses attached to each packet. When each router knows the exact time of arrival for each Guaranteed Real-Time packet, it can also know the source and destination addresses of the packet. Stripping off these addresses for each packet would make the network more efficient by reducing the number of bits sent over the net. However, the Final Destination Router 4 may have to reinsert the address for delivery to Real-Time Receiver 5.

Some Improvements

Some Time-scheduled and/or time-reserved datagram/packet Network Improvements include:
Categories and definitions of time-scheduled and/or time-reserved datagram/packet networks and switching (time-scheduled and/or time-reserved datagram/packet switching, synchronized data switching, deterministic data switching, path switching, circuit switching of packets, combination/hybrids)
Transmission media clarifications (electrical, optical, wireless; parallel-DWDM)
Additional and improved time-scheduled and/or time-reserved datagram/packet network configurations (Point to point, Access, LANs)
Network clocking, timing, and synchronization (absolute chronological time synchronization from universal reference source, relative chronological time synchronization from relative reference source, clockspeed synchronization from clock bitstream reference)
Network embodiments

Some Time-scheduled and/or time-reserved datagram/packet Device Improvements include:
Categories and definitions of Devices (Bypass switches/dual fabrics, Cut-thru switches or tunneling switches/single fabrics, path switches, circuit switches of packets, data switches, combos/hybrids)
Input line types
Device components (Optional Sniffers, Optional timestamp transmitters/receivers, Optional Framers/Deframers, Optical/Electrical and Electrical/Optical converters, Optional input and output buffers, various input and output stage switching configurations, switch fabric options)
Device embodiments

### BRIEF DESCRIPTION OF THE DRAWINGS

FIG. 1 is a high-level functional block diagram of a network system, comprising elements and components of said network system as disclosed in Disclosure Document No. 431129, and U.S. Pat. No. 6,611,519, incorporated herein by reference. FIG. 1 includes timing capabilities, and network management and control systems.

FIG. 2 is a redrawing of FIG. 1, done in a linear manner for easier visual understanding, such that data clearly flows from left to right, i.e., from source to destination, through the network system according to a preferred embodiment of the present invention. Clocking may or may not use Global Positioning System signals. Clocking may be in-band and/or out-of-band.

FIG. 3 is a more detailed high-level functional block diagram FIG. 2, showing the bi-directionality or two-way nature of the network system according to a preferred embodiment of the present invention. Clocking may or may not use Global Positioning System signals. Clocking may be in-band and/or out-of-band.

FIG. 4 is a functional diagram of the network system showing External Centralized Clock(s) Timing and Synchronization with a first timing embodiment of a centralized clock, and which may or may not use Global Positioning System signals. Clocking may be in-band and/or out-of-band.

FIG. 5 is a functional diagram of the network system showing Alternative Methods of Distributing Clocks, Timing, and Synchronization with a second Timing Embodiment that of External Common Master clock Distribution distributed over in-band or out-of-band links, which may or may not use Global Positioning System signals.

FIG. 6 is a functional diagram of the network system showing Alternative Timing Synchronization from Source or Destination or another network element with or without a Master Clock or GPS. This is a third Timing embodiment with an optional Master Clock that can also be synced off of a Source or Destination network element without a Master Clock, and which may or may not use Global Positioning system signals. Clocking may be in-band and/or out-of-band.

FIG. 7 is a functional diagram of the network system showing Alternative Methods of Distributing Clocks, Timing, and Synchronization with a fourth Timing Embodiment, using Internal Common Master clock(s) Distribution and Relay, and which may or may not use Global Positioning system signals. Clocking may be in-band and/or out-of-band.

FIG. 8A and FIG. 8B are functional diagrams of the network system showing Alternative Methods of Distributing Clocks, Timing, and Synchronization with a fifth Timing Embodiment using No centralized Master Clock. Note that there is no clock synchronization through node 33 to illustrate that multiple clocks may be used in this timing embodiment of the network. This approach may use separate timing and synchronization on point-to-point or multipoint links, and may or may not use Global Positioning system signals. Various clocks may be in-band and/or out-of-band.

FIG. 9A and FIG. 9B illustrate the capability for Point-to-Point Time Scheduled Packet Transfer using a Single Common Clock (May Use Loopback Timing, but not necessary).

FIG. 10 illustrates the architecture and timing for a Time-Scheduled Access System, such as accessing a network over copper, Copper, DSL, Fiber, Coax, Cable, Wireless, Optical Wireless, etc.

FIG. 11 illustrates the architecture of separate data and voice networks interconnecting 2 campuses with Separate PBX Dedicated Lines & Data Dedicated Lines.

FIG. 12 illustrates the architecture of Single Dedicated-Line Point-to-Point Transfer of Time Scheduled Packet and Non-Time-Scheduled Data (Packets) with Multiple Sources and Multiple Destinations.

FIG. 13 illustrates the architecture and timing of a PBX system using time-scheduled packet switching and timing.

FIG. 14A and FIG. 14B illustrate various timing architectures for time-scheduled packet switching from a mobile wireless station to a base station or mobile unit.

FIG. 15A and FIG. 15B illustrate alternative timing architectures for time-scheduled packet switching from a mobile wireless station to a base station or mobile unit.

FIG. 16A, FIG. 16B, FIG. 16C, and FIG. 16D show various methods of relative timing at source and destination using periodic sync reference markers and/or Irregular or Non-Periodic or One-Time Event Sync Reference Markers (These can be sent irregularly when the BW is unavailable to continuously maintain sync).

FIG. 17A, FIG. 17B, FIG. 17C, and FIG. 17D show various methods of relative timing at source and destination with Sync Reference Markers optionally at Beginning or Ending Point of Frame—Periodic (In-band or Out-of-band) and/or Sync Reference Markers with Pointers to Beginning of Frame—Note Sync Ref Markers Can Float.

FIG. 18A, FIG. 18B, FIG. 18C, and FIG. 18D show various methods of relative timing from source 1 to destination 5 with Sync Reference Markers Immediately Before Beginning Point (of Frame and Time Scheduled Packet) and Multiple or Single Frames between markers.

FIG. 19A, FIG. 19B, FIG. 19C, and FIG. 19D show various methods of relative timing from source 1 to destination 5 with Sync Reference Markers using Pointer(s) to Beginning Point (typically of frame) and offset to Time Scheduled Packet, which may include Multiple or Single Frames between markers.

FIG. 20A, FIG. 20B, FIG. 20C, and FIG. 20D show various methods of relative timing from source 1 to destination 5 with special Reserved time intervals 176 for additional time-scheduled and/or layer one datagrams which accumulate at various nodes due to multiple clocks, non-synced clocks, clock discrepancies, clock variations, jitter, and/or clock slippage, etc. on various links.

FIG. 21A, FIG. 21B, FIG. 21C, and FIG. 21D show various methods of relative timing from source 1 to destination 5 using pointer(s) 188 and/or offsets 187 to designate special Reserved time intervals 176 for additional time-scheduled and/or layer one datagrams which accumulate at various nodes due to multiple clocks, non-synced clocks, clock discrepancies, clock variations, jitter, and/or clock slippage, etc. on various links.

FIG. 22 illustrates a Point-to-Point clocking and Transfer of Time Scheduled Packets and Non-Time-Scheduled Data (standard Packets) with Multiple Sources and Multiple Destinations.

FIG. 23 (FIG. 23A through FIG. 23I) depicts a time-line example of the transfer of time-scheduled packets 170 and non-time-scheduled packets 172 from Source 1q to Destination 5k referring to the previous FIG. 22. Here it can be seen how time-scheduled packets 170 get delivered on time, while non-time-scheduled Standard Data Packets 172 may be delayed.

FIG. 24 illustrates the functional architecture and timing used to show how Time Reserved Packets 172 are scheduled for Time-reserved Buffers 90, thus bypassing Non-Time-Scheduled packets 170 in Standard Priority Queues 89 in output section 70.

FIG. 25 illustrates architecture and Timing Synchronization for Moving (Mobile) Ad-hoc Nodes. Timing Synch may be clock link syncs and/or Common Master clock(s) Distribution and Relay, and may or may not be GPS.

FIG. 26 illustrates methods for Mobile Ad-hoc Hidden Nodes and/or Fading Nodes. Here the old link(s) have been broken at the X, and new links and timing are established immediately. Thus, Time-scheduled packets immediately resume the session over different links.

FIG. 27 is a detailed high-level functional block diagram of a linear illustration of the network showing the first device embodiment, the preferred hybrid integrated device embodiment, shown operating as the network elements. This device embodiment may use any of the clock synchronization and/or timing embodiments, and may or may not use the global positioning system.

FIG. 28 is a detailed high-level functional block diagram of a linear illustration of the network showing the combination and/or hybrid integrated device embodiment of the timed packet switching device. This hybrid device may or may not include input buffers, output buffers, and/or input and output buffers, and may or may not comprise data switching, path switching, and/or circuit switching. It may send time-scheduled packets at specific and/or particular scheduled times. It may send non-time scheduled packets at non-scheduled times or at scheduled-times when a time-scheduled packet is not available. These devices may comprise one or more optional Blocking and/or optional Delaying Switch fabrics; Optical or Electrical and/or opto-electrical switch fabrics, and/or other non-single switch fabrics; Multiple Parallel Transmission Media (including DWDM), and/or parallel optical, electrical, and/or wireless media. This device embodiment may use any of the clock synchronization and/or timing embodiments, and may or may not use the global positioning system.

FIG. 29 is a detailed high-level functional block diagram of a linear illustration of the network showing the combination and/or hybrid integrated device embodiment of the timed packet switching device.

FIG. 30 illustrates a combination Path, or Circuit, or Path and Circuit switching network using the Integrated Embodiment of the network elements.

FIG. 31 is a detailed high-level functional block diagram of a linear illustration of the network showing separate dedicated transmission lines for the combination and/or hybrid integrated device embodiment of the timed packet switching device.

FIG. 32 is a detailed high-level functional block diagram of the network, wherein the fifth device embodiment, that of the source and/or destination device embodiment is shown operating as the source and/or destination in the network.

FIG. 33 is a detailed high-level functional block diagram of the network, wherein the second device embodiment, that of the overlay device embodiment, is shown operating as the network elements comprising a time-scheduled data switching network.

FIG. 34 is a detailed high-level functional block diagram of the network, wherein the second device embodiment, that of the overlay device embodiment, is shown operating as the network elements comprising a time-scheduled data switching network.

FIG. 35 is a detailed high-level functional block diagram of the network, wherein the pure circuit switching device embodiments are shown operating as the network elements comprising a time-scheduled data switching network.

FIG. 36 is a detailed high-level functional block diagram of the network, wherein the hybrid circuit-switching and path switching device embodiments are shown operating as the network elements comprising a time-scheduled data switching network.

FIG. 37 is a detailed high-level functional block diagram of the network, wherein the pure time-scheduled switching device and network path switching embodiments are shown comprising a time-scheduled data switching network. This non-hybrid device may or may not include input buffers, output buffers, and/or input and output buffers, and comprises path switching. It may send time-scheduled packets at specific and/or particular scheduled times. These devices may comprise one or more optional Blocking and/or optional Delaying Switch fabrics; Optical or Electrical and/or opto-electrical switch fabrics, and/or other switch fabrics; Multiple Parallel Transmission Media (including DWDM), and/or parallel optical, electrical, and/or wireless media. This device embodiment may use any of the clock synchronization and/or timing embodiments, and may or may not use the global positioning system.

FIG. 37 is a detailed high-level functional block diagram of a linear illustration of the network showing the pure timed packet switching device. This device may or may not include input buffers, output buffers, and/or input and output buffers. It sends time-scheduled packets at specific and/or particular scheduled times. These devices may comprise one or more optional Blocking and/or optional Delaying Switch fabrics; Optical or Electrical and/or opto-electrical switch fabrics, and/or other switch fabrics; Multiple Parallel Transmission Media (including DWDM), and/or parallel optical, electrical, and/or wireless media. This device embodiment may use any of the clock synchronization and/or timing embodiments, and may or may not use the global positioning system.

FIG. 38 is a detailed high-level functional block diagram of the network, wherein the seventh device embodiment, that of the pure time-scheduled and/or time-reserved datagram/packet and/or pure path switching device embodiment, is shown operating as a network element thus creating a pure path switching network.

FIG. 39 is a detailed high-level functional block diagram of the network, wherein the sixth device embodiment, that of the Time Reservation Scheduled Local Area Network (LAN) device embodiments are shown as network elements, including bus and ring oriented LANs. These may or may not operate with common clocks.

FIG. 40 illustrates the synchronization and timing of circuit switched and/or packet based (e.g., IP) PBX and/or hybrid switching systems, transmitters, radios, broadcasts, multicasts, and/or unicast mechanisms, along with the interconnection of time-scheduled systems with legacy systems.

FIG. 41 is a more detailed high-level functional block diagram of a more complex network environment with the components of a time reservation scheduled datagram network system according to the present invention. FIG. 41 also shows two examples of the sixth device embodiment as time reservation scheduled Local Area Network or LAN systems.

FIG. 42 illustrates the Generalized Network Control and/or Network Management Architecture for Time-Scheduled Packet Switching.

FIG. 43 illustrates the Generalized Network Control and/or Network Management Architecture 209 for Time-Scheduled Packet Switching, with the Switch, Device, and/or Network Element Control Functionality 212 exterior to the network elements.

FIG. 44 illustrates the Generalized Network Control and/or Network Management Architecture 209 for Time-Scheduled Packet Switching, with the Switch, Device, and/or Network Element Control Functionality 212 moved into the network elements and the Network Intelligence/Knowledge/Routing control functionality 211 exterior to the network elements.

FIG. 45 illustrates the Generalized Network Control and/or Network Management Architecture 209 for Time-Scheduled Packet Switching, with the Switch, Device, and/or Network Element Control Functionality 212 and the Network Intelligence/Knowledge/Routing control functionality 211 moved into the network elements (local) and the network interface functionality 210 located exterior to the network elements (global).

FIG. 46 illustrates the Generalized Network Control and/or Network Management Architecture 209 for Time-Scheduled Packet Switching, with the Switch, Device, and/or Network Element Control Functionality 212, the Network Intelligence/Knowledge/Routing control functionality 211, and the network interface functionality 210 all moved into the network elements (local).

FIG. 47A and FIG. 47B show various signaling architectures for call setup, teardown, and management with respect to Time-Scheduled Packet Switching and networks.

FIG. 48 shows various layers for various routing schemes. FIG. 48A shows Layer 3 Routing or Switching—Packet Forwarding—Packet-by-Packet Routing. FIG. 48B shows Cut-Through Layer 3 Switching (e.g., MPLS) with First Packet for Flow setup, then Subsequent Packets used Layer 2 Flow Forwarding. FIG. 48C shows Time-Scheduled packet switching with an Optional First Packet Flow Setup (A separate Call Setup packet may not be required) at any of the layers, with all other packets flowing according to scheduled, time-reserved, packet Switching.

FIG. 49 illustrates the control plane and user plane for Time-Scheduled packet switching using the TCP/IP reference model; the 802.11 protocol stack; and other stacks. Time-Scheduled Control plane may comprise Signaling, Routing, and Management (Time Scheduled Reservation packets may be made at various layers). The Time-Scheduled User plane comprises Time Scheduled Packets that may be routed/switched based on information in the packet at various layers and/or by arrival time.

FIG. 50A shows framed slots for circuit switching which cannot send large quantities of data effectively. FIG. 50B shows large, variable size packets which take an unpredictable number of frames, which delay real-time packets, resulting in inefficiency.

FIG. 51 shows Time-Scheduled packets 235 (e.g., voice, video, etc.) with time reservations being periodically inserted at the scheduled times, with the non-time-scheduled standard data packets 237 transmitting after the Time-Scheduled packets 235. Periodic Time-Scheduled packet 236 then transmits on time as well.

FIG. 52 shows an Illustrative Exemplary Standard Packet, Cell, Frame and/or other Information Structure 27 with Exemplary Bits/Fields (e.g., DSCP—DiffServ Code Points bits/fields) for Time Reservation/Schedule/Slot Request/Assignment 27w. These indicator bits may be optionally placed anywhere in the exemplary packet.

FIG. 53 shows an Illustrative Exemplary GRE Information Packet, Cell, and/or Frame Structure 27 with Exemplary Bits/Fields (e.g., DSCP—DiffServ Code Points bits/fields) for Time Reservation/Schedule/Slot Request/Assignment 27w. These indicator bits may be optionally placed anywhere in the exemplary packet.

FIG. 54 shows an Illustrative Exemplary PPTP Information Packet, Cell, and/or Frame Structure 27 with Exemplary Bits/Fields (e.g., DSCP—DiffServ Code Points bits/fields) for Time Reservation/Schedule/Slot Request/Assignment 27w. These indicator bits may be optionally placed anywhere in the exemplary packet.

FIG. 55 shows an Illustrative Exemplary Information Structure, e.g., in 802.11x PLCP PHY Packet, Cell, and/or Frame 27 with Exemplary Bits/Fields (e.g., DSCP—DiffServ Code Points bits/fields) for Time Reservation/Schedule/Slot Request/Assignment 27w. These indicator bits may be optionally placed anywhere in the exemplary packet.

FIG. 56 shows an Exemplary Illustrative Information Structure, e.g., in Voice IP Packet, Cell, and/or Frame 27, with or without payload and/or header compression, with or without 802.11a or other headers, and with or without Exemplary Bits/Fields (e.g., DSCP—DiffServ Code Points bits/fields) for Time Reservation/Schedule/Slot Request/Assignment 27w. These indicator bits may be optionally placed anywhere in the exemplary packet.

FIG. 57 is a high level schematic diagram of a seventh embodiment, the “pure time-scheduled and/or time-reserved datagram/packet” embodiment of a time-scheduled and/or time-reserved datagram/packet network switch or router device according to the present invention comprising master clock synchronization means, input, output, control, and switching means which may be non-blocking, non-delaying time-scheduled switching means, with no store-and-forward switching means.

FIG. 58 is a high level schematic diagram of a first embodiment and the preferred embodiment of an integrated time-scheduled and/or time-reserved datagram/packet network switch or router device according to the present invention comprising master clock synchronization means, input, output, control, and integrated store-and-forward switching means, and switching means which may be non-blocking, non-delaying switching means.

FIG. 59 is a high level schematic diagram of Integrated Time Schedule Packet Switch—Both Electrical and Optical Fabrics with Separate data switch fabric.

FIG. 60 is a high level schematic diagram of Integrated Time Schedule Packet Switch—Both Electrical and Optical Fabrics with Separate data switch fabric (alternative input switch).

FIG. 61 is a high level schematic diagram of Integrated Time Schedule Packet Switch—Completely Separate Paths between Data Switching and Time Scheduled Packet Switching.

FIG. 62 is a high level schematic diagram of Integrated Time Schedule Packet Switch—Completely Separate Paths between Data Switching, L1 Electrical Fabric and L1 Optical Fabric Switching.

FIG. 63 is a high level schematic diagram of Integrated Time Schedule Packet Switch—Optical Fabric with separate Data Switch

FIG. 64 is a high level schematic diagram of Integrated Time Schedule Packet Switch—Optical Fabric with separate Data Switch and separate paths.

FIG. 65 is a high level schematic diagram of an Integrated Time Schedule Packet Switch—Electrical Fabric with Separate Data Switch.

FIG. 66 is a high level schematic diagram of an Integrated Time Schedule Packet Switch—Electrical Fabric with Separate Data Switch and separate paths.

FIG. 67 is a high level schematic diagram of an Integrated Time Schedule Packet Switch—Electrical Fabric with Separate Data Switch and separate paths.

FIG. 68 is a high level schematic diagram of an Integrated Time Schedule Packet & Layer 2/3 Switch/router—Both Electrical and Optical Single Fabrics with Single Fabric lines per input(alternative).

FIG. 69 is a high level schematic diagram of an Integrated Time Scheduled & L2/3 Switch/router—Both Electrical and Optical Single Fabrics with Dual Fabric lines per input.

FIG. 70 is a high level schematic diagram of an Integrated Layer 1 & Layer 2/3 Switch/router—Both Electrical and Optical Single Fabrics with Separate Paths and Single Fabric lines per input.

FIG. 71 is a high level schematic diagram of an Integrated Layer 1 & Layer 2/3 Switch/router—Both Electrical and Optical Single Fabrics with Separate Paths and Dual Fabric lines per input.

FIG. 72 is a high level schematic diagram of an Integrated Time Scheduled Packet & Layer 2/3 Switch/router—Optical Single Fabric with Single Fabric lines per input.

FIG. 73 is a high level schematic diagram of an Integrated Time Scheduled Packet & Layer 2/3 Switch/router—Optical Single Fabric with Dual Fabric lines per input.

FIG. 74 is a high level schematic diagram of an Integrated Time Scheduled Packet & Layer 2/3 Switch/router—Electrical Single Fabric with Single Fabric lines per input.

FIG. 75 is a high level schematic diagram of an Integrated Time Scheduled Packet & Layer 2/3 Switch/router—Electrical Single Fabric with Dual Fabric lines per input.

FIG. 76 is a high level schematic diagram of a second embodiment, the “overlay” embodiment of a time-scheduled and/or time-reserved datagram/packet network switch or router device according to the present invention comprising master clock synchronization means, input, output, control, and switching means which may be non-blocking, non-delaying switching means, coupled to a physically separate store-and-forward switching means.

FIG. 76 is a high level schematic diagram of an Overlay Time Scheduled Packet Switch/router—Both Electrical and Optical Fabrics with separate data switch.

FIG. 77 is a high level schematic diagram of an Overlay Layer 1 Switch—Both Electrical and Optical Fabrics with Separate data switch fabric (alternative input switch).

FIG. 78 is a high level schematic diagram of an Overlay Layer 1/Time Scheduled Packet Switch/Router—Completely Separate Paths between Data Switching and L1 Switching.

FIG. 79 is a high level schematic diagram of an Overlay Time Scheduled Packet Switch/router—Completely Separate Paths between Data Switching, L1 Electrical Fabric and L1 Optical Fabric Switching.

FIG. 80 is a high level schematic diagram of an Overlay Time Scheduled Packet Switch—Optical Fabric with separate Data Switch.

FIG. 81 is a high level schematic diagram of an Overlay Time Scheduled Switch/Router—Optical Fabric with separate Data Switch and separate paths.

FIG. 82 is a high level schematic diagram of an Overlay Time Scheduled Switch/Router—Electrical Fabric with Separate Data Switch.

FIG. 83 is a high level schematic diagram of an Overlay Time Scheduled Switch/Router—Electrical Fabric with Separate Data Switch and separate paths.

FIG. 84 is a high level schematic diagram of a fifth embodiment, also termed the “source and destination” embodiment or “end-user” embodiment of a time-scheduled and/or time-reserved datagram/packet network switch or router device according to the present invention comprising master clock synchronization means, input, output, control, with standard store-and-forward packet, cell, or frame-based input and output handling means, and real-time or high priority time-scheduled and/or time-reserved datagram/packet input and output handling means.

FIG. 85 is a high level schematic diagram of a “source and destination” embodiment or “end-user” embodiment of a time-scheduled and/or time-reserved datagram/packet network switch or router device with a Destination Component—Completely Separate Paths between Data Switching and Time Scheduled Packet Switching.

FIG. 86 is a high level schematic diagram of a “source and destination” embodiment or “end-user” embodiment of a time-scheduled and/or time-reserved datagram/packet network switch or router device with a Destination Component—Completely Separate Paths between Data Switching and Time Scheduled Switching.

FIG. 87 is a high level schematic diagram of a “source and destination” embodiment or “end-user” embodiment of a time-scheduled and/or time-reserved datagram/packet network switch or router device with a Source/Destination—Optical Fabric with separate Data Switch.

FIG. 88 is a high level schematic diagram of a “source and destination” embodiment or “end-user” embodiment of a time-scheduled and/or time-reserved datagram/packet network switch or router device with a Source Destination—Optical Fabric with separate Data Switch and separate paths.

FIG. 89 is a high level schematic diagram of a “source and destination” embodiment or “end-user” embodiment of a time-scheduled and/or time-reserved datagram/packet network switch or router device with a Source/Destination—Electrical Fabric with Separate Data Switch.

FIG. 90 is a high level schematic diagram of a “source and destination” embodiment or “end-user” embodiment of a time-scheduled and/or time-reserved datagram/packet network switch or router device with a Source/Destination—Electrical Fabric with Separate Data Switch and separate paths.

FIG. 91 is a high level schematic diagram of a “source and destination” embodiment or “end-user” embodiment of a time-scheduled and/or time-reserved datagram/packet network switch or router device with a Source/Destination—Optical and Electrical Fabric with Separate Data Switch and separate paths.

FIG. 92 is a high level schematic diagram of a generalized “source and destination” embodiment or “end-user” embodiment of a time-scheduled and/or time-reserved datagram/packet network element.

FIG. 93 is a high level schematic diagram of a “source and destination” embodiment or “end-user” embodiment of a time-scheduled and/or time-reserved datagram/packet network element for a Shared, Partially Shared, or Non-Shared Physical Medium—PHY 1h, 5h, such as a LAN-attached device (NIC card. Can be separate Transmission and Receive Media, such as an Ethernet LAN and/or wireless LAN. Can be optical, electrical, and/or wireless media.

FIG. 94 is a high level schematic diagram of a “source and destination” embodiment or “end-user” embodiment of a time-scheduled and/or time-reserved datagram/packet network element for a Shared, Partially Shared, or Non-Shared Physical Medium—PHY 1h, 5h, such as an Alternative LAN-attached device (NIC card. Can be separate Transmission and Receive Media, such as an Ethernet LAN and/or wireless LAN. Can be optical, electrical, and/or wireless media.

FIG. 95 is a high level schematic diagram of a “source and destination” embodiment or “end-user” embodiment of a time-scheduled and/or time-reserved datagram/packet network element for a Shared, Partially Shared, or Non-Shared Physical Medium—PHY 1h, 5h, such as an Integrated LAN Controller—Time ScheduledSwitch—Generic Model. Can be separate Transmission and Receive Media, such as an Ethernet LAN and/or wireless LAN. Can be optical, electrical, and/or wireless media.

FIG. 96 is a high level schematic diagram of a “source and destination” embodiment or “end-user” embodiment of a time-scheduled and/or time-reserved datagram/packet network element for a Shared, Partially Shared, or Non-Shared Physical Medium—PHY 1h, 5h, with various stacks and elements for connectivity to the shared physical medium. This can be separate Transmission and Receive Media, such as an Ethernet LAN and/or wireless LAN. Can be optical, electrical, and/or wireless media.

FIG. 97 is a detailed functional block diagram of an illustrative embodiment of switching means which may be optical, electrical, electro-optical, or MEMS (Micro-Electro-Mechanical Switch, e.g., mirroring system, bubble switching, etc.) non-blocking, non-delaying and/or blocking and/or delaying switching means according to the present invention, including input amplifying and limiting means, input matrix means, output matrix means, output switching means, output switching control means, and output means.

FIG. 98 is a detailed functional block diagram of an illustrative embodiment of switching means which may be non-blocking, non-delaying switching means according to the present invention, including input amplifying and limiting means, input matrix means, output matrix means, output switching means, output switching control means, and output means.

FIG. 99, FIG. 100, and FIG. 101 are detailed schematic diagrams of illustrative embodiments of control means for selecting the output of the optical, electrical, electro-optical, or MEMS (Micro-Electro-Mechanical Switch, e.g., mirroring system, bubble switching, etc.) switching means which may be non-blocking, non-delaying switching means according to the present invention.

FIG. 102 is an exemplary diagram of a generic Overlay Time Scheduled Switch Optionally Controlled by a Time-Scheduled Controller 120.

FIG. 103 illustrates the optional transmission media and input line media connections with optional media converter to connect to the time-scheduled packet switching network element.

FIG. 104 illustrates the optional input line media and time-scheduled packet switch input stage with optional input switching and buffering and optional E/O and O/E conversion, and optional electrical and/or optical input stage switching.

FIG. 105 is a detailed functional block diagram of a preferred integrated embodiment of input means according to the present invention, including input switch means, input switch array means, input switch control means, input buffer means, input buffer array means, and input buffer control means.

FIG. 106 is a functional schematic diagram of a Input Switching Circuitry according to the present invention.

FIG. 107 is a more detailed functional schematic diagram of a Input Switching Circuitry according to the present invention.

FIG. 108 shows the Operational Process for Edge Input Circuitry, wherein the process behind the operation of the input means shown in FIG. 105 is explained.

FIG. 109 shows the Operational Process for Non-Edge or Internal Time-scheduled and/or time-reserved datagram/packet Input Circuitry, wherein the process behind the operation of the input means shown in FIG. 105 is explained.

FIG. 110 is a detailed schematic diagram of a preferred embodiment of input buffer means according to the present invention, including input switching means, input switching control means, input buffer bypass means, input buffer memory means, input interface handler means, address resolution means, input queue manager means, and input program memory means.

FIG. 111 shows the Input Queue Manager Process, wherein the process behind the operation of the input buffer means shown in FIG. 16 is explained.

FIG. 112 is a detailed functional block diagram of a preferred embodiment of output means according to the present invention, including output switch means, output switch array means, output switch control means, output buffer means, output buffer array means, and output buffer control means.

FIG. 113 and FIG. 114 show the Operational Process for Edge Output Circuitry, wherein the process behind the operation of the output means shown in FIG. 18 is explained.

FIG. 115 and FIG. 116 show the Operational Process for Non-Edge or Internal Time-scheduled and/or time-reserved datagram/packet Output Circuitry, wherein the process behind the operation of the output means shown in FIG. 18 is explained.

FIG. 117 is a detailed schematic diagram of a preferred embodiment of output buffer means according to the present invention, including output switching means, output switching control means, output buffer bypass means, output buffer memory means, output interface handler means, address resolution means, output queue manager means, and output program memory means.

FIG. 118 shows the Output Queue Manager Process, wherein the process behind the operation of the output buffer means shown in FIG. 23 is explained.

FIG. 119 shows a functional block diagram for Standard Packet Queuing using Packet Classifier 86 which classifies and feeds Non-Time-Scheduled packets 169 to Priority Queues 89, 89a through 89n to store, based on Classes and Class priority. Datagrams are then Scheduled by priority Order Scheduler 112 according to Weighted Fair Queuing or some other non-time-reservation scheduling algorithm.

FIG. 120 shows a functional block diagram showing how Time-Scheduled packets have output order of Datagrams determined based on Time-Reservation. Packet Classifier 86 looks at time schedule for time-scheduled packets 181. Packet Classifier places time-scheduled packets 181 into associated Time-Reserved and/or Time-Scheduled Buffers 90, (90a through 90n) associated with Scheduled and/or Reserved output times and/or time-slots. Datagrams are transmitted in time/time-slots according to their reservation-schedule. Time-slots may be fixed, variable-sized, and/or dynamically changeable. This forces time-scheduled packets to be almost immediately sent and prevents packet loss from buffer overflow, or delay from queuing wait.

FIG. 121 shows a functional block diagram showing both standard packet queuing and time-scheduled packet buffering in output buffer 70. FIG. 121 shows how Time Reserved Packets bypass Non-Time-Scheduled Priority Queues in output section and go directly into time slots (with bounded buffering delay).

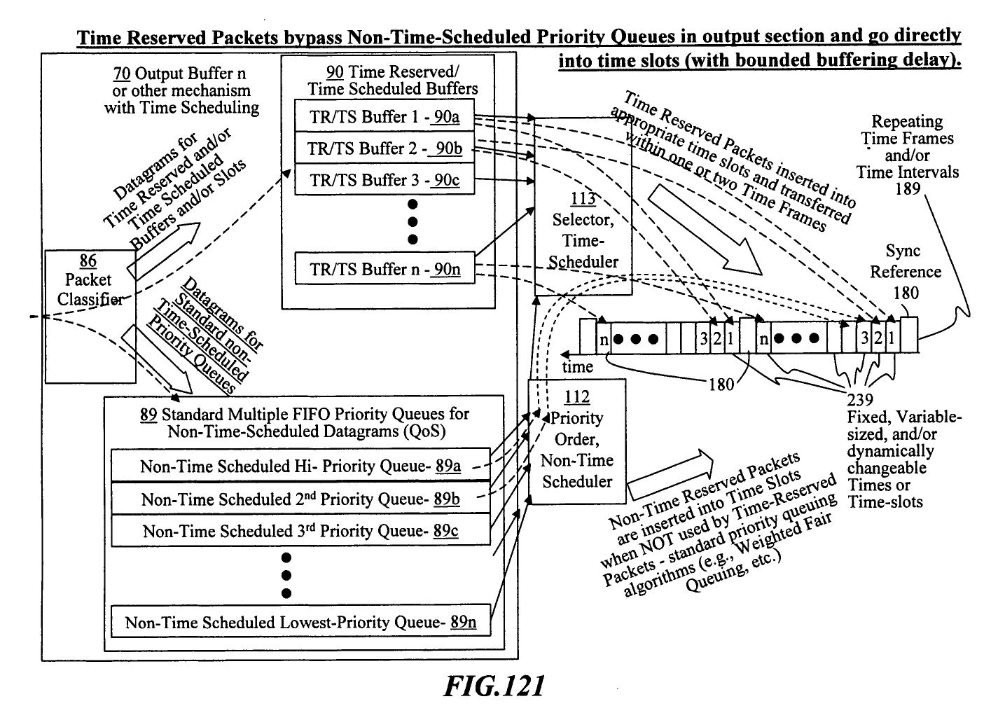

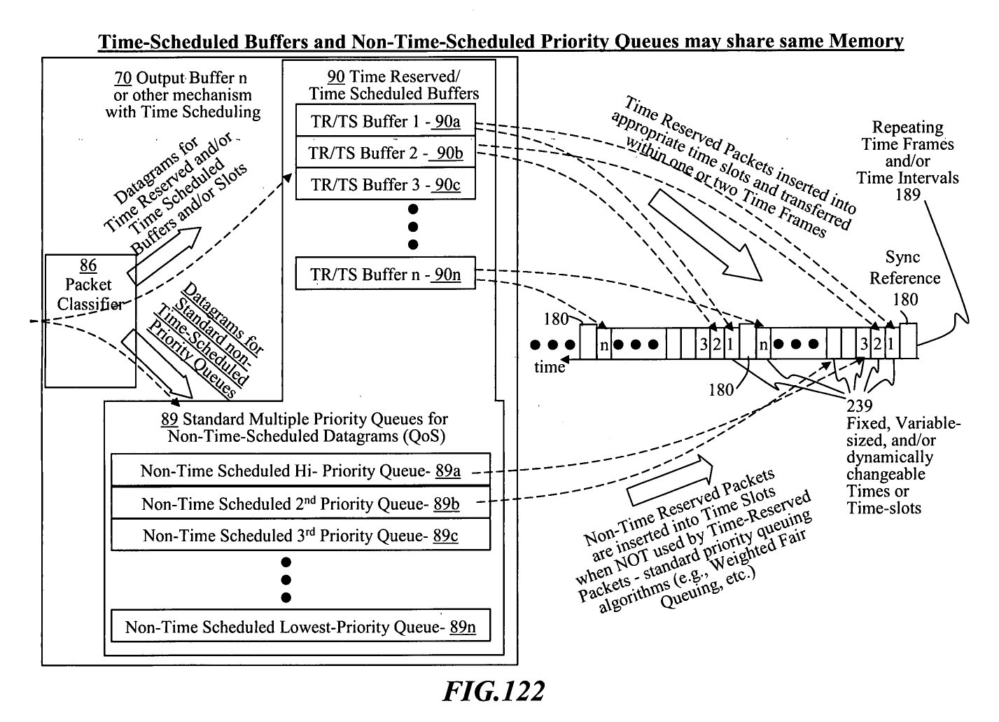

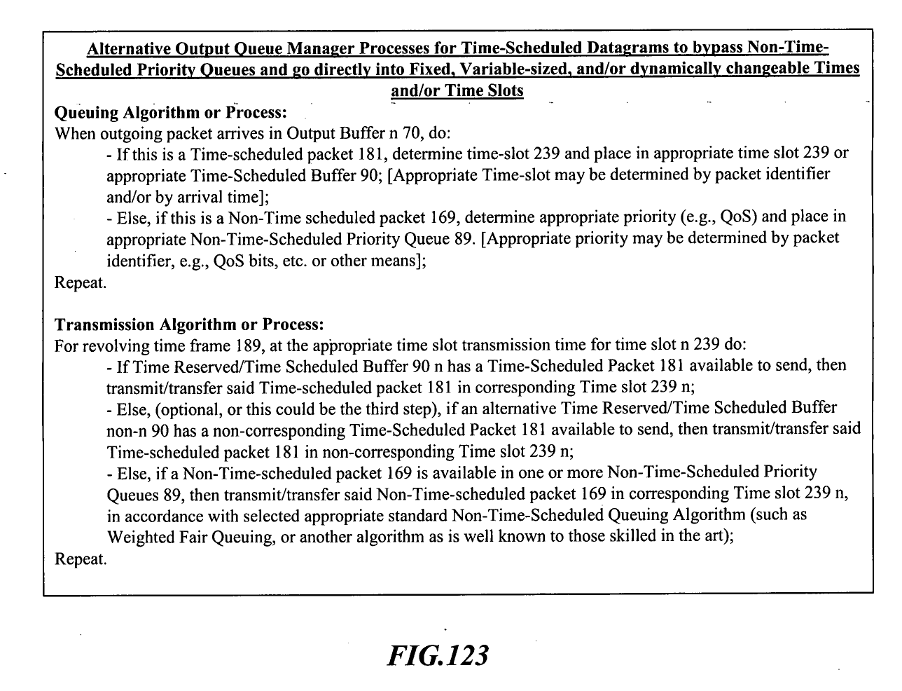

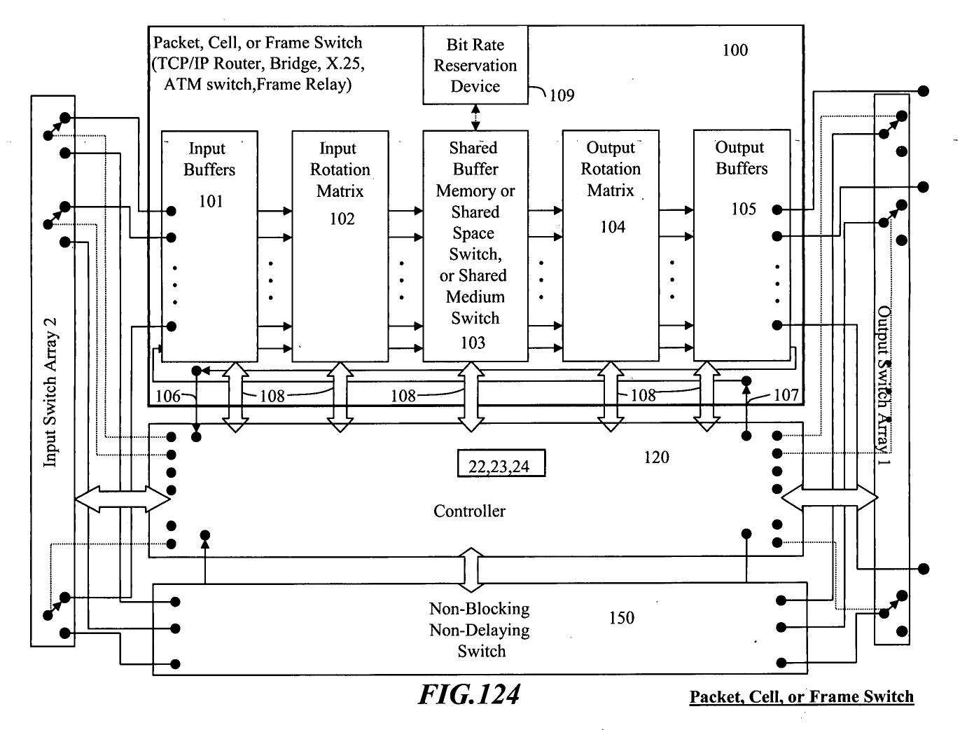

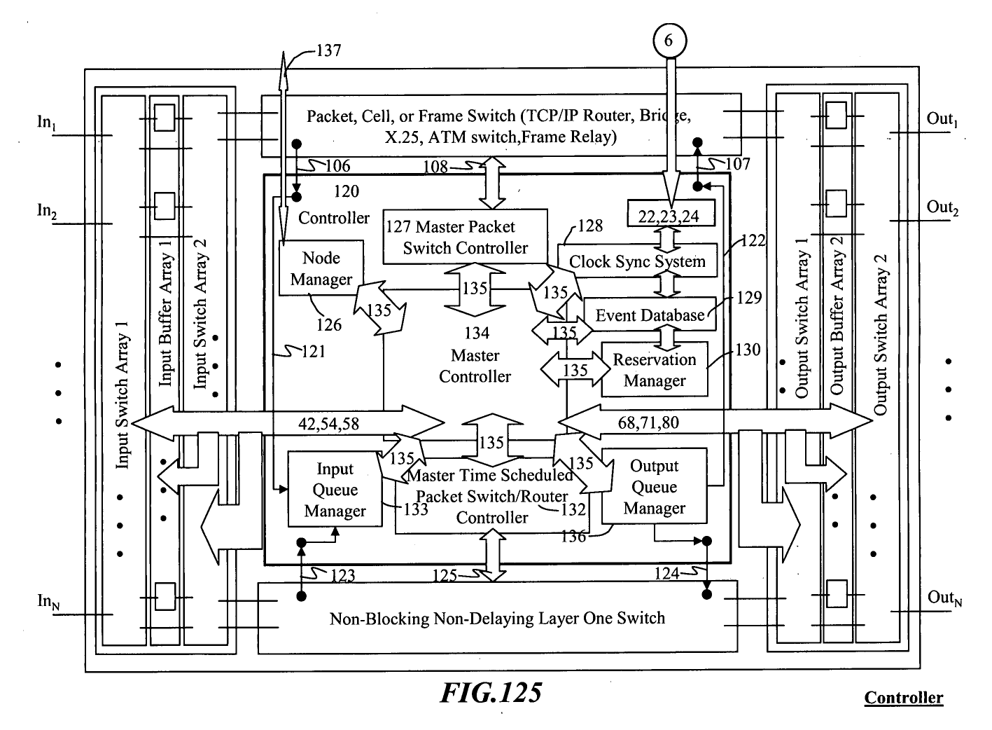

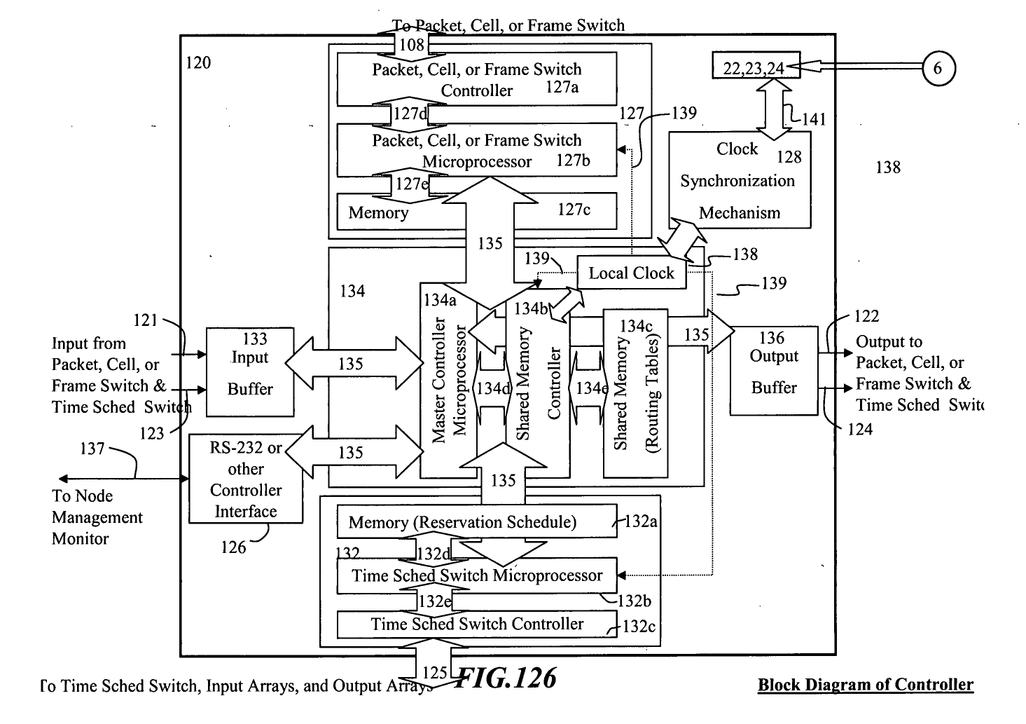

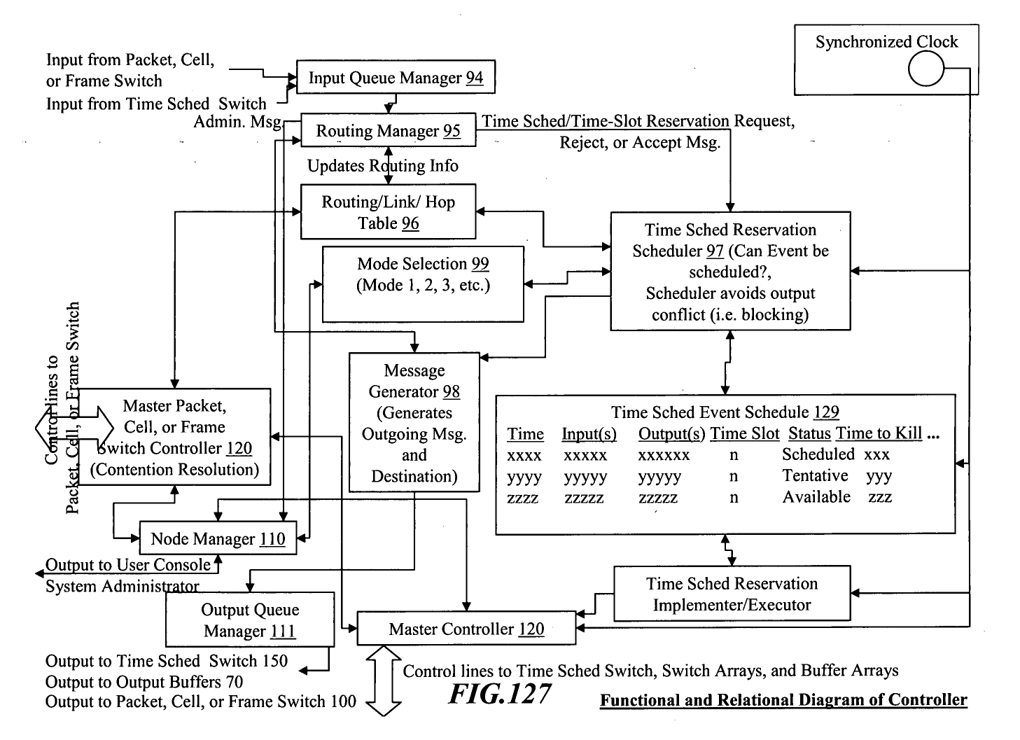

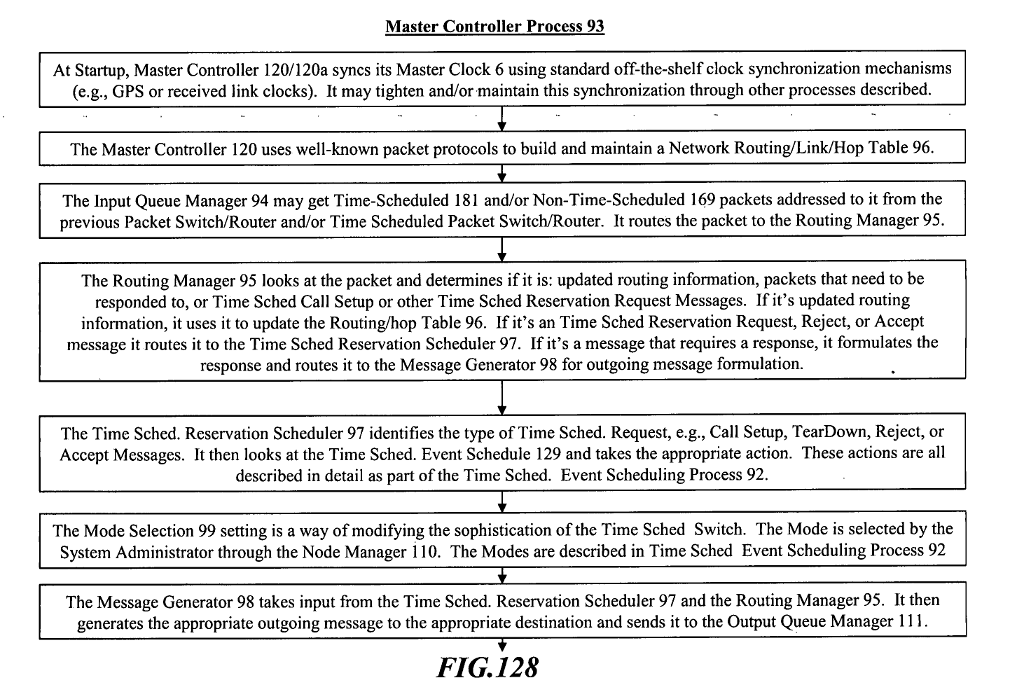

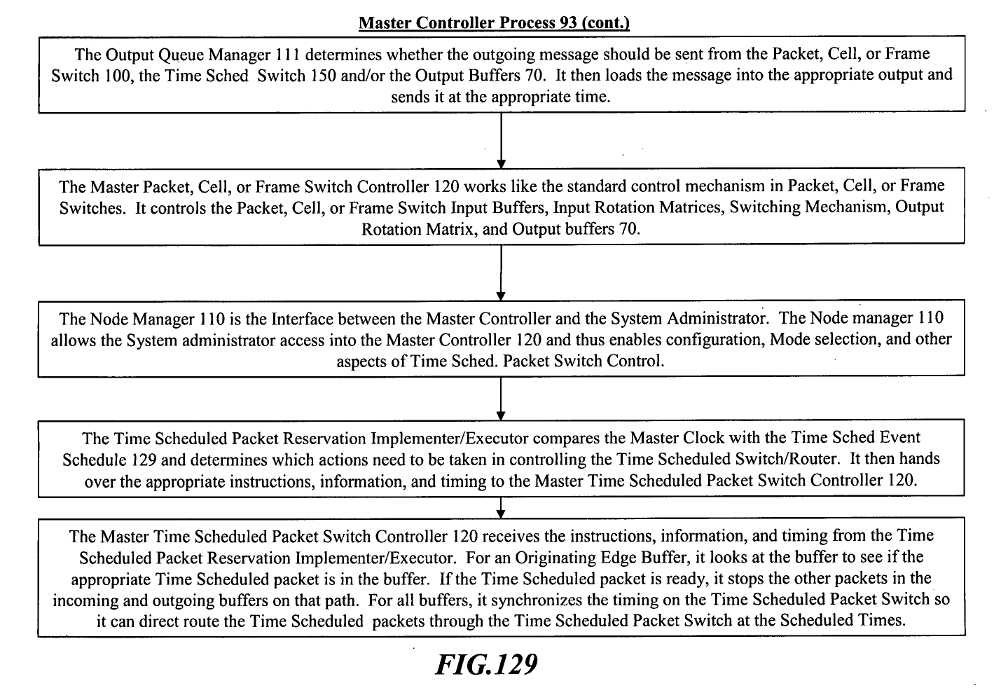

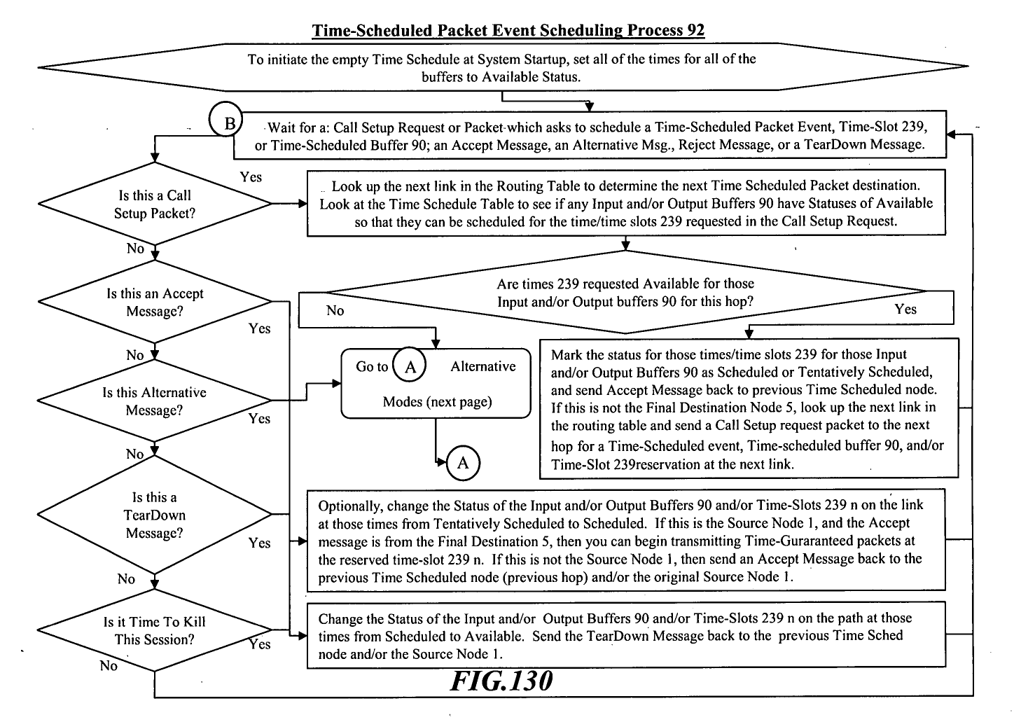

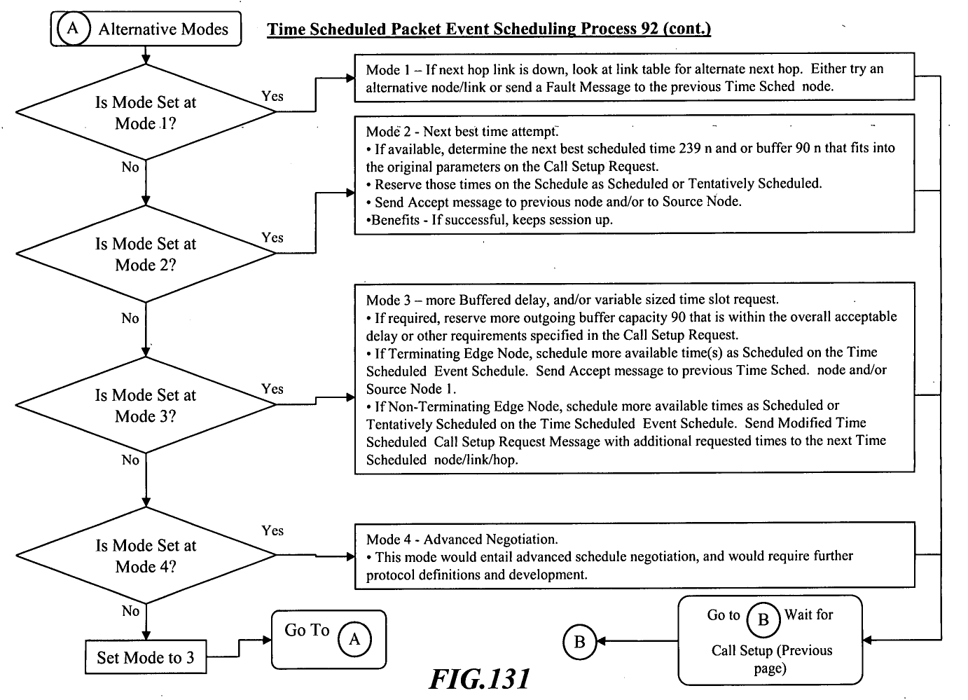

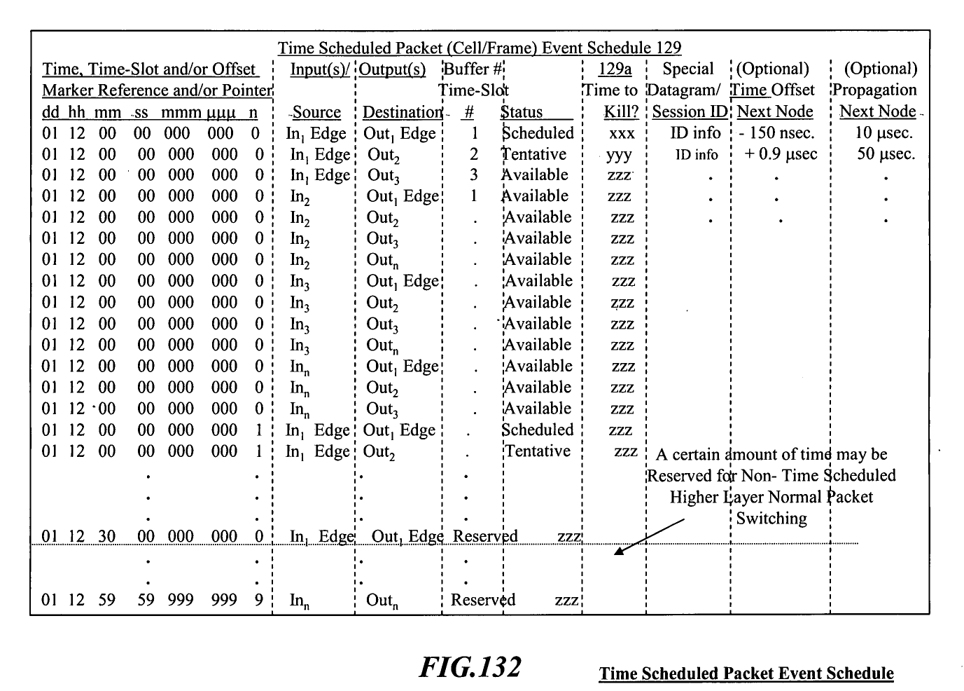

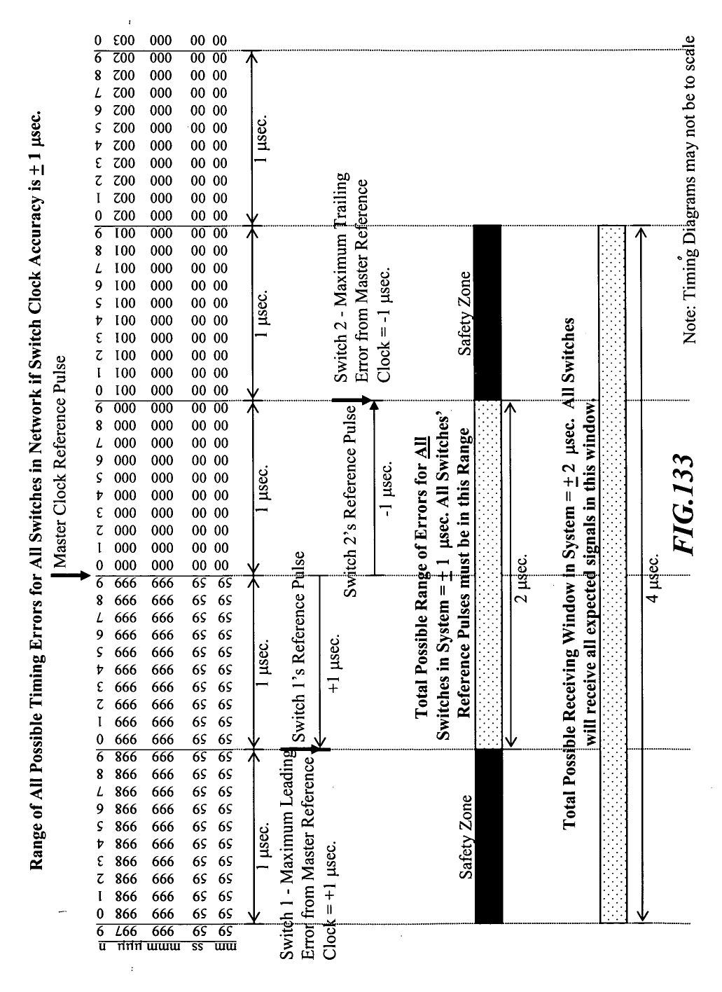

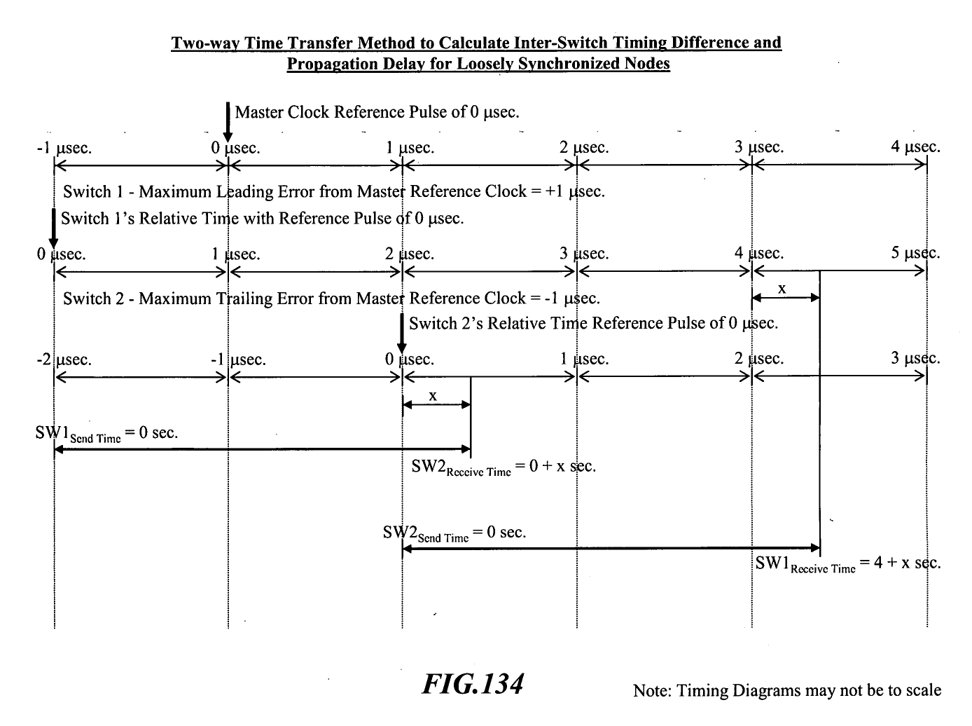

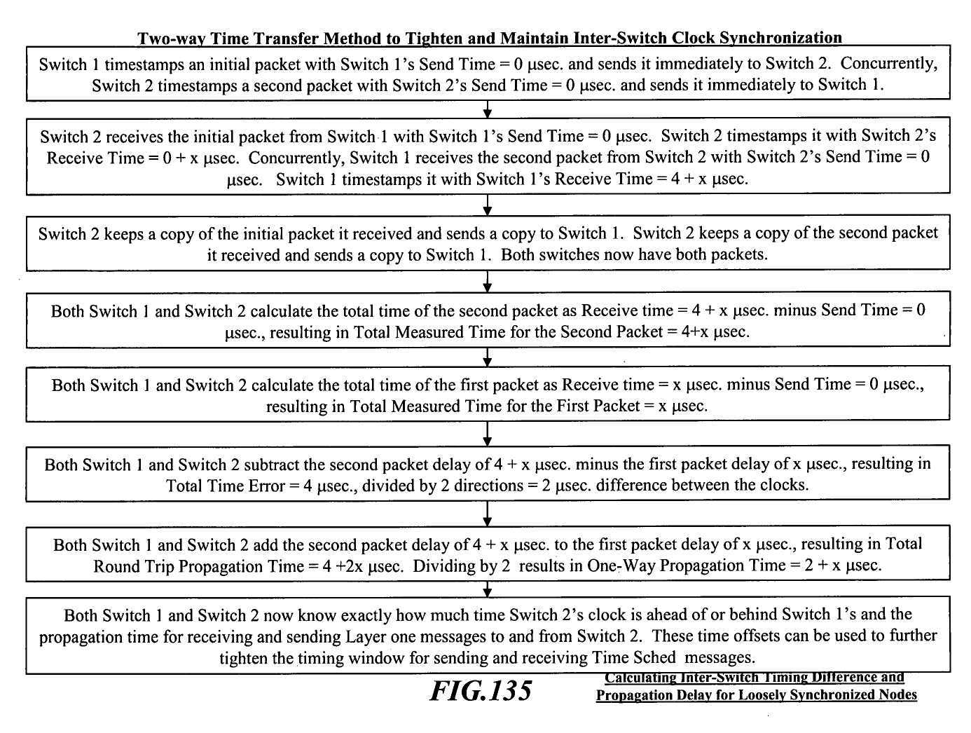

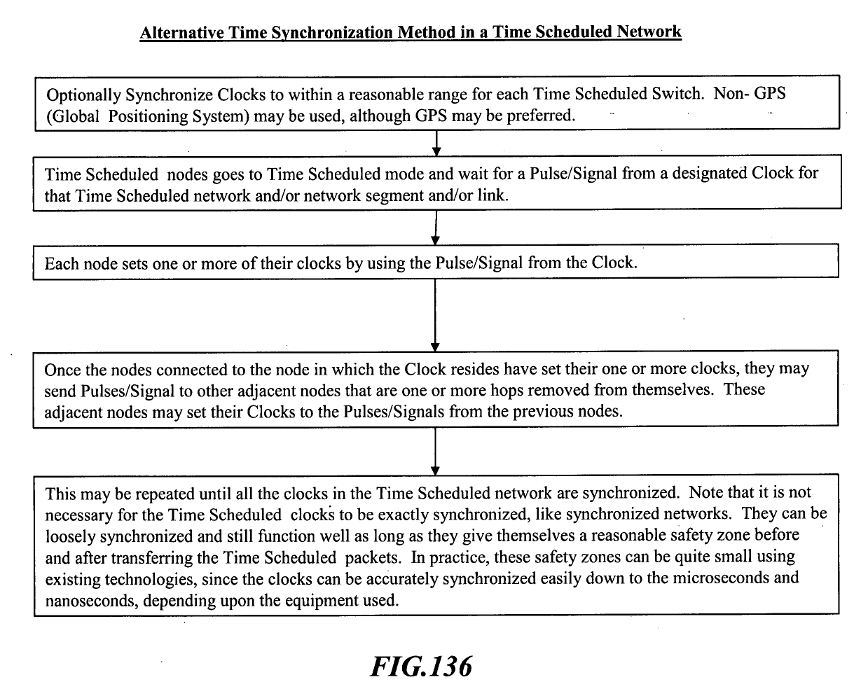

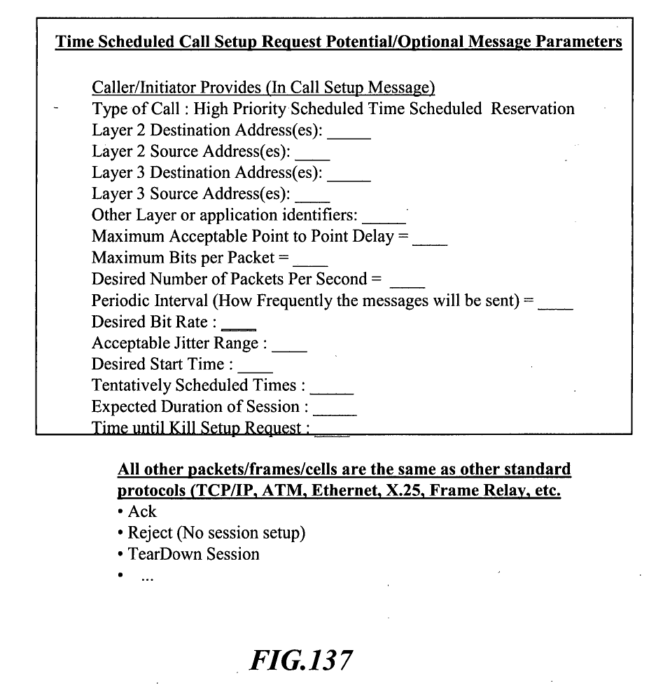

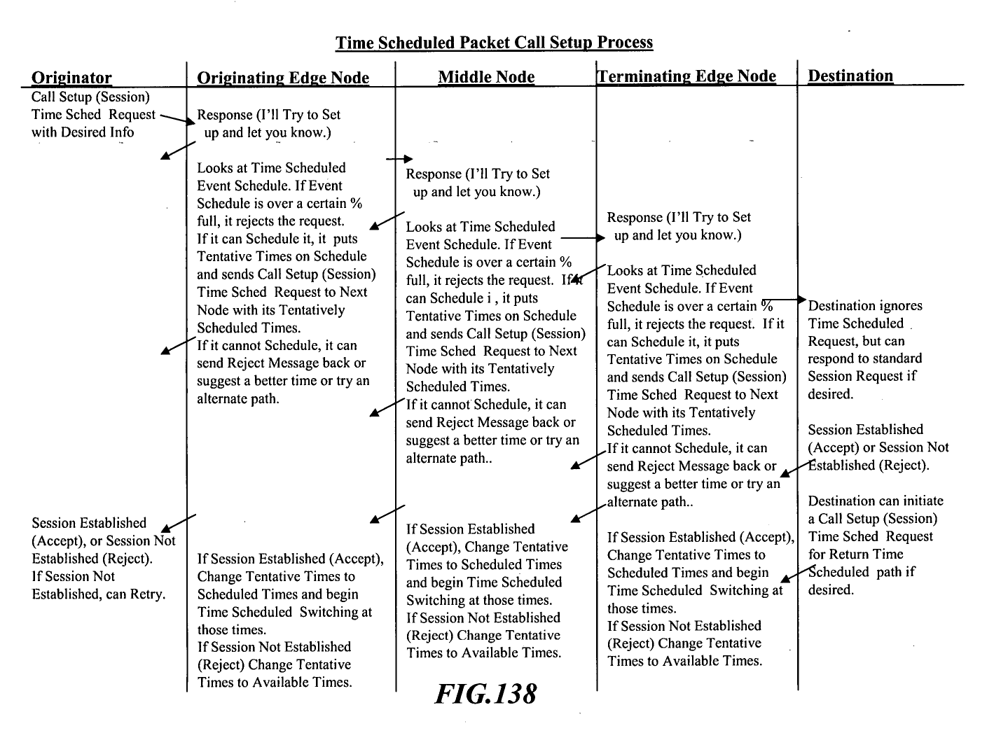

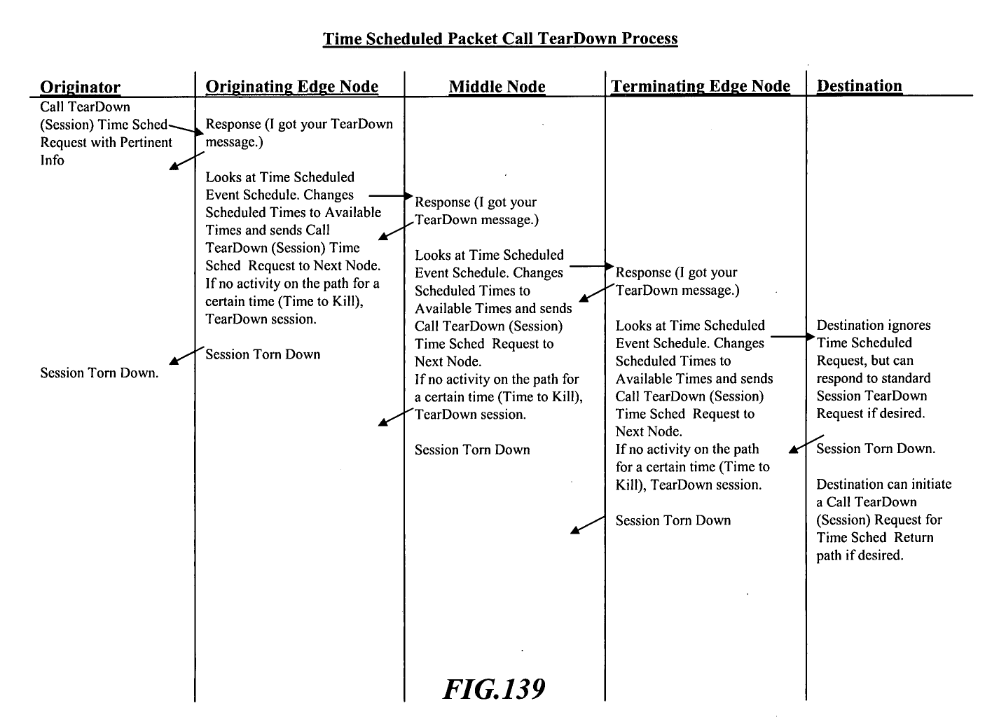

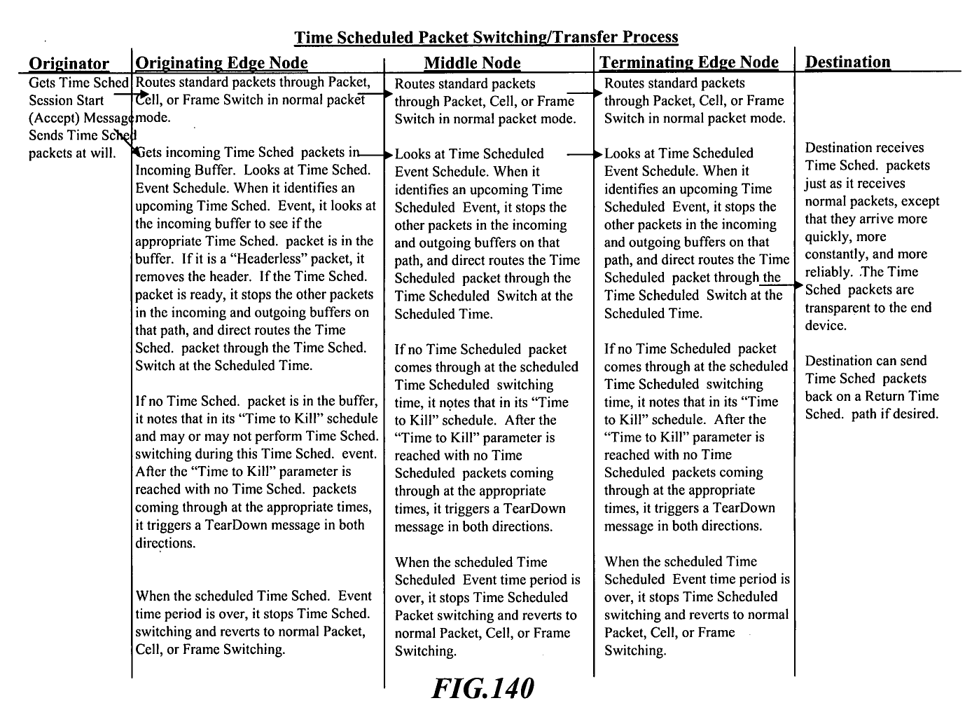

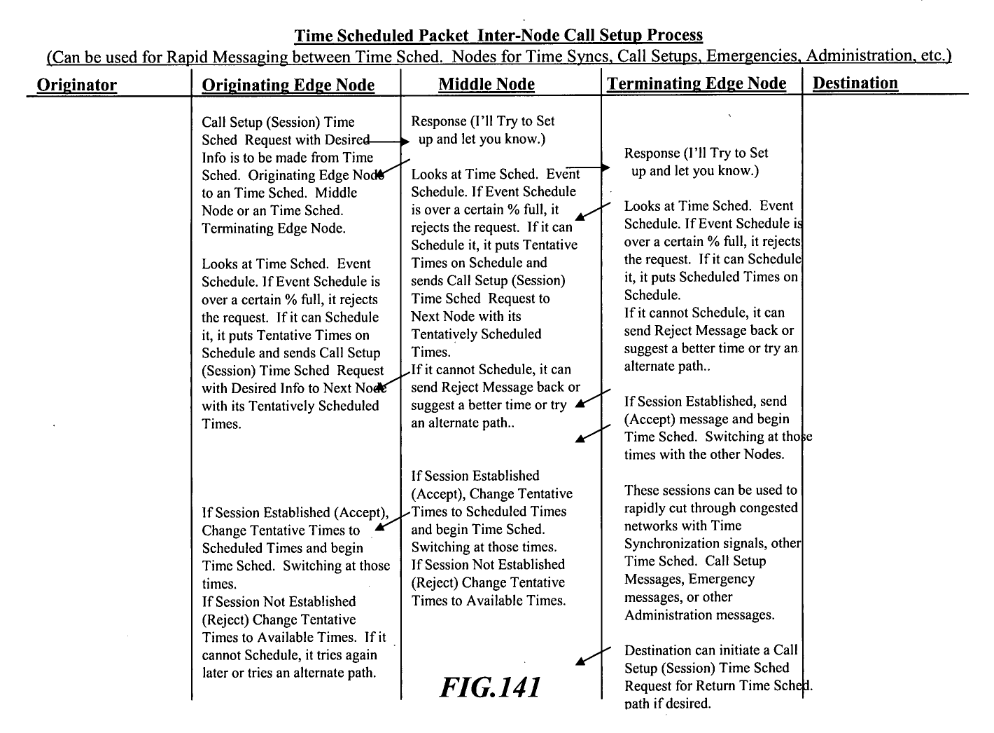

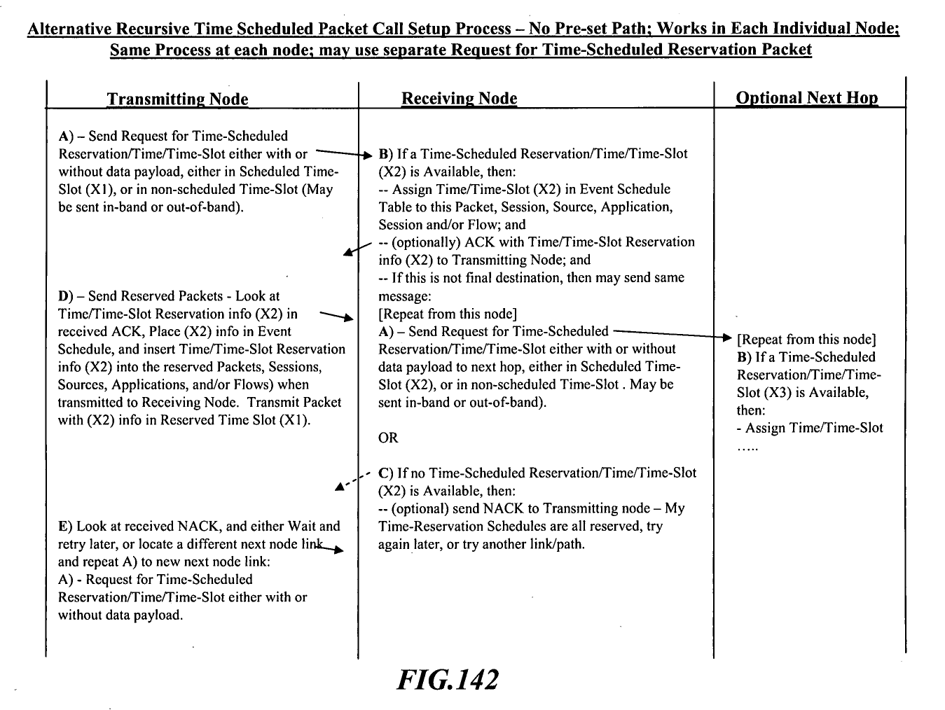

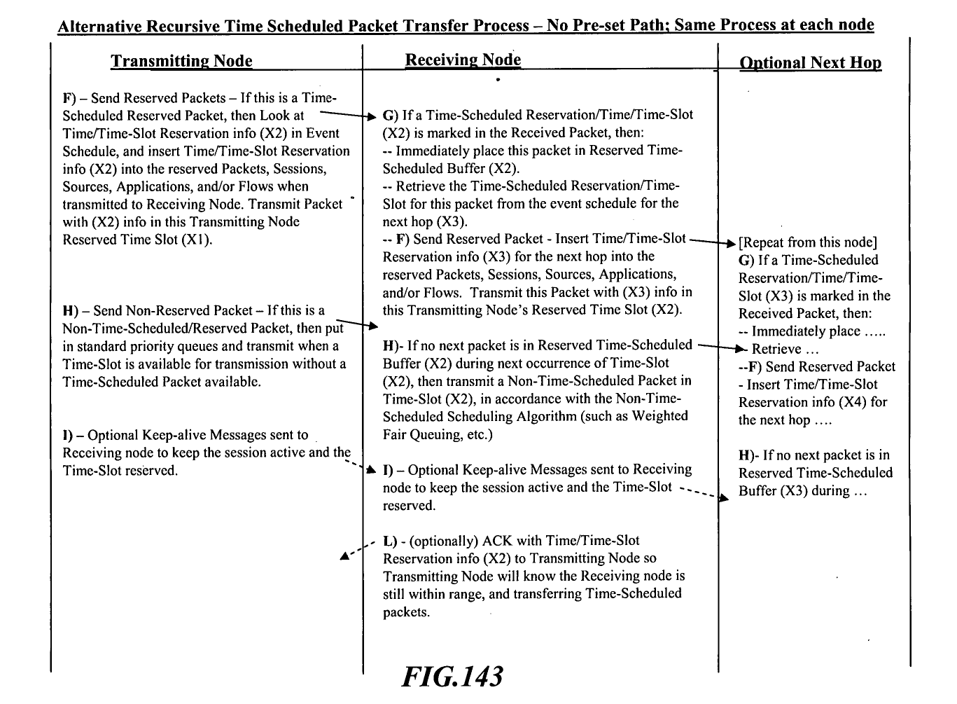

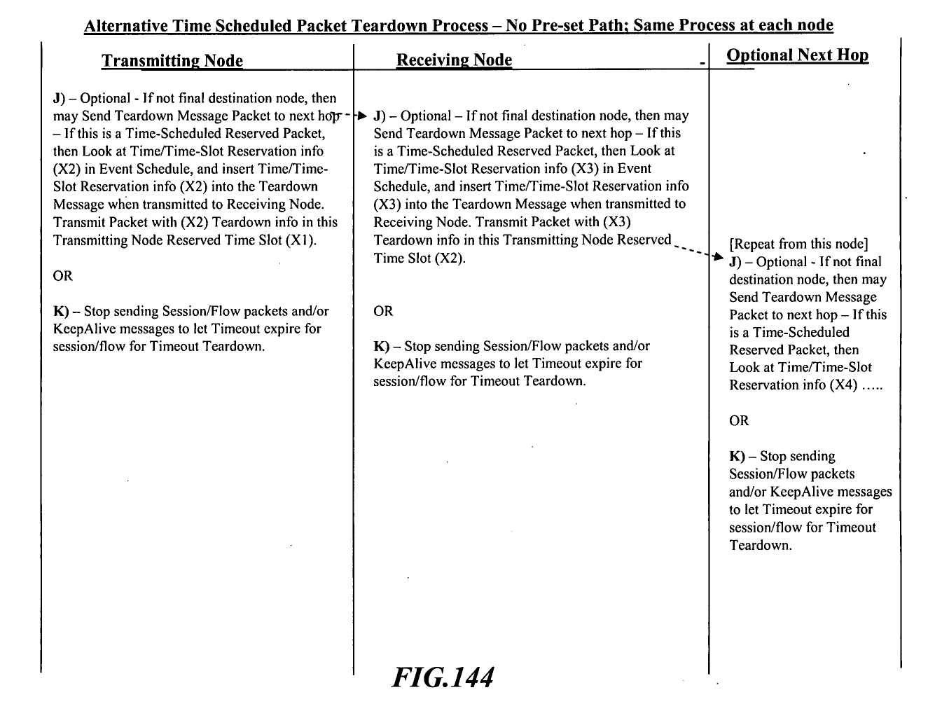

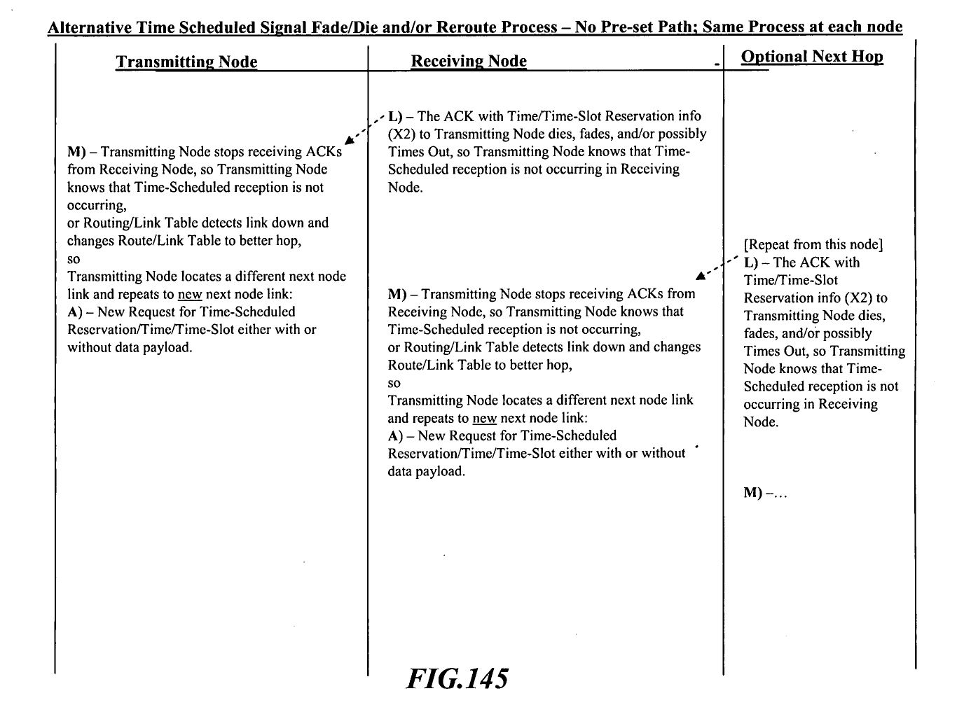

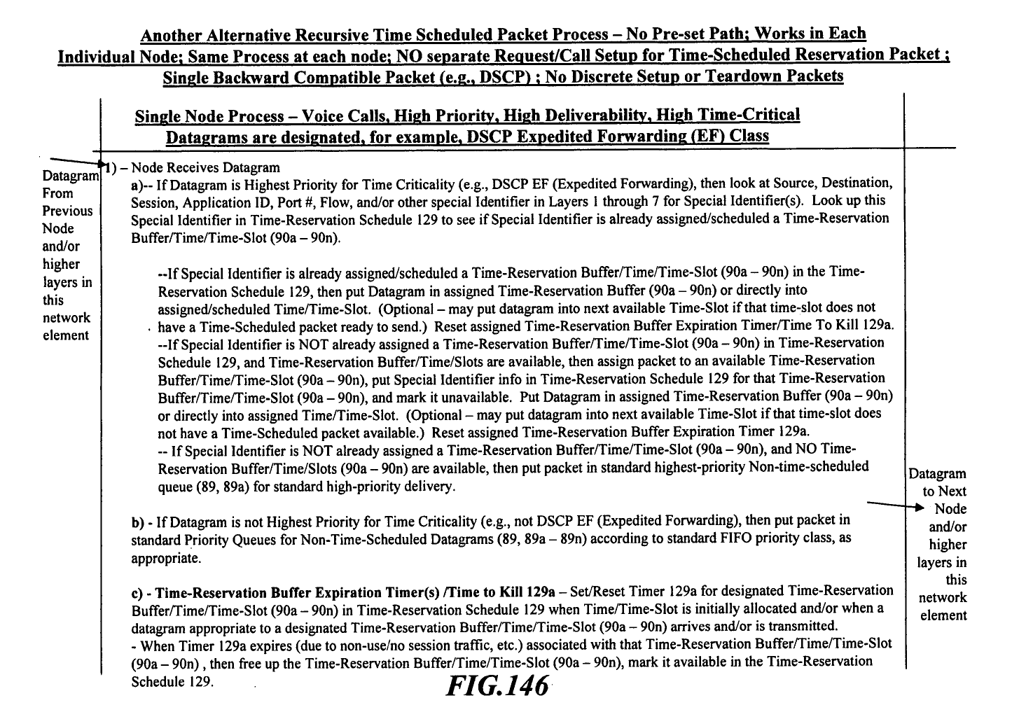

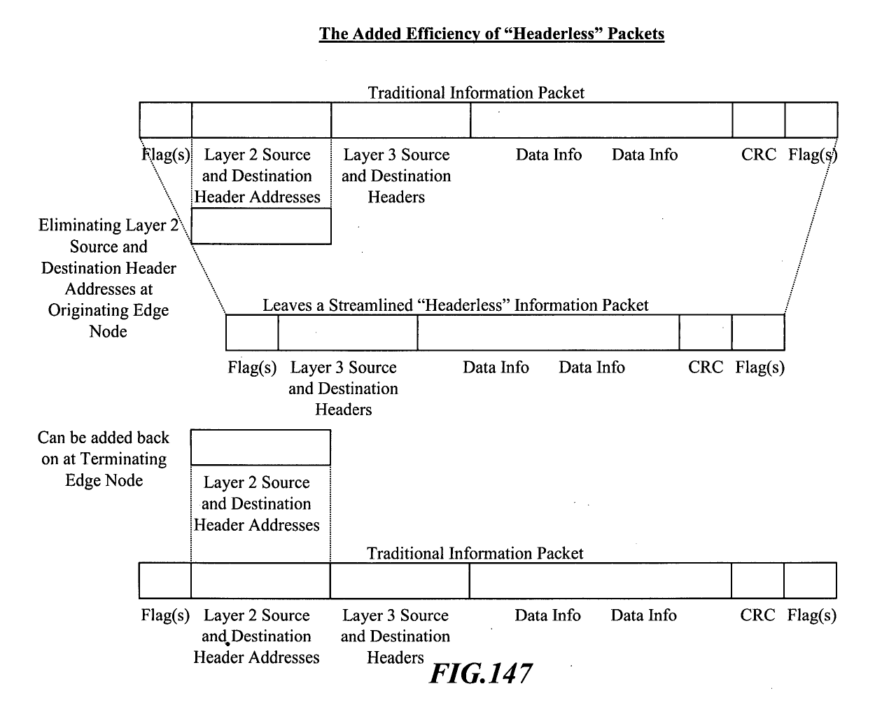

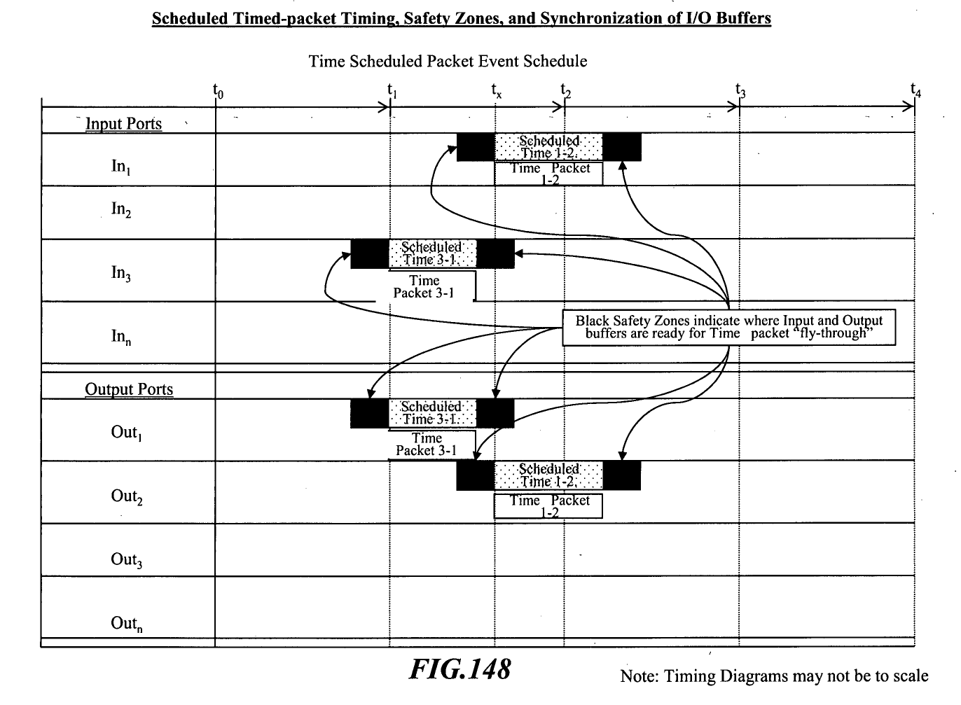

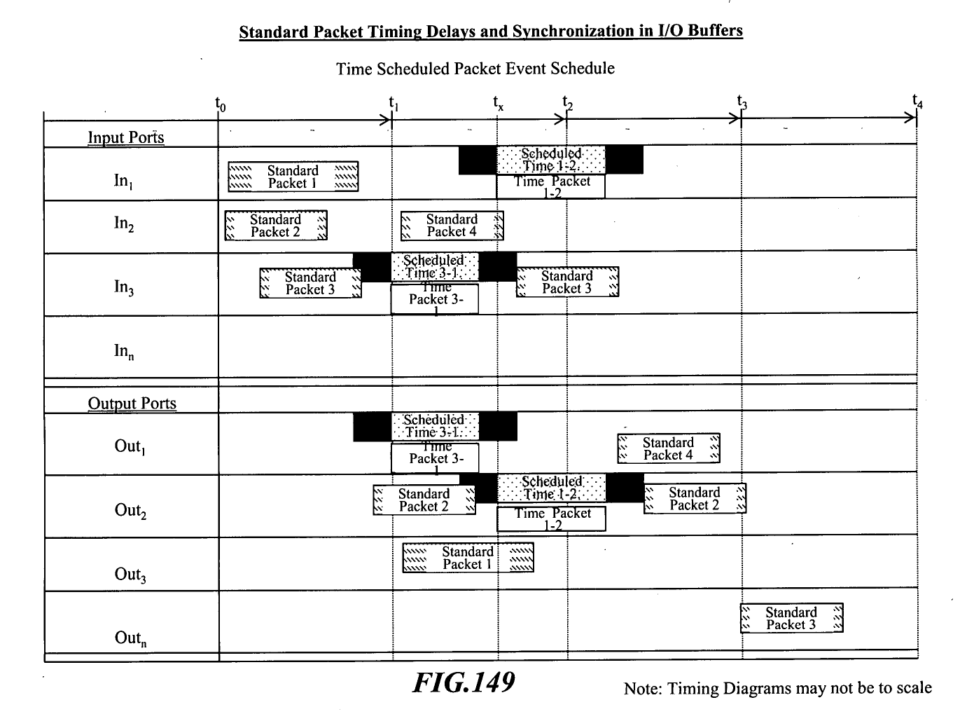

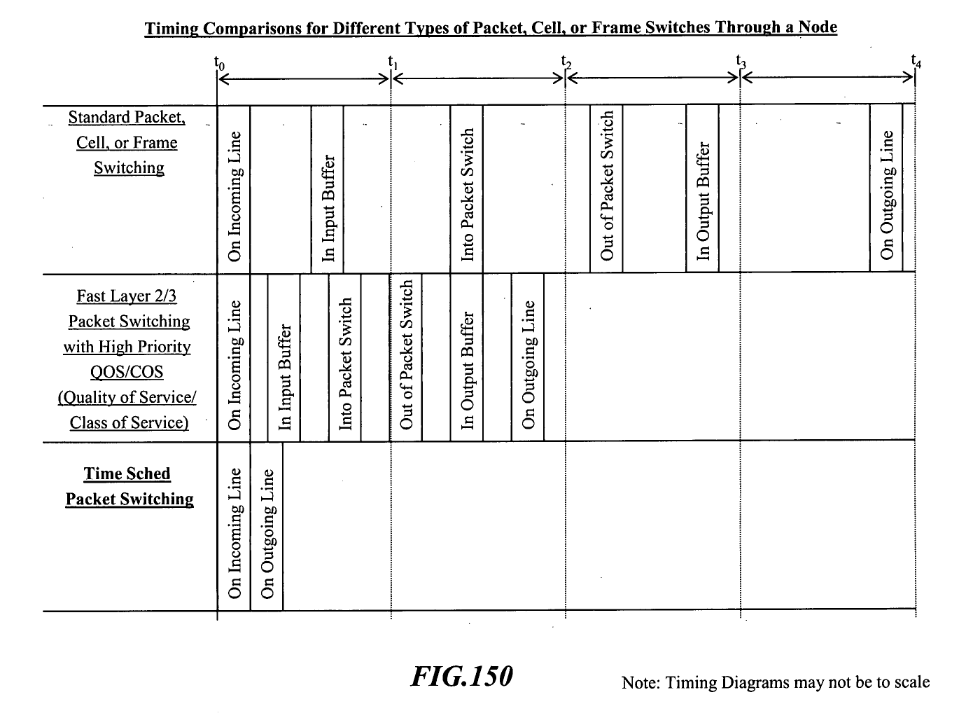

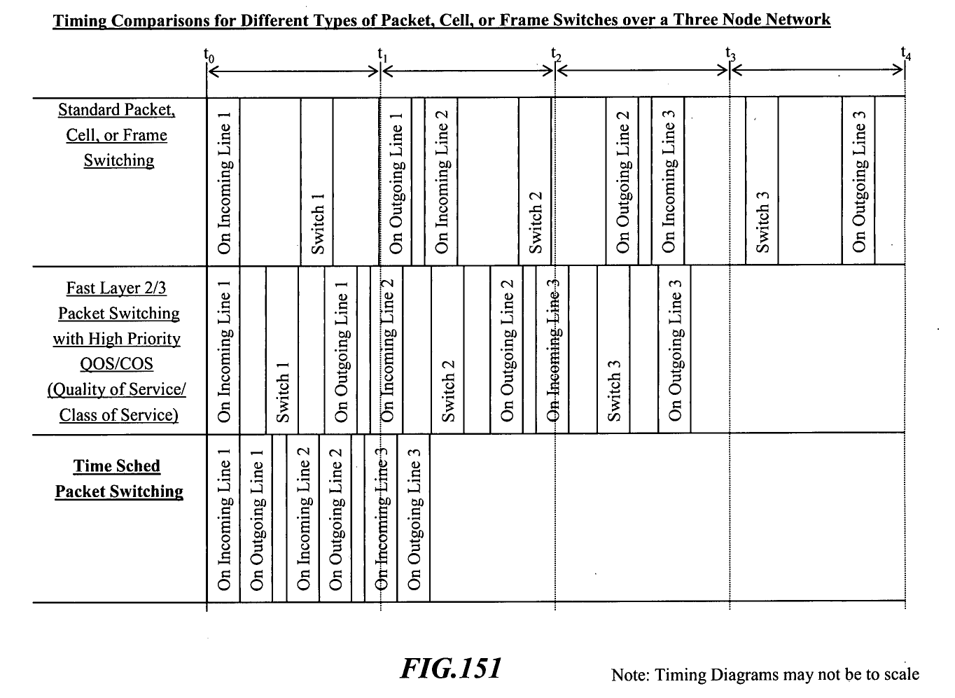

In FIG. 121, Standard Packet Queuing using Packet Classifier 86 which classifies and feeds Non-Time-Scheduled packets 169 to Priority Queues 89, 89a through 89n to store, based on Classes and Class priority. Datagrams are then Scheduled by priority Order Scheduler 112 according to Weighted Fair Queuing or some other non-time-reservation scheduling algorithm. However, non-time-schedule packets even in highest priority queues must wait behind time-scheduled packets which get immediately sent. Time-Scheduled packets have output order of Datagrams determined based on Time-Reservation. Packet Classifier 86 looks at time schedule for time-scheduled packets 181. Packet Classifier places time-scheduled packets 181 into associated Time-Reserved and/or Time-Scheduled Buffers 90, (90a through 90n) associated with Scheduled and/or Reserved output times and/or time-slots. Datagrams are transmitted in time/time-slots according to their reservation-schedule. Time-slots may be fixed, variable-sized, and/or dynamically changeable. This forces time-scheduled packets to be almost immediately sent and prevents packet loss from buffer overflow, or delay from queuing wait.

In FIG. 121, Time Slot Buffers 90 (90a through 90n) are (may be) higher priority than the highest priority Non-time-scheduled priority queue (QoS) 89a. Time Slots may be established on a per session, per hop, per transaction, per call, per message, per priority level, and/or per flow basis. Time Slot buffers may be one or more packets deep.

FIG. 122 illustrates how Time-Scheduled Buffers 90 and Non-Time-Scheduled Priority Queues 89 may share the same Memory in output buffer 70.

FIG. 123 shows Alternative Output Queue Manager Processes for Time-Scheduled Datagrams to bypass Non-Time-Scheduled Priority Queues and go directly into Fixed, Variable-sized, and/or dynamically changeable Times and/or Time Slots in output buffer 70.

FIG. 124 shows a standard Packet, Cell, or Frame Switch 100.

FIG. 125 is a detailed schematic diagram of an illustrative embodiment of the controller 120 means according to the present invention.

FIG. 126 is a detailed hardware diagram of an illustrative embodiment of the controller 120 means according to the present invention.

FIG. 127 is a detailed functional and relational block diagram of the controller means 120 according to the present invention.

FIG. 128 and FIG. 129 show the master controller process used to operate the controller shown in FIG. 125, FIG. 126, and FIG. 127.

FIG. 130 and FIG. 131 is a flowchart diagramming the time-scheduled and/or time-reserved datagram/packet event scheduling process, including Reject Modes, according to the present invention.

FIG. 132 is an illustrative example of a time-scheduled and/or time-reserved datagram/packet event schedule 129, including time, inputs, outputs, buffer number and/or time-slot number, status, time to kill, special identifier information, time offsets, and propagation delays according to the present invention.

FIG. 133 shows the range of all possible timing errors for all switches in a network using the illustrative example of switch clock accuracy of +1 microsecond, according to the present invention.

FIG. 134 is a timing diagram showing the two-way time transfer clock synchronization method according to the present invention.

FIG. 135 shows the two-way time transfer clock synchronization method process according to the present invention.

FIG. 136 shows an illustrative alternative process of synchronizing time-scheduled and/or time-reserved datagram/packet network clocks according to the present invention.

FIG. 137 shows an exemplary time-scheduled and/or time-reserved datagram/packet call setup request message parameter list according to the present invention.

FIG. 138 shows an exemplary time-scheduled and/or time-reserved datagram/packet network message flow diagram for the call setup process according to the present invention.

FIG. 139 shows an exemplary time-scheduled and/or time-reserved datagram/packet network message flow diagram for the call teardown process according to the present invention.

FIG. 140 shows an exemplary time-scheduled and/or time-reserved datagram/packet network message flow diagram for the time-scheduled and/or time-reserved datagram/packet switching process according to the present invention.

FIG. 141 shows an exemplary time-scheduled and/or time-reserved datagram/packet network message flow diagram for the time-scheduled and/or time-reserved datagram/packet inter-node call setup process according to the present invention.

FIG. 142 shows an Alternative Recursive Time Scheduled Packet Call Setup Process—No Pre-set Path; Works in Each Individual Node using the Same Process at each node, which may use separate Request/Call Setup for Time-Scheduled Reservation Packets.

FIG. 143 shows an Alternative Recursive Time Scheduled Packet Transfer Process with No Pre-set Path, using the Same Process at each node.

FIG. 144 shows an Alternative Time Scheduled Packet Teardown Process with No Pre-set Path;, using the Same Process at each node.

FIG. 145 shows an Alternative Time Scheduled Process in which the Signal Fades and/or dies, in which the Time-Scheduled Process reroutes the Time-Scheduled packets over another path. This uses no Pre-set Path and the same Process at each node.

FIG. 146 shows another Alternative Recursive Time Scheduled Packet Call Setup Process with No Pre-set Path (works for IP), that works in Each Individual Node, and uses the same Process at each node, with NO separate Request/Call Setup for Time-Scheduled Reservation Packet. This process is backward compatible to existing IP using Classes of Service such as DSCP—DiffServ Code Points. No Discrete Setup or Teardown Packets required.

FIG. 147 illustrates the added efficiency of “headerless” packet switching according to the present invention.

FIG. 148 is a timing diagram showing scheduled time-scheduled and/or time-reserved datagram/packet packet timing, safety zones, and synchronization of I/O buffers according to the present invention.

FIG. 149 is a timing diagram showing scheduled time-scheduled and/or time-reserved datagram/packet packet timing, safety zones, and synchronization of I/O buffers, along with standard store-and-forward packets illustrating the interaction effects of collisions according to the present invention.

FIG. 150 is a timing diagram showing comparisons between different types of packet, cell, or frame switches versus time-scheduled packet switching in a single node according to the present invention.

FIG. 151 is a timing diagram showing comparisons between different types of packet, cell, or frame switches versus time-scheduled packet switching in a three node network according to the present invention.

### DETAILED DESCRIPTION OF THE INVENTION

1.1 Time-Based Packet, Cell, Frame, and/or Datagram Switching

Time-scheduled and/or time-reserved datagram/packet switching comprises a class of packet/datagram switching devices, networks, architectures, systems, and methods wherein data is transmitted, received, transferred, switched, and/or routed based on time-scheduling and/or time-reservations for datagram/packets. This means that in time-scheduled and/or time-reserved datagram/packet switching, layer two and/or higher layer header lookup may or may not be used to switch or route the data, i.e., to determine the appropriate destination, device, application, port, line, or priority/quality of service (QoS). Therefore, in time-scheduled and/or time-reserved datagram/packet switching, real-time, high-priority, and/or other time-scheduled and/or time-reserved datagram/packet data may (if desired) be transmitted to its appropriate destination; received from its appropriate source; and transferred, switched, or routed between its appropriate source and destination without using the packet, cell, frame, or slot header.

On the other hand, packets may transmitted at reserved and/or scheduled times, and still have their headers (also payload) examined for priority classification purposes, error checking, to determine if the expected packet has been sent in that time-slot or another packet in its place, etc.

Time-scheduled and/or time-reserved datagram/packet switching is the broad, superset term used to describe the entire category or class of telecommunications and/or communications devices, networks, architectures, systems, and methods, wherein packet, cell, frame, datagram and/or slot-oriented data is transmitted, received, transferred, switched, and/or routed using timing, time-scheduling, reservations, time-reservations, and/or time-slot reservations. Time-scheduled and/or time-reserved datagram/packet switching also includes hybrid devices, hybrid networks, hybrid architectures, hybrid systems, and hybrid methods which combine time-scheduled and/or time-reserved datagram/packet switching with other types of non-time-scheduled, and/or non-time-reserved datagram/packet switching, such as standard packet, cell, or frame data switching.

Time-scheduled and/or time-reserved datagram/packet switching may include the operations of transmission, reception, and transfer of time-scheduled and/or time-reserved datagram/packet data in, from, and/or to one or more time-scheduled and/or time-reserved datagram/packet network elements, as well as switching/routing across multiple time-scheduled and/or time-reserved datagram/packet network elements in a network.

Time-scheduled and/or time-reserved datagram/packet switching includes path switching; network path switching; circuit switching; circuit switching of packet, cell, or frame-oriented data (called circuit/data switching or; combinations of path switching and circuit switching; combinations of path switching and data switching; combinations of circuit switching and data switching; synchronized packet switching; time-scheduled and/or time-reserved datagram/packet bypass switching; time-scheduled and/or time-reserved datagram/packet cut-through switching; deterministic data switching; combinations of deterministic and non-deterministic data switching; slotless circuit switching;

A time-scheduled and/or time-reserved datagram/packet switch is the broad, superset term used to describe the entire category or class of telecommunications and/or communications devices or hybrid devices that can transmit, receive, transfer, switch, and/or route based on timing, time-scheduling, time-reservations, time-synchronization, time slot reservations, and/or time reservation scheduling. This includes source devices, destination devices, and end-user devices, even though they may be just transmitting and receiving time-scheduled and/or time-reserved datagram/packets instead of technically acting as switching devices.

Deterministic Data Switching

In order to accomplish this, the time-scheduled and/or time-reserved datagram/packet network element should generally know in advance what to do with each packet, cell, or frame of time-scheduled and/or time-reserved datagram/packet data and when to do it. This advance knowledge of exactly what to do and when means that time-scheduled and/or time-reserved datagram/packet switching is deterministic, i.e., the time-scheduled and/or time-reserved datagram/packet device knows deterministically the time-scheduled and/or time-reserved datagram/packet data's next state. Deterministic data switching/routing is in direct contrast to today's standard non-deterministic data routing and switching approaches, which require layer two and/or higher layer examination of the data header information in order to make switching/routing decisions based on destination and quality of service.

Can Observe Data and Headers

Note: This does not mean that time-scheduled and/or time-reserved datagram/packet devices may not observe, read, or in other ways determine information in the data headers (if there are any data headers) or in the data itself (if desired) as the packets route through a time-scheduled and/or time-reserved datagram/packet node. Time-scheduled and/or time-reserved datagram/packet switching may indeed observe packet headers if desired. However, depending upon the network design, the observation of these packet headers may not be necessary to determine the routing/switching destinations or generally the qualities of service. Instead, these observations may be made to determine information such as actual packet length (versus maximum length or scheduled length), bit error rates, time of arrival of packets, etc. Nevertheless, observation of time-scheduled and/or time-reserved datagram/packet headers may be used to determine the routing/switching destinations or the qualities of service.

Switching Based on Scheduled Timing

Instead of using packet headers to determine the routing/switching destinations (or usually Quality of Service), time-scheduled and/or time-reserved datagram/packet switching may make switching/routing decisions based on the packets' scheduled timing.

For example, in time-scheduled and/or time-reserved datagram/packet switching, a time-scheduled and/or time-reserved datagram/packet network element can know in advance the destination and quality of service for an incoming time-scheduled and/or time-reserved datagram/packet packet, cell, frame, or slot based on the incoming line or port and its scheduled arrival time.

By knowing (at a minimum) the arrival time, destination and max length/duration, the receiver or switch is now deterministic or quasi-deterministic. It can therefore switch either slightly in advance or precisely at the correct time with no layer two or higher layer lookup.

Time-scheduled and/or time-reserved datagram/packets may use a call setup process which schedules in advance when the time-scheduled and/or time-reserved datagram/packet packets will be sent, when they will be switched through a device, and when they will be received. A generalized example of the time-scheduled and/or time-reserved datagram/packet Network Operation Method is as follows:

Network Operation Method

1) Synchronization—At startup, each time-scheduled and/or time-reserved datagram/packet device in the time-scheduled and/or time-reserved datagram/packet network may synchronize or coordinate itself with its adjacent time-scheduled and/or time-reserved datagram/packet devices, such that they can schedule time-scheduled and/or time-reserved datagram/packet data arrival times and/or departure times.
2) Non-contending Schedule w/SVC or PVC—A source or time-scheduled and/or time-reserved datagram/packet node schedules a time-scheduled and/or time-reserved datagram/packet transmission/transfer to at least one destination. This time scheduled transmission may occur in a non-collision domain (such as point-to-point Gigabit Ethernet) and/or in a collision domain such as wireless (such as an 802.11 and/or CSMA/CA domain) or another collision domain shared medium such as shared bus Ethernet (CSMA/CD). This time-scheduled and/or time-reserved datagram/packet transmission/transfer consists of a scheduled “reserved” arrival time and/or scheduled “reserved” departure time. Scheduling and reserving the times may guarantee/assure that there are no collisions, contentions, congestions, time delays, and/or jitter along the time-scheduled and/or time-reserved datagram/packet path for the time-scheduled and/or time-reserved datagram/packet session. This scheduled time-scheduled and/or time-reserved datagram/packet transmission/transfer/connection can be set up permanently in the network (somewhat like a time-scheduled and/or time-reserved datagram/packet version of a Permanent Virtual Circuit), or set up temporarily for the duration of a call with a Call Setup Process (somewhat like a time-scheduled and/or time-reserved datagram/packet version of a Switched Virtual Circuit, or a circuit-switched telephone call).
3) Time-scheduled and/or time-reserved datagram/packet Communication—Once the path/connection/transmission is established, time-scheduled and/or time-reserved datagram/packet communication occurs between the source and destination with time-scheduled and/or time-reserved datagram/packet data being sent, routed, and received at the reserved, pre-established times. Each time-scheduled and/or time-reserved datagram/packet device along the way could generally know in advance when the time-scheduled and/or time-reserved datagram/packet data is scheduled to arrive. Immediately before the scheduled arrival, the time-scheduled and/or time-reserved datagram/packet device could route the incoming time-scheduled and/or time-reserved datagram/packet data from the correct input line through its switch fabric to the correct output line, and then retransmits it precisely at the scheduled departure time (buffering and scheduled delays may or may not be used). In this way, depending upon the network design, the time-scheduled and/or time-reserved datagram/packet device may have no need to examine the layer two or higher header information. The time-scheduled and/or time-reserved datagram/packet device may already know in advance, deterministically, what to do and when.

There is no need to stop or delay the data, causing unneeded delay and jitter in fluctuating input and output queues behind non-scheduled data. The general design is to keep the data on schedule.

Terminology

Time-Scheduled and/or Time-Reserved Datagram/Packet Switching

Time-scheduled and/or time-reserved datagram/packet switching is a conceptual term which comprises the use of timing and/or reserved timing and/or scheduled timing to transfer datagrams, packets, cells, and/or frames. Standard data switching and/or routing have traditionally had mechanisms for scheduling the order and/or priority of datagrams, but have not had a mechanism to transfer datagrams at particular times, specific times, absolute times, relative times, reserved times, and/or scheduled times. The term time-scheduled and/or time-reserved datagram/packet switching is used to encompass devices, mechanisms, methods, and systems which transfer datagrams at particular times, specific times, absolute times, relative times, reserved times, and/or scheduled times.

Time-scheduled and/or time-reserved datagram/packet switching is a conceptual term comprising data transfer, transmission, switching, and/or reception. Time-scheduled and/or time-reserved datagram/packet switching may include layer one, layer two and/or higher layer header lookups at particular nodes, either to determine the routing and/or switching destination (e.g., next hop or final destination), or for other purposes including but not limited to prioritization, timing synchronization, status monitoring, destination rerouting (possibly caused by link/path outages), and/or to determine if this is the expected timed packet or another packet which has been inserted into the place of the expected timed packet.

In time-scheduled and/or time-reserved datagram/packet switching, the time schedule and/or link/destination/path may be determined in advance through a call setup, initialization procedure, and/or other time-scheduling and link-scheduling process, which may establish either: a) a permanent timed connection which lasts indefinitely; or b) a temporary timed connection which lasts for the duration of the call; or c) a one-time time connection which lasts only for a one-time event connection through the network. The call setup, initialization procedure, and/or other time-scheduling and link-scheduling process schedules timed connections with particular start and stop times in each node along the path. Thus, switching and/or routing destination decisions (and optionally Quality of Service and/or other decisions) may be made based upon the scheduled arrival time of the data at each time-scheduled and/or time-reserved datagram/packet node, and/or they may be made by header lookup at each node.

Combined with Non-Time Scheduled Datagram/Packet Switching

When time-scheduled and/or time-reserved datagram/packet switching is combined or aggregated with non-time-scheduled, and/or non-time-reserved datagram/packet switching, the combination or aggregation is also referred to as time-scheduled and/or time-reserved datagram/packet switching, since it has time-scheduled and/or time-reserved datagram/packet timed switching capability included in the combined or aggregated device or network. A time-scheduled and/or time-reserved datagram/packet network has time-scheduled and/or time-reserved datagram/packet timed switching capability, but it may also optionally have traditional data switching and/or non-time-scheduled, and/or non-time-reserved datagram/packet capability integrated into it as well.

Path Switching or Network Path Switching

Path Switching or Network Path Switching comprises a subset of Time-scheduled and/or time-reserved datagram/packet switching, wherein the time-scheduled and/or time-reserved datagram/packet timed data switches/routes/transfers through the time-scheduled and/or time-reserved datagram/packet network or subset of the time-scheduled and/or time-reserved datagram/packet network without storage or buffering at any nodes except perhaps the first and last node.

With path switching, it is possible to time-schedule a time-scheduled and/or time-reserved datagram/packet path completely across the network with no buffering and no output line contention. The result of path switching is network latency that is even faster than circuit switching network latency is today, since circuit switching requires brief input and output buffering at each node.

Circuit Switching of Packets, Packet-Circuit, or Circuit-Packet Switching

Circuit Switching of Packets at a time-scheduled and/or time-reserved datagram/packet level, also variously called Packet-Circuit Switching or Circuit-Packet switching comprises switching packets through the network at a time-scheduled and/or time-reserved datagram/packet level, wherein the time-scheduled and/or time-reserved datagram/packet data routes through each time-scheduled and/or time-reserved datagram/packet node based on timing without necessarily using header lookup for destination address, but the time-scheduled and/or time-reserved datagram/packet data may be stored and/or buffered at each time-scheduled and/or time-reserved datagram/packet node along the way. This is somewhat similar to the current method of circuit switching of voice slots, which stores the voice data at each node before switching it through. The differences are that in voice circuit switching: the voice slots are smaller (8 bits); are of fixed size; and do not contain headers. In Packet-Circuit switching on the other hand, the packets may be large; they may be of variable length or variable size; they usually contain headers; and the system generally uses specific, absolute, or relative time synchronization. In all cases though, standard Circuit switching and Packet-Circuit switching both entail the buffering and storage of data at the node as part of the transfer/switching process.

Path-Circuit Switching or Circuit-Path Switching

Path-Circuit Switching or Circuit-Path Switching may combine both types of time-scheduled and/or time-reserved datagram/packet switching—path switching and packet-circuit switching. Path switching comprises no storage or buffering at each node with the possible exception of the initial edge node and the final edge node, whereas packet-circuit switching uses buffering at each node. The combination of the two may use buffering or no buffering at each individual node depending upon the ability to schedule the time-scheduled and/or time-reserved datagram/packet data through the time-scheduled and/or time-reserved datagram/packet node at that specific time. If there is no scheduling conflict, the node path switches the data through without storage. If there is a scheduling conflict, the node schedules the next best time, temporarily stores the data until that time (packet-circuit switching), then sends the data on at the correct scheduled time.

Bypass Switching

Time-scheduled and/or time-reserved datagram/packet timed switching may use Bypass Switching wherein the time-scheduled and/or time-reserved datagram/packet data bypasses or switches around a standard data switch fabric, queuing buffers, and/or non-time-scheduled mechanisms in a datagram/packet switching network element. In bypass switching, the standard non-time-scheduled data switch may still be integrated with the time-scheduled and/or time-reserved datagram/packet switching component or it may be a completely separate “overlaid” device. In either case, the time-scheduled and/or time-reserved datagram/packet switching component bypasses around the standard data switching and/or buffering/queuing mechanisms. In effect, this means that the standard data switch may use a separate switching fabric or buffering system from the time-scheduled and/or time-reserved datagram/packet switching fabric. Thus there may be one or more switching fabrics or queuing/buffering mechanisms in bypass switching.

Cut-Through Switching or Tunneling Switching

Cut-Through Switching or Tunneling Switching refers to time-scheduled and/or time-reserved datagram/packet switching wherein the standard data switching and/or buffering components may be integrated with the time-scheduled and/or time-reserved datagram/packet timed switching and/or buffering components, and both switching functionalities share the same switching and/or buffering fabric. This means that a single switching and/or buffering fabric may be used for tunneling or cut-through switching, such that time-scheduled and/or time-reserved datagram/packet switching “cuts through” or “tunnels” through the combined switch fabric.

Deterministic Data Switching

Deterministic Data Switching refers to the characteristic of time-scheduled and/or time-reserved datagram/packet switching whereby each time-scheduled and/or time-reserved datagram/packet network element, and thus the time-scheduled and/or time-reserved datagram/packet network itself, may know in advance the next time-scheduled and/or time-reserved datagram/packet state that it will switch to and when it will switch to it. Nevertheless, a variation on deterministic data switching may substitute non-scheduled packets in the time-reserved time interval.

Synchronized Data Switching

Synchronized Data Switching, also variously termed Synchronized Packet Switching, Synchronized Cell Switching, or Synchronized Frame Switching refers to the aspect of time-scheduled and/or time-reserved datagram/packet switching whereby time-scheduled and/or time-reserved datagram/packet network elements, and consequently the time-scheduled and/or time-reserved datagram/packet network itself, is synchronized or timed to such a degree that it can implement the switching of layer two and/or higher layer data at a time-scheduled and/or time-reserved level due to the synchronization or timing.

Time-scheduled and/or time-reserved datagram/packet networks transmit, transfer, switch, and/or receive time-scheduled and/or time-reserved datagram/packet data through time-scheduled and/or time-reserved datagram/packet devices in basically the same deterministic way, with a synchronization system. Since standard data networks are not synchronized, and since time-scheduled and/or time-reserved datagram/packet switches carry standard computer data and are synchronized, time-scheduled and/or time-reserved datagram/packet switching may also been called Synchronized Data Switching.

Scheduled Time Switching or Scheduled Data Switching

Scheduled Time Switching and Scheduled Data Switching refer to characteristics of time-scheduled and/or time-reserved datagram/packet switching wherein specific or relative times are scheduled for time-scheduled and/or time-reserved datagram/packet data to be switched through the time-scheduled and/or time-reserved datagram/packet devices and time-scheduled and/or time-reserved datagram/packet network.

Time-Path Switching

Time-Path Switching refers to the characteristics of time-scheduled and/or time-reserved datagram/packet switching wherein a specific path or paths are formed at specific times through the time-scheduled and/or time-reserved datagram/packet network either simultaneously and/or concurrently, and/or sequentially. This phenomenon, in effect, means that the entire time-scheduled and/or time-reserved datagram/packet network is acting like a single large multi-contact switch wherein multiple complex time-scheduled and/or time-reserved datagram/packet paths are formed and then undone to make way for other multiple complex time-scheduled and/or time-reserved datagram/packet paths.

Header-Less Packet or Header-Less Data Switching

Header-less Data Switching or Header-less Packet Switching refers to a method of implementing time-scheduled and/or time-reserved datagram/packet switching in which the packet header is not sent through the network, but may be attached to the packet at the last time-scheduled and/or time-reserved datagram/packet switch in the path. Since the call setup process may establish timing as the means to route the time-scheduled and/or time-reserved datagram/packet data, no lookup of the header is therefore required. In addition, since the source knows the final destination at call setup time, it may share the final destination with the last time-scheduled and/or time-reserved datagram/packet switching component in the path during the call setup process. Consequently, the time-scheduled and/or time-reserved datagram/packet information may be sent entirely through the time-scheduled and/or time-reserved datagram/packet network without the header, such that they header (and other various protocol elements) may be installed at the last time-scheduled and/or time-reserved datagram/packet network element in the path (if desired).

Combination/Hybrid Time-Scheduled and Non-Time-Scheduled

In hybrid networks and devices which combine time-scheduled and/or time-reserved datagram/packet and layer two and/or higher layer data networks and/or non-layer one, non-time-scheduled, and/or non-time-reserved datagram/packet networks, the time-scheduled and/or time-reserved datagram/packet network switches data at a time-scheduled and/or time-reserved datagram/packet level using time-scheduled and/or time-reserved datagram/packet techniques, e.g., scheduled packets. Thus the hybrid time-scheduled and/or time-reserved datagram/packet/layer two and higher and/or non-layer one, non-time-scheduled, and/or non-time-reserved datagram/packet network may place layer two and/or higher layer data packets (or segmented data packets) between the scheduled time-scheduled and/or time-reserved datagram/packet packets when there is enough space or time. Thus combination/hybrid time-scheduled and/or time-reserved datagram/packet and layer two and/or higher layer and/or non-layer one, non-time-scheduled, and/or non-time-reserved datagram/packet data networks can achieve extremely high efficiency without increasing the delay times or jitter of real-time or other high-priority data in the hybrid networks.

Path-Data Switching or Data-Path Switching

Path-Data Switching or Data-Path Switching is a combination/hybrid of time-scheduled and/or time-reserved datagram/packet switching with layer two and/or higher layer data switching. This approach switches the time-scheduled and/or time-reserved datagram/packet data with pure path switching, whereby there is no storage of scheduled time-scheduled and/or time-reserved datagram/packet path switched data, except perhaps at the first and last time-scheduled and/or time-reserved datagram/packet nodes. Standard layer two and/or higher layer data is sent in between the scheduled time-scheduled and/or time-reserved datagram/packet path switched data, and is switched using standard layer two and/or higher layer techniques.

Circuit-Data Switching or Data-Circuit Switching

Circuit-Data Switching or Data-Circuit Switching is a combination/hybrid of time-scheduled and/or time-reserved datagram/packet switching with layer two and/or higher layer data switching. This approach switches the time-scheduled and/or time-reserved datagram/packet data using circuit switching of packets or circuit-packet switching, whereby there is temporary scheduled storage of the time-scheduled and/or time-reserved datagram/packet data at each node before it is shipped at the precisely scheduled time. Layer two and/or higher layer data is sent in between the scheduled time-scheduled and/or time-reserved datagram/packet circuit-packet switched data, and is switched using standard layer two and/or higher layer techniques.

Path-Circuit-Data Switching

Path-Circuit-Data Switching is a combination/hybrid of a) the time-scheduled and/or time-reserved datagram/packet techniques of path switching with no buffering at each node with the possible exception of the initial edge node and the final edge node, b) the time-scheduled and/or time-reserved datagram/packet technique of circuit-packet switching with buffering at each node, and c) the layer two and/or higher layer data switching techniques. For time-scheduled and/or time-reserved datagram/packet packets, the combination of path switching and circuit-packet switching may use buffering or no buffering at each individual node depending upon the ability to schedule the time-scheduled and/or time-reserved datagram/packet data through the time-scheduled and/or time-reserved datagram/packet node at that specific time. If there is no scheduling conflict, the node path switches the data through without storage. If there is a scheduling conflict, the node schedules the next best time, temporarily stores the data until that time (packet-circuit switching), then sends the data on at the correct scheduled time. Layer two and/or higher layer data is sent in between the scheduled time-scheduled and/or time-reserved datagram/packet path switched or circuit-packet switched data. Layer two and/or higher layer data is switched using standard layer two and/or higher layer techniques.

Types of Time-Scheduled and/or Time-Reserved Network Architectures & Topologies

There are multiple time-scheduled and/or time-reserved datagram/packet network architectures and topologies. These include but are not limited to:
point-to-point (unicast), multi-hop;
point-to-point (unicast), single-hop;
point-to-multipoint (multicast or broadcast), single-hop (shared media);
point-to-multipoint (multicast or broadcast), multi-hop;
network access architectures and topologies; and
mobile or moving devices and network architectures.
   Point-To-Point (Unicast), Multi-Hop Time-Scheduled and/or Time-Reserved Architecture

The point-to-point multi-hop network architecture itself consists of a source, which may be a network element, also variously termed an originator or a caller; a departure router, which is a network element, also variously termed a departure switch, a departure node, or an originating edge node; mid-destination routers, which are network elements, also variously termed mid-destination switches, internal nodes, or middle nodes; a final destination router, which is a network element, also variously termed a final-destination switch, or terminating edge node; a receiver which is a network element, also termed a called party; and transmission paths connecting the network elements. These transmission paths may be any type or types of transmission media either singular or in parallel, including, but not limited to optical, wireless, and/or electrical transmission media.

Point-To-Point, Single-Hop Time-Scheduled and/or Time-Reserved Datagram/Packet Architecture

As stated previously, other embodiments of this architecture include instances of point-to-point single-hop connections. In these embodiments, the source is the departure router; the receiver is the terminating edge node; and there are no mid-destination routers. In these embodiments the time-scheduled and/or time-reserved datagram/packet architecture comprises a time-scheduled and/or time-reserved datagram/packet source network element; a time-scheduled and/or time-reserved datagram/packet receiver network element; and a single-hop transmission media between the source and destination network elements. The one or more transmission media may be either singular and/or in parallel, and may include, but is not limited to optical, wireless, and/or electrical transmission media.

Multipoint, Shared Media, Access, and Mobile

In addition, point-to-multipoint, multipoint-to-point, and multipoint-to-multipoint time-scheduled and/or time-reserved datagram/packet architectures may also be implemented over single hops and/or shared media and/or over multiple hops. Network access methods and topologies, as well as mobile devices and networks may also implement time-scheduled and/or time-reserved datagram/packet switching.

Transmission Media

The transmission media in time-scheduled and/or time-reserved datagram/packet networks comprises any of various electrical, optical, and/or wireless transmission media; combinations of these transmission media; parallel paths of these transmission media; and/or combinations of parallel paths of these transmission media.

Time-Determined Network Methods

Time-Determined Datagram/Packet Network Operating Process

The basic time-determined, time-scheduled, and/or time-reserved datagram/packet Network Operating Process comprises the following steps:
1. Synchronize the network elements—Establish some form of a timing-oriented method that may enable each of one or more network elements to schedule and/or determine in advance when each time-scheduled and/or time-reserved datagram/packet packet will arrive (to within some acceptable margin of error). This method can be some form of synchronization, coordination, timing, absolute time, relative time, common reference, common signal, time-marker, etc. that links the time-scheduled and/or time-reserved datagram/packet network elements in some time-oriented way.
2. Schedule a transmission, transmission link, transmission path, and/or route—Establish and schedule a transmission/transfer of time-scheduled and/or time-reserved datagram/packets through one or more time-scheduled and/or time-reserved datagram/packet networks and/or hops according to the method used in step one. Each network element in the path and/or hop may be able to determine in advance: a) when each time-scheduled and/or time-reserved datagram/packet packet(s) is expected to arrive; b)from where—on what incoming port it will arrive; c) how long—what is the maximum length/time or when is the latest ending arrival time; and d) what or where to—what to do when it arrives (e.g., where to switch it to? kill it, respond to it, send it to an application, etc.). This schedule can be a one-time event, or periodic. The schedule can use a call setup process for a temporary connection or permanent connection or the initial packet may make the reservation. The call setup process can be executed sequentially node-by-node (i.e., Call Associated Signaling—CAS), or centrally controlled (i.e., Signaling System 7—SS7).
3. Transfer—Each appropriate network element transfers, transmits, switches, and/or receives the information through the network, hop, or link according to the schedule.
4. (optional) Tear-down the call.
   Network Synchronization

At network startup, system startup, and/or time-scheduled and/or time-reserved datagram/packet network element device startup, one or more of various time-scheduled and/or time-reserved datagram/packet synchronization methods may be implemented in each time-scheduled and/or time-reserved datagram/packet network element, such that each time-scheduled and/or time-reserved datagram/packet network element may determine and schedule, in advance:
For each incoming time-scheduled and/or time-reserved datagram/packet packet, cell, or frame:
   the incoming line or port;
   the arrival time, point, or mark (to within some set tolerance); and
   either the maximum time duration (maximum length/size) or the arrival ending time, point, or mark (to within some set tolerance);
   (optional) knowledge of various other information such as special identifiers to classify the uniqueness of packets, flows, sessions, etc. for time-slots, time-reserved buffers, etc.
And for each outgoing time-scheduled and/or time-reserved datagram/packet, cell, or frame:
   the outgoing line or port;
   the departure time (to within some set tolerance); and
   either the maximum duration (maximum length/size) or the departure ending time (to within some set tolerance);
   (optional) knowledge of various other information such as special identifiers to classify the uniqueness of packets, flows, sessions, etc. for time-slots, time-reserved buffers, etc.

In addition, depending upon the synchronization method(s) implemented, various other optional or mandatory parameters may also be determined. This includes but is not limited to: propagation delay between nodes; time-scheduled and/or time-reserved datagram/packet switching latency; transmission rate; buffering time; time-slots, etc.

Timing and/or Synchronization Categories

These timing and/or synchronization methods may comprise: absolute time (i.e., time of day); relative time (i.e., number of bits following an event); a combination of absolute and relative time; precise time (correct to the fraction of a second or to the bit); approximate time to within a certain inexact period; etc. Specific times pertinent to time-scheduled and/or time-reserved datagram/packet devices and systems include but are not limited to: arrival time; departure time; propagation delay; switching latency; buffering time; etc.

There are also various categories of synchronization, including but not limited to the following examples:
Timing may be specific and/or absolute as in chronological time, i.e., the specific year, month, day, hour, minute, second, millisecond, microsecond, nanosecond, picosecond, etc., down to the precision of time or bit desired. This information may be provided by or calculated from one or more universal reference sources.
Timing may be relative chronological time wherein the clocks are relatively stable, but inaccurate with respect to absolute chronological time. In these cases, extremely accurate synchronization can be implemented using one or more relative reference sources.
Timing may be relative, i.e., clockspeed synchronization, with respect to a commonly recognized synchronization marker of some sort; or with respect to some other time, event, or number of occurrences of events, e.g., the number of bits or symbols that have passed. In these cases, extremely accurate synchronization can be implemented using one or more relative reference sources.
Timing may also be a combination of absolute plus relative, e.g., X number of bits after a specific year, month, day, hour, minute, second, millisecond, and nanosecond.
   Master Clocks vs. No Master Clocks

Several embodiments of the network architecture use means for a master clock. These architectures are such that a master clock synchronizes the device embodiments using receiving synchronization means. In other embodiments of the network architecture, no master clock is required for time synchronization. In these embodiments, techniques and methods such as 2-way time transfer, or other synchronization methods may be used without a master clock to synchronize the network. Alternatively, master clocks, 2-way time transfer, and/or other methods may be used in various combinations in other embodiments.

Master Clocks

Master Clock with GPS

In one of these embodiments using a master clock, the master clock comprises the combined master clocks on the satellite Global Positioning System (GPS) or other similar systems commonly used today for timing and positioning measurements. GPS enables synchronization of device embodiment clocks down to the microsecond and nanosecond range, and potentially lower. Descriptions of GPS timing techniques and the accuracies obtainable are covered in “Tom Logsdon's “Understanding the Navstar: GPS, GIS, and IVHS”; 2^{nd} edition; 1995; Van Nostrand Reinhold; Ch. 11; pp.158-174 which is hereby incorporated by reference.

Detailed descriptions of GPS, synchronization techniques, time codes, clock measurements, accuracies, stabilities, and other useful applications of GPS technology are covered in literature from the company TrueTime, Inc, 2835 Duke Court, Santa Rosa, Calif. 95407, including Application Note #7, “Affordable Cesium Accuracy”; Application Note #11, “Video Time and Message Insertion”; Application Note #12, “Multi User Computer Time Synchronization”; Application Note #14, “Model GPS-DC Mk III Oscillator Selection Guide”; Application Note #19, “Simplified Frequency Measurement System”; Application Note #20, “Achieving Optimal Results with High Performance GPS”; Application Note #21, “Model XL-DC in Frequency Control Applications”; Application Note #22, “TrueTime's GPS Disciplined Cesium Oscillator Option”; Application Note #23, “Precise Synchronization of Computer Networks: Network Time Protocol (NTP) for TCP/IP”; Application Note #24, “Precision Time and Frequency using GPS: A Tutorial”; Application Note #25, “Precise Synchronization of Telecommunication Networks”; and Application Note #26, “Real Time Modeling of Oscillator Aging and Environmental Effects”. These application notes are available from TrueTime, Inc. and are hereby incorporated by reference.

Nevertheless, the present invention is not limited to GPS for either the master clock means nor for the device embodiment synchronization means. Any reasonably accurate clock may serve as the master clock including, but not limited to atomic clocks, cesium, rubidium, hydrogen maser clocks, or even quartz clocks; also any satellite-based clock, for example, GPS, transit navigational satellites, GOES satellites; any wireless clock, for example LORAN, TV, WWVB radio, radio phone, local radio; any land-based clock using physical interconnections such as copper wire, cable, microwave, or fiber, such as the central office clocks used currently by the telecommunications providers for synchronizing their synchronous networks; or even sea-based clocks will work as a master clock for the purposes of the present invention.

No Master Clocks

Independent Clocks on Each Link

In other alternative embodiments of the network architecture, no master clock is required for time synchronization between nodes. Instead, independent clocks may be used from each node to synchronize a link to the adjacent node or behind.

Two-Way Time Transfer

Alternatively, techniques and methods such as two-way transfer time synchronization methods may be used, including techniques similar to those described in “Two-way Satellite Time Transfer”; published by the U.S. Naval Observatory on their website at http://tycho.usno.navv.mil/twoway.html which is hereby incorporated by reference.

Network Time Protocol

Other alternative time synchronization techniques may be used or enhancements to them, including but not limited to standard time synchronization protocols such as Network Time Protocol as described in Application Note #23, “Precise Synchronization of Computer Networks: Network Time Protocol (NTP) for TCP/IP” covered in literature from the company TrueTime, Inc, 2835 Duke Court, Santa Rosa, Calif. 95407.

One-Way Time Synchronization

One-way time synchronization techniques may also be used, either in addition to or in place of other synchronization techniques. For example, assume a first network node adjacent to a second network node, both with relatively stable clockrates, but whose clocks have not been synchronized to precise time. Also assume that the first network node sends a time stamp using its own clock time of 4:00 PM to a second network node. Assume the second network node then receives the time-stamped message at 3:00 PM according to the second node's clock. Although neither node's clock knows the precise time, based on this one-way time stamping, the second node knows that packets from the first node will arrive exactly one hour earlier than the first node says it sent them—a negative one-hour offset.

Therefore, if the first node says that it will send a time-scheduled and/or time-reserved datagram/packet packet at exactly 4:05 PM and 100 nanoseconds according to the first node's clock, the second node knows to expect the packet at exactly 3:05 PM and 100 nanoseconds according to the second node's clock—an offset of exactly one hour earlier than the first node indicates.

Timestamp Accuracy

One-way or two-way synchronization timestamps could be sent frequently or infrequently, depending upon the stability of the clocks. Highly accurate clocks may send synchronization signals infrequently, whereas unstable clocks may require more frequent synchronization signals. Synchronization timestamps could also be attached to the data packets themselves, such that each packet would maintain the clock offset to the most precise degree attainable. Even with clocks that tend to wander excessively, this approach could be used to correct and stabilize the clock offset for every call setup, tear-down, and data packet sent.

Hybrids of Master Clocks and Other Time Synchronization Techniques

Hybrid synchronization embodiments and methods may also be achieved by incorporating a master clock(s), with one-way, and/or two-way and/or other timing synchronization techniques to establish and/or maintain timing. In a hybrid timing system, once a reasonably accurate time synchronization has been established in the device embodiments, well known techniques such as two-way time synchronization, common-view mode, or multi-satellite common view mode can then be used between the device embodiments in the network to measure and correct, to a high degree of accuracy, slight timing disparities and propagation delays between themselves and adjoining device embodiments. This serves to maintain and further tighten timing synchronization.

Any Time Synchronization Techniques May be Used

Any time synchronization techniques for synchronizing the device embodiments with each other may be used, such as those explained in the Logsdon reference, for example absolute time synchronization, clock fly-overs, common-view mode, and multi-satellite common view mode; those explained in the TrueTime reference, such as Network Transfer Protocol (NTP); those explained in the U.S. Naval Observatory web publication reference, such as two-way time transfer; link-to-link clocks using relative time, and/or various other techniques such as one-way synchronization explained above, or any techniques in use today such as framing bits, heartbeat packets, and/or the telecommunications synchronous network system used in central offices and other higher level switching centers.

Network and Network Element Scheduling

Time-Scheduled and/or Time-Reserved Event Scheduling Process

As the device embodiments are synchronized in the network, each device initiates its own time-scheduled and/or time-reserved datagram/packet event scheduling process. This process comprises:
1) building a time-scheduled and/or time-reserved datagram/packet event schedule;
2) establishing reservations for each input and output line on each network element device embodiment for a) permanent time-scheduled and/or time-reserved datagram/packet connections; b) specific one-time event time-scheduled and/or time-reserved datagram/packet connections; and/or c) periodic or repeating time-scheduled and/or time-reserved datagram/packet connections; and
3) switching the correct input line(s) to the correct output line(s) and controlling the input and/or output buffers according to the reservations.

In this way, packets or other data may be transferred from specific input lines through the time-scheduled and/or time-reserved datagram/packet switch to specific output lines in each network element device embodiment as scheduled.

Time-Scheduled Network and Device Call Setup Process

At this point, a real-time source, a real-time destination, or another network element device embodiment can initiate a time-scheduled and/or time-reserved datagram/packet call setup process for any purpose, such as a real-time application, high-priority message, and/or other time-scheduled and/or time-reserved datagram/packet connection. This process may establish permanent time-scheduled and/or time-reserved datagram/packet connections, specific one-time event time-scheduled and/or time-reserved datagram/packet connections, and/or periodic or repeating time-scheduled and/or time-reserved datagram/packet connections in each of the synchronized time-scheduled and/or time-reserved datagram/packet network device element embodiments along a specific path from the source through the synchronized network to the destination.

Permanent vs Switched Time-Scheduled Datagram/Packet Connections

Permanent time-scheduled and/or time-reserved datagram/packet connections, circuits, and/or paths are time-scheduled and/or time-reserved somewhat similar to a time-scheduled and/or time-reserved datagram/packet version of permanent virtual circuits used in standard data switching. In this permanent time-scheduled and/or time-reserved datagram/packet connection, circuit, and/or path approach, time-scheduled and/or time-reserved datagram/packet scheduled time connections remain in effect for the duration of the network setup or until changed by a network administrator.

Non-permanent (i.e., temporary) one-time time-scheduled and/or time-reserved datagram/packet events; and/or non-permanent (i.e., temporary) periodic or repeating time-scheduled and/or time-reserved datagram/packet connections are somewhat similar to a time-scheduled and/or time-reserved datagram/packet version of switched virtual circuits used in standard data switching. These time-scheduled and/or time-reserved datagram/packet connections are generally scheduled with a call setup process, last for the duration of the call, and are then torn down.

Switching at Scheduled Time(s)

At the scheduled time, each synchronized time-scheduled and/or time-reserved datagram/packet network element device node embodiment along that path switches their appropriate input lines, output lines, input buffers, and/or output buffers to bypass the normal store-and-forward buffering and switching, and route directly from the input lines through a time-scheduled and/or time-reserved datagram/packet switch/buffering mechanism and directly on through the output lines to the next synchronized network element device node which is synchronized and scheduled to do the same thing. In this way, at any scheduled instant, a packet may be sent in a cut-through or bypass manner directly from the source through the network to the destination with only the propagation delay of the transmission lines, the input and output bypass circuitry, the time-scheduled and/or time-reserved datagram/packet switch fabric, and possibly some time-scheduled buffer delay. This obtains the goal of a rapid, consistent, immediate, on-time, non-blocked, non-delayed, non-congested, loss-less, jitter-free, reliable flow of data in real-time, with guaranteed delivery and guaranteed quality of service.

Time-Scheduled and/or Time-Reserved Datagram/Packet Network Capabilities

Multiple Speed or Bit Rate Changes

Because time-scheduled and/or time-reserved datagram/packet networks may not require storage at intermediate nodes, path switching of electrical, wireless, and/or optical signals is able to transfer information through the time-scheduled and/or time-reserved datagram/packet switch at virtually any speed or bit rate.

Generally, the bit rate limiting factor for an electrical switch is caused by the switch's need for a relatively fixed-frequency signal, such that it may phase-lock loop and sample the incoming bitstream at the correct bit-rate. However, if no storage is required, then no sampling or phase-lock looping is required. Thus the strict requirement for relatively fixed frequency or bit rate signals is also eliminated. Real-time clipping circuits, signal-followers, regenerators, and/or other electrical, optical, mechanical, wireless, and/or hybrid devices may be used to clean up the electrical, optical, mechanical, wireless, and/or hybrid time-scheduled and/or time-reserved datagram/packet signals as they pass through the time-scheduled and/or time-reserved datagram/packet switch, but these circuits can be used to clean up an extremely broad range of frequencies and bit rate signals. Thus, for an electrical, optical, and/or wireless signal, the time-scheduled and/or time-reserved datagram/packet switch merely bypass switches or cut-through switches the time-scheduled and/or time-reserved datagram/packet data at the scheduled time regardless of the bit-rate of the time-scheduled and/or time-reserved datagram/packet signal. This means, for example, that at any one specific time, a first time-scheduled and/or time-reserved datagram/packet signal at T1/DS1 speeds of 1.544 Megabits/second could be time-scheduled and/or time-reserved datagram/packet switched from a first input port to a first output port; while simultaneously, a second time-scheduled and/or time-reserved datagram/packet signal at T3/DS3 speeds of approximately 45 Megabits/second could be time-scheduled and/or time-reserved datagram/packet switched from a second input port to a second output port; while simultaneously, a third time-scheduled and/or time-reserved datagram/packet signal running at 1 Gigabits/second speed could be time-scheduled and/or time-reserved datagram/packet switched from a third input port to a third output port.

The same result may also be achieved with time-scheduled and/or time-reserved datagram/packet switching of optical signals. Using Micro-Electro-Mechanical (MEMs) devices, or any other optical switching components with no storage, time-scheduled and/or time-reserved datagram/packet packets of photons may be optically time-scheduled and/or time-reserved datagram/packet switched in a bypass or cut-through manner at the scheduled time regardless of the frequencies or bit-rates of the time-scheduled and/or time-reserved datagram/packet signal. Using the MEMs device as an example, the time-scheduled and/or time-reserved datagram/packet switch consists of aligned mirrors that merely reflect the time-scheduled and/or time-reserved datagram/packet photonic packets through the time-scheduled and/or time-reserved datagram/packet switch. Thus, it makes no difference what bit rate the photons have been modulated at. The optical time-scheduled and/or time-reserved datagram/packet switch merely needs to have aligned the correct input to the correct output by the precise arrival time and hold that alignment until the precise departure time. Optical clipping devices, signal-followers, optical regenerators, and/or other devices may be used to clean up the optical time-scheduled and/or time-reserved datagram/packet signals as they pass through the time-scheduled and/or time-reserved datagram/packet switch, but these circuits can be used to clean up an extremely broad range of optical wavelengths and bit rate signals. Thus, for an optical signal, the time-scheduled and/or time-reserved datagram/packet switch merely bypass switches or cut-through switches the time-scheduled and/or time-reserved datagram/packet data at the scheduled time regardless of the bit-rate of the time-scheduled and/or time-reserved datagram/packet signal. This means, for example, that at any one specific time, a first time-scheduled and/or time-reserved datagram/packet optical signal at OC-1 rates of 51.84 Megabits/second could be time-scheduled and/or time-reserved datagram/packet switched from a first input port to a first output port; while simultaneously, a second time-scheduled and/or time-reserved datagram/packet optical signal at OC-192 speeds of approximately 9.953 Gigabits/second could be time-scheduled and/or time-reserved datagram/packet switched from a second input port to a second output port; while simultaneously, a third time-scheduled and/or time-reserved datagram/packet optical signal running at 1 Terabits/second speed could be time-scheduled and/or time-reserved datagram/packet switched from a third input port to a third output port.

The result is that different speeds or bit rates may simultaneously be time-scheduled and/or time-reserved datagram/packet switched through the same time-scheduled and/or time-reserved datagram/packet network element or network elements, without requiring speed or bit rate conversions at each time-scheduled and/or time-reserved datagram/packet network element.

Multiple Line Encoding Types

Time-scheduled and/or time-reserved datagram/packet may simultaneously switch signals using various line encoding types through the same network element or network elements (e.g., unipolar or bipolar; NRZ, NRZ-L, NRZ-I; differential encoding; multilevel binary such as bipolar-AMI or pseudotemary; biphase such as manchester or differential manchester; scrambling techniques; 2B1Q; QAM; DMT; CAP; FSK; PSK; ASK; B8ZS; etc.).

Multiple Modulation Schemes

Time-scheduled and/or time-reserved datagram/packet may simultaneously switch transmissions using various modulation schemes through the same network element or network elements (e.g., Ultra Wide Band; High Data Rate; Spread Spectrum; Time Division Multiplexing; Wavelength Division Multiplexing; etc.).

Multiple Protocols

Time-scheduled and/or time-reserved datagram/packet may simultaneously switch various time-scheduled and/or time-reserved datagram/packet and higher protocols through the same network element or network elements (e.g., ATM; IP; TCP/IP; UDP/IP; Ethernet; Token Ring; OSI; X.25; etc.).

Fixed Size and Variable Size Packets

Time-scheduled and/or time-reserved datagram/packets may schedule, reserve, and/or transfer fixed-size and/or variable-size packets, cells, frames, and/or slots through time-scheduled and/or time-reserved datagram/packet networks. This is achieved by reserving the maximum expected packet size for the time-scheduled packet. When a time-scheduled packet is transmitted that is shorter/smaller than the maximum reserved packet, then the remaining reserved time may be used to transfer non-time-scheduled packets and/or other time-scheduled packets.

Variable Packet Size

The size of the incoming packet may be determined by the sniffer 37, 37a looking for variable packet size. The sniffer 37, 37a may also look at specific info in the packet as it goes by. It can examine the packet as it goes by for data, but it may not need to examine the packet for the destination address, as it may already know that information based on time of arrival. For example, although it knows the reserved or scheduled maximum packet size, the actual packet size it is currently switching may be smaller than the maximum scheduled size. It can therefore look at the header as it arrives and determine the packet length/duration. If the packet length is shorter than the maximum reserved time, then it may stop switching the time-scheduled and/or time-reserved datagram/packet as soon as the current shorter packet has passed through the time-scheduled and/or time-reserved datagram/packet switch, and start switching non-scheduled packets in order to use the bandwidth more efficiently.

Alternatively, the sniffer may also examine the packet for routing information as well, since some schemes allow non-scheduled packets to be transferred in the reserved time interval if the normal packet scheduled in that time interval is not available.

The Sniffer 37, 37a may also look for a header indicating zero length data being sent, e.g., Silent voice (pause), black screen packets. Alternatively, if no data is to be sent (e.g., silence on the voice line, or black screen for the video, then a minimum sized packet can be sent with a packet header which indicates the zero size payload length, so that the time-scheduled and/or time-reserved datagram/packet switch can revert to normal packet mode for efficiency purposes.

Alternatively, if no data is to be sent, no packet at all can be sent. In this scenario, when the sniffer 37, 37a detects no data arriving when the time-scheduled and/or time-reserved datagram/packet is scheduled to arrive, then the time-scheduled and/or time-reserved datagram/packet switch may also revert to the standard data packet mode for high efficiency.

In another scenario, no packet arriving might also be defined as meaning that there has been a severance of the connection and that alternative routing may need to be initiated.

Non-Continuous or Non-Contiguous Datagram/Packet Paths or Circuits

A time-scheduled and/or time-reserved datagram/packet network and/or device may be connected to another time-scheduled and/or time-reserved datagram/packet network and/or device through a non-layer one, non-time-scheduled, and/or non-time-reserved datagram/packet network. This means that timing, reservations, and guaranteed time-of-arrival may be made in each of the time-scheduled and/or time-reserved datagram/packet networks, links, hops, and/or nodes; but time guarantees probably cannot be made across the non-time-scheduled, and/or non-time-reserved datagram/packet network, node, hop, or link in between.

Timing Control Methods

Timing control methods may be implemented by:
adding safety zones to time-scheduled and/or time-reserved datagram/packet transmissions;
adding extra bits or bytes to time-scheduled and/or time-reserved datagram/packet transmissions (e.g., for clock slippage or timing errors).
   Error Detection Methods

Error Detection methods may be implemented by:
detecting errors in time-scheduled and/or time-reserved datagram/packet connections;
detecting line breaks in time-scheduled and/or time-reserved datagram/packet networks;
isolating line faults in time-scheduled and/or time-reserved datagram/packet networks.
   Protection and Fast Rerouting or Restoration

Protection and Fast Rerouting or Restoration may be implemented by:
Establishing time-scheduled, and/or time-reservations along a primary route.
Establishing time-scheduled, and/or time-reservations along a secondary route. These time-scheduled reservations/slots may be used for non-time-scheduled packets/datagrams when the secondary route is not needed.
Monitoring the arrival of time-scheduled and/or non-time-scheduled packets/datagrams along the primary route to be sure that time-scheduled and/or non-time-scheduled packets are arriving. Optionally sending messages from receiving node to sending node to communicate the health of the primary path.
Detecting failure or degradation of the primary route at the receiver and/or the transmitter, and optionally sending or ceasing to send primary route health status messages to the transmitter and/or receiver.
Establishing fast rerouting and restoration of time-scheduled and/or time-reserved datagram/packet (and/or also non-layer one, non-time-scheduled, and/or non-time-reserved datagram/packet) connections and transmissions through the previously reserved time-scheduled and/or time-reserved and/or time slots on the secondary route.
   Network Control

Network control may be established by:
controlling in each time-scheduled and/or time-reserved datagram/packet network element and/or across the time-scheduled and/or time-reserved datagram/packet network:
   synchronization means,
   scheduling means, and
   switching and/or buffering means;
monitoring and managing time-scheduled and/or time-reserved datagram/packet networks through network management systems, MIBs, billing systems, control mechanisms, etc;
engineering and provisioning of bandwidth in time-scheduled and/or time-reserved datagram/packet networks;
scaling up or growing time-scheduled and/or time-reserved datagram/packet networks; and for
creating services for time-scheduled and/or time-reserved datagram/packet networks.
   Time-Scheduled and/or Time-Reserved Datagram/Packet Network Elements and/or Devices
   Network Element Device Elements

There are multiple time-scheduled and/or time-reserved datagram/packet network element device embodiments, which may be categorized into classes of device embodiments. These network element device embodiments and classes of network element device embodiments comprise: 1) time-scheduled and/or time-reserved datagram/packet switching and/or buffering means; 2) time-scheduled and/or time-reserved datagram/packet switch and/or buffer controlling means; and 3) time-scheduled and/or time-reserved datagram/packet switch and/or buffer scheduling means. The network element device embodiments and classes of embodiments may also include optional input and/or output buffer means; various alternative optional internal component means; various alternative optional internal switching means; and optionally, one or more internal or external packet-oriented, cell-oriented, frame-oriented, or other store-and-forward and/or data switching and/or routing means.

Network Elements and/or Device Embodiments

Various time-scheduled and/or time-reserved datagram/packet device embodiments, including but not limited to:
time-scheduled and/or time-reserved datagram/packet switches;
synchronized data switches;
scheduled time switches;
scheduled data switches;
deterministic data switches;
bypass switches;
cut-through switches;
tunneling switches;
header-less data switches or header-less packet switches;
path switches;
packet-circuit switches or switches for circuit-switching of packets; and
path-circuit switches,
combinations or hybrids of time-scheduled and/or time-reserved datagram/packet switches with layer two and/or higher layer switches and/or non-layer one, non-time-scheduled, and/or non-time-reserved datagram/packet such as:
   path-data switches,
   circuit-data switches, and
   path-circuit-data switches; etc.)
      Bypass Switch

A bypass switch may be a combination time-scheduled and/or time-reserved datagram/packet and standard and/or non-timed devices in which the layer two and higher layer and/or non-timed switching fabric and/or buffering is separate from the time-scheduled and/or time-reserved datagram/packet switching fabric and/or buffering. Hence the time-scheduled and/or time-reserved datagram/packet fabric and/or buffers “bypass” the layer two or higher layer and/or non-timed fabric and/or buffers.

Cut-Through Switch or Tunneling Switch

A cut-through switch or tunneling switch is a combination time-scheduled and/or time-reserved datagram/packet and layer two or higher layer and/or non-timed device which uses the same switching fabric and/or buffers to switch both time-scheduled and/or time-reserved datagram/packet and layer two and/or higher layer and/or non-timed data. Thus, a cut-through switch or tunneling switch would use a single optical fabric and/or possibly buffers for switching both time-scheduled and/or time-reserved datagram/packet and layer two or higher layer and/or non-timed optical signals, wireless signals, and/or a single electrical switching fabric and/or buffers for switching both time-scheduled and/or time-reserved datagram/packet and layer two or higher layer electrical signals.

Device Capabilities and Components

various input and output line types, including but not limited to:
   optical,
   electrical, and/or
   wireless inputs;
various optional device components, including but not limited to:
   optional sniffers or real-time readers;
   optional timestamp transmitters and/or receivers;
   optional framers and/or deframers;
   optional optical/electrical and/or electrical/optical converters;
   optional input and output buffers; and
   various optional input and/or output stage switching configurations supporting various paths through the switching device;
   various optional switching fabric components, including but not limited to:
      optional single switching fabrics and/or dual switching fabrics;
      optional blocking and/or non-blocking switching fabrics;
      optional delaying and/or non-delaying switching fabrics;
      optional optical, electrical, and/or both optical and electrical switching fabrics;
      optional switching fabrics wherein no speed or bit rate conversions or changes may be required to transfer information through the switch fabric;
      optional switching fabrics which may support point-to-point, point-to-multipoint, multipoint-to-point, and multipoint-to-multipoint connections;
   means and methods for time-scheduled and/or time-reserved datagram/packet device embodiments comprising edge nodes, internal nodes, and or end-user devices;
      Classes of Network Element and/or Device Embodiments
      First (Integrated) Class of Network Element Device Embodiments

The first class of network element device embodiments consists of embodiments in which a standard packet, cell, or frame-oriented switching means is both included and integrated into the device embodiment, such that these device embodiments are deployed in standard packet, cell, or frame-oriented networks. In this scenario, the class of integrated device embodiments normally operates in packet, cell, or frame-oriented mode using the layer two and/or higher layer non-time reservation packet, cell, or frame-oriented switch. However the device embodiments are then used to schedule and switch real-time, high-priority, and/or other time-scheduled and/or time-reserved datagram/packet packets to cut-through, bypass, and/or tunnel through the packet, cell, or frame-oriented devices and/or network at the scheduled times. The control circuitry in these preferred device embodiments enables complete integration into existing packet, cell, or frame-oriented networks, including the capability to store and hold non-real-time and non-high-priority in-transit packets in buffers while the time-scheduled and/or time-reserved datagram/packet switching occurs, and then resume sending the non-real-time and non-high-priority in-transit packets once the time-scheduled and/or time-reserved datagram/packet switching is terminated. The control circuitry in these preferred device embodiments enables scheduled time-scheduled and/or time-reserved datagram/packet switching from specific input lines to specific output lines through the switch fabric, while at the same time routing in normal packet, cell, or frame mode through the packet, cell, or frame switch fabric for input and output lines that are not scheduled for time-scheduled and/or time-reserved datagram/packet switching. In these integrated embodiments the switch fabrics may be separate time-scheduled and/or time-reserved datagram/packet fabrics versus layer two fabrics, or they may be the same switch fabric which switches both time-scheduled and/or time-reserved datagram/packet and layer two and/or higher layer data. The switch fabrics are preferred to be non-blocking, non-delaying switch fabrics, but they may also comprise less preferred blocking and/or delaying switch fabrics.

Second (Overlay) Class of Network Element Device Embodiments

The second class of network element device embodiments is similar to the first class of network device embodiments, except that the standard packet, cell, or frame-oriented data switching means is not integrated into the time-scheduled and/or time-reserved datagram/packet device embodiment as one complete integrated unit. Instead, the packet, cell, or frame-oriented switch is physically distinct, and the time-scheduled and/or time-reserved datagram/packet network element device embodiment is “overlaid” or placed around the existing packet, cell, or frame-oriented switch. In this way, all external input and output lines going to and from the network route first through the second network element device embodiment and then are connected to the physically separate store-and-forward and/or layer two and/or higher layer data switch. The primary purpose of the second class of device embodiments is to enable the installation of time-scheduled and/or time-reserved datagram/packet switching on top of existing store-and-forward and/or layer two and/or higher layer data switches in an existing network, to eliminate the costs and efforts of replacing the existing packet, cell, or frame-based switches.

Bi-Modal Switching

As in the first device embodiment, the second device embodiment operates in two modes—normal mode, and time-scheduled and/or time-reserved datagram/packet mode (also called variously cut-through mode, bypass mode, or tunneling mode). In normal mode, the device embodiment operates normally by switching standard layer two and/or higher layer and/or store-and-forward data packets through to the separate and distinct packet, cell, or frame-oriented standard data switch. In time-scheduled and/or time-reserved datagram/packet mode, cut-through mode, bypass mode, or tunneling mode, like the first device embodiment, the second device embodiment also uses its time-scheduled and/or time-reserved datagram/packet switch and control circuitry to schedule and switch real-time, high-priority and/or other time-scheduled and/or time-reserved datagram/packet packets to cut-through and/or bypass the store-and-forward and/or layer two and/or higher layer network at the scheduled times.

Control Means Not Integrated

However, in this second class of device embodiments, the time-scheduled and/or time-reserved datagram/packet control circuitry is generally not integrated into the packet, cell, or frame-oriented layer two and/or higher layer data switch. Consequently, there is the capability to stop, store, and hold standard packets in the input/output buffers when there is a time-scheduled and/or time-reserved datagram/packet switching conflict. However, because of the physically separate store-and-forward switch, there is generally no control capability to force the store-and-forward switch to stop, store, and hold standard packets while the time-scheduled and/or time-reserved datagram/packet switching occurs through the output stage, and then resume sending the standard packets when the time-scheduled and/or time-reserved datagram/packet switching is terminated. Instead, the time-scheduled and/or time-reserved datagram/packet circuitry in the second device embodiment is modified so that the output from the store-and-forward switch automatically routes to an output buffer which it can control, such that no time-scheduled and/or time-reserved datagram/packet collisions will occur in the output circuitry as well.

Control Means is Integrated

Alternatively, in this second class of device embodiments, the time-scheduled and/or time-reserved datagram/packet control circuitry may be integrated into the packet, cell, or frame-oriented layer two and/or higher layer data switch such that it also controls the physically separate layer two and/or higher layer data switch. This may be accomplished by implementing a control interface from the time-scheduled and/or time-reserved datagram/packet controller to the separate layer two and/or higher layer data switch, such that they time-scheduled and/or time-reserved datagram/packet controller may control any or all aspects of the separate layer two and/or higher layer switch. Thus the time-scheduled and/or time-reserved datagram/packet controller has the control capability to force the store-and-forward and/or layer two switch to stop, store, and hold standard packets while the time-scheduled and/or time-reserved datagram/packet switching occurs, and then resume sending the standard packets when the time-scheduled and/or time-reserved datagram/packet switching is terminated. The time-scheduled and/or time-reserved datagram/packet controller then has the capability to stop, store, and hold standard packets in both the time-scheduled and/or time-reserved datagram/packet input/output buffers or in the layer two switch itself when there is a time-scheduled and/or time-reserved datagram/packet switching conflict. In this way, no time-scheduled and/or time-reserved datagram/packet collisions will occur in the overlay class of device embodiments.

Third (Either No Input or No Output Buffers) Class of Device Embodiments

In a third class of device embodiments of the invention (not shown in the drawings as it merely deletes functionality from the first and/or second classes of device embodiments), the costs and functionality of the first and/or second device embodiments of the invention are reduced even further, by “dummying it down,” such that either the input or output buffers are eliminated entirely from the third device embodiment. The primary purpose of the third class of device embodiments is to lower the time-scheduled and/or time-reserved datagram/packet switching costs such that installation of time-scheduled and/or time-reserved datagram/packet switching on top of existing store-and-forward switches in an existing network is very cost-compelling.

Bi-Modal

As in the first and/or second device embodiments, the third device embodiments operate in normal mode by normally switching standard store-and-forward and/or layer two and/or higher layer data packets through to the separate and distinct packet, cell, or frame-oriented switch. Like the first and/or second device embodiments, the third device embodiments also use time-scheduled and/or time-reserved datagram/packet mode (also called variously cut-through mode, bypass mode, or tunneling mode) for the time-scheduled and/or time-reserved datagram/packet switch and control circuitry to schedule and switch real-time, high-priority, and/or other time-scheduled and/or time-reserved datagram/packet packets to cut-through and/or bypass the store-and-forward network at the scheduled times.

Integrated or Non-Integrated Time-Scheduled and/or Time-Reserved Datagram/Packet Control Circuitry

Also, as in the first and second device embodiments, the third device embodiments may or may not comprise time-scheduled and/or time-reserved datagram/packet control circuitry integrated into the standard layer two or higher layer packet, cell, or frame-oriented switch. Consequently, there may or may not be any capability to stop, store, and hold standard packets in the layer two switch when there is a time-scheduled and/or time-reserved datagram/packet switching conflict. Without integrated time-scheduled and/or time-reserved datagram/packet control circuitry, the time-scheduled and/or time-reserved datagram/packet control circuitry in this third device embodiment theoretically may interrupt standard incoming store-and-forward packets in order to execute scheduled time-scheduled and/or time-reserved datagram/packet switching from specific input lines to specific output lines. Should this theoretical interruption occur, a standard packet may be lost. If loss of the packet would occur, it would likely be re-sent through its normal protocol flow control. In actual practice, however, if the clock timing of the third device embodiment is closely synchronized to the time-scheduled and/or time-reserved datagram/packet device that is transmitting the time-scheduled and/or time-reserved datagram/packet packets, the likely event is that very few bits if any would be lost on the preceding, incoming standard packet. In fact, if any bits were lost on the incoming line, they would most likely be the trailing flag bits, frame delimiter bits, or synchronization bits, from the preceding standard packet. As long as the end of frame, packet, or cell is recognized by the input circuitry of the separate store-and-forward switch, the devices will function normally. As stated previously, should any loss of standard packets, cells, or frames occur, in most cases the protocols would re-transmit the missing data.

Fourth (No Buffers) Class of Device Embodiments

In a fourth class of device embodiments of the invention (not shown in the drawings as it merely deletes functionality from the second device embodiment), the costs and functionality of the first, second, and third device embodiments of the invention are reduced even further, by “dummying it way down”, such that both the input and output buffers are eliminated entirely from the fourth class of device embodiments. The fourth class of device embodiments significantly lowers the time-scheduled and/or time-reserved datagram/packet switching costs such that installation of time-scheduled and/or time-reserved datagram/packet switching on top of existing store-and-forward switches in an existing network is extremely cost-compelling.

Bi-Modal

As in the first, second, and third device embodiments, the fourth device embodiments operate in normal mode by normally switching standard store-and-forward and/or layer two and/or higher layer data packets through to the separate and distinct packet, cell, or frame-oriented switch. Like the first, second, and/or third device embodiments, the fourth device embodiments also use time-scheduled and/or time-reserved datagram/packet mode (also called variously cut-through mode, bypass mode, or tunneling mode) for the time-scheduled and/or time-reserved datagram/packet switch and control circuitry to schedule and switch real-time, high-priority, and/or other time-scheduled and/or time-reserved datagram/packet packets to cut-through and/or bypass the store-and-forward network at the scheduled times.

Integrated or Non-Integrated Time-Scheduled and/or Time-Reserved Datagram/Packet Control Circuitry

As in the first, second, and/or third device embodiments, the fourth device embodiments either may or may not comprise time-scheduled and/or time-reserved datagram/packet control circuitry integrated into the standard layer two or higher layer packet, cell, or frame-oriented switch. Consequently, there may or may not be any capability to stop, store, and hold standard packets in the input or output stages when there is a time-scheduled and/or time-reserved datagram/packet switching conflict. Without integrated time-scheduled and/or time-reserved datagram/packet control circuitry, the time-scheduled and/or time-reserved datagram/packet control circuitry in this fourth device embodiment in practice will possibly interrupt standard incoming store-and-forward packets and will likely interrupt standard outgoing store-and-forward packets in order to execute scheduled time-scheduled and/or time-reserved datagram/packet switching from specific input lines to specific output lines. When this practical interruption occurs, a standard packet will likely be lost. If loss of the packet occurs, it would also likely be re-sent through its normal protocol flow control. The fourth embodiment is not preferred without integrated time-scheduled and/or time-reserved datagram/packet control circuitry, but could be used to implement very inexpensive time-scheduled and/or time-reserved datagram/packet devices on top of existing store-and-forward networks, where highly cost-effective real-time or high-priority switching is desired at the understood expense of retransmitting the standard bursty, non-periodic, non-time-sensitive, lower priority store-and-forward traffic.

Fifth (Source/Destination) Class of Device Embodiments

The fifth class of device embodiments comprise placing the same device elements in the Source and/or Destination device (also called an End-User device), such that the Source and/or Destination device outside of the network edge node is also outfitted with synchronization means; controlling means; and time-scheduled and/or time-reserved datagram/packet input and/or output circuitry and/or switching means. The fifth class of device embodiments may also optionally comprise input and/or output buffering means; other internal time-scheduled and/or time-reserved datagram/packet circuitry means; and/or normal packet, cell, or frame input and output layer two and/or higher layer circuitry means.

Sixth (LAN) Class of Device Embodiments

The sixth class of device embodiments is an extension of the fifth class of device embodiments, in that the time-scheduled and/or time-reserved datagram/packet end-user functionality may be adapted to a Local Area Network (LAN) such as Ethernet or Wireless Ethernet by using the fifth class of device embodiments or “end-user” embodiments as the LAN controller, LAN bridge and/or LAN router, and either using the master clock and timing synchronization means to synchronize each LAN-attached device directly (in-band and/or out-of-band) and/or having each LAN-attached device synchronize off of the synchronized clock on the LAN controller, bridge, and/or router.

LAN Methods

LAN software (including wireless ad-hoc LANs) may be developed/modified such that (a) the LAN-attached devices may synchronize their clocks, (b) each LAN-attached device may keep track of the other LAN-attached devices' scheduled times as well as its own scheduled time(s), and (c) all LAN-attached devices do not attempt normal LAN operation when a time-scheduled and/or time-reserved datagram/packet event is scheduled for a LAN-attached device. This approach enables each device on the LAN to send and receive time-scheduled and/or time-reserved datagram/packets directly and still maintain normal LAN operation when time-scheduled and/or time-reserved datagram/packet events are not scheduled.

For an illustration of how mobile ad-hoc wireless LANs may operate, see FIG. 119 through FIG. 122 and various processes such as FIG. 123.

LAN Call Setup

Each LAN-attached device can send a time-scheduled and/or time-reserved datagram/packet call setup message to the LAN controller, LAN bridge, LAN router, and/or another LAN-attached device requesting a time-scheduled and/or time-reserved datagram/packet scheduled time. Each network element on the time-scheduled and/or time-reserved datagram/packet path would attempt to set up the call or session as with any other time-scheduled and/or time-reserved datagram/packet setup. This may not require a need to modify the basic protocol. In effect, the basic protocol could be suspended for the time-scheduled and/or time-reserved datagram/packet scheduled time. In this way, applications like Internet phone or VoIP could send and receive scheduled time-scheduled and/or time-reserved datagram/packet packets through the bridge or router, and out into any time-scheduled and/or time-reserved datagram/packet network to any time-scheduled and/or time-reserved datagram/packet connected destination. This approach would also work on intranets, wireless nets, and/or mobile ad-hoc nets. Seventh (Pure Time-Scheduled and/or Time-Reserved Datagram/Packet—No Layer Two) Class of Device Embodiments

The seventh class of device embodiments does not include a standard packet, cell, or frame-oriented and/or layer two or higher layer switching means, such that this class of device embodiments only switch packets in an entirely and exclusively time-scheduled and/or time-reserved datagram/packet scheduled network.

Specific Devices

Specific devices—device embodiments comprising
telephones,
computers,
personal computers,
packet telephones,
IP phones;
private branch exchanges (PBXs);
web servers;
web browsers;
end-user devices;
Local Area Networks (LANs) and devices connected to Local Area Networks;
CSU/DSUs;
multiplexers and/or demultiplexers;
applications running in
   computers,
   host computers,
   web servers,
   web browsers,
   including but not limited to real-time and/or high-priority applications such as
      voice,
      video,
      data,
      integrated voice and video,
      video conferencing applications,
      integrated voice video and/or data, and/or
      network management applications.
         Time-Scheduled Device Methods and Processes
         Network Device Operation Process

Network device operation process comprises synchronization, scheduling, and transfer of data.

Synchronization

Synchronization of clocks or other timing mechanisms in network elements in a network comprise:
means and methods for an optional master clock or clocks;
specific time or absolute chronological time with synchronization from one or more universal reference sources;
relative chronological time with synchronization from one or more relative reference sources;
clockspeed synchronization from clock bitstream references; and/or
other timing and synchronization means;
   Scheduling

Scheduling high-priority, real-time, or other time-scheduled and/or time-reserved datagram/packet calls or sessions in network elements in a network comprise:
means and methods for call setup and scheduling, including
means and methods for providing both time-scheduled and/or time-reserved datagram/packet switched virtual circuits or paths, and
time-scheduled and/or time-reserved datagram/packet permanent virtual circuits or paths;
   Transferring, Transmitting, Switching, and/or Receiving

Transferring, transmitting, switching, and/or receiving information at a time-scheduled and/or time-reserved datagram/packet level in accordance with said scheduling in network elements in a network;

Time-Scheduled and/or Time-Reserved Datagram/Packet Methods and Processes

Time-Scheduled Datagram/Packet Event Scheduling Process

The time-scheduled and/or time-reserved datagram/packet Event Scheduling process comprises: a) a time-scheduled and/or time-reserved datagram/packet Call Setup Process, b) a time-scheduled and/or time-reserved datagram/packet Switching Process, c) a time-scheduled and/or time-reserved datagram/packet Inter-Node Call Setup Process, and d) a time-scheduled and/or time-reserved datagram/packet Call TearDown Process. The time-scheduled and/or time-reserved datagram/packet Call Setup Process schedules a time-scheduled and/or time-reserved datagram/packet Event along a path of time-scheduled and/or time-reserved datagram/packet device embodiments through a time-scheduled and/or time-reserved datagram/packet network. The time-scheduled and/or time-reserved datagram/packet Switching process switches the time-scheduled and/or time-reserved datagram/packet packets through the time-scheduled and/or time-reserved datagram/packet network at the scheduled times. The time-scheduled and/or time-reserved datagram/packet Inter-Node Call Setup Process establishes calls between time-scheduled and/or time-reserved datagram/packet device embodiments in the network for purposes of time synchronization, rapid call setups, emergencies, administration, etc. The time-scheduled and/or time-reserved datagram/packet TearDown Process terminates time-scheduled and/or time-reserved datagram/packet calls and frees up the time-scheduled and/or time-reserved datagram/packet Scheduling process for other time-scheduled and/or time-reserved datagram/packet calls/sessions.

Reject Modes

Further, the time-scheduled and/or time-reserved datagram/packet Event Scheduling Process has various Reject Mode handling capabilities that it can implement if it cannot successfully set up a call. Some examples of Reject Mode include sending a Reject Message back to the previous node thereby canceling setup of the call; enabling the node device embodiment to try an alternate route; or determining the next best scheduled time that fits into the original parameters on the Call Setup Request.

Time-scheduled and/or time-reserved datagram/packet Network Switching System Process

One process by which the time-scheduled and/or time-reserved datagram/packet switching system works is achieved in the following steps:

Step 1 (Synchronize)—Using various methods discussed elsewhere, all routers synchronize themselves such that they may schedule the approximate arrival and/or departure times for packets sent from them and/or received by them from adjacent routers. These techniques may include master clock(s), two-way timestamps, one-way timestamps, sync packets/pulses, and/or any other methods to establish synchronization and determination of packet arrival/departure time(s).

Step 2 (optional Call Setup or Notification Message)—Real-time or high-priority Source 1 may send a call setup message to Departure Router 2 indicating that it wants to set up a real-time, high-priority, or other time-scheduled and/or time-reserved datagram/packet transmission to real-time or high-priority Receiver 5. This message may notify the Departure Router/device 2 that this is a one-time event or the first of a long stream of packets, whose delivery is time-dependent and should not be subject to router, buffer, or other avoidable packet network delays. Included in this notification may be a requested bit rate for the data and a requested periodicity.

Step 3—(Note that Departure Router 2 may connect directly to Destination Router 4 directly instead of going through Mid-destination Router 3). Departure Router 2 looks at the intended destination and possibly the requested data rate or data time duration in the call setup message. Just as it does in standard packet switching, it may determine that the next router is Mid-destination Router 3 and the transmission path is Transmission Path 12. Departure Router 2 then looks at Transmission Path 12's data rate and compares it to the requested data rate from real-time or high-priority Source 1. Departure Router 2 then determines how frequently and for what duration it should send packets of data from real-time or high-priority Source 1 over Transmission Path 12 to Mid-destination Router 3. This determination is based upon data rates and pre-existing time-scheduled and/or time-reserved datagram/packet schedules/reservations that may already be in existence. Based upon this determination, Departure Router 2 reserves times and durations for it to send information over Transmission Path 12 to Mid-destination Router 3. It then sends a call setup message to Mid-destination Router 3 telling it that it is requesting to reserve/schedule a real-time or high-priority transmission, along with the appropriate source address, destination address, its preferred departure times and duration time from Departure Router 2, and its estimated arrival times at Mid-destination Router 3.

Step 4—The Mid-destination Router 3 receives the call setup message from Departure Router 2. Router 3 looks at the source, destination, and possibly the requested data rate or data time duration. It determines that the next router is Final Destination Router 4 using Transmission Path 13. It then looks at its own schedule, the transmission delay times, the calculated arrival times and duration time of the data that is to come from Departure Router 2. Mid-destination Router 3 then tries to schedule its time-scheduled and/or time-reserved datagram/packet switching mechanism to effectively “hardwire” route the stream straight on through to the Final Destination Router 4. If there is a scheduling conflict due to an existing schedule, Mid-destination Router 3 may use various Reject Modes to try to accommodate the data by buffering and delaying it very slightly. If this can't be done with only a slight delay, Mid-Destination Router 3 may determine a reservation/schedule that works better for it. It reserves those times and communicates back to Departure Router 2 its suggested changes to the original schedule. It also may at this time notify Final Destination Router 4 what it is trying to do to determine what unreserved/unscheduled time Final Destination Router 4 might have available. This information is passed back to Departure Router 2. In this way the routers may negotiate an acceptable reservation and/or schedule that works for all of them.

If no schedule is acceptable, then the Departure Router 2 notifies the real-time or high-priority Source 1 that it has been unable to set up a guaranteed real-time or high-priority time-scheduled and/or time-reserved datagram/packet reservation. Real-time or high-priority Source 1 can then decide if it wants to: (a) use standard packet switching with all of the inherent delays, (b) wait until the reservation/schedule frees up from other sessions which will complete and tear down their reservations/schedules soon, or (c) begin a standard packet switching session with the hope that a guaranteed real-time or high-priority reservation/schedule will become available during the session as other real-time or high-priority sessions are completed and torn down. In situation (c) a standard packet switching style session can be converted to a guaranteed on-time real-time or high-priority time-scheduled and/or time-reserved datagram/packet session once the reservation/scheduling arrangements can be made, even during the course of a session, if desired.

Step 5—Final Destination Router 4 repeats the process described in Step 4, communicating its reservation/schedule back to Departure Router 2 and Mid-destination Router 3 until an acceptable reservation/schedule is set up between them. Final Destination Router 4 then notifies the Real-time or high-priority Receiver 5 that a session is being established. In this way the Real-time or high-priority Receiver 5 gets ready to accept Real-time or high-priority data input.

Step 6 (Call or Connection Proceeds)—Once the reservation/scheduling is agreed upon, Departure Router 2 notifies real-time or high-priority Source 1 to start shipping data. Departure Router 2 then ships the data to Mid-destination Router 3 over Transmission Path 12 at exactly the agreed upon time. Mid-destination Router 3 is ready and waiting for the data at exactly the calculated arrival time and “hardwire” time-scheduled and/or time-reserved datagram/packet switches the data straight on through to Final Destination Route 4 over Transmission Path 13 at precisely the correct times. Final Destination Route 4 then “hardwire” time-scheduled and/or time-reserved datagram/packet switches the data straight on through to the Real-time or high-priority Receiver 5 over Transmission Path 14.

Step 7 (Tear-Down)—When the session has no more data to ship, for example, the streaming program is completed, or the phone call is “hung up”, then the reservation/schedule for that session needs to be torn down. This event can be triggered by a TearDown notification message from either of the end routers to the routers along the path. Once a router receives notification that the session is over, it tears down that session, wherein it frees up its reservation schedule, and reverts to standard packet network mode until another guaranteed real-time or high-priority session is requested and negotiated, which starts the process all over again.

Convergence

The result is that time-scheduled and/or time-reserved datagram/packet switching fully and finally enable the convergence of voice, video, and data over the same network. It does this by combining the efficiencies of non-deterministic frame, cell, and packet-based data networks with the timeliness, reliability, low-jitter, and low-delay of deterministic circuit switched networks.

From a device perspective, layer two and/or higher layer data switches/routers inevitably result in throughput delays and jitter due to input buffering, header lookup, switch fabric queuing, and output buffering. Time-scheduled and/or time-reserved datagram/packet switching enables time-scheduled and/or time-reserved datagram/packet data to completely avoid these uncontrolled delays and jitter. The result at the device level is a) virtually zero jitter, b) extremely low switch delay, and c) extremely fast switch latency for time-scheduled and/or time-reserved datagram/packet devices. This is true even on data switches with extremely high-speed ASICs (Application Specific Integrated Circuits) using “wire-speed” designs, high-QoS, and other speed-up mechanisms. The result is that time-scheduled and/or time-reserved datagram/packet devices can switch faster and have lower delay and jitter than even the fastest layer two and higher switch/routers available today.

From a network perspective, variable delays and jitter from layer two and higher layer devices is cumulative. Layer two and/or higher layer devices can slow down and congest due to full output buffers and contention on output lines. This is true even with high-QoS, multi-protocol label switching (MPLS), traffic shaping, and other network mechanisms. With time-scheduled and/or time-reserved datagram/packet switching on the other hand, it is possible to schedule a time-scheduled and/or time-reserved datagram/packet path completely across the network with no buffering and no output line contention. This is called path switching. The result of path switching is network latency that is even faster than circuit switching network latency is today, since circuit switching requires brief input and output buffering at each node.

Object of the Invention

It is accordingly an object of the present invention to guarantee high-quality, rapid, consistent, on-time, non-blocked; non-delayed, non-congestion-affected, loss-less, jitter-free, reliable delivery of packets in a packet network, for real-time, high-priority, and/or high-quality-of service applications that require it. It may do this in some of the following ways: (a) It may assure delivery of the packets without being discarded or dropped as in normal packet, cell, or frame switching. (b) It may deliver the packets on time by scheduling arrival times and departure times. (c) It may reduce or completely eliminate switch and/or buffer delays by skipping or bounding the switching, queuing mechanisms, and header lookup mechanisms in the routers. (d) It may eliminate the need for large buffers, thereby reducing or eliminating long start delays and awkward pauses. (e) It may significantly reduce or entirely eliminate jitter by delivering packets at known, predictable times.

Benefits of the Invention

Thus the overall benefits of the invention are:
It establishes a means to deliver packets, cells, or frames over a packet switched network in a way that guarantees that they will be delivered on-time and in time to be used by the receiving application. This means that packets won't be lost or arrive too late to be used by the application.
It reduces the overall delay time for real-time applications such as voice, video, and other real-time multimedia delivery needs over a packet network. This will reduce or eliminate the noticeable “lag-time” for Internet Phone or VoIP. It also will reduce or eliminate the delayed start times in “streaming” audio and video, because the receiver doesn't need to wait to fill its huge incoming buffer.
It can be used as a prioritization and advanced reservation scheme, thus assuring high priority users that they can have the capacity needed at a particular time.
It solves the non-guaranteed, random, lossy degraded, and delayed response time problems of packet, cell, and frame-based networks for real-time applications, high-priority messages, and high-quality-of-service.
It works with standards based protocols and networks, e.g., RIP, OSPF, RSVP, ISA, IGMP (multicast), ATM, TCP/IP, UDP, Ethernet, Token Ring, X.25, Frame Relay, SMDS, 802.11, IntServ, DiffServ, etc.
It thus creates the capability for a Next Generation of routers and/or software.

### DETAILED DESCRIPTION OF THE DRAWINGS

Cross-References to Drawing Element Reference Numbers

TABLE 1
Patent Cross-Reference to Numbers in Drawings and Specification
for Time-scheduled, Time-Reservation Packet Switching.

| Item# | Patent Element |
|---|---|
| 1 | Real-time, (and/or non-real-time), high-priority, and/or high-reliability Source for |
| | time-scheduled, time-reserved, and/or layer one data. May be real-time data |
| | source and/or call originator such as a streaming audio/video application source |
| | or an Internet phone caller. This source may also optionally include time- |
| | scheduled transmission/switching capability, non-time-scheduled |
| | transmission/switching capability, and/or a hybrid of both time-reserved and non- |
| | time-reserved capability. Source may fixed and/or mobile; an optical, electrical, |
| | electromagnetic, wireless, and/or hybrid device. Source 1 and Departure Node 2 |
| | may be integrated into the same network element or they may be discrete. |
| 1a | Source 1a and Destination 5a are illustrative examples of the sixth device |
| | embodiment also termed the “LAN” embodiment. Source 1a exemplifies a layer |
| | one, and/or time scheduled packet, and/or time scheduled packet-capable |
| | Ethernet-style, CSMA/CD LAN controller, mux, bridge, router, and/or switching |
| | device. Layer one and/or time scheduled/reserved packet, and/or time scheduled |
| | packet with star-type LANs could also be implemented in the same manner. 5e is |
| | token-style LAN and/or ring-style LAN. Source 1a and Destination 5a may also |
| | be wireless devices such as 802.11 and/or CSMA/CA style LANs. |
| 1b | Source 1b exemplifies a source connected directly to the layer one and/or time |
| | scheduled packet switch/router and/or time scheduled packet network through |
| | transmission line 11. |
| 1c | Source 1c exemplifies a host system with layer one and/or time scheduled packet |
| | and/or time scheduled packet switching capability |
| 1d | Source 1d exemplifies a layer one and/or time scheduled packet network and/or a |
| | hybrid (time-scheduled and/or non-time-scheduled) network that may be |
| | connected to a separate layer one and/or time scheduled packet network and/or |
| | hybrid (time-reserved and/or non-time-reserved) network or device. |
| 1e | LAN-attached devices 1e, 21a, 31a; 1f, 21b, 31b; and 1g, 21c, 31c representing a |
| | layer one and/or time scheduled packet synchronized LAN, with said devices |
| | attached to the LAN having layer one and/or time scheduled packet functionality |
| | as well as the LAN controller 1a |
| 1f | LAN-attached devices 1e, 21a, 31a; 1f, 21b, 31b; and 1g, 21c, 31c representing a |
| | layer one and/or time scheduled packet synchronized LAN, with said devices |
| | attached to the LAN having layer one and/or time scheduled packet functionality |
| | as well as the LAN controller 1a |
| 1g | LAN-attached devices 1e, 21a, 31a; 1f, 21b, 31b; and 1g, 21c, 31c representing a |
| | layer one and/or time scheduled packet synchronized LAN, with said devices |
| | attached to the LAN having layer one and/or time scheduled packet functionality |
| | as well as the LAN controller 1a. May included wireless LANs with CSMA/CA |
| | as well. |
| 1h | may be shared media with collision potential such as air interface, shared |
| | wireless bus, shared optical bus, shared copper bus, and/or CSMA/CD or |
| | CSMA/CA type LAN |
| 1i | analog phone |
| 1j | Real-time Source - e.g., digital phone |
| 1k | Real-time Source - e.g., packet phone |
| 1m | Real-Time Source - e.g., video source or receiver |
| 1n | circuit switched and/or packet-based (e.g., IP) PBX; voice and/or data |
| | transmitter; and/or radio |
| 1o | other device |
| 1p | path between devices and PBX (copper, fiber, coax, wireless) |
| 1q | Non-Real-Time Source - e.g., PC |
| 1r | Non-Real-Time Source - e.g., Host Computer |
| 2 | departure and/or transmitting/transferring router, switch, bridge, gateway, mux, |
| | PBX, and/or originating edge node and/or network element. May be fixed and/or |
| | mobile; electrical, optical, wireless and/or hybrid. |
| 3 | Mid-destination and/or transmitting/transferring router, switch, bridge, gateway, |
| | mux, PBX, and/or middle node; network element. May be fixed and/or mobile; |
| | electrical, optical, wireless and/or hybrid. |
| 4 | Final destination and/or receiver and/or transmitting/transferring router, switch, |
| | bridge, gateway, mux, PBX, and/or terminating edge node; network element. |
| | May be fixed and/or mobile; electrical, optical, wireless and/or hybrid. |
| 5 | Real-time, (or non-real-time), high-priority, and/or high-reliability receiver for |
| | time-scheduled and/or layer one data; real-time data destination or call receiver |
| | such as a streaming audio/video application destination or an Internet phone |
| | called party. This receiver may also optionally include time-scheduled |
| | transmission/switching capability, non-time-scheduled transmission/switching |
| | capability, and/or a hybrid of both time-reserved and non-time-reserved |
| | capability. Real-time receiver may be fixed and/or mobile; and may be an |
| | optical, electrical, electromagnetic, wireless, and/or hybrid device. Receiver 5 |
| | and Final Destination node 4 may be integrated into the same network element or |
| | they may be be discrete. |
| 5a | Source 1a and Destination 5a are illustrative examples of the sixth device |
| | embodiment also termed the “LAN” embodiment. Destination 5a exemplifies a |
| | layer one and/or time scheduled packet -capable Token Ring or other ring-style |
| | LAN controller, bridge, or router, layer one and/or time scheduled packet star- |
| | type LANs could also be implemented in the same manner, illustrative example |
| | of a ring-style “LAN” embodiment of the device, wherein a Local Area Network |
| | or LAN is connected to the layer one and/or time scheduled packet Network |
| 5b | Destination 5b exemplifies a layer one and/or time scheduled packet enabled |
| | end-user destination receiving layer one and/or time scheduled packet routing |
| | directly to its internal layer one and/or time scheduled packet system 35 through |
| | transmission line 14. |
| 5c | Destination 5c exemplifies a host system with layer one and/or time scheduled |
| | packet switching capability. |
| 5d | Destination 5d exemplifies a layer one and/or time scheduled packet, cell, or |
| | frame network, and/or a hybrid network for time-scheduled and non-time- |
| | scheduled data that may be connected to a different layer one and/or time |
| | scheduled packet, cell, or frame network, and/or hybrid (time-reserved and non- |
| | time-reserved) network or device. |
| 5e | Ring-style LAN-attached device with layer one and/or time scheduled packet |
| | capability |
| 5f | Ring-style LAN-attached device with layer one and/or time scheduled packet |
| | capability |
| 5g | Ring-style LAN-attached device with layer one and/or time scheduled packet |
| | capability |
| 5h | Ring-style LAN; may be shared media with collision potential or token-passing |
| | capability, including, but not limited to air interface, shared wireless media/bus, |
| | shared optical media/bus, shared copper media/bus, and/or CSMA/CD or |
| | CSMA/CA token sharing and/or token passing LAN system. |
| 5i | Real-Time Destination - e.g. Packet Phone |
| 5j | Real-Time and Non-Real-Time Destination - e.g. PC with Steaming Video Player |
| 5k | Non-Real-Time Destination - e.g. Host Computer |
| 6 | Real or virtual timing system 6 which communicates with |
| | receiver/synchronization means 22, 23, and 24, thereby enabling the network |
| | device embodiments of the present invention to synchronize or quasi-synchronize |
| | their clocks; Various approaches include: satellite Global Positioning System |
| | (GPS) as the master clock 6; and/or other in-band and/or out-of-band signals, |
| | such as disparate clocks, timing bits, pulses, signals, timing-packets, timing- |
| | frames, timing-cells, timing datagrams, tuning-polls, etc. However, any means |
| | for synchronizing the clocks to a high degree of accuracy is acceptable, such as |
| | synchronization pulses on transmission lines, synchronization through radio |
| | signals, atomic, cesium, or radium clocks, etc. |
| 6a | direct and/or indirect timing and synchronization signals |
| 6b | direct and/or indirect timing and synchronization signals with or without a |
| | Master clock |
| 6c | Alternative clock timing and synchronization signals with no Master Clock |
| 6d | direct and/or indirect timing and synchronization signals with or without a |
| | Master clock |
| 6e | Local Clock |
| 7 | First Input Switch Array 7 |
| 8 | Input Buffer Array 8 |
| 9 | Second Input Switch Array 9 |
| 10 | Potential (Optional) Network Boundary |
| 11 | transmission/communications path 11 between the real-time and/ornon-real-time |
| | data source or call originator 1 and the next device in the transmission path, e.g., |
| | real-time, high-priority, and/or high-reliability receiver/destination node 5, and/or |
| | departure router, switch, or originating edge node 2. |
| | Transmission/comrnunications path 11 may be fixed or mobile; electrical, optical, |
| | and/or wireless. |
| 11a | parallel transmission/communications paths 11a between the real-time data |
| | source or call originator 1 and the departure router, switch, or originating edge |
| | node 2; can be DWDM or another electrical, light, or wireless signal. |
| | Transmission/communications path 11a may be fixed or mobile; electrical, |
| | optical, and/or wireless. |
| 12 | transmission/communications path 12 between the departure router, switch, or |
| | originating edge node 2 and either the optional mid-destination router, switch, or |
| | middle node 3; or the final destination/router/switch 4. |
| | Transmission/communications path may be fixed and/or mobile; electrical, |
| | optical, and/or wireless. |
| 12a | parallel transmission/communications paths 12a between the real-time data |
| | source or call originator 1 and the departure router, switch, or originating edge |
| | node 2; can be DWDM or another electrical, light, or wireless signal. |
| | Transmission/communications path may be fixed or mobile; electrical, optical, |
| | and/or wireless. |
| 13 | transmission/communications path 13 between the mid-destination router, |
| | switch, or middle node 3 and the final destination router, switch, or terminating |
| | edge node 4. Transmission/communications path may be fixed or mobile; |
| | electrical, optical, and/or wireless. |
| 13a | parallel transmission/communications paths 13a between the real-time data |
| | source or call originator 1 and the departure router, switch, or originating edge |
| | node 2; can be DWDM or another electrical, light, or wireless signal. |
| | Transmission/communications path may be fixed or mobile; electrical, optical, |
| | and/or wireless. |
| 14 | transmission/communications path 14 between the final destination router, |
| | switch, or terminating edge node 4 and the real-time receiver or destination node |
| | 5. Transmission/communications path may be fixed or mobile; electrical, optical, |
| | and/or wireless. |
| 14a | parallel transmission/communications paths 14a between the real-time data |
| | source or call originator 1 and the departure router, switch, or originating edge |
| | node 2; can be DWDM or another electrical, light, or wireless signal. |
| | Transmission/communications path may be fixed or mobile; electrical, optical, |
| | and/or wireless. |
| 15 | Lookup Table/Database and/or MIB for standard and/or stealth information |
| | structures |
| 16 | Stealth Interpreter |
| 17 | First Output Switch Array 17 |
| 18 | Output Buffer Array 18 |
| 19 | Second Output Switch Array 19 |
| 20 | Stealth Assembler |
| 21 | end-user timing synchronization means 21 synchronizes the layer one and/or time |
| | scheduled packet system 31 in the source device 1; clock timing synchronization |
| | means |
| 21a | synchronization means 21a synchronizes the layer one and/or time scheduled |
| | packet system 31a in the Ethernet LAN-attached device 1e |
| 21b | synchronization means 21b synchronizes the layer one and/or time scheduled |
| | packet system 31b in the Ethernet LAN-attached device 1f |
| 21c | synchronization means 21c synchronizes the layer one and/or time scheduled |
| | packet system 31c in the Ethernet LAN-attached device 1g |
| 22 | clock receiver/transmitter/synchronization means 22 enables the network device |
| | embodiments of the present invention to synchronize their clocks to an |
| | appropriate degree of accuracy; may or may not be a GPS Receiver; may be in- |
| | band or out-of band; may sync on absolute and/or relative time; |
| 23 | clock receiver/transmitter/synchronization means 23 enables the network device |
| | embodiments of the present invention to synchronize their clocks to an |
| | appropriate degree of accuracy; may or may not be a GPS Receiver; may be in- |
| | band or out-of band; may sync on absolute and/or relative time; |
| 24 | clock receiver/transmitter/synchronization means 24 enables the network device |
| | embodiments of the present invention to synchronize their clocks to an |
| | appropriate degree of accuracy; may or may not be a GPS Receiver; may be in- |
| | band or out-of band; may sync on absolute and/or relative time; |
| 25 | end-user synchronization means 25 synchronizes the layer one and/or time |
| | scheduled packet system 35 in the destination device 5 |
| 25a | timing synchronization means on Ring-style LAN; Alternatively, the devices on |
| | the LAN 5e, 5f, and 5g could use timing synchronization means 25a, 25b, and |
| | 25c respectively with other timing synchronization methods such as the two-way |
| | time transfer method cited in the U.S. Naval observatory reference, or they could |
| | each synchronize directly with the GPS system |
| 25b | timing synchronization means on Ring-style LAN; Alternatively, the devices on |
| | the LAN 5e, 5f, and 5g could use timing synchronization means 25a, 25b, and |
| | 25c respectively with other timing synchronization methods such as the two-way |
| | time transfer method cited in the U.S. Naval observatory reference, or they could |
| | each synchronize directly with the GPS system |
| 25c | timing synchronization means on Ring-style LAN; Alternatively, the devices on |
| | the LAN 5e, 5f, and 5g could use timing synchronization means 25a, 25b, and |
| | 25c respectively with other timing synchronization methods such as the two-way |
| | time transfer method cited in the U.S. Naval observatory reference, or they could |
| | each synchronize directly with the GPS system |
| 26 | scheduled/reserved times being transferred from element to element (dashed line) |
| | (may or may not be secret times) |
| 27 | Exemplary packet, cell, frame, and/or other information structure |
| 27a | Optional Exemplary Preamble and/or Flag(s) |
| 27a1 | Optional Exemplary Preamble Synchronization Bits |
| 27a2 | Optional Exemplary Preamble Start of Frame Delimiter (SFD) |
| 27a3 | Optional Exemplary PLCP (Physical Layer Convergence Procedure) in e.g., |
| | 802.11x |
| 27b | Optional Example Layer 2 and/or Data Link Layer and/or Frame and/or Cell |
| | Header |
| 27c | Optional Example MPLS and/or other optional Header(s) and/or Tag(s) and/or |
| | Labels |
| 27d | Optional Example Layer 3 and/or Network Layer and/or Packet Header(s) |
| 27e | Optional Example Layer 4 and/or Transport Layer Header(s) |
| 27f | Optional Example Layer 5 and/or Session Layer Header(s) |
| 27g | Optional Example Layer 6 and/or Presentation Layer Header(s) |
| 27h | Optional Example Layer 7 and/or Application Layer Header(s) |
| 27i | Optional Example Data Info and/or payload |
| 27j | Optional Example CRC(s) and/or parity(ies) and/or error check(s) |
| 27k | Optional Example Trailing Flag(s) and/or other info |
| 27L | Exemplary Standard Start of Frame |
| 27m | Exemplary Rule Violation (Stealth) Start of Frame |
| 27n | Exemplary Undershot False Start of Frame |
| 27o | Exemplary Overshot False Start of Frame |
| 27p | Exemplary No Standard Start of Frame nor Start of Frame Delimiter (could have |
| | standard, extra, or fewer bits) |
| 27q | Exemplary Rule Violation (Stealth) Start of Frame Delimiter (could have |
| | standard, extra, or fewer bits) |
| 27r | Exemplary Standard SOFD Delimiter or Rule Violation (Stealth) Start of Frame |
| | Delimiter (could have standard, extra, or fewer bits) |
| 27s | Exemplary Repeating Rule Violation (Stealth) Preamble Octet, less than Octet, or |
| | greater than Octet |
| 27t | Exemplary Non-Repeating Rule Violation (Stealth) Preamble Octet, less than |
| | Octet, or greater than Octet |
| 27u | Exemplary Optional Bits |
| 27w | Existing and/or additional bits/fields for indicating Time Reservation requests |
| | and/or Time Reservation Assignments, Time Scheduled Buffer(s) Assignment, |
| | and/or Time slot(s) Assignment. May be anywhere in packet/datagram. |
| 28 | Unauthorized Transmitter/Receiver |
| 29a | wireless and/or wired communications |
| 29a1 | wireless, wired, and/or optical communications or communications path input |
| 29a2 | wireless, wired, and/or optical communications or communications path output |
| 29b | wireless, wired, and/or optical communications or communications path |
| 29c | wireless, wired, and/or optical communications or communications path |
| 30 | wireless, wired, and/or optical communications or communications path |
| 31 | layer one and/or time scheduled packet transmitting and/or switching |
| | functionality in Source 1 |
| 31a | layer one and/or time scheduled packet switching functionality or capability in |
| | Ethernet LAN-attached device 1e |
| 31b | layer one and/or time scheduled packet switching functionality or capability in |
| | Ethernet LAN-attached device 1f |
| 31c | layer one and/or time scheduled packet switching functionality or capability in |
| | Ethernet LAN-attached device 1g |
| 32 | layer one and/or time scheduled packet hardware and/or software 32 which may |
| | be added to, included with, or separated from standard packet, cell, and/or frame |
| | network routers and switches designated network elements 2, 3, and 4 in order to |
| | create the capabilities of the present invention; |
| 33 | layer one and/or time scheduled packet hardware and/or software 33 which may |
| | be added to, included with, or separated from standard packet, cell, and/or frame |
| | network routers and switches designated network elements 2, 3, and 4 in order to |
| | create the capabilities of the present invention. May be fixed and/or mobile; |
| | electrical, optical, and/or wireless. |
| 33a | layer one and/or time scheduled packet hardware and/or software 33 which may |
| | be added to, included with, or separated from standard packet, cell, and/or frame |
| | network routers and switches designated network elements 2, 3, and 4 in order to |
| | create the capabilities of the present invention. May be fixed and/or mobile; |
| | electrical, optical, and/or wireless. |
| 33b | layer one and/or time scheduled packet hardware and/or software 33 which may |
| | be added to, included with, or separated from standard packet, cell, and/or frame |
| | network routers and switches designated network elements 2, 3, and 4 in order to |
| | create the capabilities of the present invention. May be fixed and/or mobile; |
| | electrical, optical, and/or wireless. |
| 34 | layer one and/or time scheduled packet hardware and/or software 34 which may |
| | be added to, included with, or separated from standard packet, cell, and/or frame |
| | network routers and switches designated network elements 2, 3, and 4 in order to |
| | create the capabilities of the present invention; |
| 35 | layer one and/or time scheduled packet receiving and/or switching functionality |
| | in Destination 5 |
| 35a | layer one and/or time scheduled packet capability on Ring-Style LAN; 35a, 35b, |
| | and 35c respectively, or could then synchronize off of the LAN controller 5a |
| 35b | layer one and/or time scheduled packet capability on Ring-Style LAN; 35a, 35b, |
| | and 35c respectively, or could then synchronize off of the LAN controller 5a |
| 35c | layer one and/or time scheduled packet capability on Ring-Style LAN; 35a, 35b, |
| | and 35c respectively, or could then synchronize off of the LAN controller 5a |
| 36 | Not used |
| 37 | Optional Sniffer/Snooper/Input Receiver/Monitor/Time Stamp Receiver -- ASIC, |
| | FPGA, or other input examining and comparing mechanism for determining |
| | packet (cell, frame) size (could be in header or actual length) or whether packet is |
| | a Sync frame with timing info, etc. - optional O/E conversion if input is optical |
| 37a | Optional Collision Detector/Listener/Sniffer/Snooper/Time Stamp Receiver -- |
| | ASIC, FPGA, or other input examining and comparing mechanism for |
| | determining packet (cell, frame) size (could be in header or actual length), QoS, |
| | priority, routing, and/or whether packet is a Sync frame with timing info, etc. - |
| 38 | Optional Input Deframer, Receiver, Converter, Deframer, Deserializer, Decoder |
| | and/or Header lookup mechanism. |
| 38a | Optional Input Deframer, Receiver, Converter, Deframer, Deserializer, Decoder |
| | and/or Header lookup mechanism |
| 38b | Optional Input Deframer, Receiver, Converter, Deframer, Deserializer, Decoder |
| | and/or Header lookup mechanism for standard Network Interface Card (NIC) |
| 38c | Optional Input Deframer, Receiver, Converter, Deframer, Deserializer, Decoder |
| | and/or Header lookup mechanism for layer 1 and/or time scheduled packet |
| | and/or time scheduled packet Network Interface Card (NIC) |
| 39 | Optional O/E or E/O Optional Electrical to Optical or Optical to Electrical |
| | Converter (optional) |
| 40 | input lines such as In1 40 |
| 40a | electrical, electromagnetic, wireless, and/or optical input line ; any single, |
| | combination, or hybrid input lines can be used on same L1 and/or time scheduled |
| | packet switch; input line 40a may come from any input medium, e.g., wireless, |
| | optical, electrical |
| 40c | optional electrical, optical, or wireless connector or interface |
| 41 | optional switch 41; controller 120 uses control line(s) 42 to position switch 41 |
| | into the position to route the standard packets, cells, or frames from input line In1 |
| | 40 to input buffer InBuffer1 45. |
| 42 | control line(s) 42; controller 120 uses control line(s) 42 to position switch 41 |
| | into the position to route the standard packets, cells, or frames from input line In1 |
| | 40 to input buffer InBuffer1 45. |
| 42a | control line(s) 42a; controller 120 uses control line(s) 42a to control optional |
| | sniffer/snooper/Input Monitor 37 |
| 42b | control line(s) 42b; controller 120 uses control line(s) 42b to control optional |
| | Framer 38 |
| 42c | control line(s) 42c; controller 120 uses control line(s) 42c to control 38b and 38c |
| 43 | input line to InBuffer |
| 44 | bypass line 44, through switch 55 to line 57, and directly into the non-blocking, |
| | non-delaying switch 150. |
| 45 | (optional) input buffer InBuffer1 (InBuffer n) 45; alternatively, input buffers 45 |
| | could be also optionally moved into switch 100 and/or 100a optical, electrical, or |
| | combination opto/electrical packet, cell, or frame switch 100a; controller 120 |
| | uses control line(s) 42 to position switch 41 into the position to route the standard |
| | packets, cells, or frames from input line In1 40 to input buffer InBuffer1 45. |
| | InBuffer1 45 may look at each packet, cell, or frame and determines its layer |
| | three destination or layer two flow path or equivalent or layer 4 and up if desired, |
| | and its priority, if any. Alternatively, InBuffer1 45 may determine packet |
| | characteristics based on arrival time, either using absolute time and/or time |
| | relative to some other reference time (e.g., a sync pulse). May comprise ASIC |
| | for in-line routing, priority, and/or other lookup; May be Shared Memory |
| | Buffers, or Buffer Separation, Partial Buffer Sharing or Common Buffer Pool |
| | with push-out; may be physically or logically allocated in Queues. May be |
| | multiple independent priority queues for non-time-scheduled packets; and/or |
| | buffers associated with specific time-slots and/or time-reservations for time- |
| | scheduled packets. |
| 46 | Input Handler on Shift Registers of Input Buffer |
| 47 | Control Lines between Input Handlers 46 and Input Queue Manager 47 on Input |
| | Buffer, |
| 48 | Address Resolution Manager (RAM); [Error - OutBuffer section of Output |
| | Buffer] |
| 49 | Input Queue Manager (microprocessor) |
| 50 | Program Memory (optionally RAM) |
| 51 | Control lines from Address Resolution Manager 48 to Program Memory 50 |
| 52 | Control lines from Input Queue Manager 49 to Program Memory 50 |
| 53 | line from input buffer array to switch 55 |
| 53a | line from input buffer array to switch 55 |
| 53b | line from input buffer bypass to switch 55 |
| 54 | control line from controller 120 to Inbuffers |
| 55 | switch 55; control line(s) 58 to positions switch 55 such that the non-layer one |
| | and/or time scheduled packet packet, cell, or frame will be routed to the packet, |
| | cell, or frame switch 100. |
| 55a | switch 55a; switch 55 such that the non-layer one and/or time scheduled packet |
| | packet, cell, or frame will be routed to the packet, cell, or frame switch 100 or |
| | other. |
| 55b | switch 55b; switch 55 such that the non-layer one and/or time scheduled packet |
| | packet, cell, or frame will be routed to the packet, cell, or frame switch 100 or |
| | other. |
| 56 | routed through lines 56 to the “overlaid” packet, cell, or frame switch 2; It then |
| | triggers the InBuffer1 45 to move the packet, cell, or frame into packet, cell, or |
| | frame switch 100 via switch 55 and line 56. |
| 56a | from switch 55 to optional O/E or E/O 39 to 100a O or E or combo O/E switch |
| 56b | from switch 55 to optional O/E or E/O 39 to 100a O or E or combo O/E switch |
| 57 | line 57; switch 55 to line 57, and directly into the non-blocking, non-delaying |
| | switch 150. |
| 57a | from switch 55 to optional O/E or E/O 39 to 150d Electrical Fabric |
| 57b | from switch 55 to optional O/E or E/O 39 to 150d Electrical Fabric |
| 57c | from switch 55 to optional O/E or E/O 39 to 150d Electrical Fabric |
| 57d | from switch 55 to optional O/E or E/O 39 to 150d Electrical Fabric |
| 57e | from switch 55 to optional O/E or E/O 39 to 150e Optical Fabric |
| 57f | from switch 55 to optional O/E or E/O 39 to 150e Optical Fabric |
| 57g | from switch 55 to optional O/E or E/O 39 to 150e Optical Fabric |
| 57g | from switch 55 to optional O/E or E/O 39 to 150e Optical Fabric |
| 58 | control line(s) 58 to positions switch 55 such that the non-layer one and/or time |
| | scheduled packet packet, cell, or frame will be routed to the packet, cell, or |
| | frame switch 100. |
| 58a | control line(s) 58a to positions switch 55a such that the non-layer one and/or time |
| | scheduled packet packet, cell, or frame will be routed to the fabric 150d or 150e |
| 58b | control line(s) 58b to positions switch 55b such that the non-layer one and/or |
| | time scheduled packet packet, cell, or frame will be routed to the fabric 150d or |
| | 150e |
| 59 | a first input switch array 59 |
| 60 | input buffer array 60 |
| 61 | second input switch array 61 |
| 62 | first output switch array 62 |
| 63 | output buffer array 63 |
| 64 | second output switch array 69 [error in spec on Pg. 51-line 10 - should say 64 |
| | instead of 69] |
| 65 | switch 65; controller 120 uses control line(s) 68 to position switch 65 so that the |
| | packet will route into OutBuffer1 70. The packet, cell, or frame then routes out |
| | of switch 100 through line 66, through switch 69, and into OutBuffer1 70. |
| 65a | switch 65a on Output Switch Array 1 selects output from switch 100a, fabric |
| | 150d, or fabric 150e; |
| 65b | switch 65b on Output Switch Array1 determines whether output goes to optional |
| | output buffer 70 or bypasses optional output buffer 70 |
| 66 | output line from the packet, cell, or frame switch 100; line out of the packet |
| | switch in the Overlay Embodiment; |
| 66a | from switch 100a to optional O/E or E/O 39 |
| 66b | from switch 55 to optional O/E or E/O 39 to 100a O or E or combo O/E switch |
| 67 | line 67 out of non-blocking, non-delaying switch 150; controller 120 uses control |
| | lines 125 to cause non-blocking, non-delaying switch 150 to route the layer one |
| | and/or time scheduled packet packet, cell, or frame directly from the line 57, |
| | through switch 150 and out the correct line 67 |
| 67a | from Electric Fabric 150d; line 67a out of non-blocking, non-delaying switch |
| | 150d through optional O/e or E/O 39 to switch 65a; controller 120 uses control |
| | lines 125 to cause non-blocking, non-delaying switch 150 to route the layer one |
| | and/or time scheduled packet packet, cell, or frame directly from the line 57, |
| | through switch 150 and out the correct line 67 |
| 67b | from Electric Fabric 150d; line 67b out of optional O/e or E/O 39 to switch 65a; |
| | controller 120 |
| 67c | from Electric Fabric 150d; line 67c out of optical fabric 150e through optional |
| | O/e or E/O 39 to switch 65a; |
| 67d | from Electric Fabric 150d; line 67d out of optional O/e or E/O 39 to switch 65a; |
| 67e | from Optical Fabric 150e; line 67a out of non-blocking, non-delaying switch |
| | 150d through optional O/e or E/O 39 to switch 65a; controller 120 uses control |
| | lines 125 to cause non-blocking, non-delaying switch 150 to route the layer one |
| | and/or time scheduled packet packet, cell, or frame directly from the line 57, |
| | through switch 150 and out the correct line 67 |
| 67f | from Optical Fabric 150e; line 67b out of optional O/e or E/O 39 to switch 65a; |
| | controller 120 |
| 67g | from Optical Fabric 150e; line 67c out of optical fabric 150e through optional |
| | O/e or E/O 39 to switch 65a; |
| 67h | from Optical Fabric 150e; line 67d out of optional O/e or E/O 39 to switch 65a; |
| 68 | control line(s) 68; controller 120 uses control line(s) 68 to position switch 65 so |
| | that the packet will route into OutBuffer1 70. The packet, cell, or frame then |
| | routes out of switch 100 through line 66, through switch 69, and into OutBuffer1 |
| | 70. |
| 68a | control line(s) 68a to control switch 65a |
| 68b | control line(s) 68b to control switch 65b |
| 69 | line 69; controller 120 uses control line(s) 68 to position switch 65 so that the |
| | packet will route into OutBuffer1 70. The packet, cell, or frame then routes out |
| | of switch 100 through line 66, through [Error pg. 53-line 16 should be line 69, |
| | not switch 69], and into OutBuffer1 70. |
| 70 | Output buffer OutBuffer 1 (OutBuffer n) 70 may be a single queue and/or |
| | multiple queues for various priorities and handling of Time-scheduled datagrams |
| | and non-time-scheduled datagrams. For example, non-time-scheduled output |
| | buffering may include priority queues for Quality of Service (QoS), Class of |
| | Service (CoS), Type of Service, etc., while time-scheduled and/or time-reserved |
| | datagrams may be assigned to buffers corresponding to Time Reservations, Time |
| | Scheduled Services, Time-Allocation, Time-Assignments/Designations, and/or |
| | Time Slots (fixed, variable, and/or dynamically changeable size). Output buffers |
| | 70 could be external to switch 100 and/or 100a, or they may optionally be |
| | situated internal to switch 100 and/or 100a. Output buffers 70 may be optical, |
| | electrical, and/or a combination opto/electrical or any other buffer technology. |
| 71 | control lines to output buffers |
| 72 | Output Queue Manager (microprocessor), Classifier |
| 73 | Output Handler (Shift Registers) |
| 74 | Program Memory (optionally RAM) |
| 75 | Control lines from Output Queue Manager 72 to Program Memory 74 |
| 76 | Control lines from Output Queue Manager 72 to Output Handler 73 |
| 77 | output buffer bypass line 77, |
| 78 | line from outbuffer to switch 79 |
| 79 | switch 79; controller 120 also positions switches 65 and 79 respectively such |
| | that the scheduled layer one and/or time scheduled packet packet, cell, or frame |
| | routes through from non-blocking, non-delaying switch 150 on line 67 through |
| | switch 65 to the buffer bypass line 77, out switch 79 to output line Out1 81 and |
| | on to the next layer one and/or time scheduled packet switch which repeats the |
| | process. |
| 80 | control line(s) 68 and 80, controller 120 also positions switches 65 and 79 |
| | respectively such that the scheduled layer one and/or time scheduled packet |
| | packet, cell, or frame routes through from non-blocking, non-delaying switch 150 |
| | on line 67 through switch 65 to the buffer bypass line 77, out switch 79 to output |
| | line Out1 81 and on to the next layer one and/or time scheduled packet switch |
| | which repeats the process. |
| 80a | control lines to control optional Output Time Sync Transmitter 87 |
| 80b | control lines to control optional Output Framer 88 |
| 80c | control lines to control 88b and 88c |
| 81 | output line Out1 81 |
| 81a | either electrical or optical output line; both E or O output lines can be used on |
| | same L1 and/or time scheduled packet switch, or can be exclusively E or |
| | exclusively O; output line 81a may go to any input medium, e.g., wireless, |
| | optical, electrical |
| 82 | Buffer Memory on Input Buffer |
| 83 | Buffer Memory on Output Buffer |
| 84 | Control lines from Output Queue Manager 72 to Buffer Memory 83 on Output |
| | Buffer |
| 85 | Control lines from Input Queue Manager 49 to Buffer Memory 82 on Input |
| | Buffer |
| 86 | Packet/Datagram Classifier - Categorizes Packets into different Classes; and puts |
| | them in appropriate queue/buffer |
| 87 | Optional Output Time Stamp and Time Sync Transmitter (electrical or optical); |
| 87a | Optional Output Time Stamp, Time Sync, header additions/deletions, scrambler, |
| | gaussifier, encryptor, and/or Transmitter (electrical, electromagnetic, wireless, |
| | and/or optical); |
| 88 | Optional Output Framer (can output electrically or optically) |
| 88a | Optional Output Encoder/Framer/Serializer/Transmitter |
| 88b | Standard Data LAN Network Interface Card (NIC) Output |
| | Buffer/Encoder/Framer/Serializer/Transmitter |
| 88c | layer 1 and/or time scheduled packet and/or time scheduled packet LAN Output |
| | Buffer/Encoder/Framer/Serializer/Transmitter |
| 89 | One or more Priority Queues (e.g., QoS, DiffServ, Classes of Service, Per Hop |
| | Behaviors, Assured Forwarding, Expedited Forwarding, etc.) for standard Non- |
| | Time-Scheduled Packets/cells/frames/Datagrams. Non-Time-scheduled packets |
| | are put into these queues according to their priority. Non-time-scheduled packets |
| | move from these queues into available time-slots (generally only when not used |
| | by Time-Scheduled Packets) in accordance with various standard Queuing |
| | algorithms, e.g., WFQ (Weighted Fair Queuing), DWFQ (Distributed Weighted |
| | Fair Queuing), Round Robin, etc. |
| 89a | One or more Hi-Priority Queues (e.g., highest-QoS, DiffServ, Classes of Service, |
| | Per Hop Behaviors, Expedited Forwarding, etc.) for Non-Time-Scheduled |
| | Packets/cells/frames/Datagrams |
| 89b | One or more second highest-Priority Queues (e.g., QoS, DiffServ, Classes of |
| | Service, Per Hop Behaviors, Assured Forwarding, etc.) for Non-Time- |
| | Scheduled Packets/cells/frames/Datagrams |
| 89c | One or more third highest-Priority Queues (e.g., QoS, DiffServ, Classes of |
| | Service, Per Hop Behaviors, Best Effort, etc.) for Non-Time-Scheduled |
| | Packets/cells/frames/Datagrams |
| 89n | One or more third highest-Priority Queues (e.g., QoS, DiffServ, Classes of |
| | Service, Per Hop Behaviors, Drop First, etc.) for Non-Time-Scheduled |
| | Packets/cells/frames/Datagrams |
| 90 | One or more Time Reserved, Time Scheduled, Time-Allocated, and/or Time |
| | Slotted Buffers and/or storage/memory- These Buffers are normally allocated to |
| | specific time slots. These buffers are normally higher priority than the highest |
| | priority Non-time-scheduled priority queue (QoS), but this may be changed |
| | depending upon the design. Time Reserved/Time Scheduled/Time Slotted |
| | Buffers may be variously allocated/reserved on a per session, per hop, per |
| | transaction, per call, per message, per priority level, and/or per flow basis |
| | depending upon the design. These Time Slot buffers may be one or more packets |
| | deep, depending upon network design, to accomodate for clock slippages, |
| | moving mobile ad-hoc nodes, time variations due to changing route paths, etc. |
| | Time Slots may be fixed-size, variable-size, or dynamically changeable. |
| 90a | One or more Time Reserved, Time Scheduled, Time Slotted Buffers which are |
| | normally assigned to Time Slot 1, but may be reassigned as part of design. These |
| | buffers are normally higher priority than the highest priority Non-time-scheduled |
| | priority queue 89a (e.g., highest QoS), but this may be changed depending upon |
| | the design. Time Reserved/Time Scheduled/Time Slotted Buffers may be |
| | variously allocated/reserved on a per session, per hop, per transaction, per call, |
| | per message, per priority level, and/or per flow basis. Time Slot buffers may be |
| | one or more packets deep. Time Slots may be fixed-size, variable-size, or |
| | dynamically changeable. |
| 90b | One or more Time Reserved, Time Scheduled, Time Slotted Buffers which are |
| | normally assigned to Time Slot 2, but may be reassigned as part of design. These |
| | buffers are normally higher priority than the highest priority Non-time-scheduled |
| | priority queue 89a (e.g., highest QoS), but this may be changed depending upon |
| | the design. Time Reserved/Time Scheduled/Time Slotted Buffers may be |
| | variously allocated/reserved on a per session, per hop, per transaction, per call, |
| | per message, per priority level, and/or per flow basis. Time Slot buffers may be |
| | one or more packets deep. Time Slots may be fixed-size, variable-size, or |
| | dynamically changeable. |
| 90c | One or more Time Reserved, Time Scheduled, Time Slotted Buffers which are |
| | normally assigned to Time Slot 3, but may be reassigned as part of design. These |
| | buffers are normally higher priority than the highest priority Non-time-scheduled |
| | priority queue 89a (e.g., highest QoS), but this may be changed depending upon |
| | the design. Time Reserved/Time Scheduled/Time Slotted Buffers may be |
| | variously allocated/reserved on a per session, per hop, per transaction, per call, |
| | per message, per priority level, and/or per flow basis. Time Slot buffers may be |
| | one or more packets deep. Time Slots may be fixed-size, variable-size, or |
| | dynamically changeable. |
| 90n | One or more Time Reserved, Time Scheduled, Time Slotted Buffers which are |
| | normally assigned to Time Slot n where n is the Time slot number. These Time |
| | Reserved, Time Scheduled, Time Slotted Buffers are normally higher priority |
| | than the highest priority Non-time-scheduled priority queue 89a (e.g., highest |
| | QoS), but this may be changed depending upon the design. Time Reserved/ |
| | Time Scheduled/Time Slotted Buffers may be variously allocated/reserved on a |
| | per session, per hop, per transaction, per call, per message, per priority level, |
| | and/or per flow basis. Time Slot buffers may be one or more packets deep. Time |
| | Slots may be fixed-size, variable-size, or dynamically changeable. |
| 92 | Time-Scheduled Packet/Datagram Event Scheduling Process |
| 93 | Master Controller Process 93 |
| 94 | Input Queue Manager |
| 95 | Routinng Manager |
| 96 | Node Network Routing/Link/Hop Table |
| 97 | Time-Schedule Reservation Scheduler |
| 98 | Message Generator - Generates Outgoing Msg. and Destination |
| 99 | Mode Selection - (Mode 1, 2, 3, etc.) |
| 100 | packet, cell, or frame switch 100 |
| 100a | optical or electrical or combination of optical and electrical packet, cell, or frame |
| | switch 100a |
| 100b | Standard Data (Packet, Cell, or Frame) Input Capability to Higher Layers in End |
| | User Source/Destination or LAN device |
| 100c | From Higher Layers in End User Source/Destination or LAN device to Standard |
| | Data (Packet, Cell, or Frame) Output Capability. |
| 101 | Input Buffers on Packet, Cell, Frame Switch 100 |
| 102 | Input Rotation Matrix on Packet, Cell, Frame Switch 100 |
| 103 | Shared Buffer Mem & Switch Fabric) on Packet, Cell, Frame Switch 100 |
| 104 | Output Rotation Matrix on Packet, Cell, Frame Switch 100 |
| 105 | Output Buffers on Packet, Cell, Frame Switch 100 |
| 106 | line 106; from packet cell frame switch 100 to controller 120; controller 120 has |
| | a network address for standard packet, cell, or frame messages whereby switch |
| | 100 routes these messages to controller 120 through line 106. Controller 120 can |
| | also send standard packet, cell, or frame messages through line 107 to switch 100 |
| | for routing to the network. |
| 107 | line 107; from controller 120 to packet cell frame switch 100; Controller 120 can |
| | also send standard packet, cell, or frame messages through line 107 to switch 100 |
| | for routing to the network. |
| 108 | control lines; In this preferred integrated embodiment, also termed the |
| | “integrated” embodiment, the layer one and/or time scheduled packet controller |
| | is the primary controller of the entire device, such that it can control integrated |
| | packet, cell, or frame switches 2, 3, and 4 through control lines 108, to cause |
| | delaying, stopping or starting standard non-real-time, non-high-priority store-and- |
| | forward packets in the input and output buffers and in the packet, cell, or frame |
| | switches 2, 3, or 4 respectively for the purposes of scheduling and switching layer |
| | one and/or time scheduled packet real-time or high-priority packets. |
| 108a | control lines; from controller to data output capability in Source Dest. |
| | Embodiment |
| 108b | control lines; from controller to data input capability in Source Dest. |
| | Embodiment |
| 109 | Bit Rate Reservation Device on Packet, Cell, Frame Switch 100 |
| 110 | Node Manager |
| 111 | Output Queue Manager |
| 112 | Priority Order Scheduler, but Non-Time-Scheduler |
| 113 | Selector, Time-Scheduler |
| 114 | Not Used |
| 115 | Not Used |
| 116 | Not Used |
| 117 | Not Used |
| 118 | Not Used |
| 119 | Not Used |
| 120 | controller 120 with timing synchronization means 22, 23, 24; the layer one |
| | and/or time scheduled packet switch controller 120 uses control line(s) 42 to |
| | position switch 41 into the position to route the standard packets, cells, or frames |
| | from input line In1 40 to input buffer InBuffer1 45. Here the standard packets, |
| | cells, or frames are stored while the controller 120 determines where each packet |
| | should go and which packets to route first. |
| 120a | controller 120a with timing synchronization means 22, 23, 24; the layer one |
| | and/or time scheduled packet switch controller 120a uses control line(s) 42 to |
| | position switch 41 into the position to route the standard packets, cells, or frames |
| | from input line In1 40 to input buffer InBuffer1 45. Here the standard packets, |
| | cells, or frames are stored while the controller 120 determines where each packet |
| | should go and which packets to route first. |
| 121 | Input line from line 106 to Input Queue Manager 133 on Controller |
| 122 | Output line from Output Queue Manager 136 of Controller 120 Output Buffer to |
| | line 107 |
| 123 | line 123; controller 120 has a network address for layer one and/or time |
| | scheduled packet messages whereby switch 150 routes these messages to |
| | controller 120 through line 123. |
| 123a | communications line from electrical switch to controller 120a |
| 123b | communications line from optical switch to controller 120a |
| 124 | line 124; Controller 120 can also send high-priority scheduled layer one and/or |
| | time scheduled packet messages such as emergency messages, synchronization |
| | timing messages, and administrative messages through line 124 to switch 150 for |
| | routing to the network. |
| 124a | communications line from controller 120a to electrical switch |
| 124b | communications line from controller 120a to optical switch |
| 125 | control lines 125; controller 120 uses control lines 125 to cause non-blocking, |
| | non-delaying switch 150 to route the layer one and/or time scheduled packet |
| | packet, cell, or frame directly from the line 57, through switch 150 and out the |
| | correct line 67 |
| 125a | control lines 125a for controller 120a to control electrical fabric 150d; |
| 125b | control lines 125b for controller 120a to control optical fabric 150e |
| 126 | RS-232 or other controller interface (Node Manager) to Node Management |
| | Monitor 137 |
| 127 | Master Packet Switch Controller |
| 128 | Clock Synchronization Mechanism |
| 129 | Event Database |
| 129a | Event Timer; Time to Kill; |
| 130 | Reservation Manager |
| 131 | Not Used |
| 132 | master L1 and/or time scheduled packet and/or time scheduled packet switch |
| | controller 132 |
| 133 | input queue manager 133; input buffer 133 |
| 134 | master controller 134 |
| 135 | control lines 135 for internal communication from Master Controller |
| | microprocessor 134a to Output Buffer 136 |
| 136 | output buffer 136 for transmitting messages externally through switches 100 and |
| | 150; output queue manager 136 |
| 137 | line betweeen Node Management Monitor and Controller Interface 126 |
| 138 | local clock 138 |
| 139 | control lines 139 from local clock 138 |
| 140 | Not Used |
| 141 | Control lines between synchronization receivers 22, 23, 24 and clock sync |
| | mechanism 128 |
| 142 | Not Used |
| 143 | Not Used |
| 144 | Not Used |
| 145 | Not Used |
| 146 | Not Used |
| 147 | Not Used |
| 148 | Not Used |
| 149 | Standard POTS circuit switch |
| 150 | one or more input to one or more output switch 150 preferred non-blocking, non- |
| | delaying but optionally blocking and/or delaying. May be single fabric or multi- |
| | fabric, optical, eletrical, MEMs, and/or any switching mechanism. |
| 150a | [Could be blocking or delaying, but prefferred is non-block, nondelaying] NON- |
| | Single Fabric; optical or electrical or both fabric; optional blocking; optional |
| | delaying switch |
| 150b | SINGLE Fabric; optical or electrical or both fabric; optional blocking; optional |
| | delaying switch [Could be blocking or delaying, but prefferred is non- |
| | block, nondelaying] |
| 150c | SINGLE or NON_SINGLE Fabric; optical or electrical or both fabric; optional |
| | blocking; optional delaying switch[Could be blocking or delaying, but prefferred |
| | is non-block, nondelaying] |
| 150d | electrical fabric; optional blocking; optional delaying switch [Could be blocking |
| | or delaying, but prefferred is non-block,nondelaying] |
| 150e | optical fabric; optional blocking; optional delaying switch [Could be blocking or |
| | delaying, but prefferred is non-block,nondelaying] |
| 150f | From layer 1 and/or time scheduled packet and/or time scheduled packet Input |
| | Capability to Higher Layers in End-User Device; Source Destination or LAN |
| | device [Could be blocking or delaying, but prefferred is non-block, nondelaying] |
| 150g | From Higher Layers to layer 1 and/or time scheduled packet and/or time |
| | scheduled packet Output Capability for End-User Device; Source Destination or |
| | LAN device [Could be blocking or delaying, but prefferred is non- |
| | block, nondelaying] |
| 151 | Input line 151 feeding non-inverting amplifier 157 is a means whereby the |
| | controller 120 can send scheduled layer one and/or time scheduled packet |
| | packets. |
| 151a | Electrical Input line 151 feeding non-inverting amplifier 157 is a means whereby |
| | the controller 120 can send scheduled layer one and/or time scheduled packet |
| | packets. |
| 151b | Optical Input line 151 feeding non-inverting amplifier 157 is a means whereby |
| | the controller 120 can send scheduled layer one and/or time scheduled packet |
| | packets. |
| 152 | Input line 152 feeding non-inverting amplifier 158 feeds input into non-blocking, |
| | non-delaying switch 150 |
| 153 | Output buses 153, 154, 155, and 156, which are tapped on to these input buses |
| | 161, 162, 163, and 164, respectively, are configured such that every possible |
| | output receives every possible input, thus the switch is non-blocking. |
| 153a | Electrical Output buses 153, 154, 155, and 156, which are tapped on to these |
| | input buses 161, 162, 163, and 164, respectively, are configured such that every |
| | possible output receives every possible input, thus the switch is non-blocking. |
| 153b | Optical Output buses 153, 154, 155, and 156, which are tapped on to these input |
| | buses 161, 162, 163, and 164, respectively, are configured such that every |
| | possible output receives every possible input, thus the switch is non-blocking. |
| 154 | Output buses 153, 154, 155, and 156, which are tapped on to these input buses |
| | 161, 162, 163, and 164, respectively, are configured such that every possible |
| | output receives every possible input, thus the switch is non-blocking. |
| 154a | Electrical Output buses 153, 154, 155, and 156, which are tapped on to these |
| | input buses 161, 162, 163, and 164, respectively, are configured such that every |
| | possible output receives every possible input, thus the switch is non-blocking. |
| 154b | Optical Output buses 153, 154, 155, and 156, which are tapped on to these input |
| | buses 161, 162, 163, and 164, respectively, are configured such that every |
| | possible output receives every possible input, thus the switch is non-blocking. |
| 155 | Output buses 153, 154, 155, and 156, which are tapped on to these input buses |
| | 161, 162, 163, and 164, respectively, are configured such that every possible |
| | output receives every possible input, thus the switch is non-blocking. |
| 155a | Electrical Output buses 153, 154, 155, and 156, which are tapped on to these |
| | input buses 161, 162, 163, and 164, respectively, are configured such that every |
| | possible output receives every possible input, thus the switch is non-blocking. |
| 155b | Optical Output buses 153, 154, 155, and 156, which are tapped on to these input |
| | buses 161, 162, 163, and 164, respectively, are configured such that every |
| | possible output receives every possible input, thus the switch is non-blocking. |
| 156 | Output buses 153, 154, 155, and 156, which are tapped on to these Input buses |
| | 161, 162, 163, and 164, respectively, are configured such that every possible |
| | output receives every possible input, thus the switch is non-blocking. |
| 156a | Electrical Output buses 153, 154, 155, and 156, which are tapped on to these |
| | input buses 161, 162, 163, and 164, respectively, are configured such that every |
| | possible output receives every possible input, thus the switch is non-blocking. |
| 156b | Optical Output buses 153, 154, 155, and 156, which are tapped on to these input |
| | buses 161, 162, 163, and 164, respectively, are configured such that every |
| | possible output receives every possible input, thus the switch is non-blocking. |
| 157 | amplifiers 157, 158, 159, and 160, |
| 157a | Optional Electrical repeater/regenerator/amplifiers/waveshaper 157, 158, 159, |
| | and 160, |
| 157a | Optional Optical repeater/regenerator/amplifier/combiner/tunable wavelength |
| | converter 157, 158, 159, and 160, |
| 158 | amplifiers 157, 158, 159, and 160, |
| 158a | Optional Electrical repeater/regenerator/amplifiers/waveshaper 157, 158, 159, |
| | and 160. |
| 158b | Optional Optical repeater/regenerator/amplifier/combiner/tunable wavelength |
| | converter 157, 158, 159, and 160, |
| 159 | amplifiers 157, 158, 159, and 160, |
| 159a | Optional Electrical repeater/regenerator/amplifiers/waveshaper 157, 158, 159, |
| | and 160, |
| 159b | Optional Optical repeater/regenerator/amplifier/combiner/tunable wavelength |
| | converter 157, 158, 159, and 160, |
| 160 | amplifiers 157, 158, 159, and 160, |
| 160a | Optional Electrical repeater/regenerator/amplifiers/waveshaper 157, 158, 159, |
| | and 160, |
| 160b | Optional Optical repeater/regenerator/amplifier/combiner/tunable wavelength |
| | converter 157, 158, 159, and 160, |
| 161 | input buses 161, 162, 163, and 164, respectively, are configured such that every |
| | possible output receives every possible input, thus the switch is non-blocking. |
| 161a | Electrical input buses 161, 162, 163, and 164, respectively, are configured such |
| | that every possible output receives every possible input, thus the switch is non- |
| | blocking. |
| 161b | Optical input buses 161, 162, 163, and 164, respectively, are configured such that |
| | every possible output receives every possible input, thus the switch is non- |
| | blocking. |
| 162 | input buses 161, 162, 163, and 164, respectively, are configured such that every |
| | possible output receives every possible input, thus the switch is non-blocking. |
| 162a | Electrical input buses 161, 162, 163, and 164, respectively, are configured such |
| | that every possible output receives every possible input, thus the switch is non- |
| | blocking. |
| 162b | Optical input buses 161, 162, 163, and 164, respectively, are configured such that |
| | every possible output receives every possible input, thus the switch is non- |
| | blocking. |
| 163 | input buses 161, 162, 163, and 164, respectively, are configured such that every |
| | possible output receives every possible input, thus the switch is non-blocking. |
| 163a | Electrical input buses 161, 162, 163, and 164, respectively, are configured such |
| | that every possible output receives every possible input, thus the switch is non- |
| | blocking. |
| 163b | Optical input buses 161, 162, 163, and 164, respectively, are configured such that |
| | every possible output receives every possible input, thus the switch is non- |
| | blocking. |
| 164 | input buses 161, 162, 163, and 164, respectively, are configured such that every |
| | possible output receives every possible input, thus the switch is non-blocking. |
| 164a | Electrical input buses 161, 162, 163, and 164, respectively, are configured such |
| | that every possible output receives every possible input, thus the switch is non- |
| | blocking. |
| 164b | Optical input buses 161, 162, 163, and 164, respectively, are configured such that |
| | every possible output receives every possible input, thus the switch is non- |
| | blocking. |
| 165 | output switch 165 is configured such that only one of the output buses 153, 154, |
| | 155, or 156 is switched to the output line 166 |
| 165a | Electrical switch 165 is configured such that only one of the output buses 153, |
| | 154, 155, or 156 is switched to the output line 166 |
| 165b | Optical switch 165 is configured such that only one of the output buses 153, 154, |
| | 155, or 156 is switched to the output line 166 |
| 166 | output line 166 from output switch 165 is configured such that only one of the |
| | output buses 153, 154, 155, or 156 is switched to the output line 166 |
| 167 | Not Used |
| 168 | Not Used |
| 169 | Non-layer 1 and/or non-time scheduled packet; Standard Data Packet, Standard |
| | Datagram - No Preset Scheduled Time |
| 170 | layer 1 and/or time scheduled packet from Source 1k to Destination 5i |
| 171 | layer 1 and/or time scheduled packet from Source 1m to Destination 5j |
| 172 | Non-layer 1 and/or non-time scheduled packet from Source 1q to Destination 5k- |
| | Standard Data Packet - No Preset Scheduled Time |
| 173 | Non-layer 1 and/or non-time scheduled packet from Source 1q to Destination 5j- |
| | Standard Data Packet - No Preset Scheduled Time |
| 174 | Non-layer 1 and/or non-time scheduled packet from Source 1r to Destination 5j - |
| | Standard Data Packet - No Preset Scheduled Time |
| 175 | Non-layer 1 and/or non-time scheduled packet from Source 1r to Destination 5k- |
| | Standard Data Packet - No Preset Scheduled Time |
| 176 | Reserved time interval for additional time-scheduled and/or layer one datagrams |
| | which accumulate at various nodes due to multiple clocks, non-synced clocks, |
| | clock discrepancies, clock variations, jitter, and/or clock slippage, etc. on various |
| | links. If this reserved time interval is not used, a non-time-scheduled and/or non- |
| | layer one datagram may be sent in this interval for efficiency reasons. Thus a |
| | header lookup may be used to determine the datagram and it's next action. |
| 177 | Not Used |
| 178 | Not Used |
| 179 | Not Used |
| 180 | Sync Reference and/or framing Marker, may be in-band or out-of-band; may be |
| | one or more bit(s), symbols(s), sync pulse(s), heartbeat pulse(s), signal(s), |
| | field(s), and/or packet(s); may be GPS and/or non-GPS derived, may be visible or |
| | hidden as part of the signal. |
| 180a | Floating Sync Reference Marker |
| 181 | Time-Scheduled Packet/Datagram, Time-Reserved Packet/Datagram, Time- |
| | Reservation Packet/Datagram, Time-Reservation/Scheduled Packet/Datagram, |
| | and/or Layer One Packet-Datagram. Layer 1 and/or time-scheduled and/or time- |
| | reserved packet. Packet for Prearranged or Prescheduled absolute or relative |
| | Timing. |
| 182 | Waiting Time and Propagation Delay from Real-Time Source 1 to Transmitter |
| | Node 2 |
| 183 | Propagation Delay Time from Transmitter Node 2 Output to Receiver Node 4 |
| | Input |
| 184 | Switching Time Delay in Receiver Node 4 and Propagation Delay to Real-Time |
| | Receiver 5 Input |
| 185 | Timing Error or Bit Error on Transmission Line 12 |
| 186 | Re-Establishment of Correct Timing |
| 187 | Prearranged and/or Scheduled Offset and/or Delta From Pointer or frame |
| | Beginning Point to layer 1 and/or time scheduled packet (in bits, symbols, time, |
| | etc.) |
| 188 | Pointer and/or Offset and/or Delta to Beginning Point of Frame, datagram, |
| | packet, and or other data. |
| 189 | Repeating Frame and/or Time-Interval |
| 190 | Time-line for layer 1 and/or time scheduled packet. Packet with Prearranged or |
| | Prescheduled absolute or relative Timing |
| 191 | Time-line for Non-layer 1 and/or non-time scheduled packet; Standard Data |
| | Packet - No Preset Scheduled Time |
| 192 | Not Used |
| 193 | Not Used |
| 194 | Not Used |
| 195 | Not Used |
| 196 | Not Used |
| 197 | Not Used |
| 198 | Not Used |
| 199 | Not Used |
| 200 | Network Manager |
| 201 | SCP Service Control Point in Signaling System |
| 202 | STP - Signaling Transfer Point in Signaling System |
| 203 | Communication link from Network Manager 200 to SCP 201 |
| 204 | Signaling links in Signaling System |
| 205 | PSTN - Public Switched Telephone Network |
| 206 | Data Network or device |
| 207 | Gateway |
| 208 | ° |
| 209 | Internal or External Network Control, Network Management, Network Planning, |
| | and/or Billing Functionality, including MIBs (Management Information Bases); |
| | (Comprises 210, 211, 212); Capability to establish, coordinate, and maintain |
| | management of the network; Includes but is not limited to: Fault Management, |
| | Configuration Management, Addressing Management, Accounting, Tracking, |
| | Event Management, Network Event Management, Agent Management, |
| | Performance Management, Security Management, Policy Management, Quality |
| | of Service Management, Key Management (e.g. PKI - Public Key Infrastructure), |
| | Bandwidth Management, Dense Wavelength Division Multiplexing |
| | Management, Frequency Management, Bandwidth Management, and/or |
| | Spectrum Management. |
| 210 | Network Interface Function |
| 211 | Network Intelligence/Knowledge/Routing Control Functionality |
| 212 | Switch, Device, and/or Network Element Control Functionality in the Network |
| | Management/Control System; may be internal or external to the network element |
| | being managed. |
| 213 | Communication link from Network Interface Function 210 to Network |
| | Intelligence/Knowledge/Routing Control Functionality 211 |
| 214 | Communication link from Network Intelligence/Knowledge/Routing Control |
| | Functionality 211 to Switch Control Functionality 212 |
| 215 | Communication link from Internal and/or External Network Management and |
| | Control Functionality 212 to switching node32, 33,34, also 31 and 35 |
| 216 | |
| 217 | Non-IP based Protocol Suite |
| 218 | IP-based Protocol Suite (e.g., 802.11) |
| 219 | TCP/IP Reference Suite |
| 220 | OSI Stack |
| 221 | All Packets of Flow Forwarding for Layer 3 Routing and Switching |
| 222 | First Packet of Flow Forwarding for Cut-through Layer 3 Switching (e.g., MPLS) |
| 223 | Subsequent Packets of Flow Forwarding for Cut-through Layer 3 Switching (e.g., |
| | MPLS) |
| 224 | Optional First Packet Flow for Call Setup of time-scheduled, time-reserved, |
| | and/or layer 1; Alternatively, can be pre-established for layer 1 and/or time |
| | scheduled packet. |
| 225 | Subsequent Packets of L1, and/or time scheduled packet Flow. This may be |
| | thought of as Layer 1, layer 2, layer 3, or higher layers, as long as |
| | packets/datagrams have a reservation. Indication in the packet of its time- |
| | schedule may be at any layer. |
| 226 | |
| 227 | |
| 228 | |
| 229 | |
| 230 | 8 bit Slots for Circuit Switching with Voice |
| 231 | 8 bit Slots for Circuit Switching with Data |
| 232 | 8 bit Slots for Circuit Switching with Unused Bandwidth |
| 233 | Variable Size Data Packet takes an unknown number of frames |
| 234 | layer 1 and/or time scheduled packet Packet must wait unknown Frames, |
| | creating uncontrolled delay and jitter. |
| 235 | layer one and/or time scheduled packet/datagram (e.g., Voice, Video) is |
| | Scheduled and sent at scheduled time as desired |
| 236 | Next Pre-Scheduled Packet at Fixed Time with Virtually No Jitter |
| 237 | Standard Data Packets/Datagrams (i.e., Non-Time-Scheduled |
| | Packets/Datagrams) are inserted in between Scheduled Real-Time Packets |
| 238 | Unused bandwidth if all standard data packets are sent |
| 239 | Fixed and/or Variable Size Slots and/or Times in Revolving Frame and/or Time |
| | Interval. Time Slots may be fixed-size, variable-size, and/or dynamically |
| | changeable. |

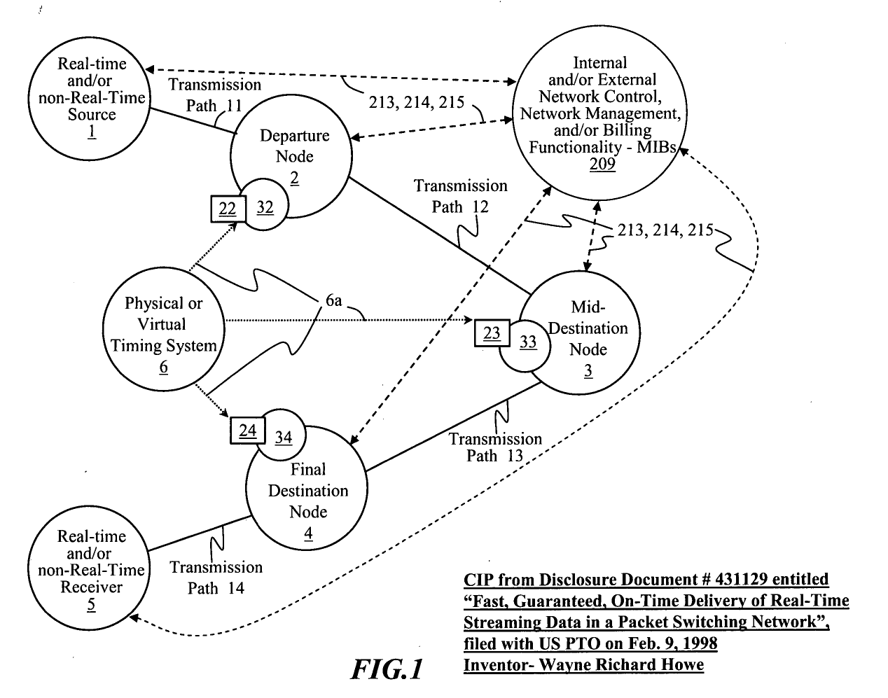

FIG. 1 shows an illustrative packet, cell, or frame-based network as adapted from U.S. PTO Disclosure Document NO. 431129, which has been previously incorporated herein by reference. It shows a packet, cell, frame, and/or datagram switched/routed network elements comprised of sources, destinations, transfer elements, and control elements coupled by fixed or mobile communications paths. Said network elements may be tightly or loosely synchronized by various physical and/or virtual timing mechanisms such as one or more clocks, synchronization pulses, and/or synchronization systems. Said network system may optionally include internal and/or external control mechanisms, network management, and/or billing functionality, according to a preferred embodiment of the network architecture in the present invention. Clocking may be global or multiple autonomous discrete link-to-link clocks. Clocking may or may not use Global Positioning System signals. Clocking may be in-band and/or out-of-band.

FIG. 1 illustrates network architecture that is point-to-point and multi-hop. This network architecture comprises a real-time data source or call originator 1 such as a streaming audio/video application source or an Internet phone caller; a departure router, switch, or originating edge node 2; a mid-destination router, switch, or middle node 3; a final destination router, switch, or terminating edge node 4; and a real-time receiver or destination 5 for the real-time streaming audio/video application destination and/or Internet phone or video conference receiver.

FIG. 1 also illustratively shows a transmission/communications path 11 between the real-time data source or call originator 1 and the departure router, switch, or originating edge node 2; a transmission/communications path 12 between the departure router, switch, or originating edge node 2 and the mid-destination router, switch, or middle node 3; a transmission/communications path 13 between the mid-destination router, switch, or middle node 3 and the final destination router, switch, or terminating edge node 4; and a transmission/communications path 14 between the final destination router, switch, or terminating edge node 4 and the real-time receiver or destination node 5.

FIG. 1 includes upgraded hardware and software 32, 33, and 34 which is added to standard packet, cell, or frame network routers and switches designated network elements 2, 3, and 4 in order to create the capabilities of the present invention.

FIG. 1 includes a master clock 6 which communicates clock timing and synchronization signals 6a to receiver/synchronization means 22, 23, and 24, thereby enabling the network device embodiments of the present invention to synchronize their clocks to a high degree of accuracy.

This embodiment of the present invention may use the existing satellite Global Positioning System (GPS) or other clocks as a master clock 6. The GPS system and means for synchronizing the network elements will be described in more detail later. However, any means for synchronizing the clocks to a high degree of accuracy is acceptable, such as synchronization pulses on transmission lines, synchronization through radio signals, atomic, cesium, or radium clocks, etc.

FIG. 1 shows that the network and devices may incorporate Internal or External Network Control, Network Management, Network Planning, and/or Billing Functionality 209, including MIBs (management Information Bases). This network management functionality 209 comprises Network Interface Function 210; Network Intelligence/Knowledge/Routing Control Functionality 211; and Switch, Device, and/or Network Element Control Functionality 212 in the Network Management/Control System. This capability may be internal and/or external to the network element being managed. (see also FIG. 42 through FIG. 47. Network Management 209 includes the capability to establish, coordinate, and maintain management of the network. It includes but is not limited to: Fault Management, Configuration Management, Addressing Management, Accounting, Tracking, Event Management, Network Event Management, Agent management, Performance Management, Security Management, Policy Management, Quality of Service Management, Key Management (e.g. PKI—Public Key Infrastructure), Bandwidth Management, Dense Wavelength Division Multiplexing Management, Frequency Management, Bandwidth Management, and/or Spectrum Management.

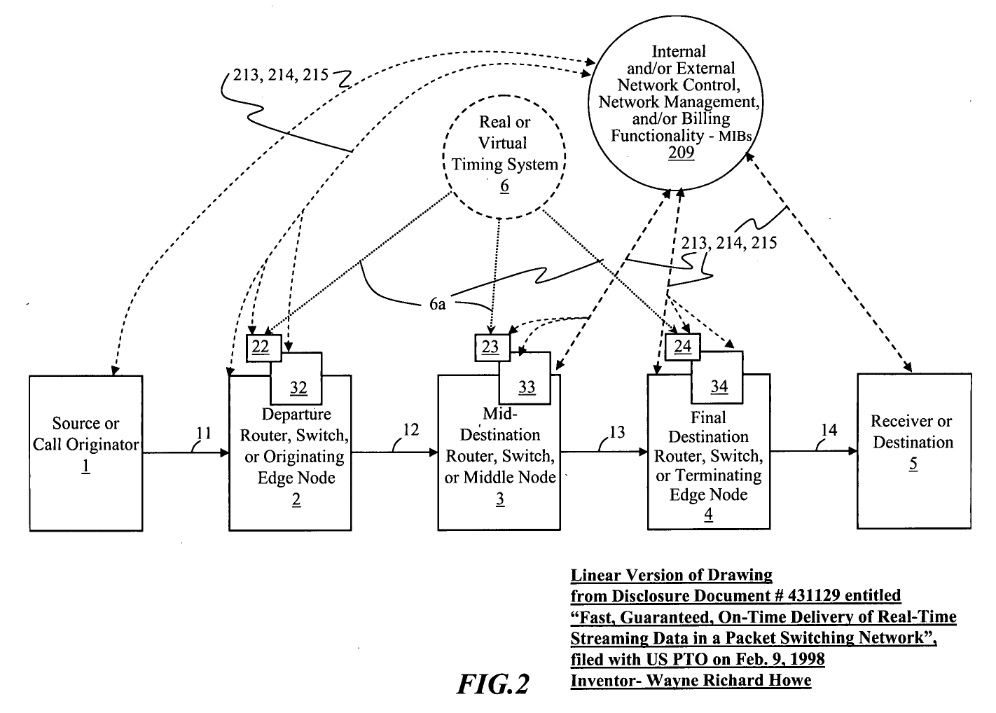

FIG. 2 shows a redrawing of FIG. 1 done in a linear manner with additional descriptors to better enable discussion of the flow of data and information from left to right. In this way information can be seen to travel from the real-time source or originating edge node 2, 22, and 32, through mid-destination router or middle node 3, 23, and 33, through final destination router or terminating edge node 4, 24, and 34, and finally to real-time receiver or destination 5. In these diagrams, the mid-destination router or middle node 3, 23, and 33 are meant to represent a plurality of middle nodes 3, 23, and 33.

Additional hardware/software 32, 33, and 34 includes means to enable a time-scheduled and/or time-reserved datagram/packet and/or physical layer bypass connection for the transfer of incoming data from one incoming line such as transmission path 12 to an outgoing line such as transmission path 13 through mid-destination node 3 and 33. This capability enables real-time or high-priority packets to bypass the standard queuing or buffering means of routers and switches 2, 3, and 4 and tunnel straight through the node at the physical or time-scheduled and/or time-reserved datagram/packet level.

FIG. 2 also shows master clock 6 to be optional as indicated by master clock 6's dashed border line. Various alternatives to master clock 6 and clock timing and synchronization signals 56a exist in the present invention. These alternatives are described and explained in other figures that follow in more detail.

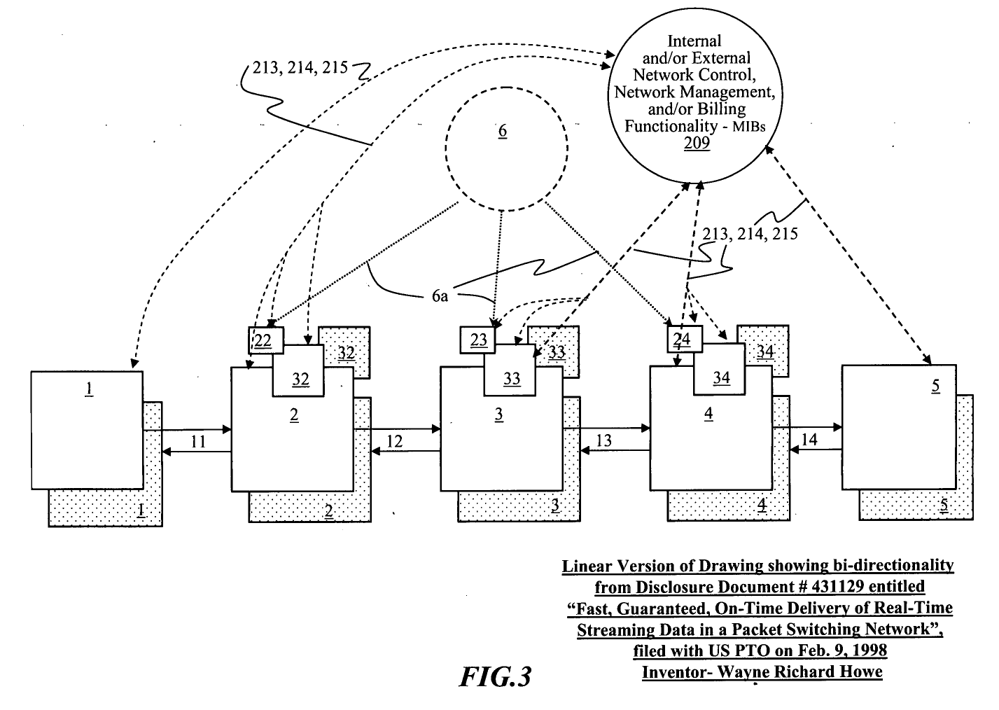

Although we have simplified the flow of data in FIG. 1 and FIG. 2 to show a flow of data from left to right, it is important to understand that the communications across the network are bi-directional, such that parallel process is occurring in the opposite direction, from right to left as shown in FIG. 3. In FIG. 3, the shaded areas indicate the flow of information in the opposite direction, such that destination 5 also serves as a source of information for this reverse flow, while final destination or termination node 4 and 34 serve as a departure or origination node. In the reverse flow, mid-destination node 3 and 33 continue to represent a plurality of mid-destination nodes, while departure or origination node 2 and 32 also serve the function of final destination or terminating edge node. A specific example of this two-way flow is when source 1 and destination 5 are participants in a two-way phone call such as Internet phone or video conferencing. Source 1 serves the role of a source and destination, as does destination 5.

For purposes of clarity in the present description, we will show all the path flows as unidirectional, but for practical purposes, the present invention is bi-directional, with the same devices and processes used in both directions.

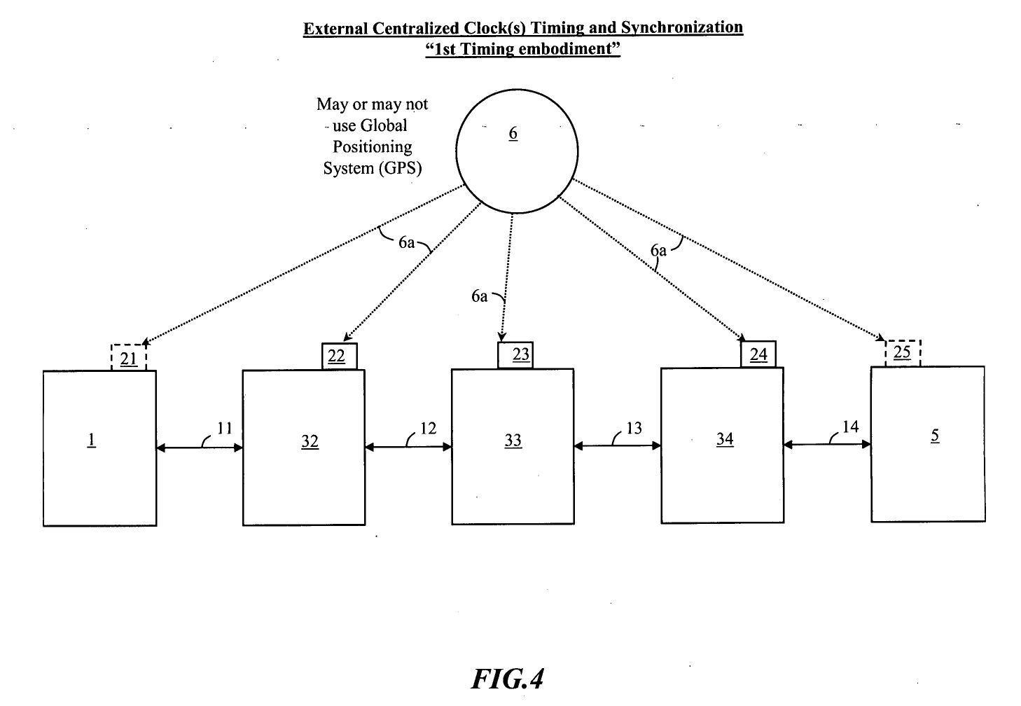

FIG. 4 illustrates a “first timing embodiment” for distributing clocks, timing, and synchronization signals to time-scheduled and/or time-reserved datagram/packet networks comprising an external centralized clock(s) for timing and synchronization. In this embodiment of the present invention, master clock 6 may include information in its clock timing and synchronization signals 6a which enable clock receiver/synchronization means 22, 23, and/or 24 to determine and synchronize to the specific or absolute time in each of their own respective locations. By specific or absolute time in each of their own respective locations. By specific time or absolute time is meant the specific time of day, hour, minute, second, fraction of a second, etc. (to within some reasonable level of accuracy). For example, UTC (Coordinated Universal Time) or Greenwich Mean Time are examples of specific time or absolute time, although other standards may be used wherein the precise time of day is determined and/or known by clock receiver/synchronization means 22, 23, and/or 24.

In addition, master clock 6 through clock timing and synchronization signals 6a may also optionally synchronize end-user clock synchronization means 21 and 25 associated with real-time and/or high-priority source 1 and real-time and/or high-priority receiver 5 respectively, outside of optional potential network boundaries 10.

The Global Positioning System (GPS), either by itself or in conjunction with other methods is just one example of many possible approaches to this centralized clocking embodiment. However, any similar approaches to distributing clocking, timing, and synchronization to the clock receiver/synchronization means 21, 22, 23, 24, and 25, is acceptable.

Alternatively, in some embodiments of the present invention, master clock 6 may not include information for determining absolute time or specific time in its clock timing and synchronization signals 6a. In this case clock receiver/synchronization means 21, 22, 23, 24, and/or 25 may use other methods such as two-way timestamp transfer to synchronize their clocks to specific times or absolute times and measure propagation delay between nodes.

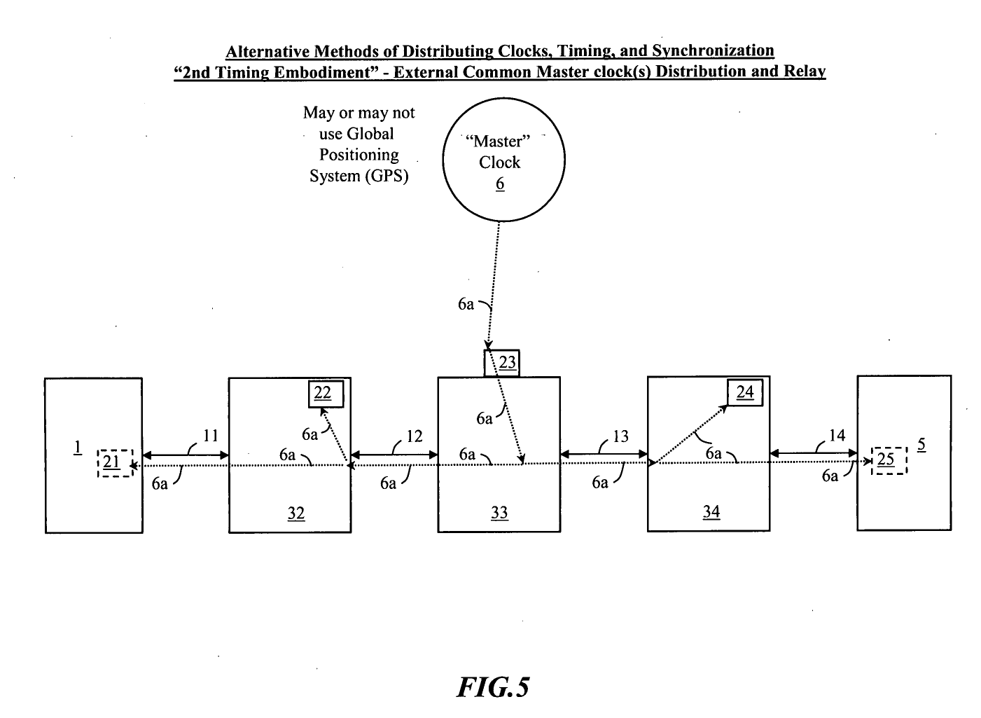

FIG. 5 is a simplified illustrative example showing an alternative “second timing embodiment” for distributing clocks, timing, and synchronization signals to time-scheduled and/or time-reserved datagram/packet networks. In this “second timing embodiment”, one or more master clock(s) 6 supply master clock timing, and synchronization signal(s) 6a to time-scheduled and/or time-reserved datagram/packet clock receiver/synchronization means 23. Clock receiver/synchronization means 23 attached to time-scheduled and/or time-reserved datagram/packet hardware and software 33 may then relay the master clock synchronization signal(s) 6a either in-band or out-of-band to other clock receiver/synchronization means 22 and/or 24, attached to time-scheduled and/or time-reserved datagram/packet hardware and software 32 and/or 34 respectively, in the network. Master clock synchronization signal(s) 6a may also optionally be relayed either in-band or out-of-band to end-user clock receiver/synchronization means 21 and/or 25 attached to real-time or high-priority source 1 and real-time or high-priority receiver 5. In this “second timing embodiment” for the distribution and relay of master clock(s), timing and synchronization signals 6a, the Global Positioning System (GPS), either by itself or with other methods, is just one example of many possible approaches that may be used. Alternatively, or in addition, clock receiver/synchronization means 21, 22, 23, 24, and/or 25 may use other methods such as two-way timestamp transfer to synchronize their clocks to specific times or absolute times and measure propagation delay between nodes. Any similar methods to establish and relay master clock timing and synchronization signal(s) 6a may be used, both in-band and out-of-band, as are known to those skilled in the art.

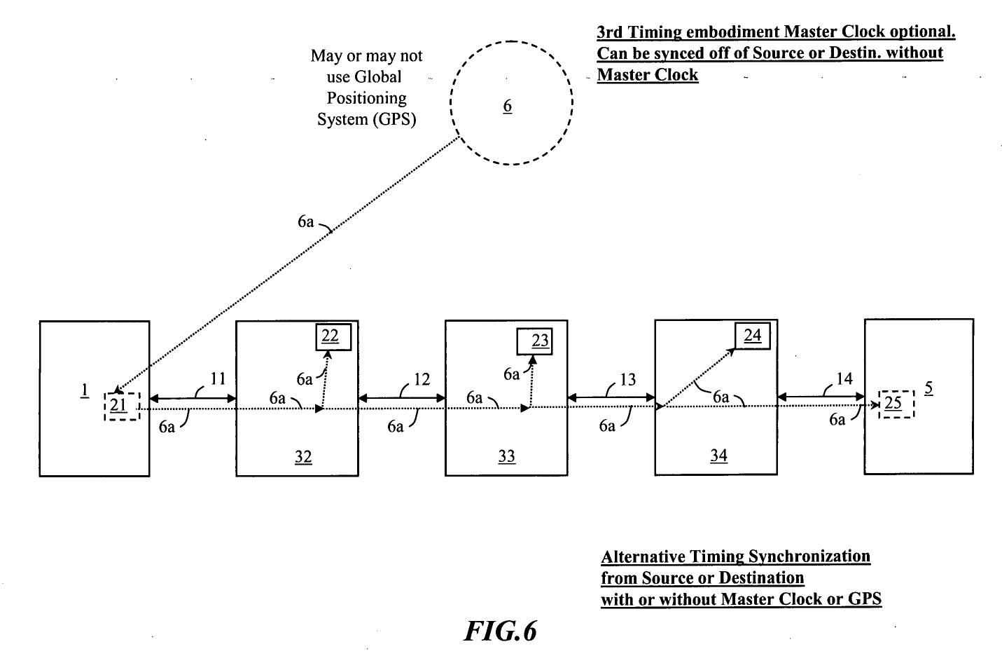

FIG. 6 is a simplified illustrative example showing an alternative “third timing embodiment” for distributing clocks, timing, and synchronization signals to time-scheduled and/or time-reserved datagram/packet networks. In this “third timing embodiment”, one or more master clock(s) 6 optionally supply master clock timing, and synchronization signal(s) 6a to time-scheduled and/or time-reserved datagram/packet clock receiver/synchronization means 21. Clock receiver/synchronization means 21 attached to source 1 may then relay the master clock synchronization signal(s) 6a either in-band or out-of-band to other clock receiver/synchronization means 22, 23, 24, and/or 25 in the network. In this “third timing embodiment” for the distribution and relay of master clock(s), timing and synchronization signals 6a, the Global Positioning System (GPS), either by itself or with other methods, is just one example of many possible approaches that may be used. Alternatively, or in addition, clock receiver/synchronization means 21, 22, 23, 24, and/or 25 may use other methods such as two-way timestamp transfer to synchronize their clocks to specific times or absolute times and measure propagation delay between nodes. Any similar methods to establish and relay master clock timing and synchronization signal(s) 6a may be used, both in-band and out-of-band, as are known to those skilled in the art.

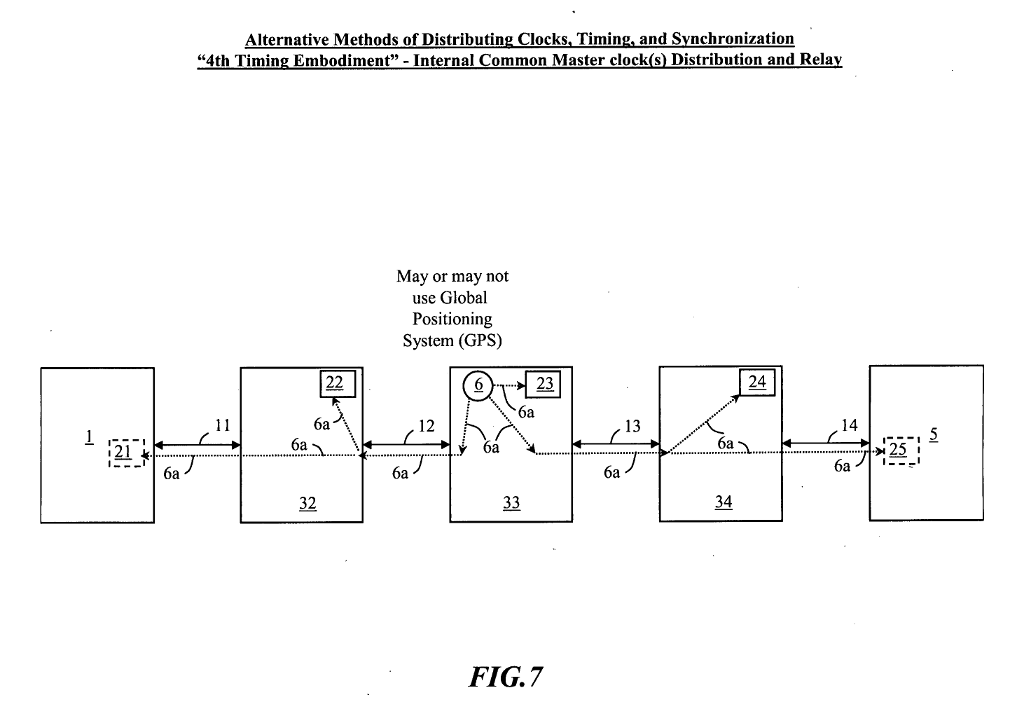

FIG. 7 is a simplified illustrative example showing an alternative “fourth timing embodiment” for distributing clocks, timing, and synchronization to time-scheduled and/or time-reserved datagram/packet networks. In this “fourth timing embodiment”, one or more master clock(s) 6 supplies master clock, timing, and synchronization signal(s) 6a to time-scheduled and/or time-reserved datagram/packet clock receiver/synchronization means 23. Clock receiver/synchronization means 23 may then relay the master clock synchronization signal(s) 6a either in-band or out-of-band to other clock receiver/synchronization means 22 and/or 24, in the network. Master clock synchronization signal(s) 6a may also optionally be relayed either in-band or out-of-band to end-user clock receiver/synchronization means 21 and/or 25 attached to real-time or high-priority source 1 and real-time or high-priority receiver 5. In this “fourth timing embodiment” for the distribution and relay of master clock(s), timing and synchronization signals 6a, the Global Positioning System (GPS) is not used. Alternatively, or in addition, clock receiver/synchronization means 21, 22, 23, 24, and/or 25 may use other methods such as two-way timestamp transfer to synchronize their clocks to specific times or absolute times and measure propagation delay between nodes. Any similar methods to establish and relay master clock timing and synchronization signal(s) 6a may be used, both in-band and out-of-band, as are known to those skilled in the art.

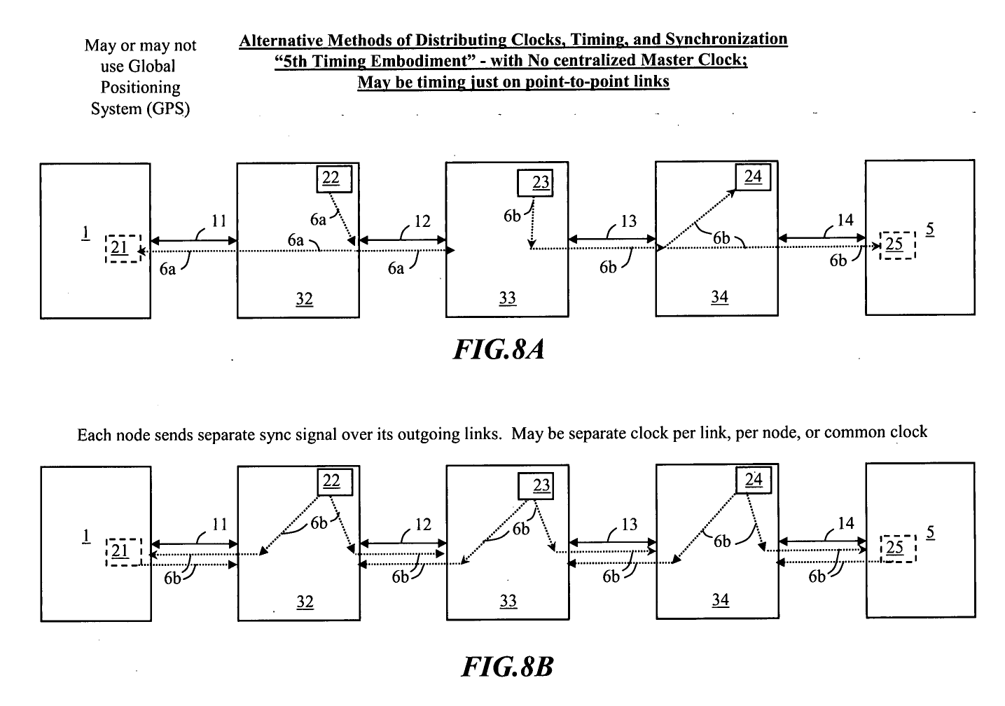

FIG. 8A and FIG. 8B are functional diagrams of the network system showing Alternative Methods of Distributing Clocks, Timing, and Synchronization with a fifth Timing Embodiment using No centralized Master Clock. Note that there is no clock synchronization through node 33 to illustrate that multiple clocks may be used in this timing embodiment of the network. This approach may use separate timing and synchronization on point-to-point or multipoint links, and may or may not use Global Positioning system signals. Various clocks may be in-band and/or out-of-band. FIG. 8A and FIG. 8B may be mobile ad-hoc networks.

FIG. 8 is a simplified illustrative example showing an alternative “fifth timing embodiment” for distributing clocks, timing, and synchronization to time-scheduled and/or time-reserved datagram/packet networks. In this “fifth timing embodiment”, no master clock 6 or GPS system is used. Instead, each clock synchronization means 21, 22, 23, 24, and/or 25 uses its own internal clock as its own reference time. Then, using various methods described elsewhere, the systems can enforce time-reservation-scheduling of packets. In this case, it does not matter that the clocks are not set accurately to a universal time standard. Any similar methods to establish and relay master clock timing and synchronization signal(s) 6a may be used, both in-band and out-of-band, as are known to those skilled in the art.

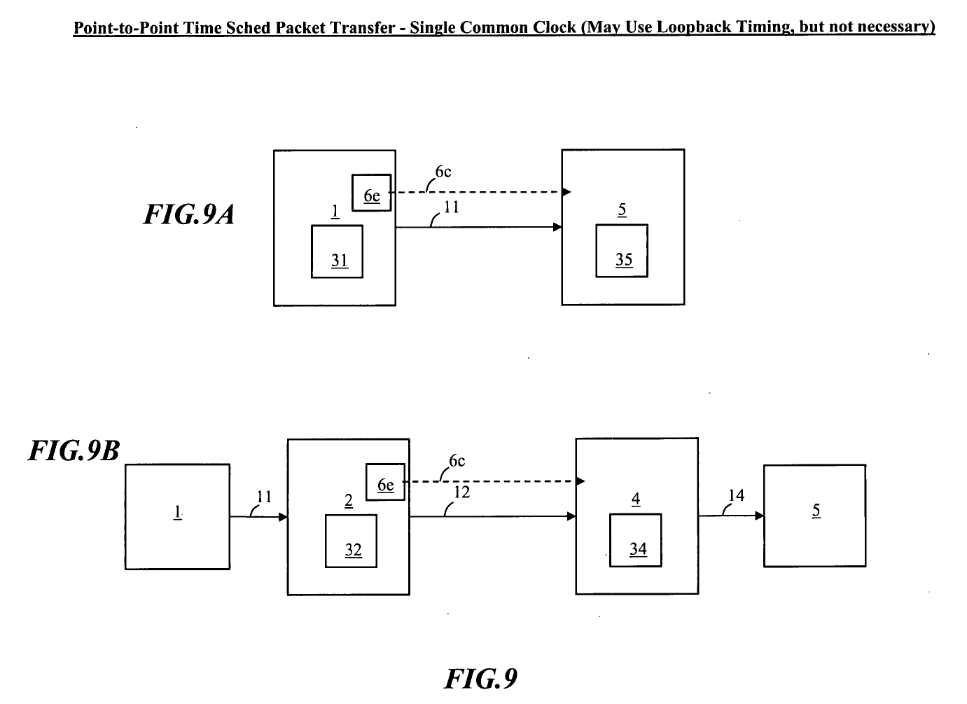

FIG. 9A and FIG. 9B illustrate the capability for Point-to-Point Time Scheduled Packet Transfer using a Single Common Clock (May Use Loopback Timing, but not necessary).

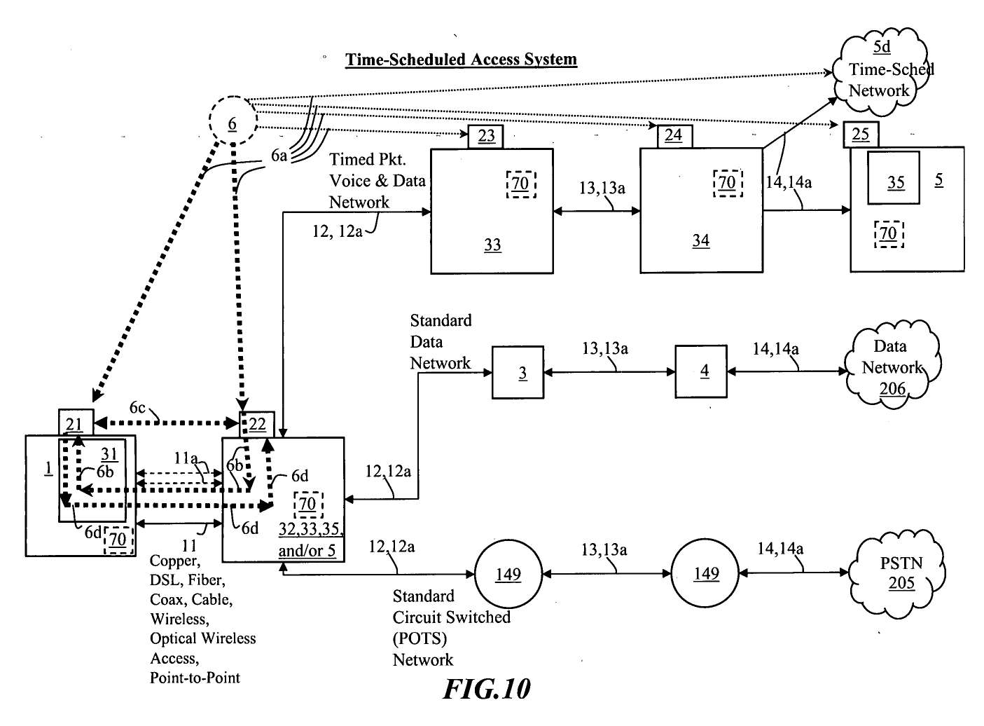

FIG. 10 illustrates the architecture and timing for a Time-Scheduled Access System, such as accessing a network over copper, DSL, Fiber, Coax, Cable, Wireless, Optical Wireless, etc.

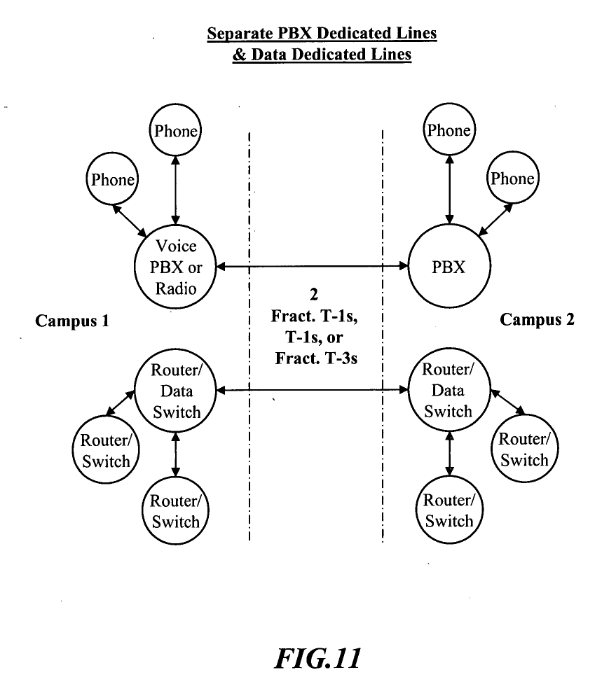

FIG. 11 illustrates the architecture of separate data and voice networks interconnecting 2 campuses with Separate PBX Dedicated Lines & Data Dedicated Lines.

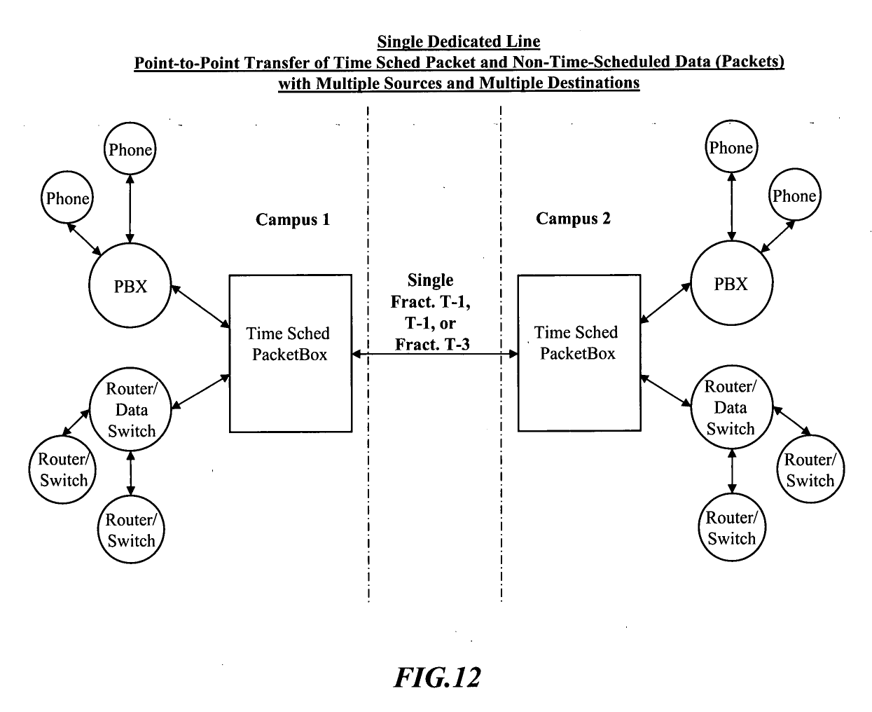

FIG. 12 illustrates the architecture of Single Dedicated-Line Point-to-Point Transfer of Time Scheduled Packet and Non-Time-Scheduled Data (Packets) with Multiple Sources and Multiple Destinations.

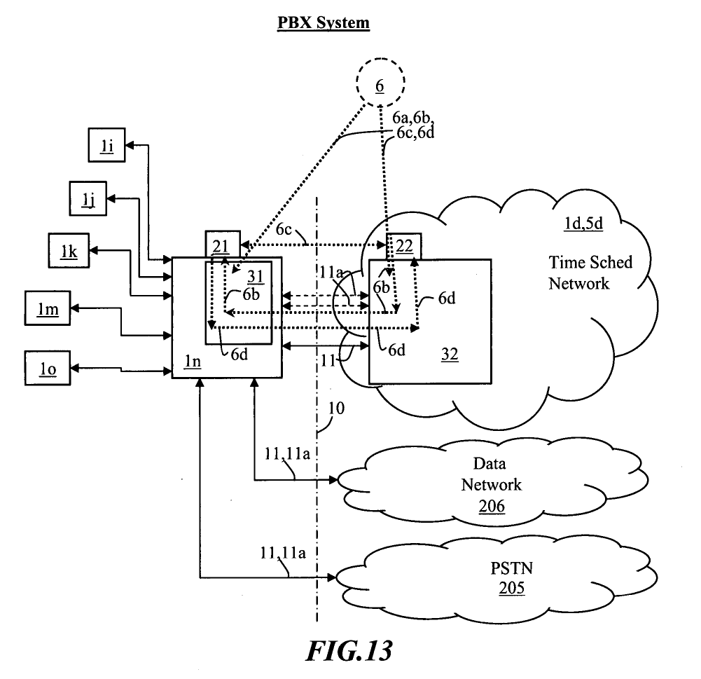

FIG. 13 illustrates the architecture and timing of a PBX system using time-scheduled packet switching and timing.

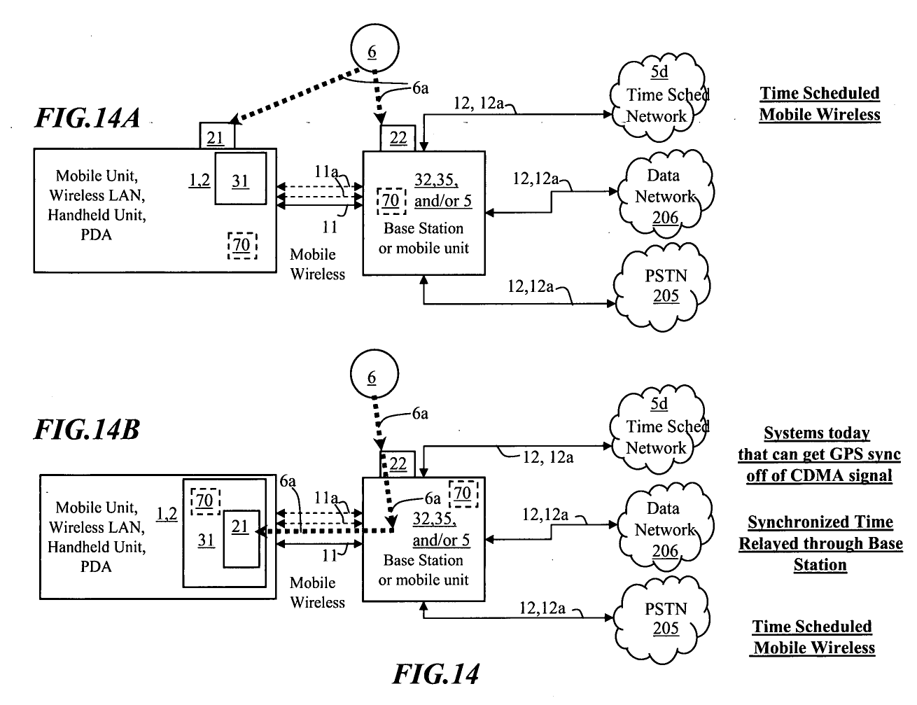

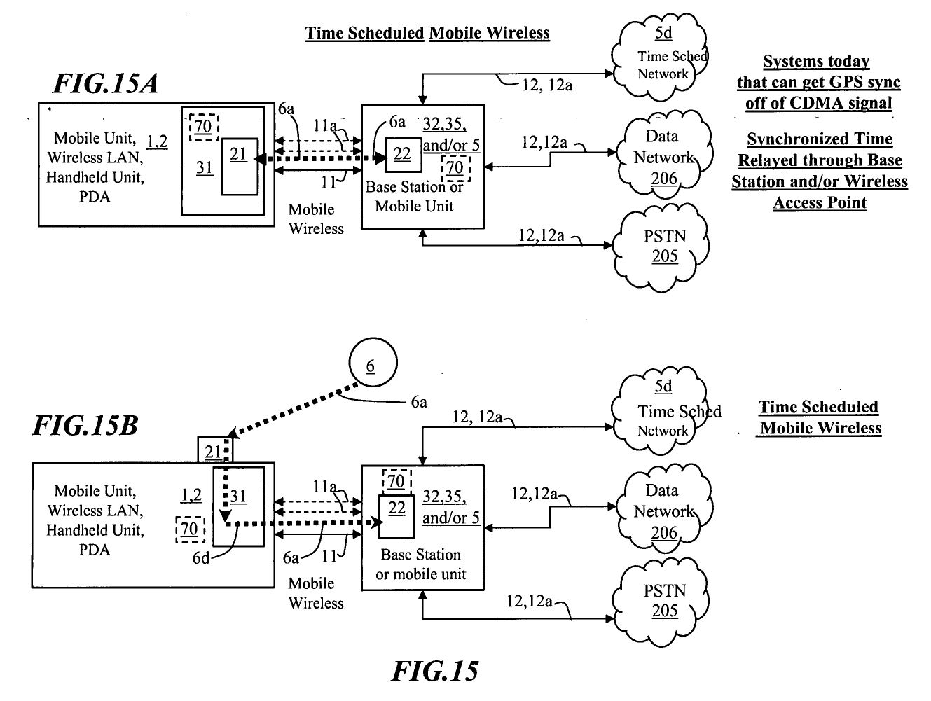

FIG. 14A and FIG. 14B illustrate various timing architectures for time-scheduled packet switching from a mobile wireless station to a base station or mobile unit.

FIG. 15A and FIG. 15B illustrate alternative timing architectures for time-scheduled packet switching from a mobile wireless station to a base station or mobile unit.

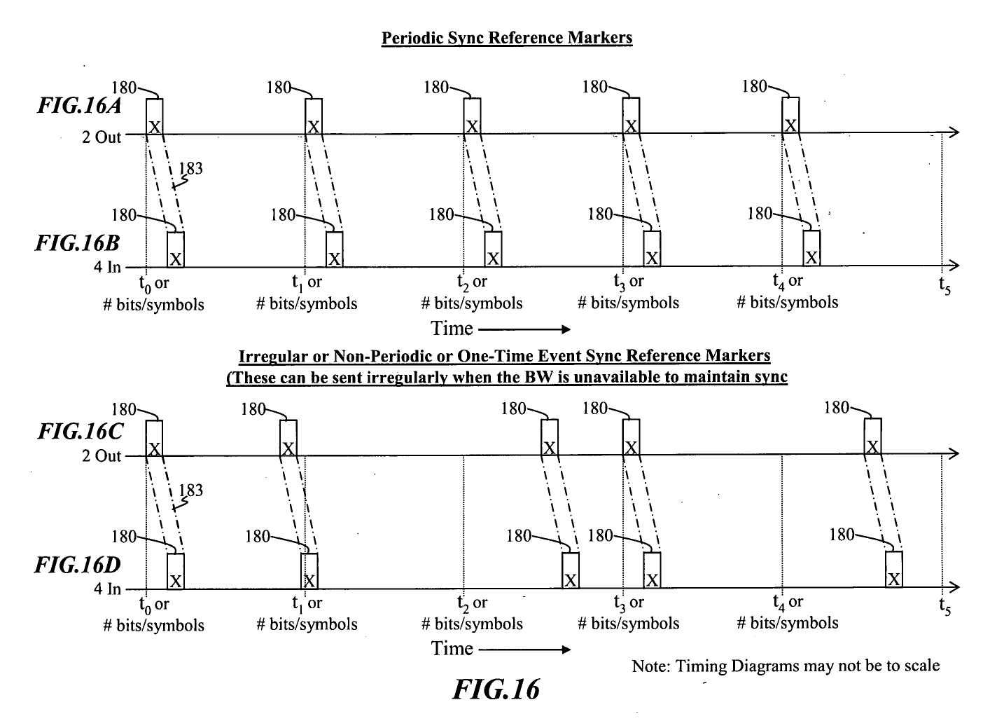

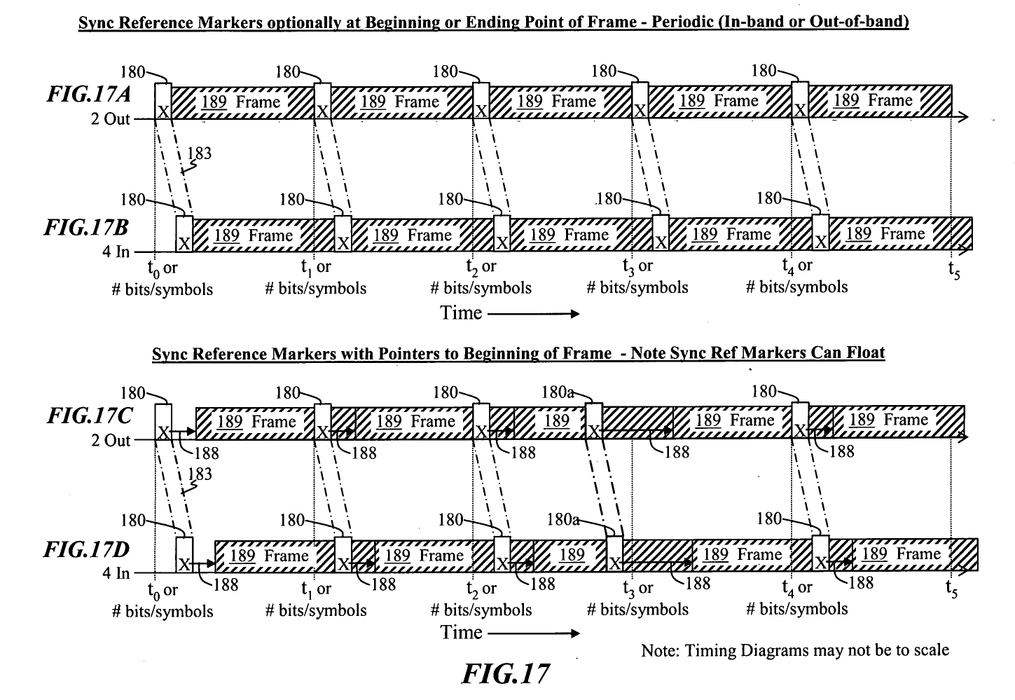

FIG. 16A, FIG. 16B, FIG. 16C, and FIG. 16D show various methods of relative timing at source and destination using periodic sync reference markers and/or Irregular or Non-Periodic or One-Time Event Sync Reference Markers (These can be sent irregularly when the BW is unavailable to continuously maintain sync).

FIG. 17A, FIG. 17B, FIG. 17C, and FIG. 17D show various methods of relative timing at source and destination with Sync Reference Markers optionally at Beginning or Ending Point of Frame—Periodic (In-band or Out-of-band) and/or Sync Reference Markers with Pointers to Beginning of Frame—Note Sync Ref Markers Can Float.

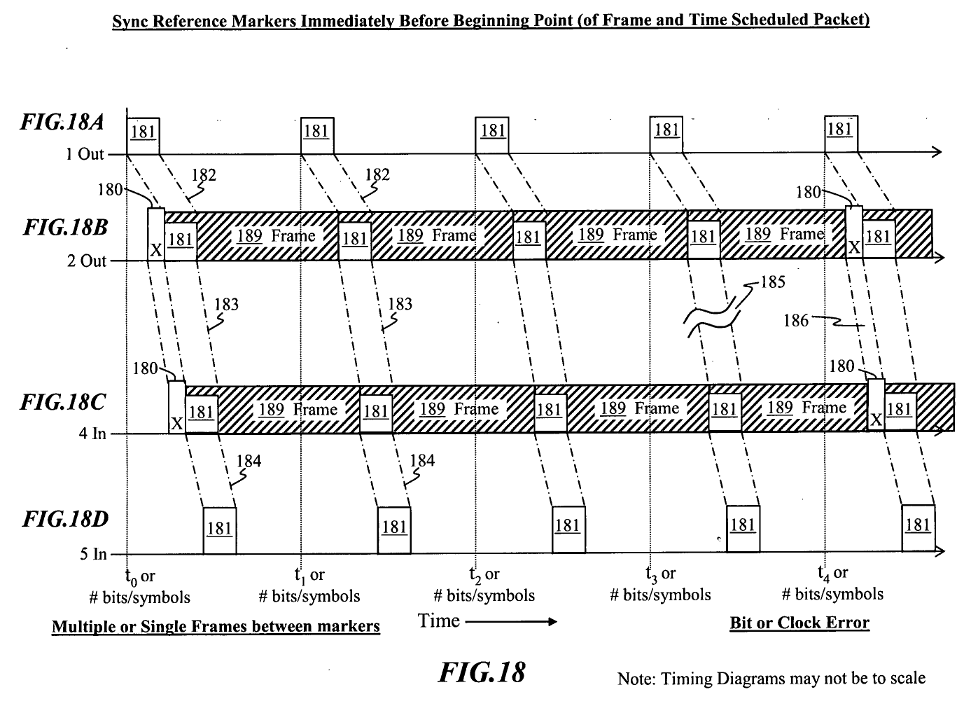

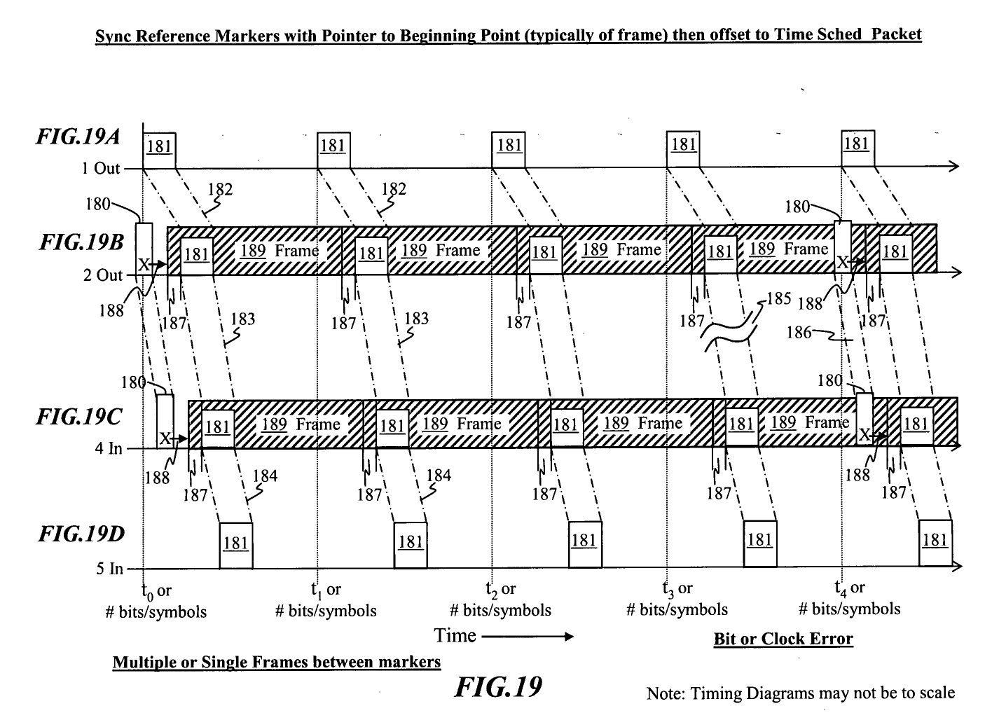

FIG. 18A, FIG. 18B, FIG. 18C, and FIG. 18D show various methods of relative timing from source 1 to destination 5 with Sync Reference Markers Immediately Before Beginning Point (of Frame and Time Scheduled Packet) and Multiple or Single Frames between markers.

FIG. 19A, FIG. 19B, FIG. 19C, and FIG. 19D show various methods of relative timing from source 1 to destination 5 with Sync Reference Markers using Pointer(s) to Beginning Point (typically of frame) and offset to Time Scheduled Packet, which may include Multiple or Single Frames between markers.

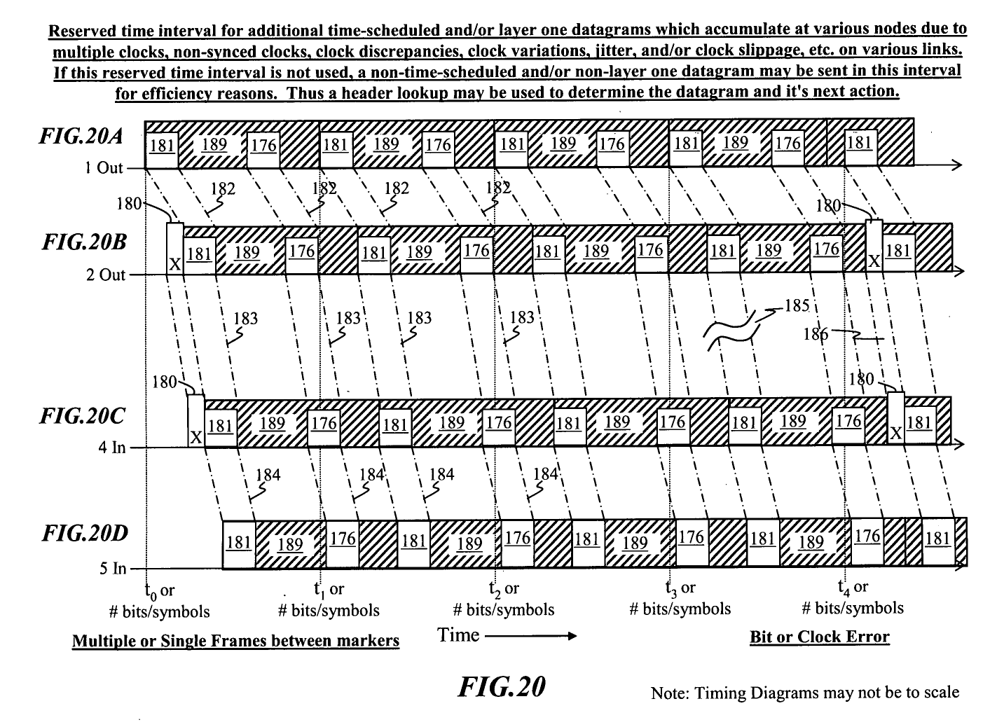

FIG. 20A, FIG. 20B, FIG. 20C, and FIG. 20D show various methods of relative timing from source 1 to destination 5 with special Reserved time intervals 176 for additional time-scheduled and/or layer one datagrams which accumulate at various nodes due to multiple clocks, non-synced clocks, clock discrepancies, clock variations, jitter, and/or clock slippage, etc. on various links. If this reserved time interval 176 is not used, a non-time-scheduled and/or non-layer one datagram may be sent in this interval 176 for efficiency reasons. Thus a header lookup may be used to determine the datagram and its next action.

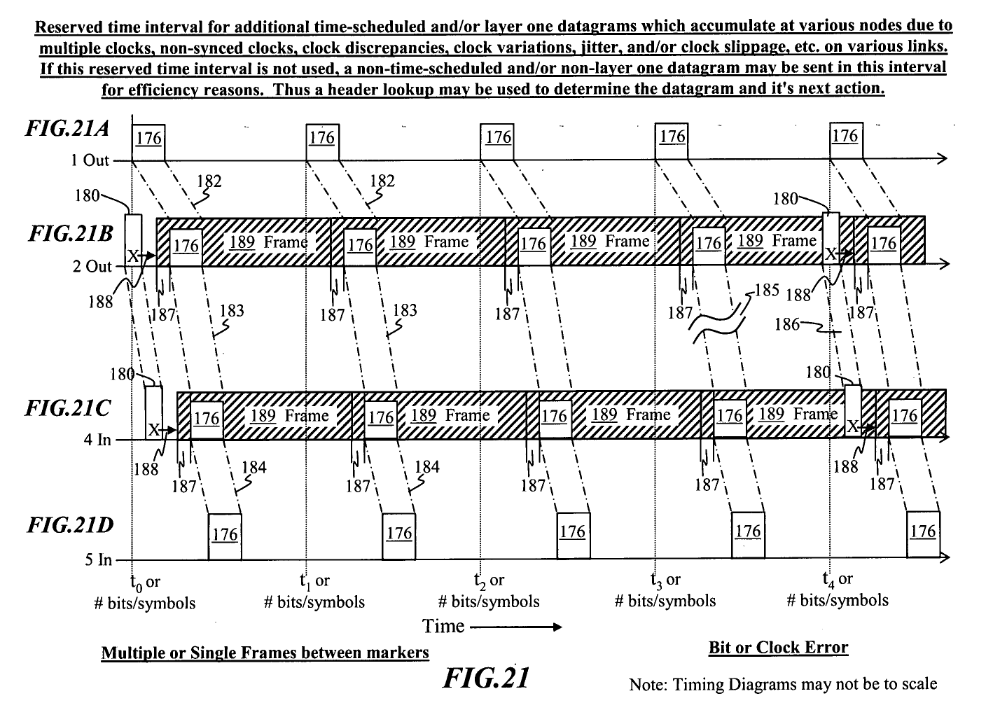

FIG. 21A, FIG. 21B, FIG. 21C, and FIG. 21D show various methods of relative timing from source 1 to destination 5 using pointer(s) 188 and/or offsets 187 to designate special Reserved time intervals 176 for additional time-scheduled and/or layer one datagrams which accumulate at various nodes due to multiple clocks, non-synced clocks, clock discrepancies, clock variations, jitter, and/or clock slippage, etc. on various links. If this reserved time interval 176 is not used, a non-time-scheduled and/or non-layer one datagram may be sent in this interval 176 for efficiency reasons. Thus a header lookup may be used to determine the datagram and its next action.

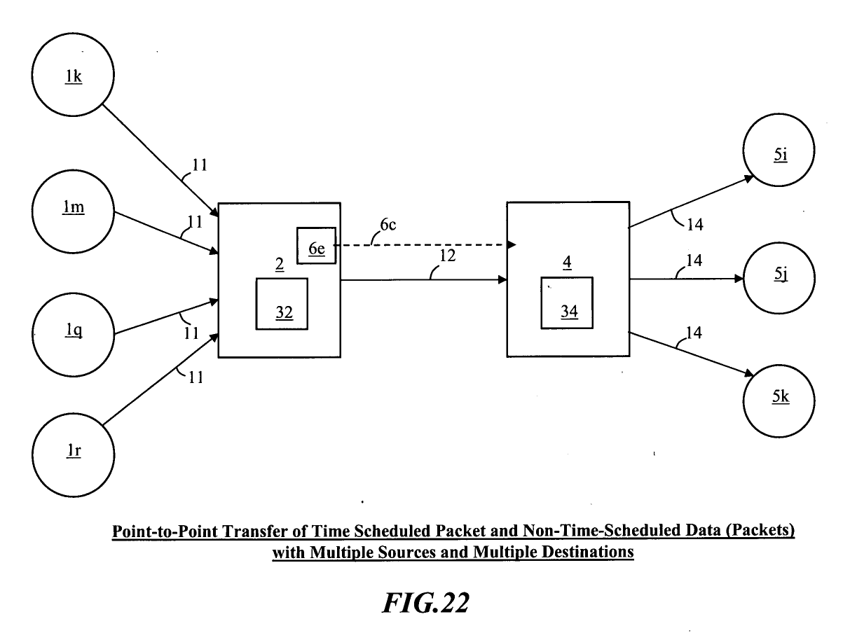

FIG. 22 illustrates a Point-to-Point clocking and Transfer of Time Scheduled Packets and Non-Time-Scheduled Data (standard Packets) with Multiple Sources and Multiple Destinations.

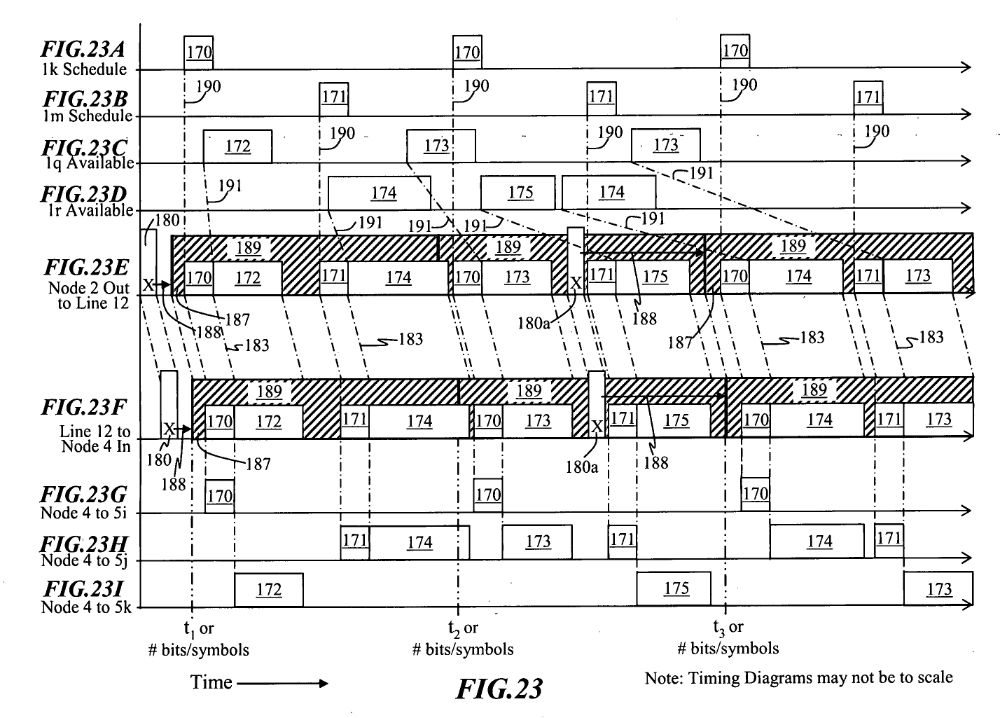

FIG. 23 (FIG. 23A through FIG. 23I) depicts a time-line example of the transfer of time-scheduled packets 170 and non-time-scheduled packets 172 from Source 1q to Destination 5k referring to the previous FIG. 22. Here it can be seen how time-scheduled packets 170 get delivered on time, while non-time-scheduled Standard Data Packets 172 may be delayed.

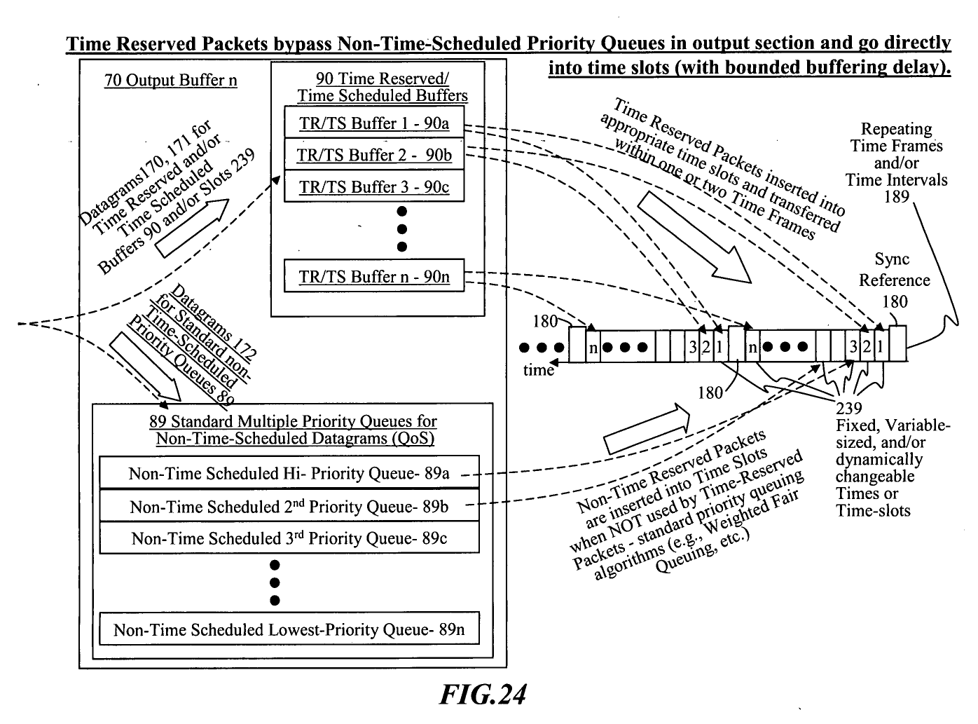

FIG. 24 illustrates the functional architecture and timing used to show how Time Reserved Packets 172 are scheduled for Time-reserved Buffers 90, thus bypassing Non-Time-Scheduled packets 170 in Standard Priority Queues 89 in output section 70. Thus Time-reserved packets go directly and immediately into time slots 239 with bounded buffering delay. Time Slot Buffers are generally higher priority than the highest priority non-time-scheduled priority queue (QoS), although this could be changed by design. Time-Slots may be established on a per session, per hop, per transaction, per call, per message, per priority level, and/or per flow basis. Time Slot buffers may be one or more packets deep, depending upon design.

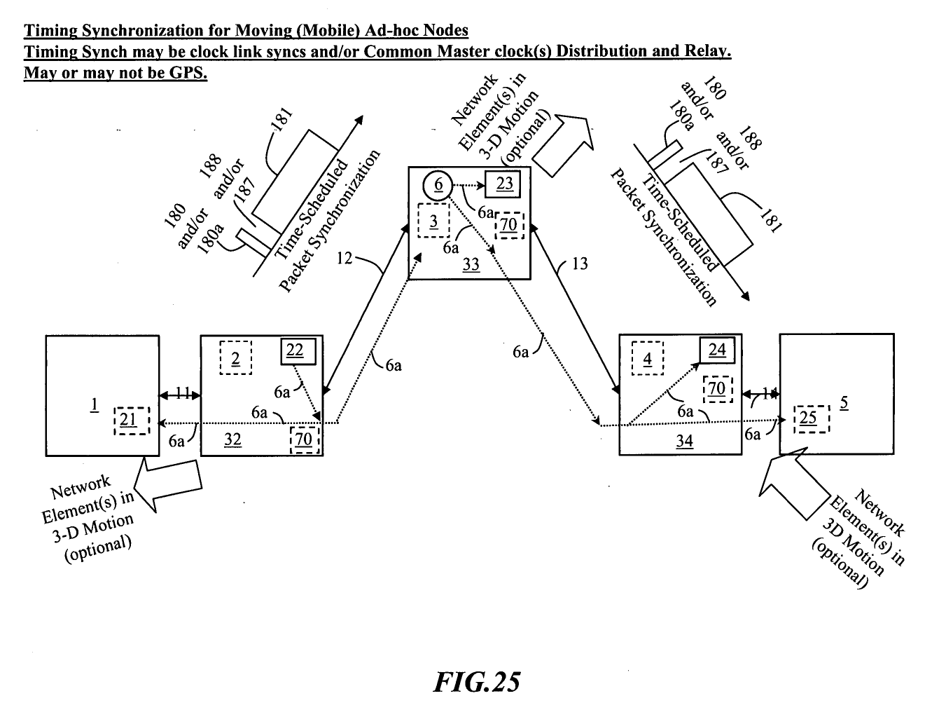

FIG. 25 illustrates architecture and Timing Synchronization for Moving (Mobile) Ad-hoc Nodes. Timing Synch may be clock link syncs and/or Common Master clock(s) Distribution and Relay, and may or may not be GPS.

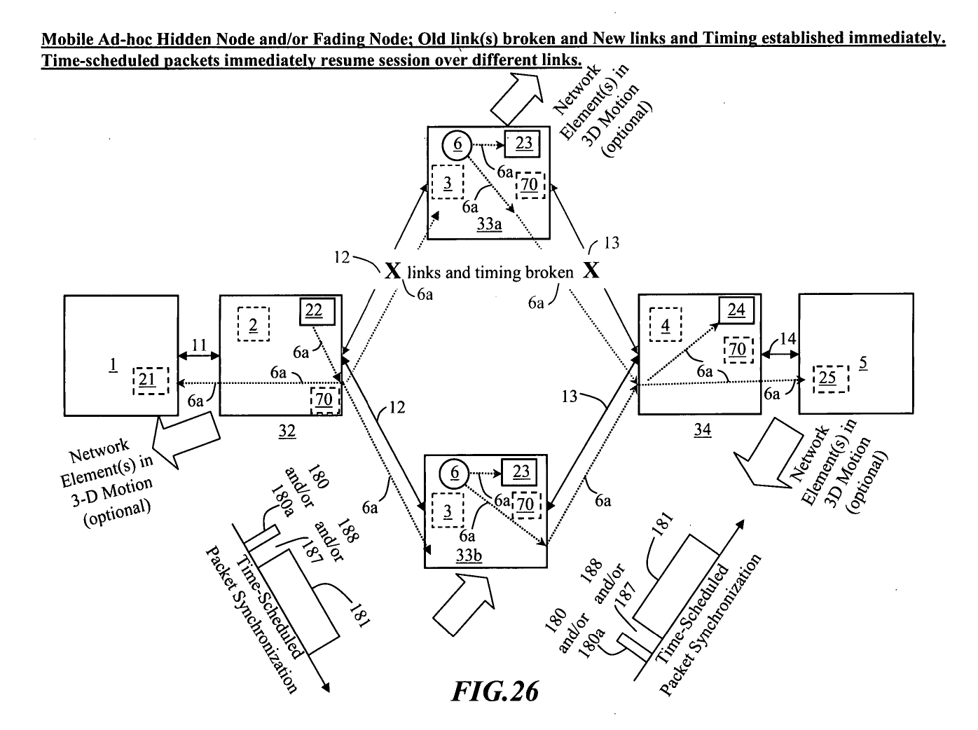

FIG. 26 illustrates methods for Mobile Ad-hoc Hidden Nodes and/or Fading Nodes. Here the old link(s) have been broken at the X, and new links and timing are established immediately. Thus, Time-scheduled packets immediately resume the session over different links.

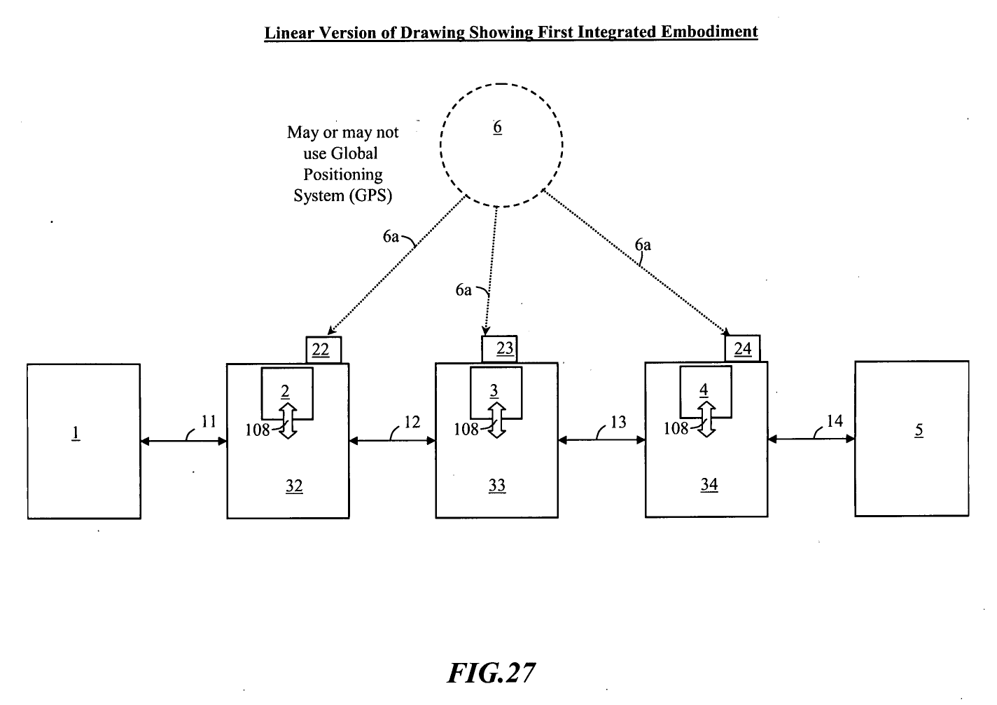

FIG. 27 is an illustrative example of the time-scheduled and/or time-reserved datagram/packet network showing a first “integrated” embodiment of the network element devices as deployed in the network, wherein the device embodiments integrate the packet, cell, or frame data routers/switches 2, 3, and 4 within the time-scheduled and/or time-reserved datagram/packet bypass switching systems 32, 33, and 34 respectively. In this “integrated” embodiment, the time-scheduled and/or time-reserved datagram/packet controller in each device 32, 33, and 34 is the primary controller of the entire device. Consequently, it can control the integrated standard packet, cell, or frame switches 2, 3, and 4 through control lines 108. In this way, the time-scheduled and/or time-reserved datagram/packet bypass switching systems 32, 33, and 34 can delay, stop, or start the standard non-real-time, non-high-priority data packets, cells, or frames in the input and output buffers and in the packet, cell, or frame switches 2, 3, or 4 respectively, for the purposes of scheduling and switching time-scheduled and/or time-reserved datagram/packet real-time or high-priority packets. This integrated embodiment means that standard non-time-scheduled and/or time-reserved datagram/packet packets which are routed through packet, cell, or frame switches 2, 3, or 4 are not lost due to time-scheduled and/or time-reserved datagram/packet timing considerations, although they may be delayed.

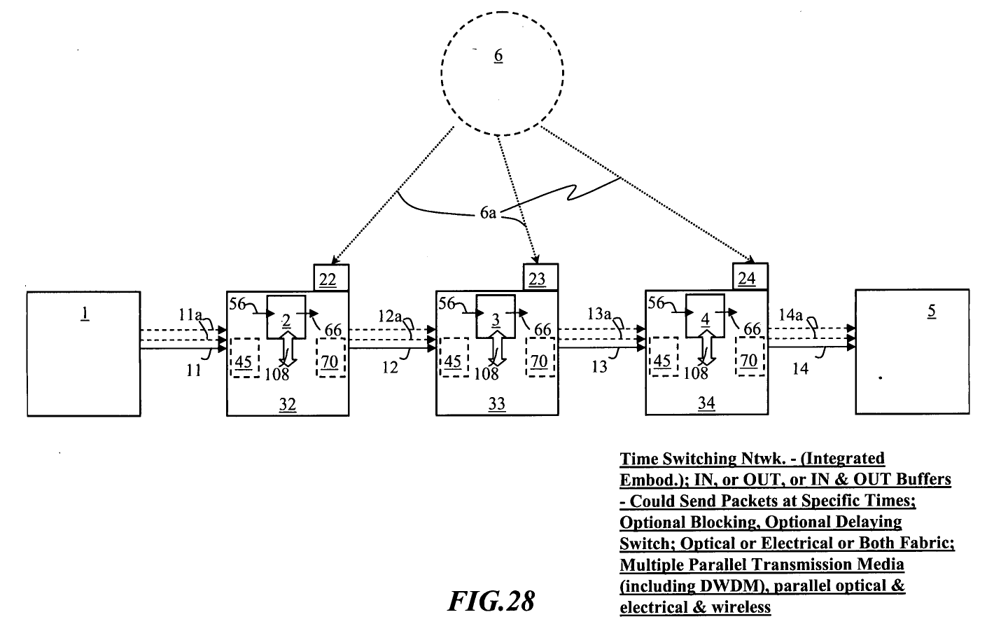

FIG. 28 shows improvements to the “integrated” embodiment according to the present invention. These improvements comprise various transmission media, parallel transmission media, categories of switching, device types, device input types, device buffers.

In FIG. 28, parallel transmission/communications paths 11a, 12a, 13a, and 14a have been deployed between network elements 1, 32, 33, 34, and 5 respectively. These parallel transmission paths 11a, 12a, 13a, and 14a can comprise any parallel transmission media, including but not limited to electrical (such as copper, coax, cable etc.), wireless (e.g., fixed, mobile, etc.), optical (i.e., fiber or freespace, etc.), and/or any combination of these transmission media in parallel. These parallel transmission paths may also comprise different frequencies carrying different parallel information signals on single transmission media, such as with frequency division multiplexing on the same wireline or wireless media, or parallel optical wavelengths on the same fiber such as with dense wave division multiplexing.

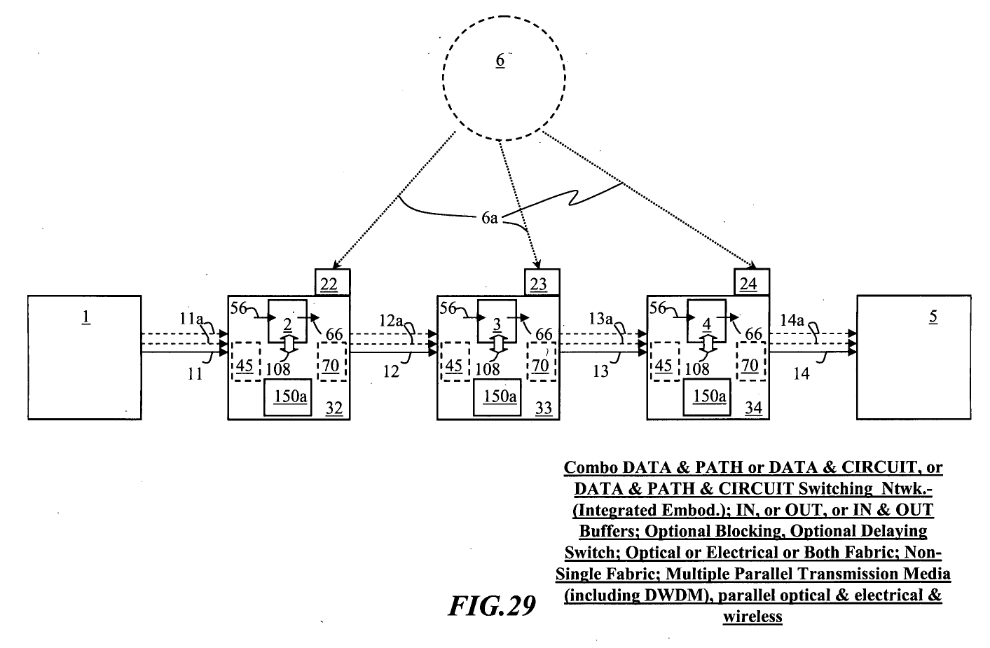

FIG. 29 is a detailed high-level functional block diagram of a linear illustration of the network showing the combination and/or hybrid integrated device embodiment of the timed packet switching device. This hybrid device may or may not include input buffers, output buffers, and/or input and output buffers, and may or may not comprise data switching, path switching, and/or circuit switching. It may send time-scheduled packets at specific and/or particular scheduled times. It may send non-time scheduled packets at non-scheduled times or at scheduled-times when a time-scheduled packet is not available. These devices may comprise a single optional Blocking and/or optional Delaying Switch fabric; Optical or Electrical and/or opto-electrical switch fabric, and/or other single switch fabric; Multiple Parallel Transmission Media (including DWDM), and/or parallel optical, electrical, and/or wireless media. This device embodiment may use any of the clock synchronization and/or timing embodiments, and may or may not use the global positioning system.

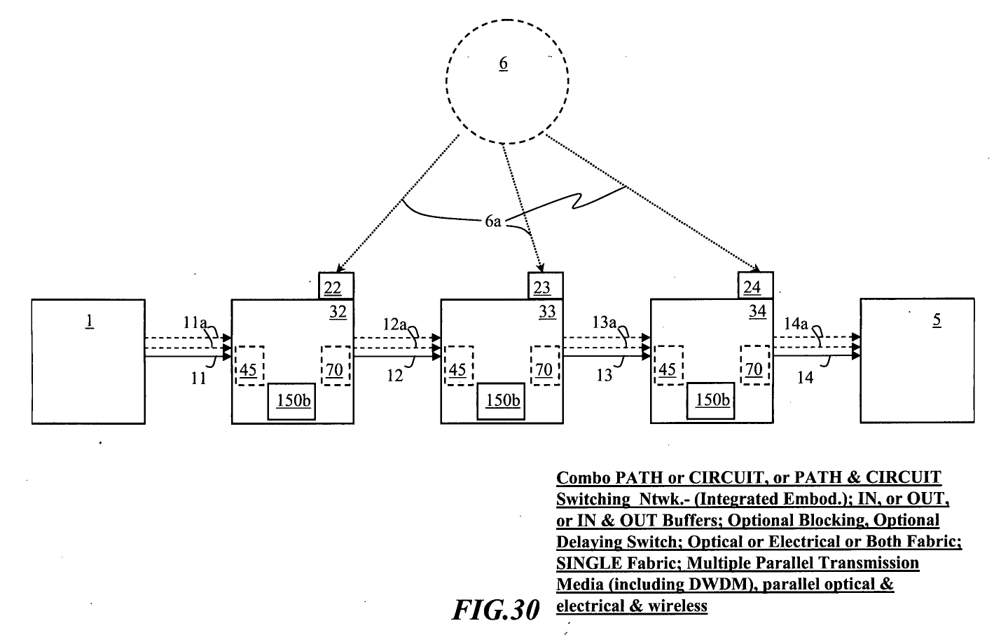

FIG. 30 illustrates a combination Path, or Circuit, or Path and Circuit switching network using the Integrated Embodiment of the network elements.

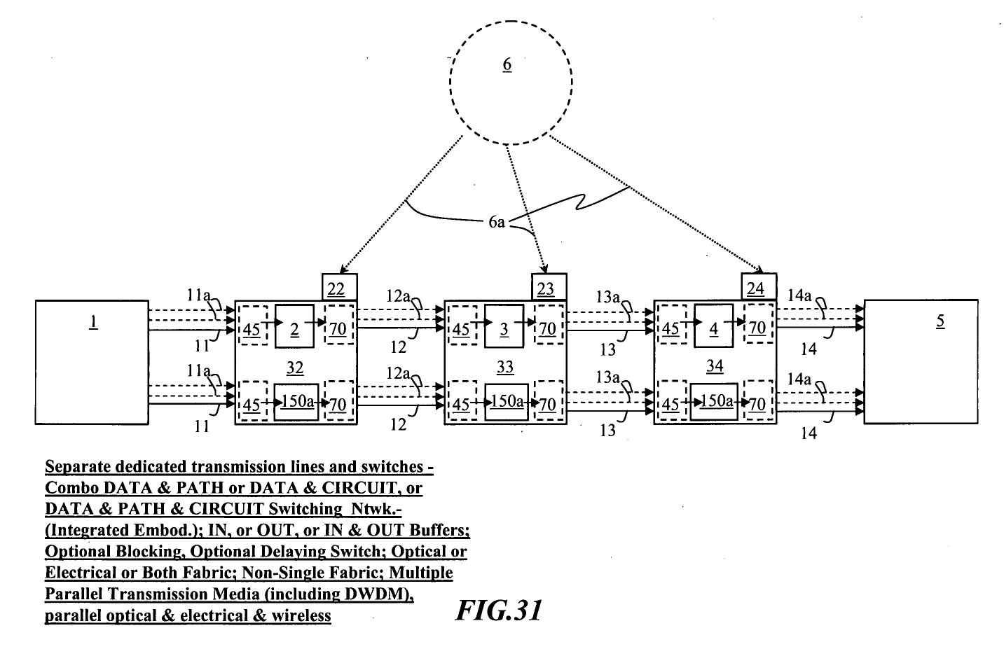

FIG. 31 is a detailed high-level functional block diagram of a linear illustration of the network showing separate dedicated transmission lines for the combination and/or hybrid integrated device embodiment of the timed packet switching device. This hybrid device may or may not include input buffers, output buffers, and/or input and output buffers, and may or may not comprise data switching, path switching, and/or circuit switching. It may send time-scheduled packets at specific and/or particular scheduled times. It may send non-time scheduled packets at non-scheduled times or at scheduled-times when a time-scheduled packet is not available. These devices may comprise one or more optional Blocking and/or optional Delaying Switch fabrics; Optical or Electrical and/or opto-electrical switch fabrics, and/or other switch fabrics; Multiple Parallel Transmission Media (including DWDM), and/or parallel optical, electrical, and/or wireless media. This device embodiment may use any of the clock synchronization and/or timing embodiments, and may or may not use the global positioning system.

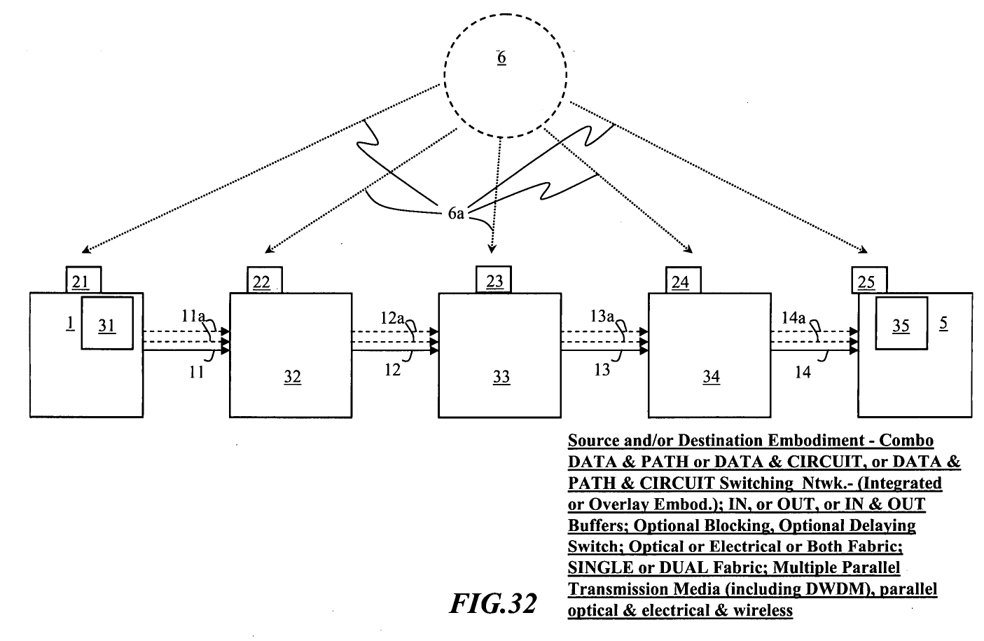

FIG. 32 is a detailed high-level functional block diagram of the network, wherein the fifth device embodiment, that of the source and/or destination device embodiment is shown operating as the source and/or destination in the network. This network and device combines data switching with path switching, data switching with circuit switching, and/or data switching with patch switching and circuit switching. It may send time-scheduled packets at specific and/or particular scheduled times. It may send non-time scheduled packets at non-scheduled times or at scheduled-times when a time-scheduled packet is not available. These devices may comprise one or more optional Blocking and/or optional Delaying Switch fabrics; Optical or Electrical and/or opto-electrical switch fabrics, and/or other switch fabrics; Multiple Parallel Transmission Media (including DWDM), and/or parallel optical, electrical, and/or wireless media. This device embodiment may use any of the clock synchronization and/or timing embodiments, and may or may not use the global positioning system.

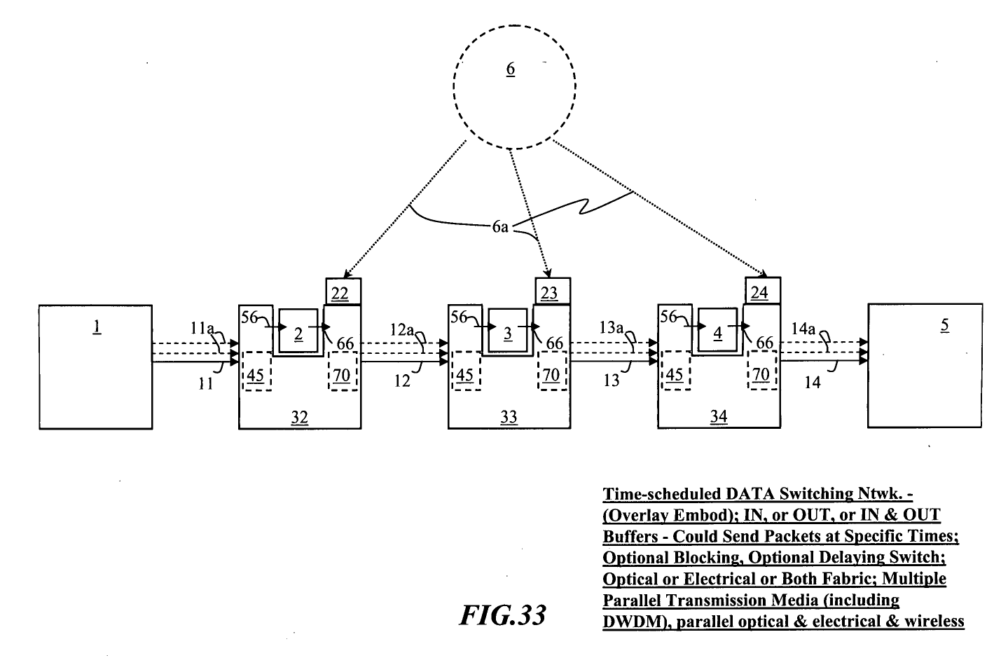

FIG. 33 is a detailed high-level functional block diagram of the network, wherein the second device embodiment, that of the overlay device embodiment, is shown operating as the network elements comprising a time-scheduled data switching network. This hybrid device may or may not include input buffers, output buffers, and/or input and output buffers, and may or may not comprise data switching, path switching, and/or circuit switching. It may send time-scheduled packets at specific and/or particular scheduled times. It may send non-time scheduled packets at non-scheduled times or at scheduled-times when a time-scheduled packet is not available. These devices may comprise one or more optional Blocking and/or optional Delaying Switch fabrics; Optical or Electrical and/or opto-electrical switch fabrics, and/or other switch fabrics; Multiple Parallel Transmission Media (including DWDM), and/or parallel optical, electrical, and/or wireless media. This device embodiment may use any of the clock synchronization and/or timing embodiments, and may or may not use the global positioning system.

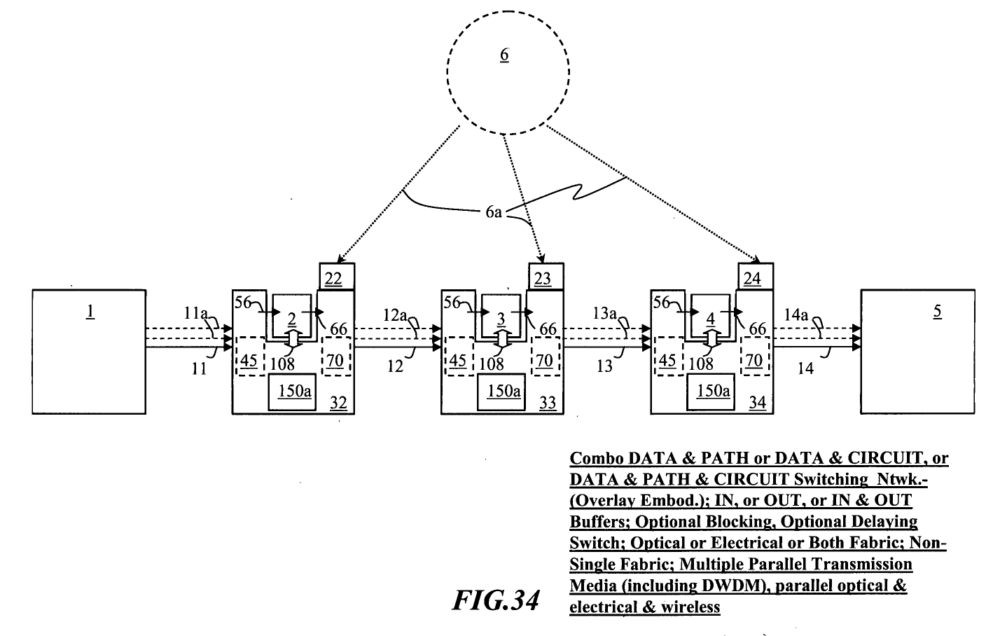

FIG. 34 is a detailed high-level functional block diagram of the network, wherein the second device embodiment, that of the overlay device embodiment, is shown operating as the network elements comprising a time-scheduled data switching network. This hybrid device may or may not include input buffers, output buffers, and/or input and output buffers, and may or may not comprise data switching, path switching, and/or circuit switching. It may send time-scheduled packets at specific and/or particular scheduled times. It may send non-time scheduled packets at non-scheduled times or at scheduled-times when a time-scheduled packet is not available. These devices may comprise one or more optional Blocking and/or optional Delaying Switch fabrics; Optical or Electrical and/or opto-electrical switch fabrics, and/or other switch fabrics; Multiple Parallel Transmission Media (including DWDM), and/or parallel optical, electrical, and/or wireless media. This device embodiment may use any of the clock synchronization and/or timing embodiments, and may or may not use the global positioning system.

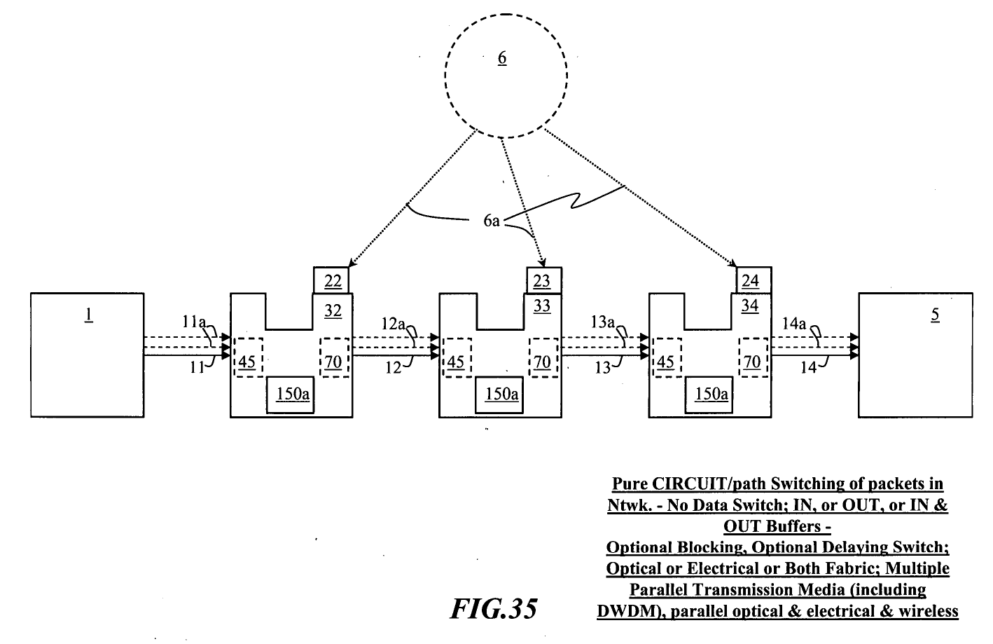

FIG. 35 is a detailed high-level functional block diagram of the network, wherein the pure circuit switching device embodiments are shown operating as the network elements comprising a time-scheduled data switching network. This non-hybrid device may or may not include input buffers, output buffers, and/or input and output buffers, and may comprise circuit switching. It may send time-scheduled packets at specific and/or particular scheduled times. These devices may comprise one or more optional Blocking and/or optional Delaying Switch fabrics; Optical or Electrical and/or opto-electrical switch fabrics, and/or other switch fabrics; Multiple Parallel Transmission Media (including DWDM), and/or parallel optical, electrical, and/or wireless media. This device embodiment may use any of the clock synchronization and/or timing embodiments, and may or may not use the global positioning system.

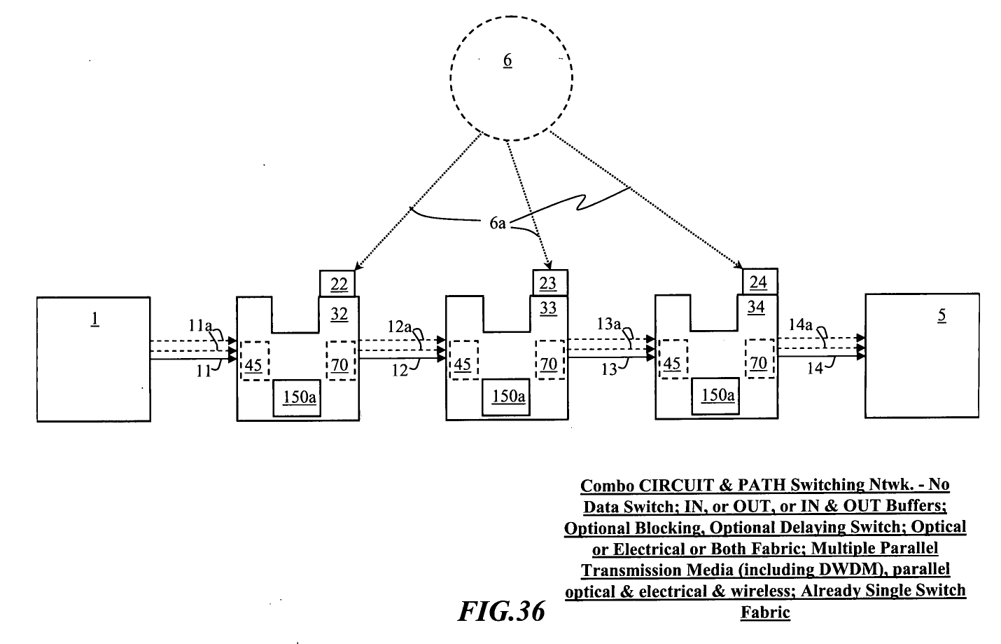

FIG. 36 is a detailed high-level functional block diagram of the network, wherein the hybrid circuit-switching and path switching device embodiments are shown operating as the network elements comprising a time-scheduled data switching network. This hybrid device may or may not include input buffers, output buffers, and/or input and output buffers, and may comprise path switching, and/or circuit switching. It may send time-scheduled packets at specific and/or particular scheduled times. These devices may comprise one or more optional Blocking and/or optional Delaying Switch fabrics; Optical or Electrical and/or opto-electrical switch fabrics, and/or other switch fabrics; Multiple Parallel Transmission Media (including DWDM), and/or parallel optical, electrical, and/or wireless media. This device embodiment may use any of the clock synchronization and/or timing embodiments, and may or may not use the global positioning system.

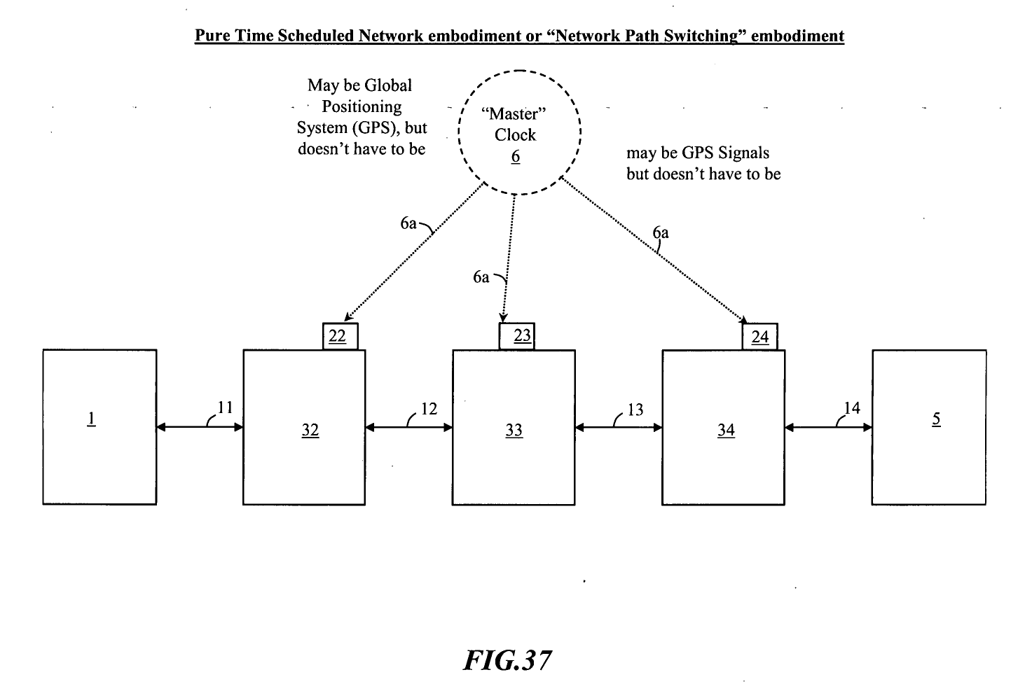

FIG. 37 is a simplified illustrative example showing the elements of a “pure time-scheduled and/or time-reserved datagram/packet” network embodiment, also termed the “path switching” embodiment or “network path switching” embodiment of the present invention. In this embodiment, the standard packet, cell, or frame routers or switches 2, 3, and 4 have been removed entirely, such that the network element “pure time-scheduled and/or time-reserved datagram/packet” embodiment device consists exclusively of the time-scheduled and/or time-reserved datagram/packet hardware and software 32, 33, and 34, together with synchronization means 22, 23, and 24. This means that the “network path switching” embodiment performs scheduled time-scheduled and/or time-reserved datagram/packet switching exclusively, such that standard data switching, i.e., packet, cell, or frame switching, store-and-forward switching, and/or layer two and higher switching do not take place in this embodiment of the present invention. In addition, for pure path switched, time-scheduled, and/or time-reserved datagram/packet switching, time-scheduled and/or time-reserved datagram/packet hardware and software 32, 33, and 34 would only use input and output buffers at the input edge nodes.

As a result, in FIG. 37, source 1 would request a scheduled time or times across the time-scheduled and/or time-reserved datagram/packet network. If the network elements accepted the request, they would schedule reserved times for the time-scheduled and/or time-reserved datagram/packet packets so that they would depart at precisely scheduled times from time-scheduled and/or time-reserved datagram/packet hardware and software 32; route through transmission lines 12 exactly according to the schedule; arrive at time-scheduled and/or time-reserved datagram/packet switch 33 precisely at the scheduled arrival time; route directly through time-scheduled and/or time-reserved datagram/packet switch 33 and out onto line 13 at precisely the correct time; then into time-scheduled and/or time-reserved datagram/packet switch 34 at the precise scheduled time; through time-scheduled and/or time-reserved datagram/packet switch 34 and out onto transmission line 14; thus arriving at destination 5 exactly according to schedule.

In this manner, source 1 transmits and switches its information directly across the network, on a predetermined, precisely scheduled “path”, with no buffering and no delays other than transmission line and time-scheduled and/or time-reserved datagram/packet switch propagation delays.

It is for this reason that this embodiment is called “Path Switching” or “Network Path Switching.” In essence, the network switches an entire path across the network in one continuous manner, as one simultaneous event. This is not the same as what is commonly called circuit switching, because circuit switching stores information briefly in an input buffer at each node, then switches the information through to the circuit switch's output buffer, then puts the information in the designated output slot, and repeats the buffering and switching at each node across the network. In “Network Path Switching”, on the other hand, the whole network acts as a single point-to-point switch for each path. Essentially, in path switching, the entire network is a single multinode switch.

In pure “Network Path Switching,” source 1 competes for network resources from other time-scheduled and/or time-reserved datagram/packet scheduled sessions, but only time-scheduled and/or time-reserved datagram/packet resources and switching are consumed. No standard data switching take place across this embodiment of the time-scheduled and/or time-reserved datagram/packet network. In FIG. 37, if there was a scheduling conflict at some point across the network, then the time-scheduled and/or time-reserved datagram/packet connection might have to be rescheduled.

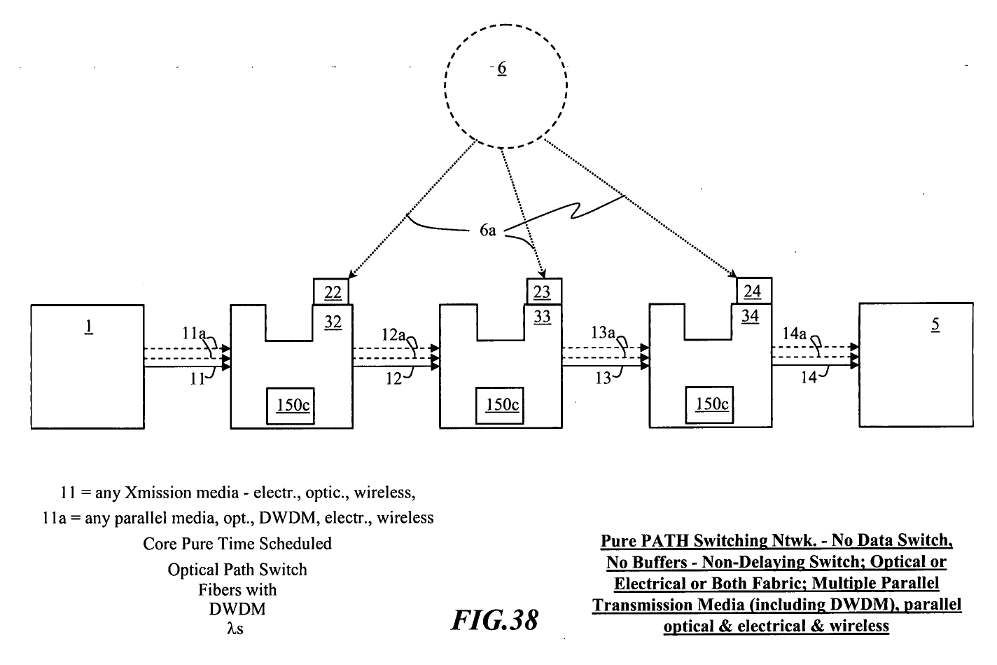

FIG. 38 shows improvements to the pure “path switching” network embodiment of FIG. 37. In FIG. 38, parallel transmission/communications paths 11a, 12a, 13a, and 14a have been deployed between network elements 1, 32, 33, 34, and 5 respectively. These parallel transmission paths 11a, 12a, 13a, and 14a can comprise any parallel transmission media, including but not limited to electrical (such as copper, coax, cable etc.), wireless (e.g., fixed, mobile, etc.), optical (i.e., fiber or freespace, etc.), and/or any combination of these transmission media in parallel. These parallel transmission paths may also comprise different frequencies carrying different parallel information signals on single transmission media, such as with frequency division multiplexing on the same wireline or wireless media, or parallel optical wavelengths on the same fiber such as with dense wave division multiplexing.

When these parallel transmission media, as illustrated in FIG. 38, are used with pure network path switching, the probability of time-scheduled and/or time-reserved datagram/packet scheduling conflicts is drastically reduced. For example, if the first transmission line was 10% scheduled, the next time-scheduled and/or time-reserved datagram/packet packet would have roughly only a 10% probability of having a conflict and being bumped to the second parallel line. A third packet would have roughly a 10% probability of a conflict on the first line and roughly a 1% probability of a scheduling conflict on the second line. Today, with over 100 wavelengths or lambdas on a single fiber, if the utilization of the first lambda was 10%, then the probability of a conflict over 100 parallel lambdas would be roughly 0.1 to the 100^{th} power, an extremely low probability of scheduling conflict. Thus parallel transmission paths are an extremely powerful tool in implementing pure path switching.

FIG. 38 also includes improvements to the time-scheduled and/or time-reserved datagram/packet switching fabric 150c of the devices in a pure time-scheduled and/or time-reserved datagram/packet network embodiment. First, although a non-blocking, non-delaying switching fabric is preferred for time-scheduled and/or time-reserved datagram/packet switching, cost considerations and a demand for a large number of input and output ports might require the use of optionally blocking and/or optionally delaying switching fabric(s), so switching fabric 150c includes these options.

Second, in FIG. 38, the switching fabric 150c itself may be either optical, or electrical, or both, or some combination of optical and electrical, with the potential for opto-electrical conversion and electrical-optical conversion at various points in the device embodiments. An additional, optional characteristic of these time-scheduled and/or time-reserved datagram/packet switch fabrics such as fabric 150c, may also be that they have a constant propagation delay, such that the switch fabric latency from any input to any output, is the same or as close to the same as possible. This makes the switching propagation times more constant and stable.

In fact, as illustrated in FIG. 38, end-to-end pure optical switching is especially well-suited to time-scheduled and/or time-reserved datagram/packet networks and to network path switching. Unlike layer two and higher data switching which requires opto-electrical conversion to an electrical form for storage while looking up the layer two or higher layer data header, time-scheduled and/or time-reserved datagram/packet switching requires no storage or data lookup, hence it requires no opto-electrical conversion. In pure network path switching, the entire path is scheduled in advance with no possible contention or scheduling conflict. At the scheduled time(s), the controllers in each node along the path, switch their respective time-scheduled and/or time-reserved datagram/packet optical bypass switches so the light beam bounces directly through all the time-scheduled and/or time-reserved datagram/packet switches from one side of the network to the other. In this way, the photonic packets, cells, and frames can be switched and/or routed optically, by electrically controlled optical switch fabrics, the entire way through the time-scheduled and/or time-reserved datagram/packet network on a packet by packet basis. This is much more efficient and scalable than the current view of lambda routing or wavelength routing where an entire lambda is permanently dedicated from one point to another point in the network.

In addition to path switching being deployed for real-time or high-priority packets on a call by call basis using a call setup process (somewhat like a time-scheduled and/or time-reserved datagram/packet version of a switched virtual circuit), the whole network could be set up somewhat like time-scheduled and/or time-reserved datagram/packet versions of permanent virtual circuits, such that:
from various points in the network, previously scheduled times are established to transport layer two and/or higher layer information to other points in the network, through the network in a time-scheduled and/or time-reserved datagram/packet switched manner.
Times and intervals are set up in advance.
A master controller, or various individual controllers can vary the time schedules and end points depending upon the load, i.e., if there is heavy traffic from point A to point B across the network, that path gets more time-scheduled and/or time-reserved datagram/packet scheduled time.

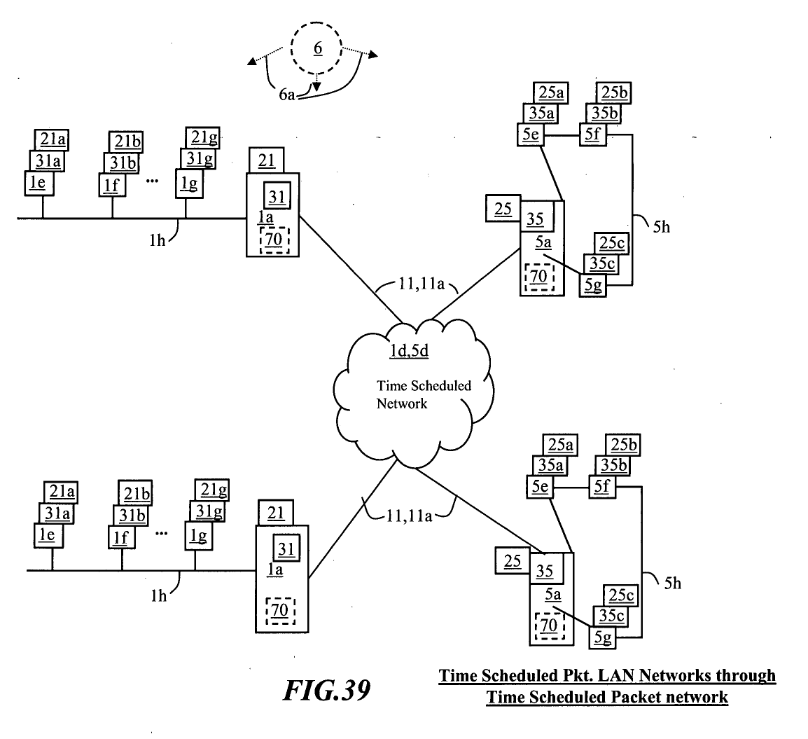

FIG. 39 is a detailed high-level functional block diagram of the network, wherein the sixth device embodiment, that of the Time Reservation Scheduled Local Area Network (LAN) device embodiments are shown as network elements, including bus and ring oriented LANs. These may or may not operate with common clocks.

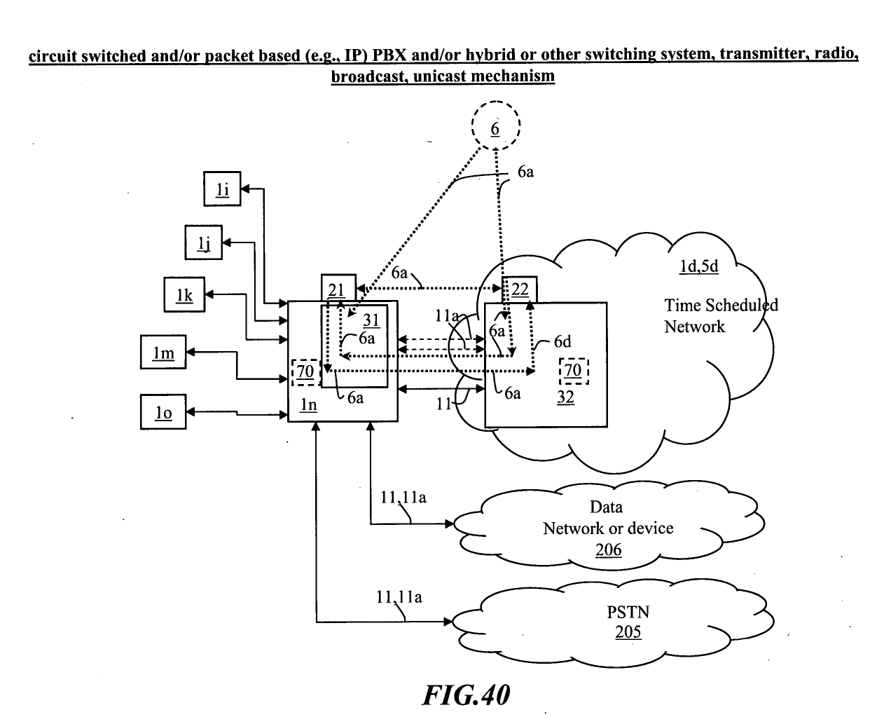

FIG. 40 illustrates the synchronization and timing of circuit switched and/or packet based (e.g., IP) PBX and/or hybrid switching systems, transmitters, radios, broadcasts, multicasts, and/or unicast mechanisms, along with the interconnection of time-scheduled systems with legacy systems.

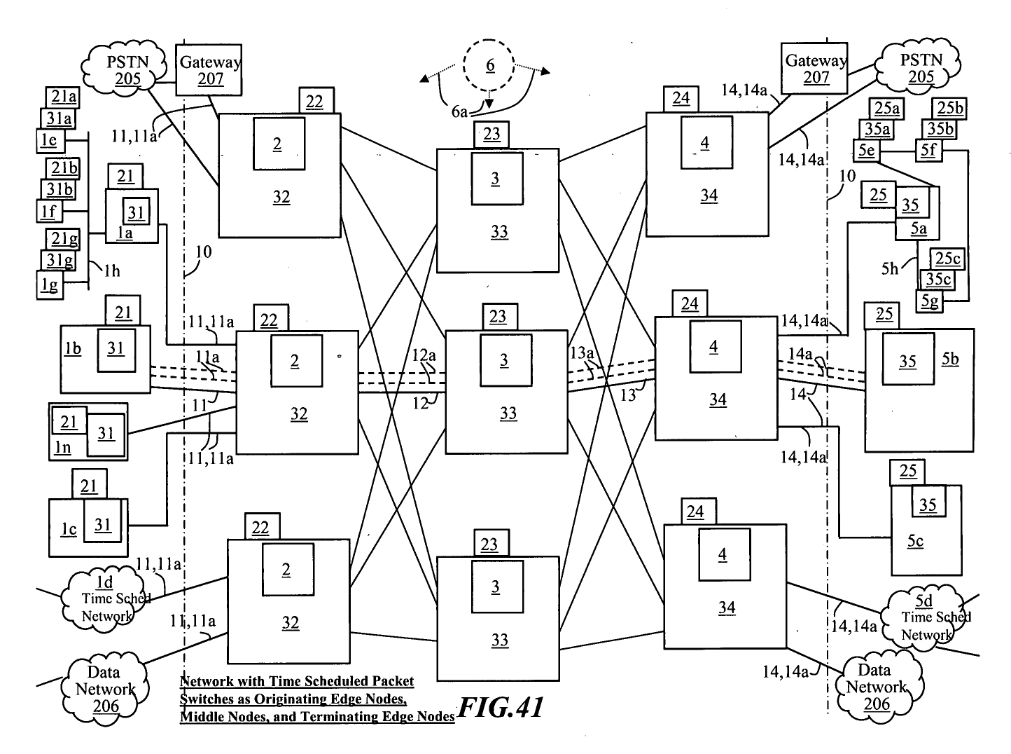

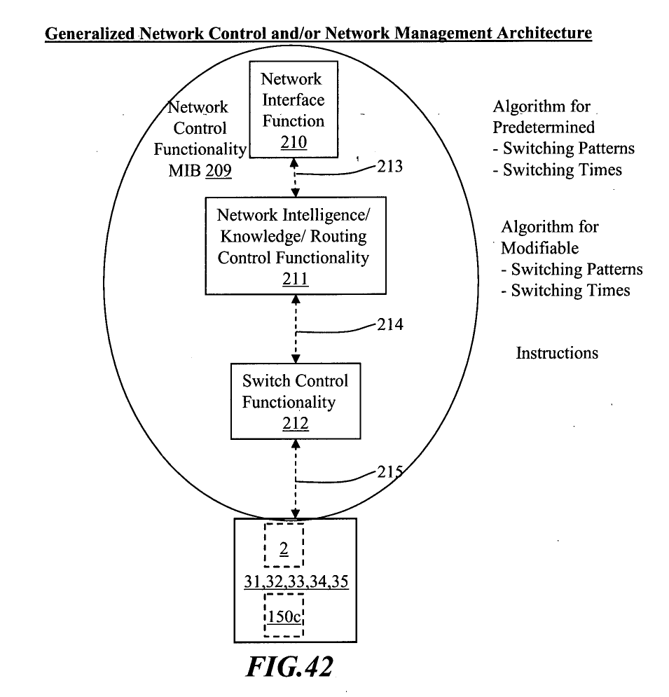

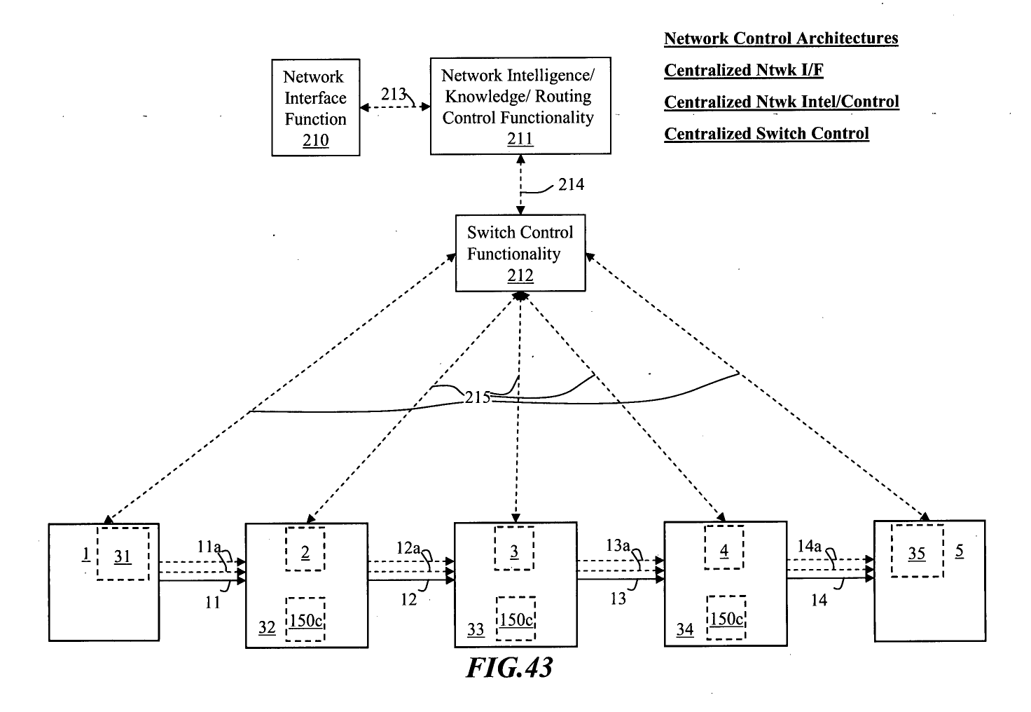

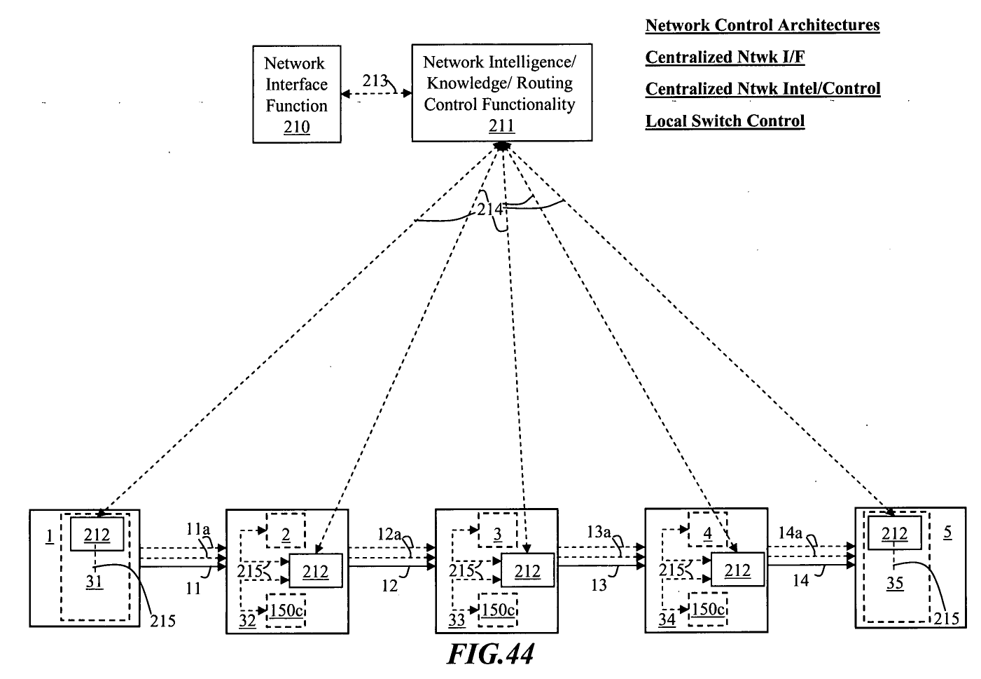

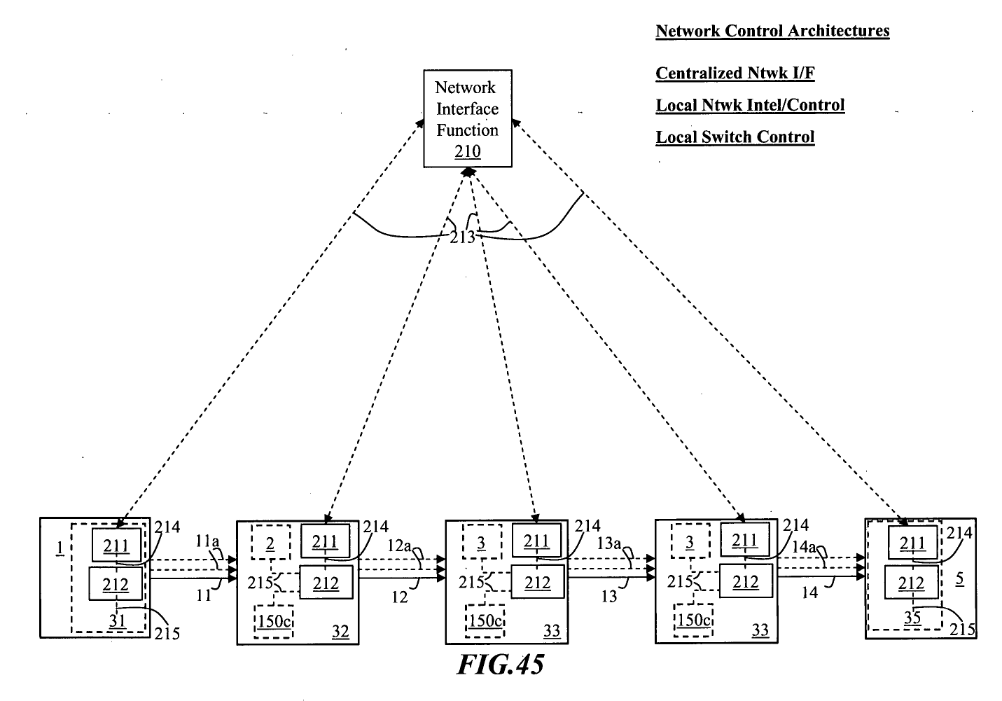

FIG. 41 is a more detailed high-level functional block diagram of a more complex network environment with the components of a time reservation scheduled datagram network system according to the present invention. FIG. 41 also shows two examples of the sixth device embodiment as time reservation scheduled Local Area Network or LAN systems.

FIG. 42 illustrates the Generalized Network Control and/or Network Management Architecture for Time-Scheduled Packet Switching, comprising the Internal or External Network Control, Network Management, Network Planning, and/or Billing Functionality, including MIBs (Management Information Bases). Network Control Functionality 209 comprises the capability to establish, coordinate, and maintain management of the network; which includes but is not limited to: Fault Management, Configuration Management, Addressing Management, Accounting, Tracking, Event Management, Network Event Management, Agent Management, Performance Management, Security Management, Policy Management, Quality of Service Management, Key Management (e.g. PKI—Public Key Infrastructure), Bandwidth Management, Dense Wavelength Division Multiplexing Management, Frequency Management, Bandwidth Management, and/or Spectrum Management. Any or all of these may be external and/or internal to the network elements.

FIG. 43 illustrates the Generalized Network Control and/or Network Management Architecture 209 for Time-Scheduled Packet Switching, with the Switch, Device, and/or Network Element Control Functionality 212 exterior to the network elements.

FIG. 44 illustrates the Generalized Network Control and/or Network Management Architecture 209 for Time-Scheduled Packet Switching, with the Switch, Device, and/or Network Element Control Functionality 212 moved into the network elements and the Network Intelligence/Knowledge/Routing control functionality 211 exterior to the network elements.

FIG. 45 illustrates the Generalized Network Control and/or Network Management Architecture 209 for Time-Scheduled Packet Switching, with the Switch, Device, and/or Network Element Control Functionality 212 and the Network Intelligence/Knowledge/Routing control functionality 211 moved into the network elements (local) and the network interface functionality 210 located exterior to the network elements (global).

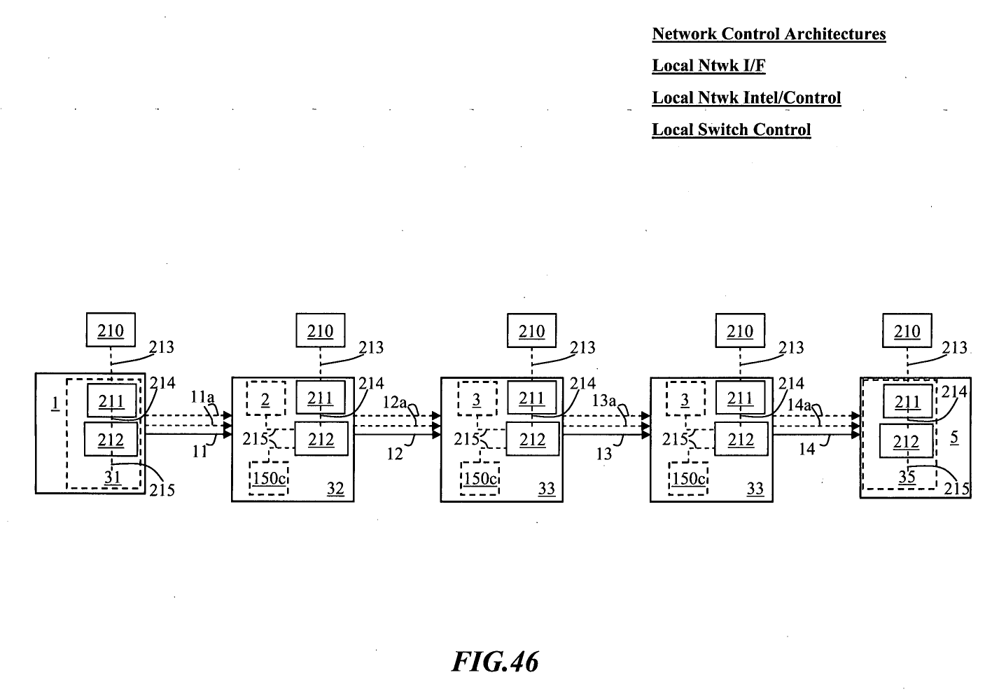

FIG. 46 illustrates the Generalized Network Control and/or Network Management Architecture 209 for Time-Scheduled Packet Switching, with the Switch, Device, and/or Network Element Control Functionality 212, the Network Intelligence/Knowledge/Routing control functionality 211, and the network interface functionality 210 all moved into the network elements (local).

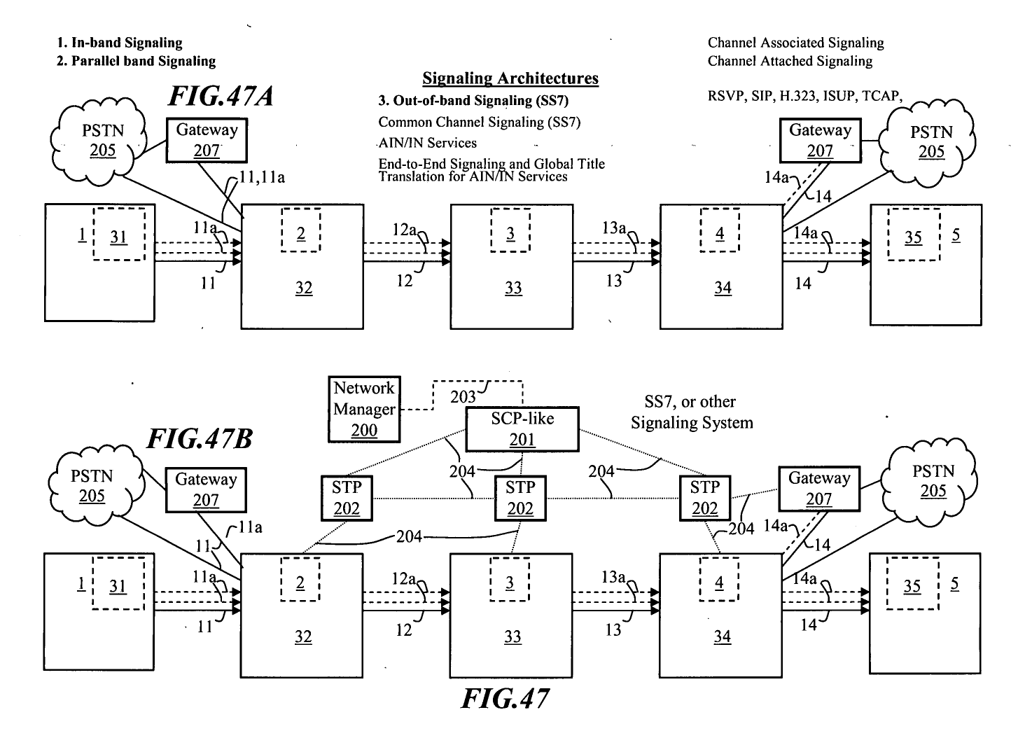

FIG. 47A and FIG. 47B show various signaling architectures for call setup, teardown, and management with respect to Time-Scheduled Packet Switching and networks.

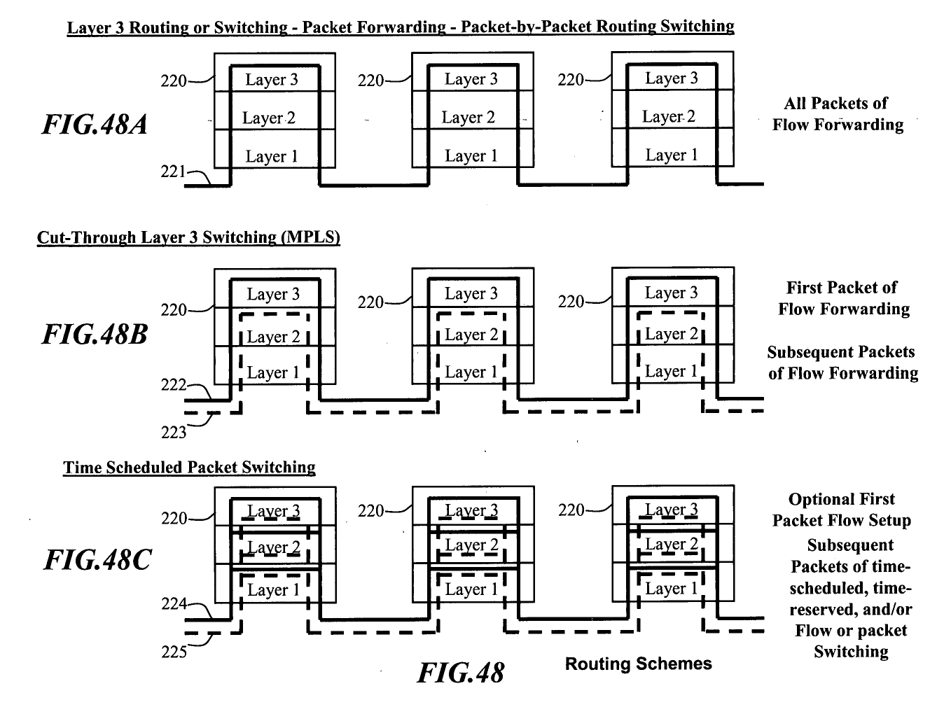

FIG. 48 shows various layers for various routing schemes. FIG. 48A shows Layer 3 Routing or Switching—Packet Forwarding—Packet-by-Packet Routing. FIG. 48B shows Cut-Through Layer 3 Switching (e.g., MPLS) with First Packet for Flow setup, then Subsequent Packets used Layer 2 Flow Forwarding. FIG. 48C shows Time-Scheduled packet switching with an Optional First Packet Flow Setup (A separate Call Setup packet may not be required) at any of the layers, with all other packets flowing according to scheduled, time-reserved, packet Switching.

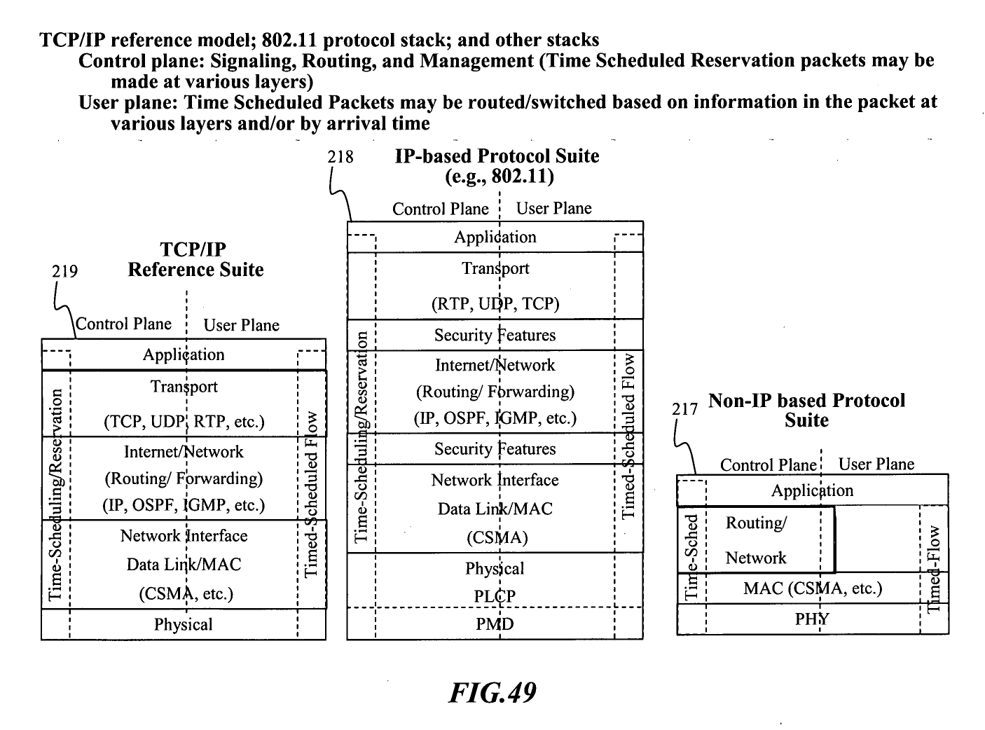

FIG. 49 illustrates the control plane and user plane for Time-Scheduled packet switching using the TCP/IP reference model; the 802.11 protocol stack; and other stacks. Time-Scheduled Control plane may comprise Signaling, Routing, and Management (Time Scheduled Reservation packets may be made at various layers). The Time-Scheduled User plane comprises Time Scheduled Packets that may be routed/switched based on information in the packet at various layers and/or by arrival time.

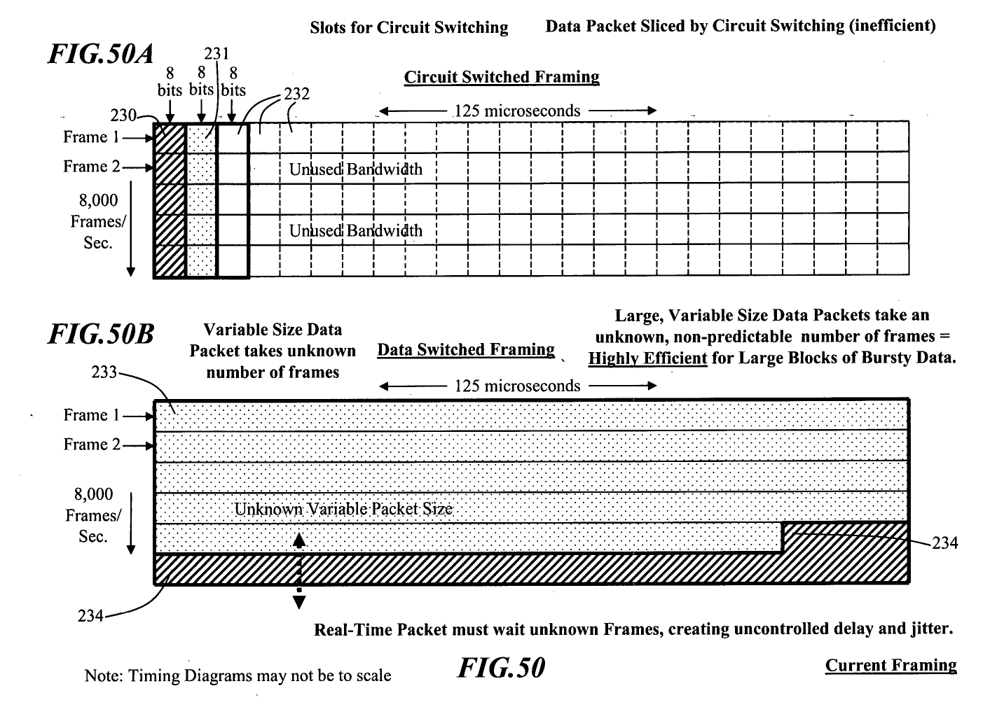

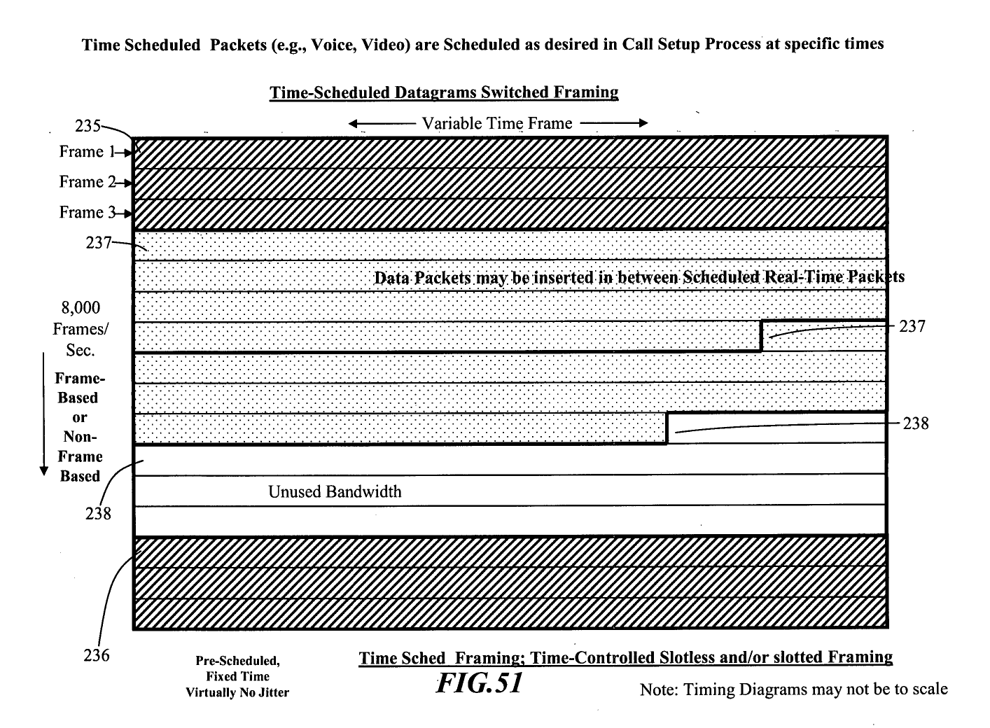

FIG. 50A shows framed slots for circuit switching which cannot send large quantities of data effectively. FIG. 50B shows large, variable size packets which take an unpredictable number of frames, which delay real-time packets, resulting in inefficiency.

FIG. 51 shows Time-Scheduled packets 235 (e.g., voice, video, etc.) with time reservations being periodically inserted at the scheduled times, with the non-time-scheduled standard data packets 237 transmitting after the Time-Scheduled packets 235. Periodic Time-Scheduled packet 236 then transmits on time as well.

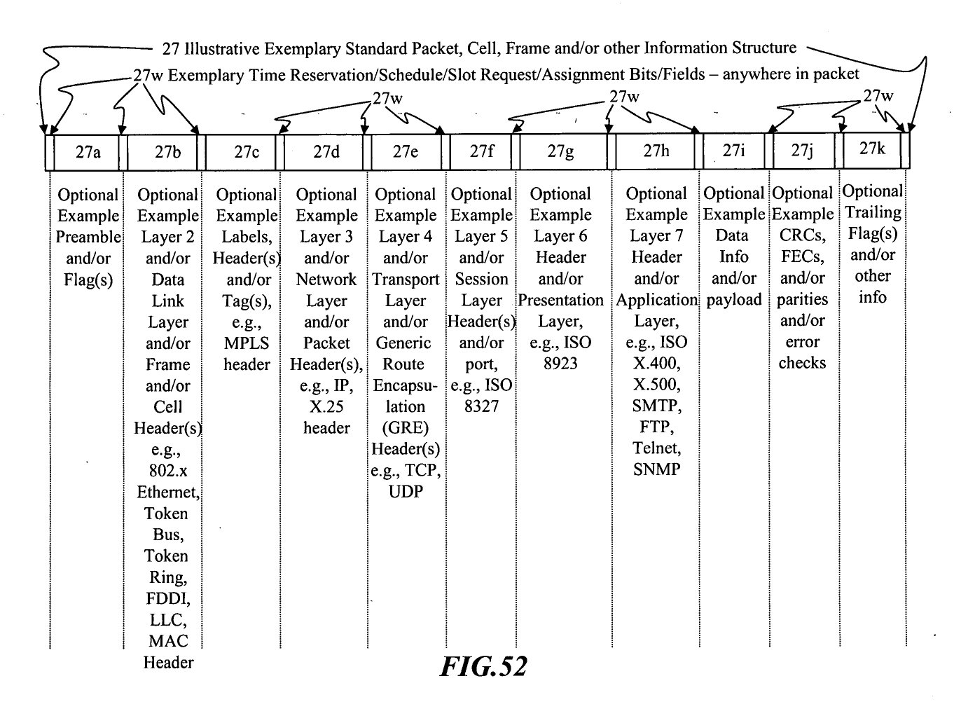

FIG. 52 shows an Illustrative Exemplary Standard Packet, Cell, Frame and/or other Information Structure 27 with Exemplary Bits/Fields (e.g., DSCP—DiffServ Code Points bits/fields) for Time Reservation/Schedule/Slot Request/Assignment 27w. These indicator bits may be optionally placed anywhere in the exemplary packet.

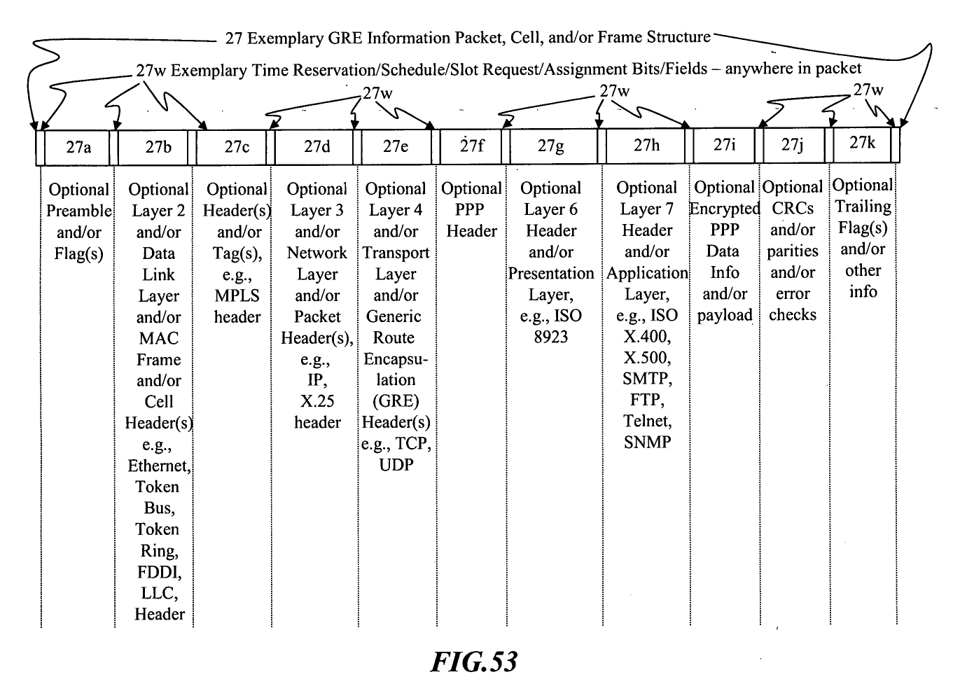

FIG. 53 shows an Illustrative Exemplary GRE Information Packet, Cell, and/or Frame Structure 27 with Exemplary Bits/Fields (e.g., DSCP—DiffServ Code Points bits/fields) for Time Reservation/Schedule/Slot Request/Assignment 27w. These indicator bits may be optionally placed anywhere in the exemplary packet.

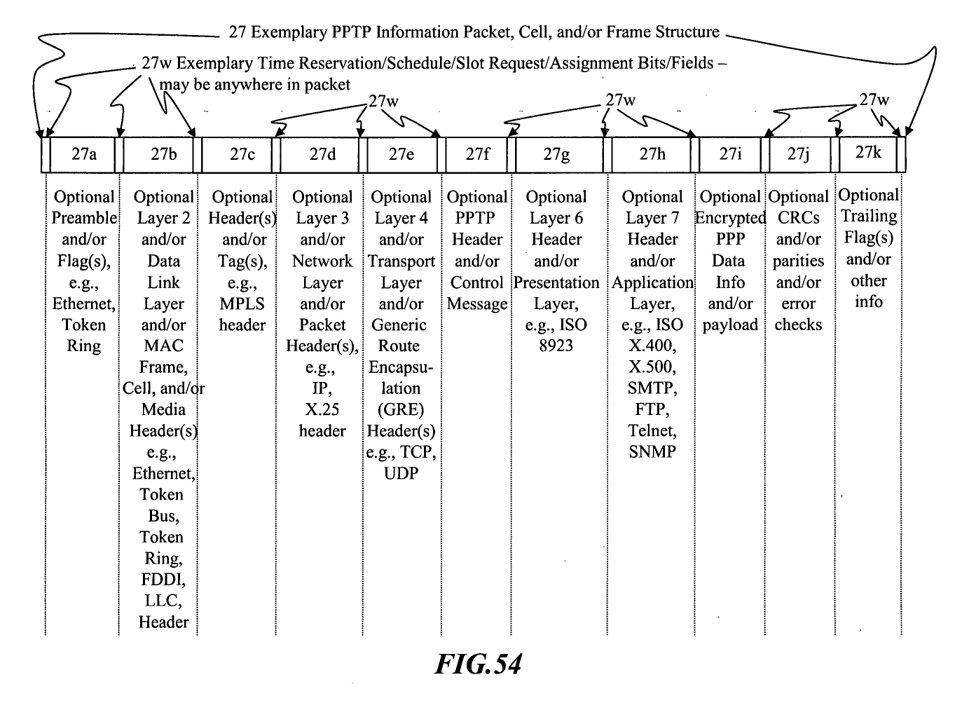

FIG. 54 shows an Illustrative Exemplary PPTP Information Packet, Cell, and/or Frame Structure 27 with Exemplary Bits/Fields (e.g., DSCP—DiffServ Code Points bits/fields) for Time Reservation/Schedule/Slot Request/Assignment 27w. These indicator bits may be optionally placed anywhere in the exemplary packet.

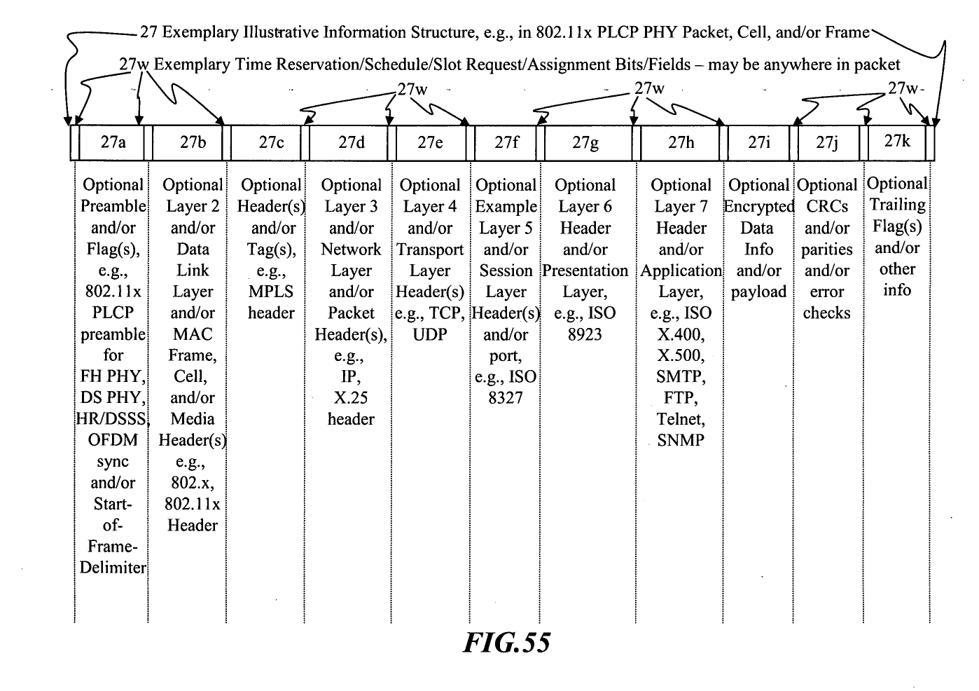

FIG. 55 shows an Illustrative Exemplary Information Structure, e.g., in 802.11x PLCP PHY Packet, Cell, and/or Frame 27 with Exemplary Bits/Fields (e.g., DSCP—DiffServ Code Points bits/fields) for Time Reservation/Schedule/Slot Request/Assignment 27w. These indicator bits may be optionally placed anywhere in the exemplary packet.

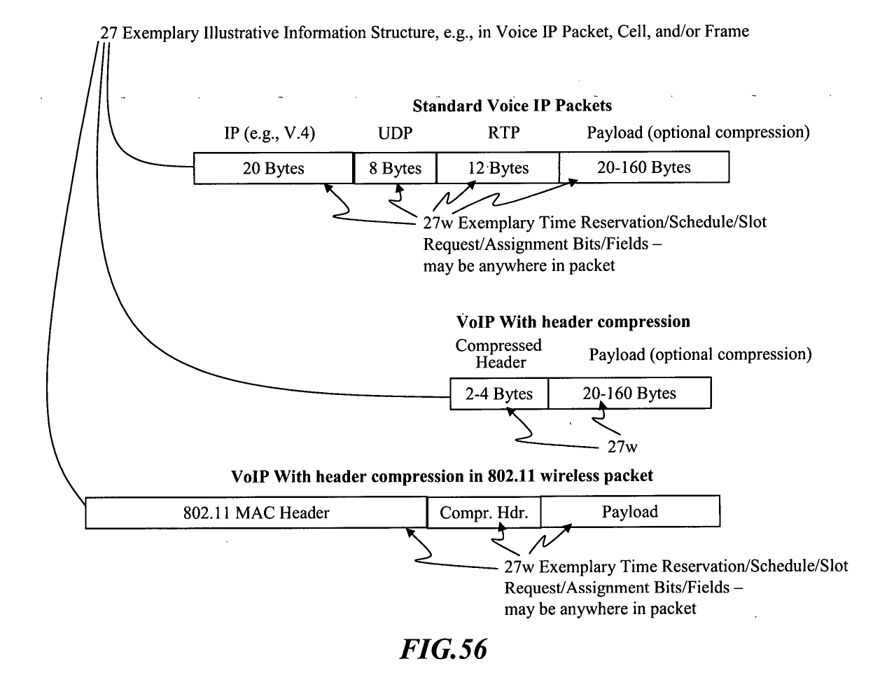

FIG. 56 shows an Exemplary Illustrative Information Structure, e.g., in Voice IP Packet, Cell, and/or Frame 27, with or without payload and/or header compression, with or without 802.11a or other headers, and with or without Exemplary Bits/Fields (e.g., DSCP—DiffServ Code Points bits/fields) for Time Reservation/Schedule/Slot Request/Assignment 27w. These indicator bits may be optionally placed anywhere in the exemplary packet.

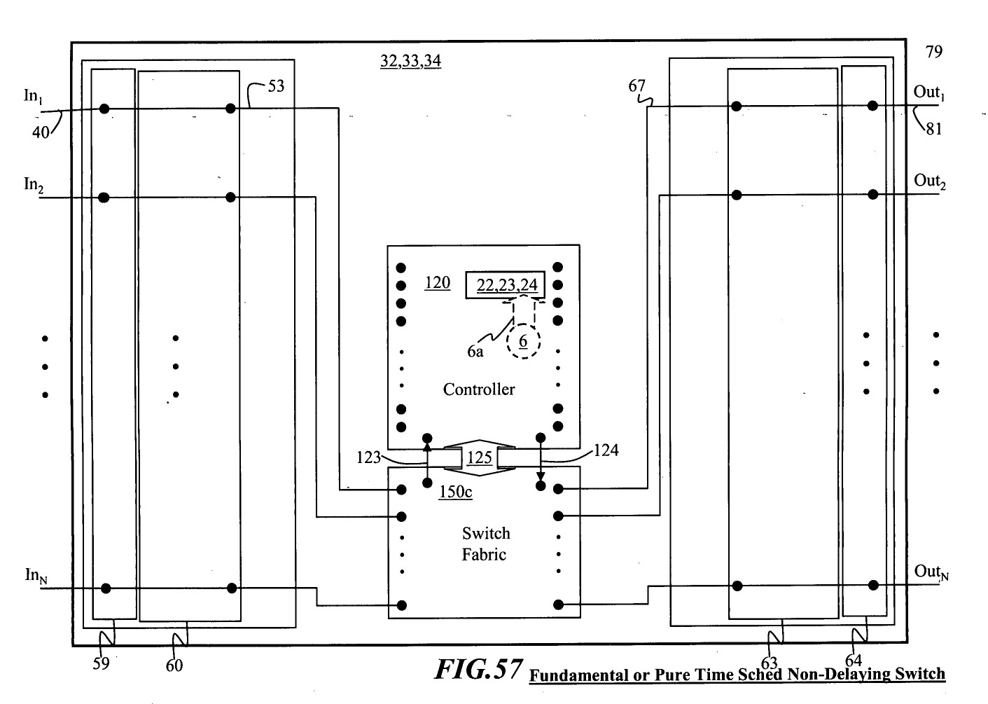

FIG. 57 is an illustrative example of the “pure time-scheduled and/or time-reserved datagram/packet” or “path switch” device embodiment according to the present invention. This device embodiment comprises only time-scheduled and/or time-reserved datagram/packet system functionality, thus standard layer two or higher layer data switch functionality is not included.

In this device, optional master clock 6 may communicate timing and synchronization information through clock timing and synchronization signals 6a to clock receiver/synchronization means 22,23, and/or 24 on controller 120. Controller 120 operates the time-scheduled and/or time-reserved datagram/packet even schedule and uses it to control switch fabric 150c through controls lines 125. Switch fabric 150c may be optical, electrical, or some combination of optical and electrical, with the potential for opto-electrical conversion and electrical-optical conversion at various points in the device embodiments. Switch fabric 150c is preferred to be non-blocking and non-delaying, but may be optionally blocking and optionally delaying fabric. Switch fabric 150c, may also optionally have a constant propagation delay, such that the switch fabric latency from any input to any output is the same or as close to the same as possible.

In FIG. 57, controller 120 communicates to and from the rest of the network through lines 124 and 123 respectively through switch fabric 150c. Time-scheduled and/or time-reserved datagram/packet call setup messages and scheduling are sent and received in this manner. Once a time-scheduled and/or time-reserved datagram/packet call is scheduled, it routes at the precise scheduled time on input line 40, is switched through fabric 150c at the scheduled time under the control of controller 120, and then routes out output line 81 to the next node. The transmission input media may be electrical, optical, or both. In addition, this device embodiment may incorporate electrical-optical or optical-electrical conversion at various points in the input stage or output stage. In addition, the device may incorporate optional buffering, which may be used to control correct transmission times when the device is deployed as an edge node.

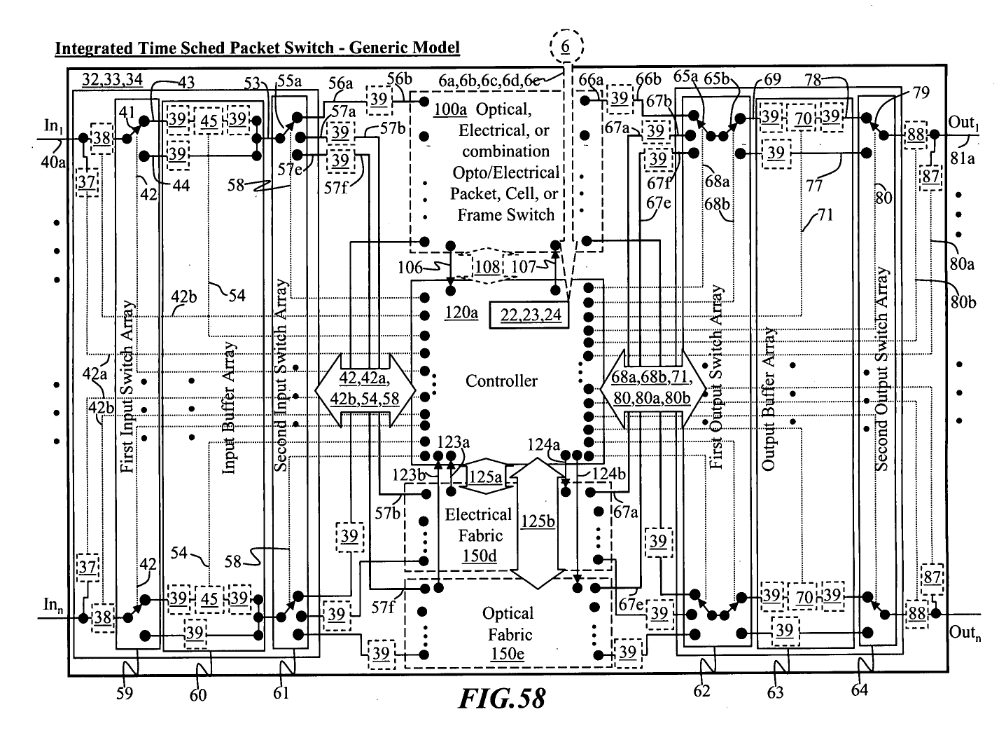

FIG. 58 is a high level schematic diagram of a first embodiment and the preferred embodiment of an integrated time-scheduled and/or time-reserved datagram/packet network switch or router device according to the present invention comprising master clock synchronization means, input, output, control, and integrated store-and-forward switching means, and switching means which may be non-blocking, non-delaying switching means.

FIG. 58 shows a high level block diagram of a first embodiment, also termed the “integrated” embodiment, of an integrated time-scheduled and/or time-reserved datagram/packet switch. This preferred embodiment integrates a packet, cell, or frame switch 100 into the rest of the time-scheduled and/or time-reserved datagram/packet switch 32, 33, or 34, comprising a first input switch array 59; an input buffer array 60; a second input switch array 61; a controller 120 with timing synchronization means 22, 23, 24; a switching means which may be non-blocking, non-delaying switch 150; a first output switch array 62, an output buffer array 63, and a second output switch array 69.

In this preferred embodiment, both time-scheduled and/or time-reserved datagram/packet packets and standard packets, cells, or frames are routed from the previous node to the input lines such as In₁ 40. In standard packet mode, while standard packets, cells, or frames are streaming into input line 40, the time-scheduled and/or time-reserved datagram/packet switch controller 120 uses control line(s) 42 to position switch 41 into the position to route the standard packets, cells, or frames from input line In₁ 40 to input buffer InBuffer₁ 45. Here the standard packets, cells, or frames are stored while the controller 120 determines where each packet should go and which packets to route first. To do this, the InBuffer₁ 45 looks at each packet, cell, or frame and determines its layer three destination or layer two flow path or equivalent, and its priority, if any. Using the layer three destination or layer two flow path or equivalent, the controller 120 then looks at its routing or flow table and determines the next destination and which output line the packets, cells, or frames are to be sent out on. It may at this point insert the next destination into the packet, cell, or frame, or perform this operation in the output buffer OutBuffer₁ 70. Alternatively, for high speed packet, cell, or frame switching, the routing table can be stored in a high speed cache as part of the InBuffer circuitry.

Once the destination is determined, if standard packet, cell, or frame priority systems such as Quality of Service (QOS), Class of Service (COS), Resource Reservation Protocol (RSVP) or other priority schemes are incorporated in the device, the controller 120 or InBuffer₁ 45 uses the priority level to determine which packets, cells, or frames should be moved out of the buffer first into the packet, cell, or frame switch fabric 100. Otherwise a simpler algorithm such as round-robin may be used or any other sharing algorithms well-known to those skilled in the art.

Before moving a standard packet from the InBuffer₁ 45 to the packet, cell, or frame switch 100, the controller 120 first looks at the time-scheduled and/or time-reserved datagram/packet schedule to be sure that moving the standard packet out of the InBuffer₁ 45 will not conflict with a scheduled time-scheduled and/or time-reserved datagram/packet packet due to arrive on input line In₁ 40. Based upon which output line Outₙ the packet is supposed to route out of, the controller 120 also looks at the time-scheduled and/or time-reserved datagram/packet schedule to be sure that moving this packet out of the InBuffer₁ 45 will not cause it to load into the output buffer OutBufferₙ at a time when it will conflict with a scheduled time-scheduled and/or time-reserved datagram/packet packet due to be switched through on that output line Outₙ. When the controller determines that no time-scheduled and/or time-reserved datagram/packet conflict will occur at that input port, it uses control line(s) 58 to positions switch 55 such that the non-time-scheduled and/or time-reserved datagram/packet packet, cell, or frame will be routed to the packet, cell, or frame switch 100. It then triggers the InBuffer₁ 45 to move the packet, cell, or frame into packet, cell, or frame switch 100 via switch 55 and line 56.

Packet, cell, or frame switch 100 uses standard packet-oriented switch fabric well-know to those skilled in the art to route the packet to the correct output line, which for illustrative purposes we choose to be line 66. Since controller 120 has already determined that there is no time-scheduled and/or time-reserved datagram/packet conflict with output buffer OutBuffer₁ 70, controller 120 uses control line(s) 68 to position switch 65 so that the packet will route into OutBuffer₁ 70. The packet, cell, or frame then routes out of switch 100 through line 66, through switch 69, and into OutBuffer₁ 70.

Either controller 120 and/or OutBuffer₁ 70, now determine which packets should be shipped out first based on priority. When OutBuffer₁ 70 is ready to ship a packet, cell, or frame out of output line Out₁ 81, controller 120 checks the time-scheduled and/or time-reserved datagram/packet schedule to be sure that no time-scheduled and/or time-reserved datagram/packet packets, cells, or frames are scheduled to be shipped out of output line Out, 81 during the time it takes to send out the next standard packet. OutBuffer₁ 70 can compute the time that it will take to send the next outgoing standard packet, cell, or frame because it knows how fast its output link is and how large the next packet, cell, or frame is by looking at its header or by examining the space taken up in the buffer. If there will be a conflict between a scheduled time-scheduled and/or time-reserved datagram/packet packet on this output line Out₁ 81 and a standard packet from OutBuffer₁ 70, the scheduled time-scheduled and/or time-reserved datagram/packet packet takes priority and OutBuffer₁ 70 holds the outgoing packet until the time-scheduled and/or time-reserved datagram/packet scheduled event is completed. This process is then repeated continuously, thus shipping time-scheduled and/or time-reserved datagram/packet packets, cells, or frames at scheduled times, and standard packets, cells, or frames at non-layer one, non-time-scheduled, and/or non-time-reserved datagram/packet times.

When a time-scheduled and/or time-reserved datagram/packet is scheduled to arrive on input line In₁ 40, the master controller 120, uses control line(s) 42 and 58 to shift input switches 41 and 55 respectively to the bypass position, such that packets will not flow from input line In₁ 40 to the InBuffer₁ 45. Instead the time-scheduled and/or time-reserved datagram/packet packet, cell, or frame is routed directly from input line In₁ 40, through bypass line 44, through switch 55 to line 57, and directly into the switching means which may be non-blocking, non-delaying switch 150. At precisely the same time, controller 120 uses control lines 125 to cause switching means which may be non-blocking, non-delaying switch 150 to route the time-scheduled and/or time-reserved datagram/packet packet, cell, or frame directly from the line 57, through switch 150 and out the correct line 67. At precisely the same time, using control line(s) 68 and 80, controller 120 also positions switches 65 and 79 respectively such that the scheduled time-scheduled and/or time-reserved datagram/packet packet, cell, or frame routes through from switching means which may be non-blocking, non-delaying switch 150 on line 67 through switch 65 to the buffer bypass line 77, out switch 79 to output line Out₁ 81 and on to the next time-scheduled and/or time-reserved datagram/packet switch which repeats the process.

There is one variation to the way that time-scheduled and/or time-reserved datagram/packet switching works that occurs only when the time-scheduled and/or time-reserved datagram/packet Switch is the first time-scheduled and/or time-reserved datagram/packet device in the time-scheduled and/or time-reserved datagram/packet path, i.e., either it is the originating edge node 32, see FIG. 4, or it plays the role of an originating edge node as does time-scheduled and/or time-reserved datagram/packet switching means 31 in FIG. 6. This is because, when a time-scheduled and/or time-reserved datagram/packet switch is the first switch in the path from source to destination, there is no preceding time-scheduled and/or time-reserved datagram/packet entity to send the time-scheduled and/or time-reserved datagram/packet packets at the precise times required. Consequently, the originating edge node 32 must hold the time-scheduled and/or time-reserved datagram/packet packets, cells, or frames that it receives from the non-time-scheduled and/or time-reserved datagram/packet source or originating device 1 in its input buffer InBuffer₁ 45, see FIG. 58, until the scheduled time-scheduled and/or time-reserved datagram/packet event occurs. The controller 120 for the originating edge node 32 must then, at the scheduled time, switch to time-scheduled and/or time-reserved datagram/packet mode and cause the input buffer InBuffer₁ 45 to release the time-scheduled and/or time-reserved datagram/packet packets through the switching means which may be non-blocking, non-delaying switch and on through the rest of the time-scheduled and/or time-reserved datagram/packet path. All of the subsequent time-scheduled and/or time-reserved datagram/packet devices work as previously described.

FIG. 58 also illustrates how store-and-forward messages are communicated over the standard packet network both from and to the controller 120 from sources 1, destinations 5, and other network elements 2, 3, 4, 32, 33, and 34. In addition to routing end-to-end packets through switch 100, the controller 120 has a network address for standard packet, cell, or frame messages whereby switch 100 routes these messages to controller 120 through line 106. Controller 120 can also send standard packet, cell, or frame messages through line 107 to switch 100 for routing to the network.

FIG. 58 also illustrates how time-scheduled and/or time-reserved datagram/packet messages such as emergency messages, synchronization timing messages, and administration messages are communicated from and to the controller 120 from other time-scheduled and/or time-reserved datagram/packet devices. In addition to routing time-scheduled and/or time-reserved datagram/packet packets through switch 150, the controller 120 has a network address for time-scheduled and/or time-reserved datagram/packet messages whereby switch 150 routes these messages to controller 120 through line 123. Controller 120 can also send high-priority scheduled time-scheduled and/or time-reserved datagram/packet messages such as emergency messages, synchronization timing messages, and administrative messages through line 124 to switch 150 for routing to the network.

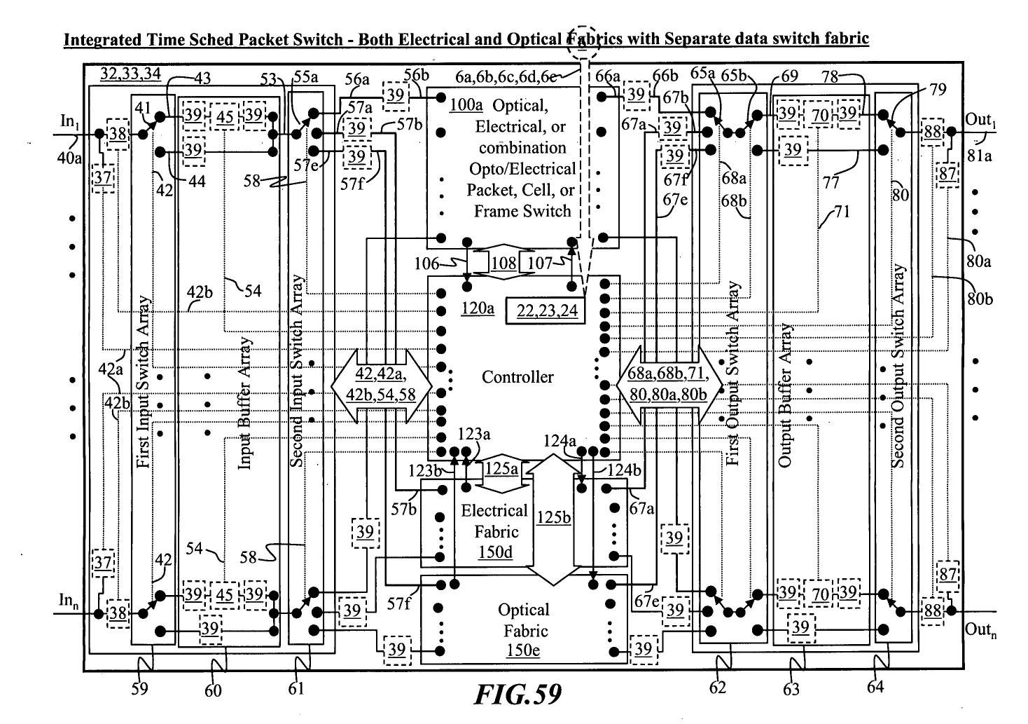

FIG. 59 is a high level schematic diagram of Integrated Time Schedule Packet Switch—Both Electrical and Optical Fabrics with Separate data switch fabric.

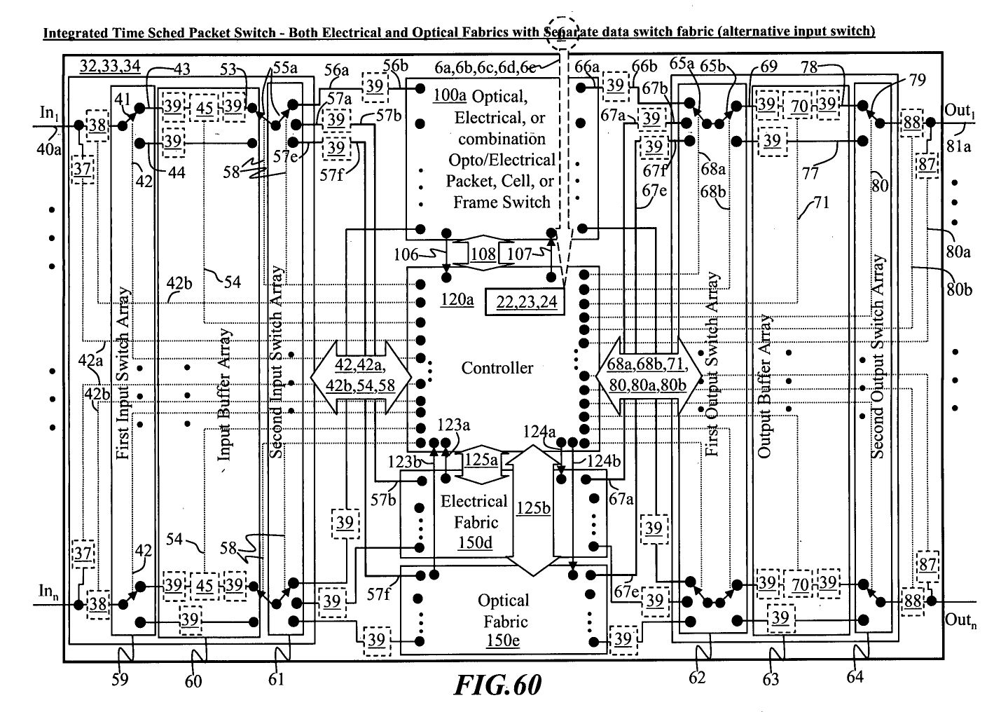

FIG. 60 is a high level schematic diagram of Integrated Time Schedule Packet Switch—Both Electrical and Optical Fabrics with Separate data switch fabric (alternative input switch).

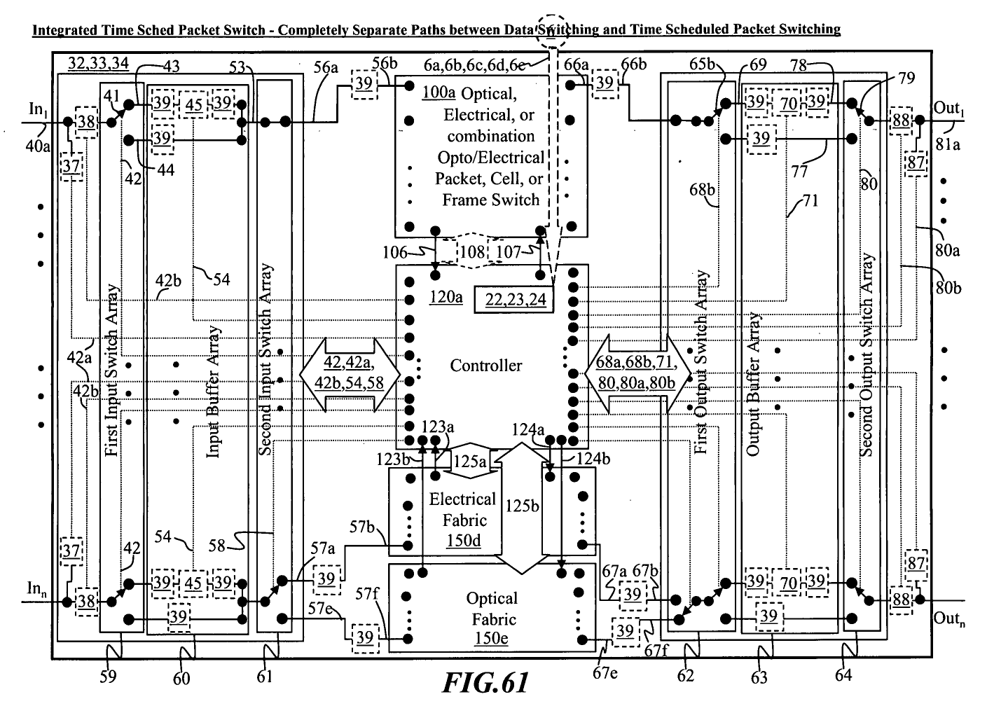

FIG. 61 is a high level schematic diagram of Integrated Time Schedule Packet Switch—Completely Separate Paths between Data Switching and Time Scheduled Packet Switching.

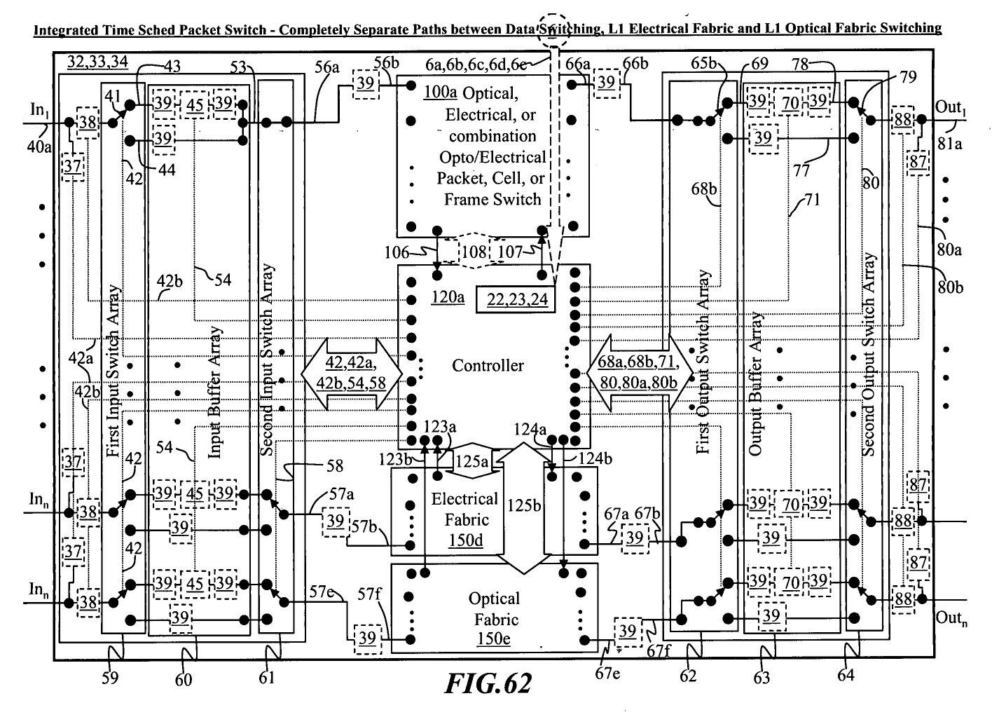

FIG. 62 is a high level schematic diagram of Integrated Time Schedule Packet Switch—Completely Separate Paths between Data Switching, L1 Electrical Fabric and L1 Optical Fabric Switching.

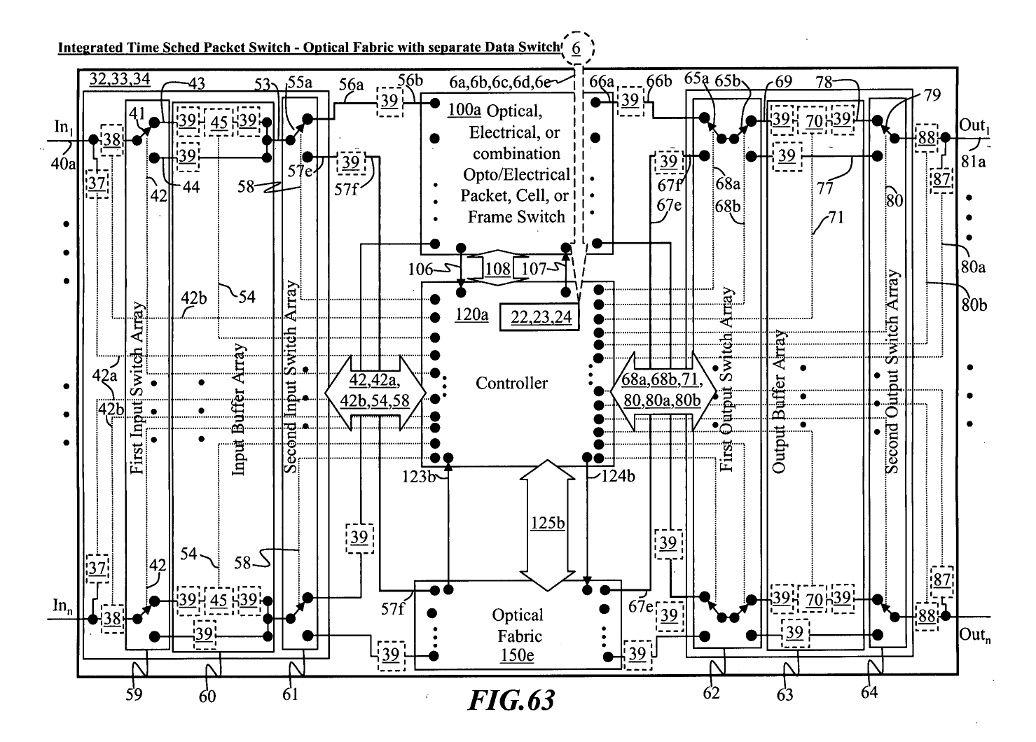

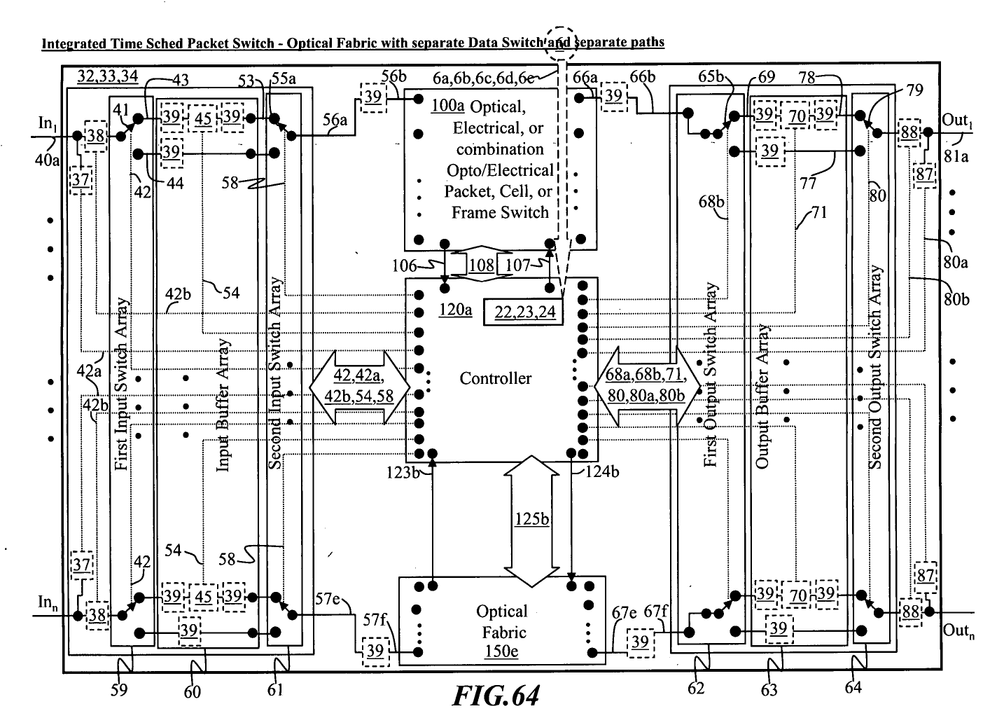

FIG. 63 is a high level schematic diagram of Integrated Time Schedule Packet Switch—Optical Fabric with separate Data Switch FIG. 64 is a high level schematic diagram of Integrated Time Schedule Packet Switch—Optical Fabric with separate Data Switch and separate paths.

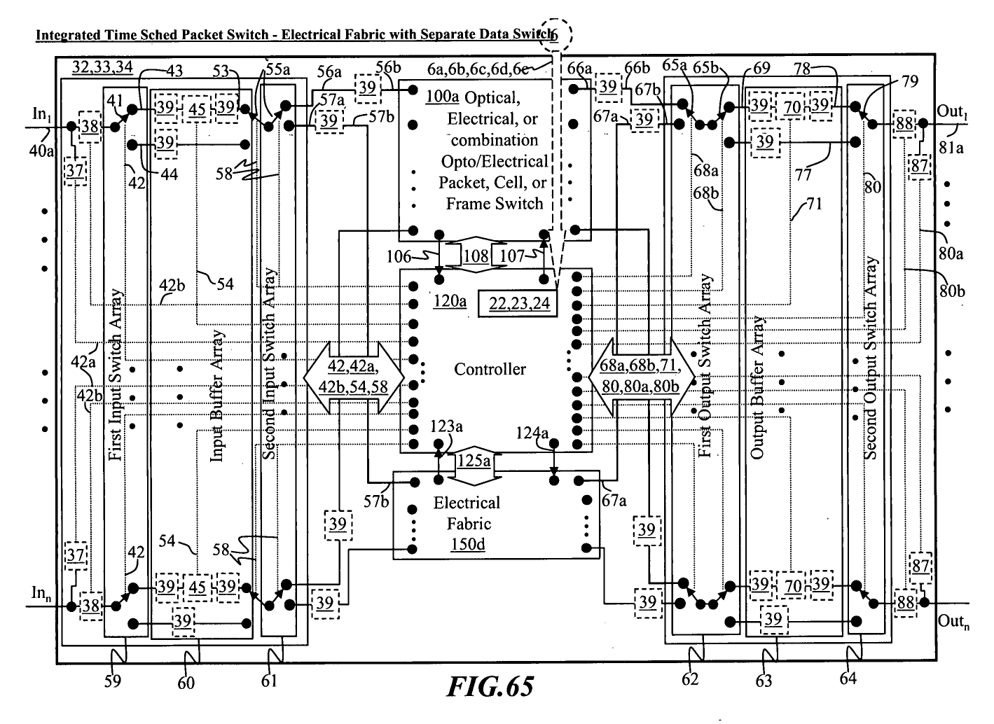

FIG. 65 is a high level schematic diagram of an Integrated Time Schedule Packet Switch—Electrical Fabric with Separate Data Switch.

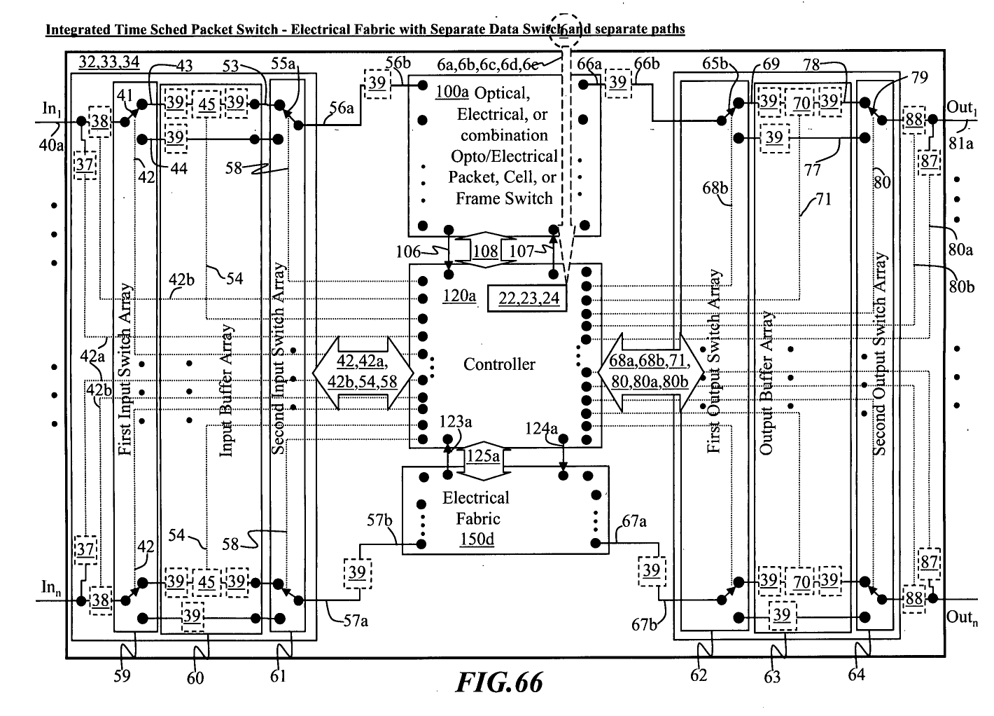

FIG. 66 is a high level schematic diagram of an Integrated Time Schedule Packet Switch—Electrical Fabric with Separate Data Switch and separate paths.

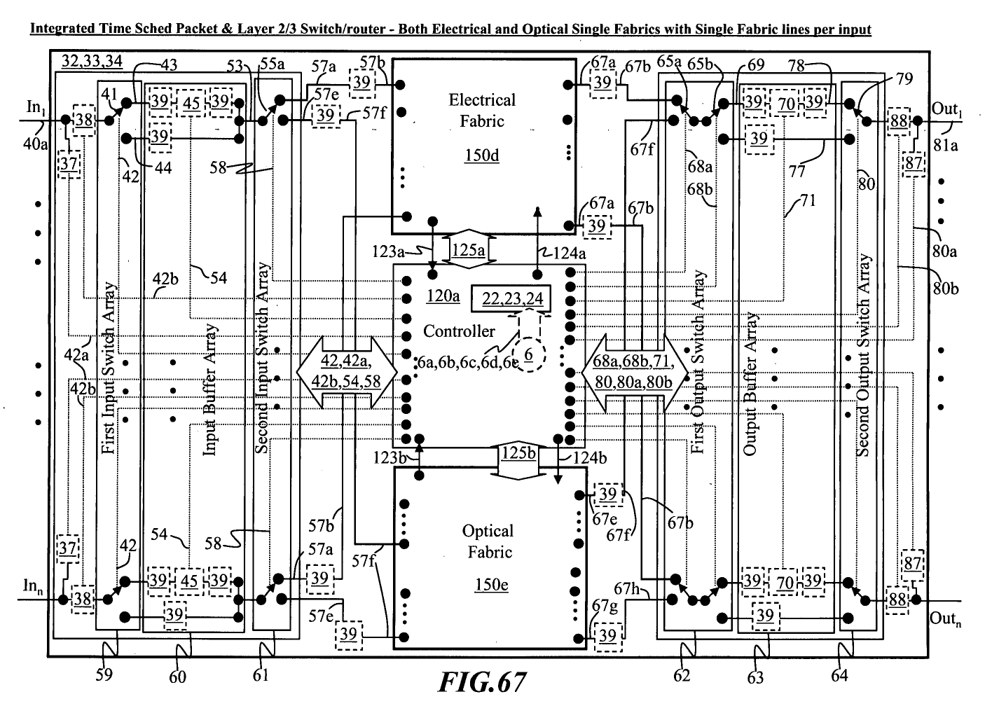

FIG. 67 is a high level schematic diagram of an Integrated Time Schedule Packet Switch—Electrical Fabric with Separate Data Switch and separate paths.

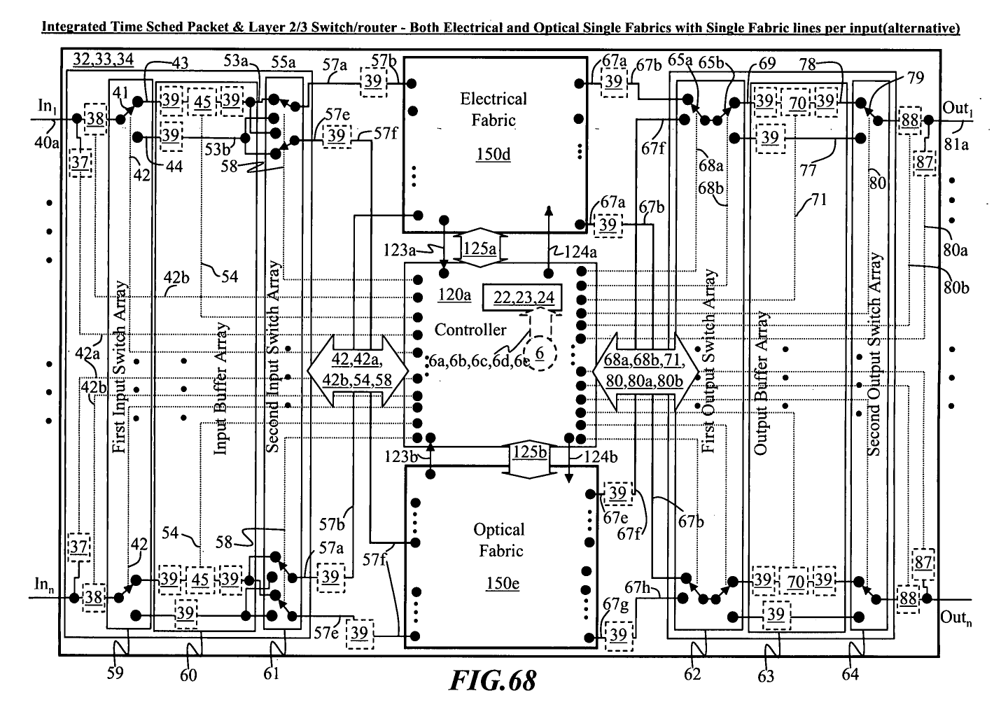

FIG. 68 is a high level schematic diagram of an Integrated Time Schedule Packet & Layer 2/3 Switch/router—Both Electrical and Optical Single Fabrics with Single Fabric lines per input (alternative).

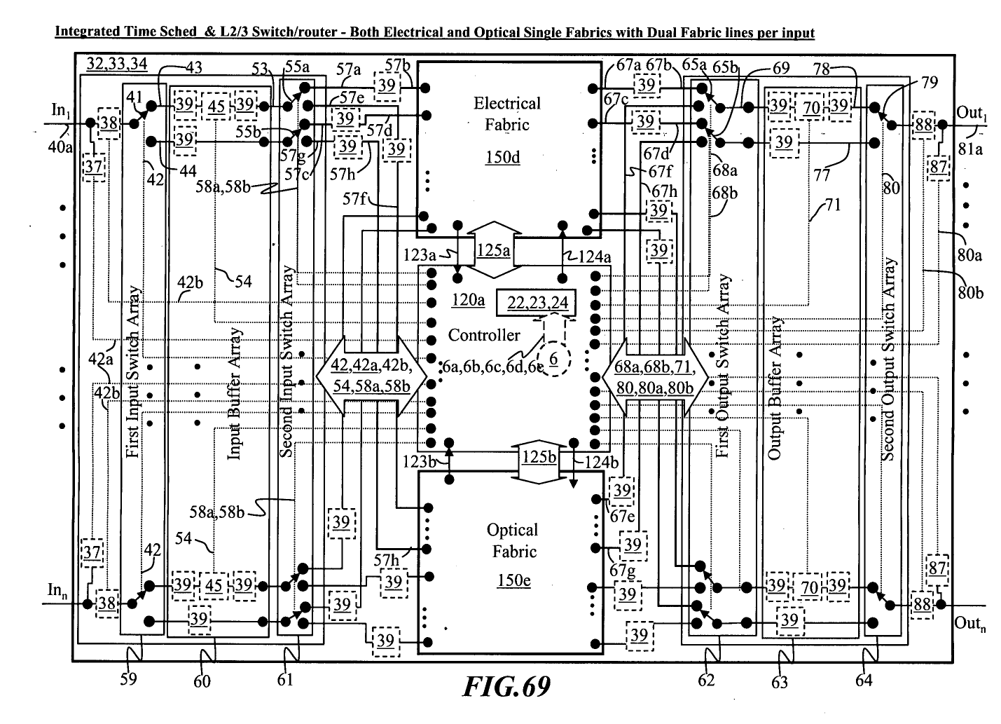

FIG. 69 is a high level schematic diagram of an Integrated Time Scheduled & L2/3 Switch/router—Both Electrical and Optical Single Fabrics with Dual Fabric lines per input.

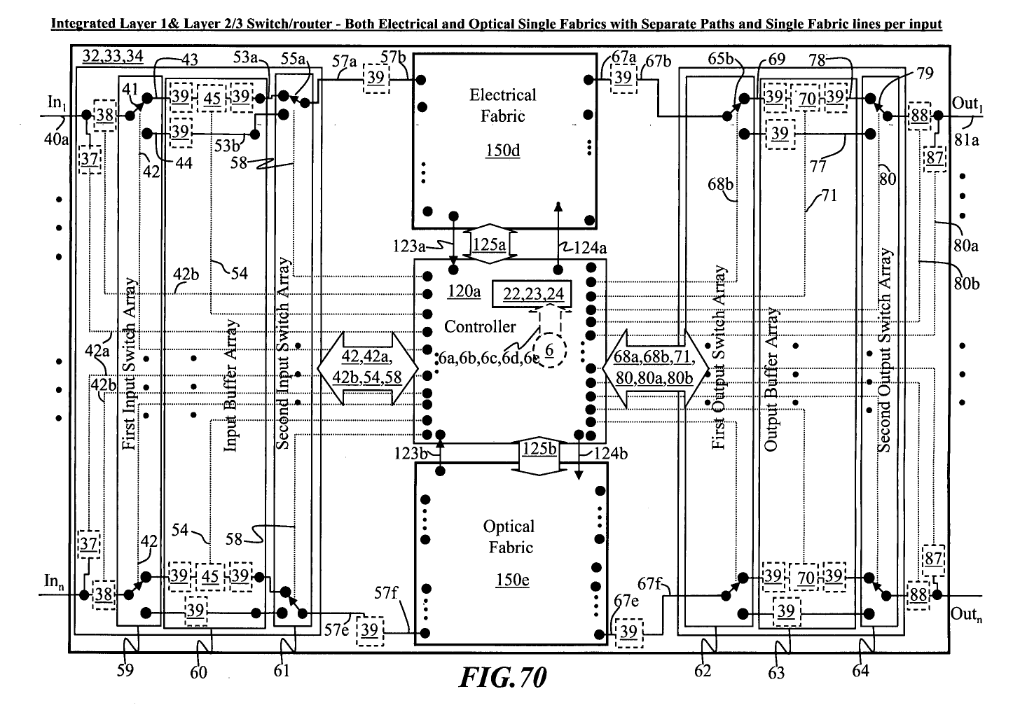

FIG. 70 is a high level schematic diagram of an Integrated Layer 1 & Layer 2/3 Switch/router—Both Electrical and Optical Single Fabrics with Separate Paths and Single Fabric lines per input.

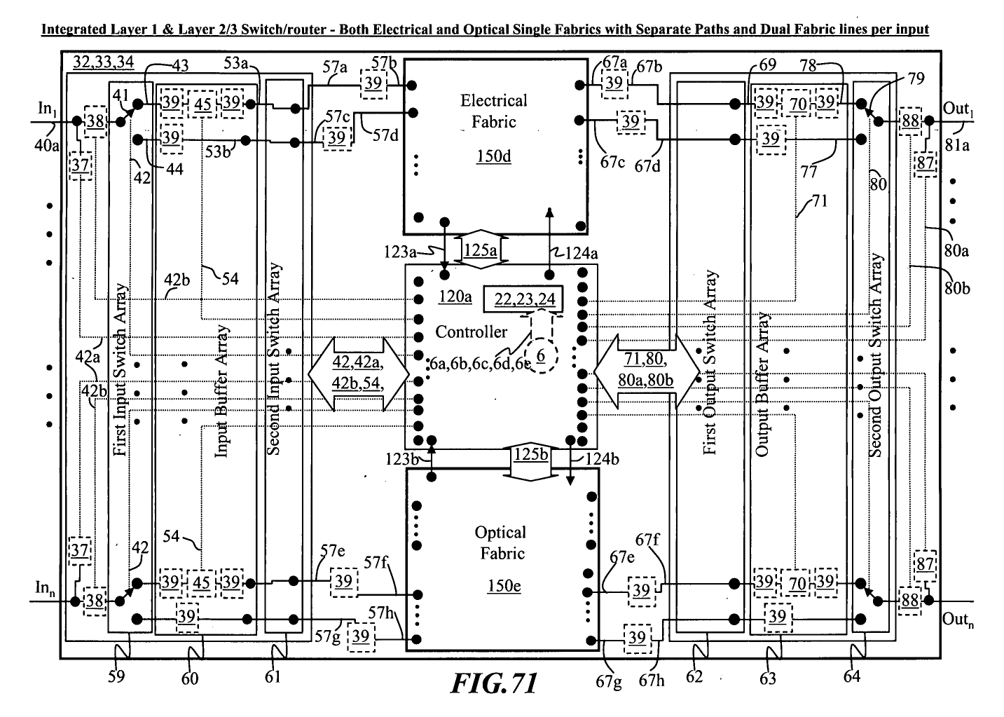

FIG. 71 is a high level schematic diagram of an Integrated Layer 1 & Layer 2/3 Switch/router—Both Electrical and Optical Single Fabrics with Separate Paths and Dual Fabric lines per input.

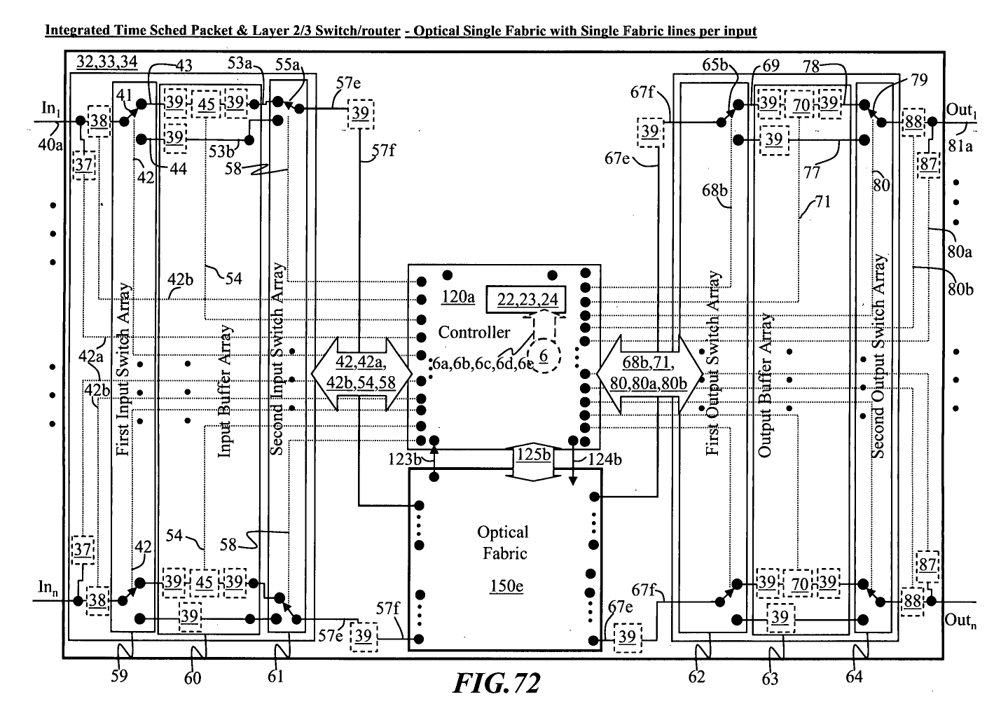

FIG. 72 is an illustrative example of a second pure time-scheduled and/or time-reserved datagram/packet switch device embodiment with an optical fabric 150e. In this optical path switch device embodiment, input lines 40a and output lines 81a could be either optical or electrical or both, as desired.

In FIG. 72, attached to input line 40a is a real-time optional sniffer device 37, also variously described as a snooper, input receiver, input monitor, listener, and/or time stamp receiver 37 which is controlled by and sends feedback to controller 120 over control lines 42a. If the input line 40a is optical, then optional sniffer 37 would have a real-time optical-electrical converter. It may then comprise an ASIC, FPGA, shift register, or other input examining and comparing mechanism for determining information about the incoming packet, cell, or frame as it shoots past at a time-scheduled and/or time-reserved datagram/packet level. It is important to note that the sniffer 37 is not directly in line with the input circuit so it does not cause any delays to the incoming data. It merely “taps” the incoming line such that it can monitor the incoming packet for information which may be of value.

The sniffer 37 can be used in various ways, including but not limited to:
detecting inter nodal time stamp packets in real-time for precise inter-nodal synchronization using various timestamp methods, such as the two-way time transfer method.
detecting packet arrival time to tighten the timing precision between nodes.
determining information about the packet, such as the packet length or size or DSCP code point values, by reading the value in the header.
detecting line breaks if packets do not arrive.

Examples of how the sniffer 37 might be used, include but are not limited to:
Techniques to tighten the timing precision between nodes. For example, because of clock wander or for various other reasons, a time-scheduled and/or time-reserved datagram/packet switch might be waiting for a time-scheduled and/or time-reserved datagram/packet packet to arrive from the preceding node at a certain time plus or minus some variable time range. The expecting node knows that the transmitting node will send the packet at 1:00 PM and zero nanoseconds according to the transmitting node's clock. The expecting node also knows that the propagation delay between the two nodes is exactly 5 milliseconds. However, due to potential wander of both clocks, the receiving node would like to resync that line to be as accurate as possible. The receiving node therefore instructs the sniffer 37 on that input line to listen for the packet beginning at, for illustrative purposes, assume 1:00 PM plus 3 milliseconds. The sniffer 37 detects that the packet actually arrives at 1:00 PM plus 4 milliseconds and 2 nanoseconds according to the receiving node's clock. The receiving node controller now knows that the error or clock offset between the sending clock and the receiving clock is 1:00:00.004000002 minus 1:00:00.005000000=−0.000999998 seconds or negative 999 microseconds and 998 nanoseconds. The receiver then places an offset in his schedule for that line and can now expect the next packet accurately to within several nanoseconds. In this example, it doesn't matter whether either clock is accurate to universal time. Even if both clocks are inaccurate with respect to universal time, the error or offset between them can be determined with the sniffer 37 to an extremely high degree of accuracy, thus enabling the devices to predict and switch the next packets with extremely accuracy. Periodically using the sniffer 37 in this way enables continuous inter-node resynchronization and therefore extremely precise overall network synchronization.

Although pure time-scheduled and/or time-reserved datagram/packet switching does not require the use of framers and deframers, for purposes of compatibility with existing networks, FIG. 72 optionally may include an optional input deframer 38 at the input from line 40a. This optional input deframer 38 may include means for receiving, converting, deframing, serializing, and/or decoding information.

Pure time-scheduled and/or time-reserved datagram/packet device embodiments may require the use of input buffers and output buffers when they are used as edge nodes in the network. This is done because the packets may need to be held until the reserved transmission time occurs. Therefore, FIG. 72 also optionally includes input buffers 45 and output buffers 70 for pure time-scheduled and/or time-reserved datagram/packet device embodiments. Input switch 41 is controlled by controller 120 through control line 42. Input switch 41 switches previously scheduled incoming time-scheduled and/or time-reserved datagram/packet packets directly through line 44, through optional O/E or E/O converter 39 to line 53b, through switch 55a to line 57e, through optional O/E or E/O converter 39 to line 57f, and into optical fabric 150e. on Input buffer 45 is fed through optional optical-electrical (O/E) or electrical/optical (E/O) converter 39

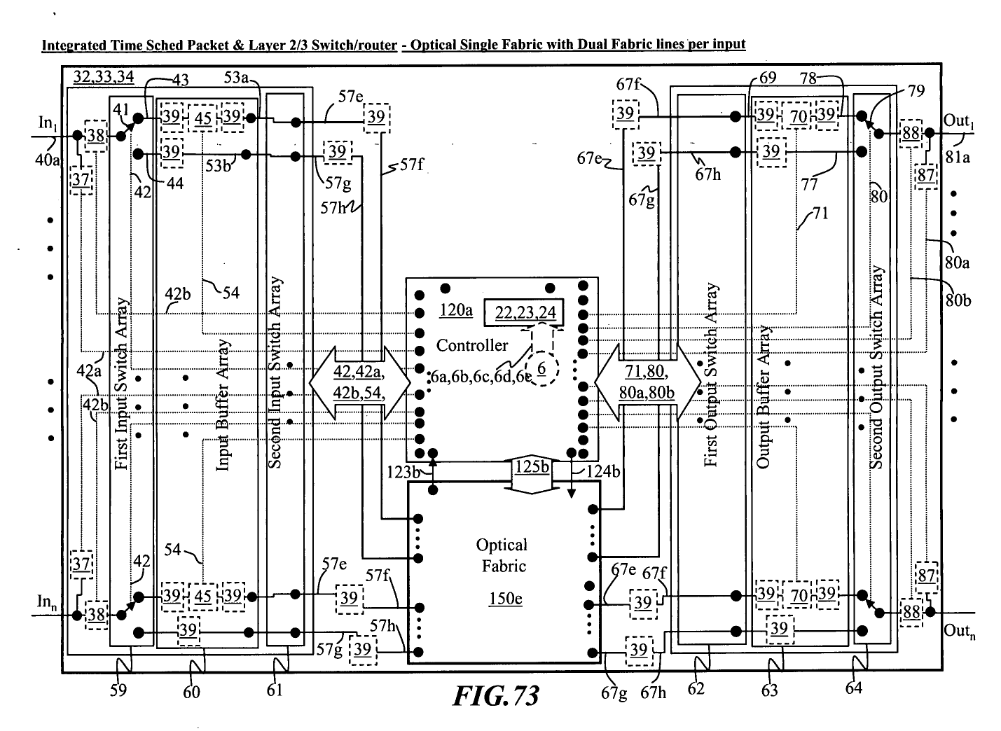

FIG. 73 is a high level schematic diagram of an Integrated Time Scheduled Packet & Layer 2/3 Switch/router—Optical Single Fabric with Dual Fabric lines per input.

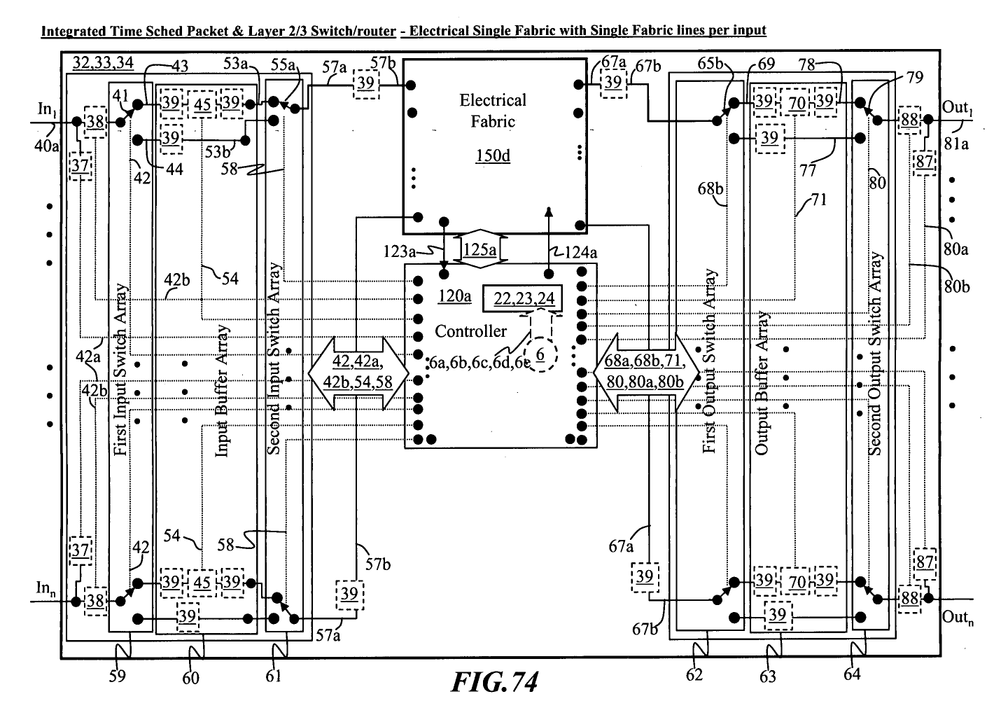

FIG. 74 is a high level schematic diagram of an Integrated Time Scheduled Packet & Layer 2/3 Switch/router—Electrical Single Fabric with Single Fabric lines per input.

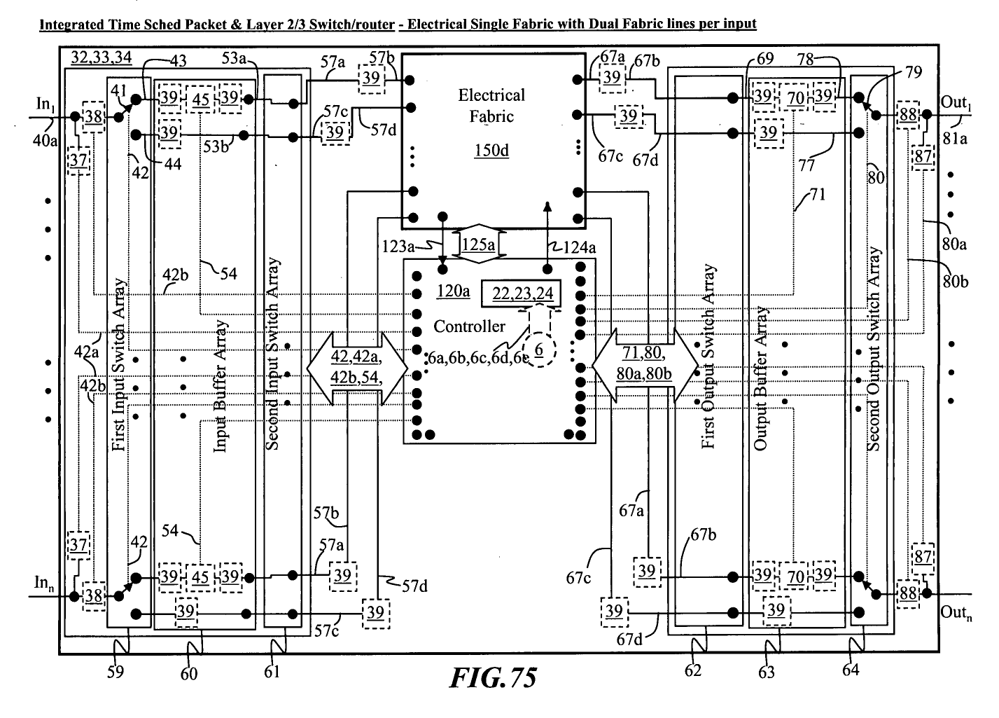

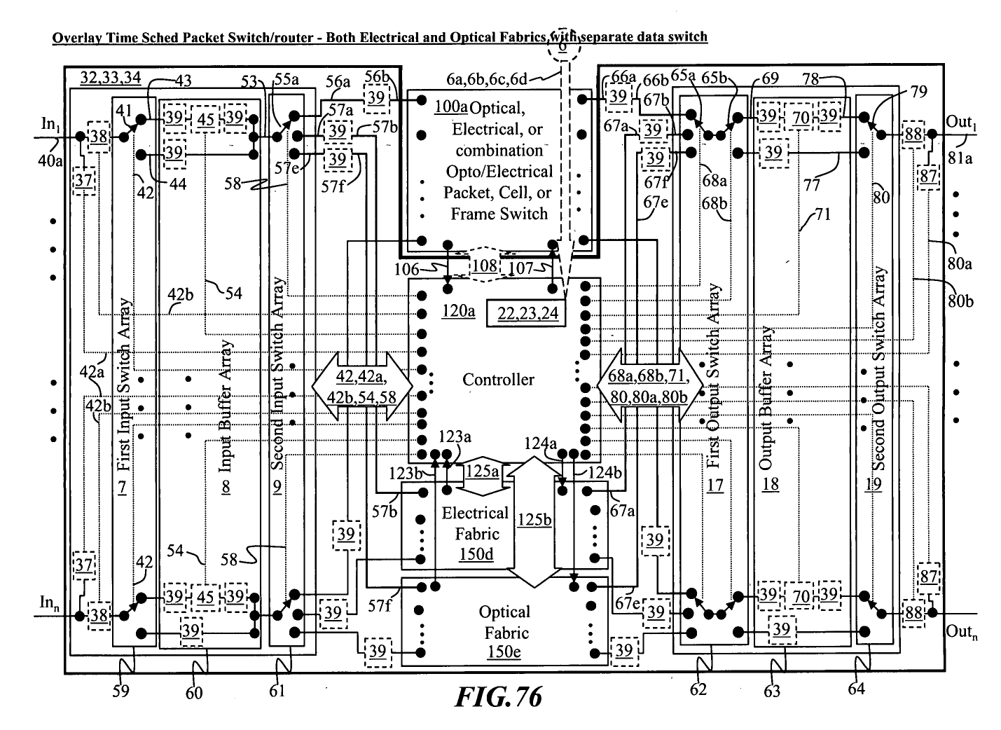

FIG. 75 is a high level schematic diagram of an Integrated Time Scheduled Packet & Layer 2/3 Switch/router—Electrical Single Fabric with Dual Fabric lines per input.

FIG. 76 is an illustrative example of the time-scheduled and/or time-reserved datagram/packet network showing a second embodiment of the network element devices descriptively entitled an “overlay” embodiment, wherein the packet, cell, or frame routers or switches 2, 3, and 4 are separate devices both structurally and control-wise from the time-scheduled and/or time-reserved datagram/packet bypass switching systems 32, 33, and 34 respectively. One purpose of this “overlay” embodiment is to be able to less expensively add time-scheduled and/or time-reserved datagram/packet switching to existing packet networks with existing packet, cell, or frame switches. In this case, only the time-scheduled and/or time-reserved datagram/packet systems 32, 33, or 34 along with their synchronization means require additional expense.

In this second embodiment, the time-scheduled and/or time-reserved datagram/packet controllers in systems 32, 33, and 34 are not the primary controllers of the packet, cell, or frame routers or switches 2, 3, and 4. Packet, cell, or frame routers or switches 2, 3, and 4 can operate as stand-alone units and control their own functionality. The time-scheduled and/or time-reserved datagram/packet systems 32, 33, and 34 are “overlaid” on top of or around the standard packet, cell, or frame switches 2, 3, and 4, such that standard packets arriving on lines 12 coming into the node 33 go through the time-scheduled and/or time-reserved datagram/packet system 33 and then are routed through lines 56 to the “overlaid” packet, cell, or frame switch 2. Output lines coming out of packet, cell, or frame switch 2 are routed through lines 66 back into the time-scheduled and/or time-reserved datagram/packet system 33 and then out on transmission lines 14.

This means that the time-scheduled and/or time-reserved datagram/packet systems 32, 33, and 34 will be unable to directly control delaying, stopping or starting standard non-real-time, non-high-priority store-and-forward packets while they are partially or completely in packet, cell, or frame switches 2, 3, and 4. As a result, if there is contention for an output port between the time-scheduled and/or time-reserved datagram/packet systems 32, 33, or 34 and their respective standard packet, cell, or frame switches 2, 3, or 4, the time-scheduled and/or time-reserved datagram/packet control system will prevail and the time-scheduled and/or time-reserved datagram/packet packet that is scheduled will get routed. The standard packet from packet, cell, or frame switch 2, 3, or 4 contending for the output port will be stored in the output buffers of the respective time-scheduled and/or time-reserved datagram/packet system 32, 33, or 34. The “overlay” embodiment can be designed to store standard packets coming from the packet, cell, or frame switch 2, 3, or 4, to the output buffers, but the output buffers must be large enough to prevent overflow if the Level 1 scheduled time is lengthy.

A third embodiment of the device (not shown because it is a deconstruction of the second embodiment) can be implemented in which the “overlay” embodiment is used, but the input buffers are removed. This cost-cutting approach, also termed the “dummied down” embodiment theoretically could lose incoming packets, cells, or frames due to time-scheduled and/or time-reserved datagram/packet switching contention. However, practically speaking the output of the previous switch which is feeding the current input buffers must typically uses synchronization flags, frame delimiters, or the like, which is all that would probably be lost in this scenario. In the case that standard packets were lost, as they inevitably are in congested store-and-forward networks, standard protocols will generally ensure retransmission.

A fourth embodiment of the device (not shown because it is a deconstruction of the second and third embodiments) can be implemented in which the “overlay” embodiment is used, but the input and output buffers are removed. This cost-cutting approach, also termed the “really dummied down” embodiment will undoubtedly lose outgoing packets, cells, or frames due to time-scheduled and/or time-reserved datagram/packet switching contention. In the case that standard packets, cells, or frames are lost, as they inevitably are in congested store-and-forward networks, standard protocols will generally ensure retransmission. However, this is viewed as a low-cost, low-performance trade-off and is not preferred. Nevertheless, the use of this approach has the advantages that time-scheduled and/or time-reserved datagram/packet packet switching with its benefits can be implemented over an existing store-and-forward network at very low cost, thus giving time-scheduled and/or time-reserved datagram/packet performance at the expense of degraded standard packet, cell, or frame-based performance.

FIG. 76 illustrates a second embodiment of the device, also termed the “overlay” embodiment, wherein the packet, cell, or frame switch 100 is a separate, non-integrated device, as explained previously. FIG. 10 works in the same manner as the preferred embodiment shown in FIG. 58, except that there is no control means 108 between controller 120 and switch 100. From a practical standpoint, controller 120 can still control when it sends packets from InBuffer₁ 45 to switch 100, so that it can avoid time-scheduled and/or time-reserved datagram/packet conflicts when transferring standard packets, cells, or frames in InBuffer₁ 45 to switch 100. However, controller 120 cannot control when separate and discrete switch 100 will send packets, cells, or frames into OutBuffer₁ 70. The solution is to modify the first output switch array 62 in the non-integrated second embodiment as shown in FIG. 10. This modification comprises removing the first output switch array 62 including switch 65, line 69, and control line(s) 68; then adding line 69a such that the output line 66 from switch 100 routes directly from the output of switch 100 through line 69a into OutBuffer₁ 70; then adding line 69b, such that switch 150 feeds out through line 67, directly over line 69b, and into output buffer bypass line 77. In this way, whenever there is conflict at the output buffer between scheduled time-scheduled and/or time-reserved datagram/packet packets from switching means which may be non-blocking, non-delaying switch 150 and store-and-forward packets from switch 100, both packets route without interfering with each other. The time-scheduled and/or time-reserved datagram/packet packets route straight through the bypass line and out of the output line Out₁ 81. The store-and-forward packets dump into the OutBuffer₁ 70. The only danger is that if the time-scheduled and/or time-reserved datagram/packet schedule is highly filled, OutBuffer₁ 70 may overflow, losing packets and causing congestion. This effect may be partially ameliorated by increasing the size of OutBuffer₁ 70 and decreasing the time-scheduled and/or time-reserved datagram/packet scheduling commitments that this embodiment's device is allowed to accept.

The third and fourth embodiments, descriptively titled the “dummied down” and “dummied way down” embodiments respectively, are modifications of the second embodiment shown in FIG. 76.

In the third embodiment, the input buffer array 60 with its input buffers InBuffer₁ 45 is eliminated along with the first input switch array 59 with its switches 41. This means that input line In₁ 40 goes directly to the input of switch 55. Controller 120 continues to use control lines 58 to control the switching of switch 55 for time-scheduled and/or time-reserved datagram/packet switching. However, control lines 42 and 54 are not used in this embodiment.

In the fourth embodiment, the output buffer array 63 with its output buffers OutBuffer₁ 70 is eliminated. This means that lines 66 and 67 go directly to switch 79, which is still controlled by control line 80. Switch 79 continues to feed output line Out₁ 81. Control line 71 is no longer used in this embodiment.

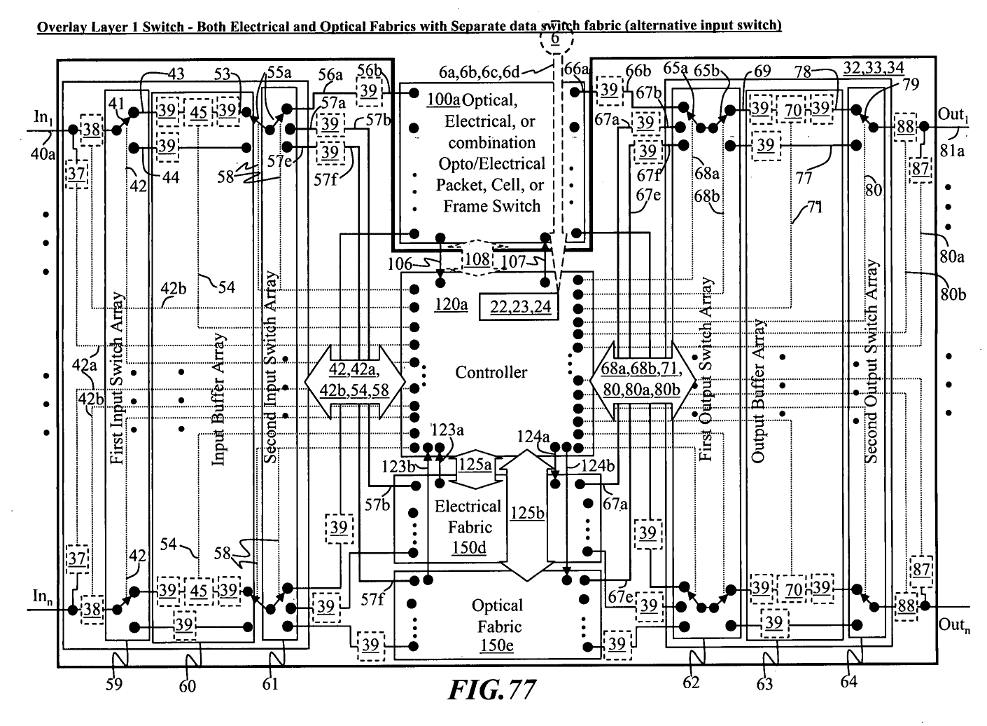

FIG. 77 is a high level schematic diagram of an Overlay Layer 1 Switch—Both Electrical and Optical Fabrics with Separate data switch fabric (alternative input switch).

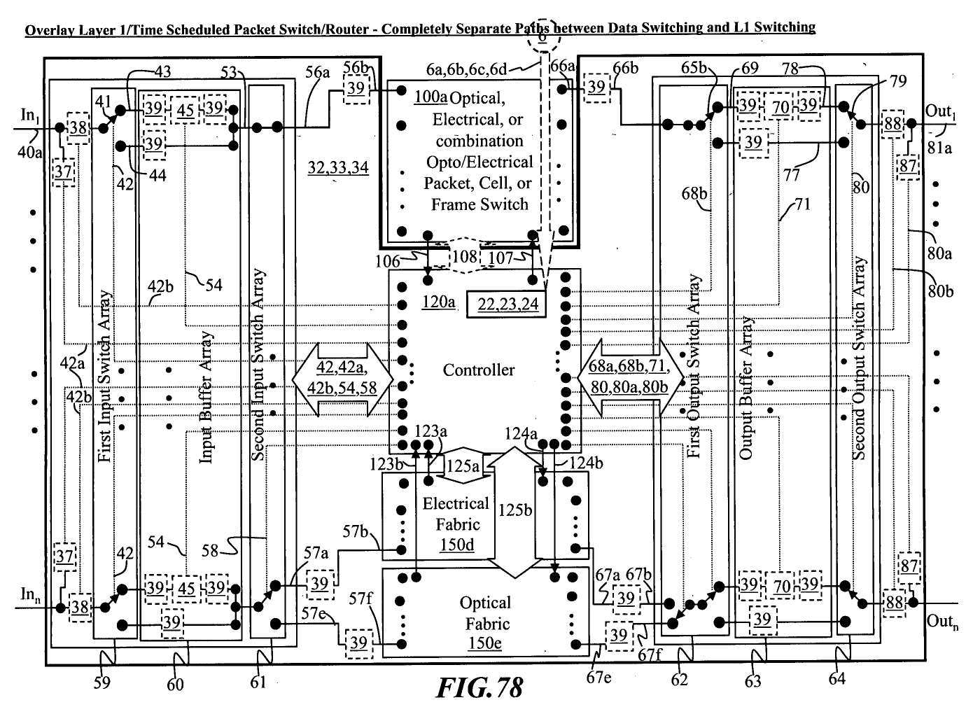

FIG. 78 is a high level schematic diagram of an Overlay Layer 1/Time Scheduled Packet Switch/Router—Completely Separate Paths between Data Switching and L1 Switching.

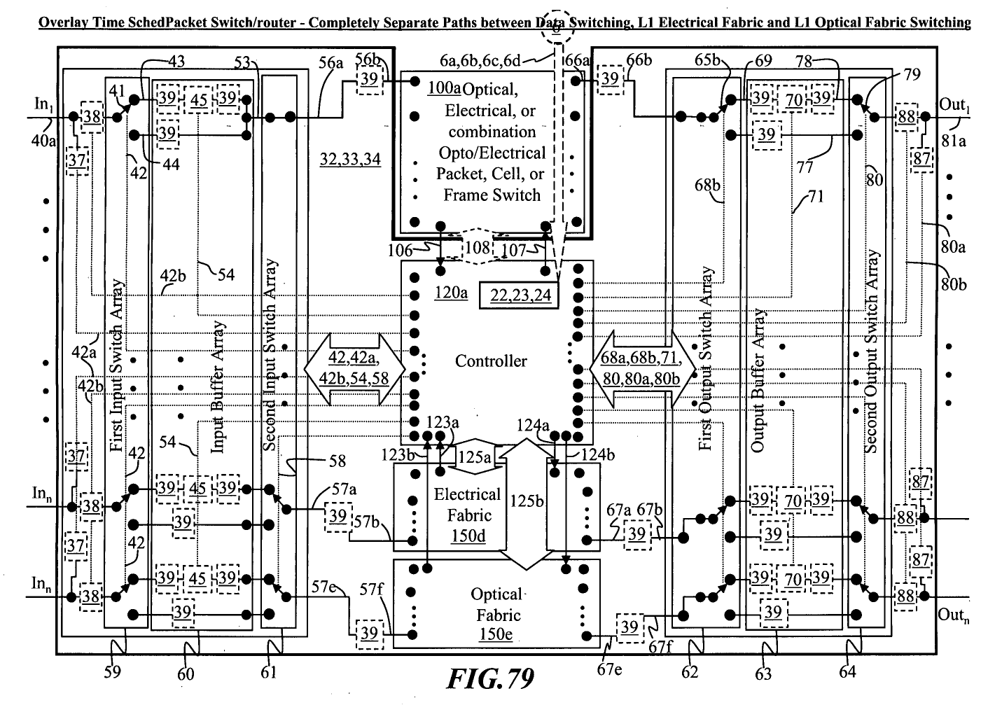

FIG. 79 is a high level schematic diagram of an Overlay Time Scheduled Packet Switch/router—Completely Separate Paths between Data Switching, L1 Electrical Fabric and L1 Optical Fabric Switching.

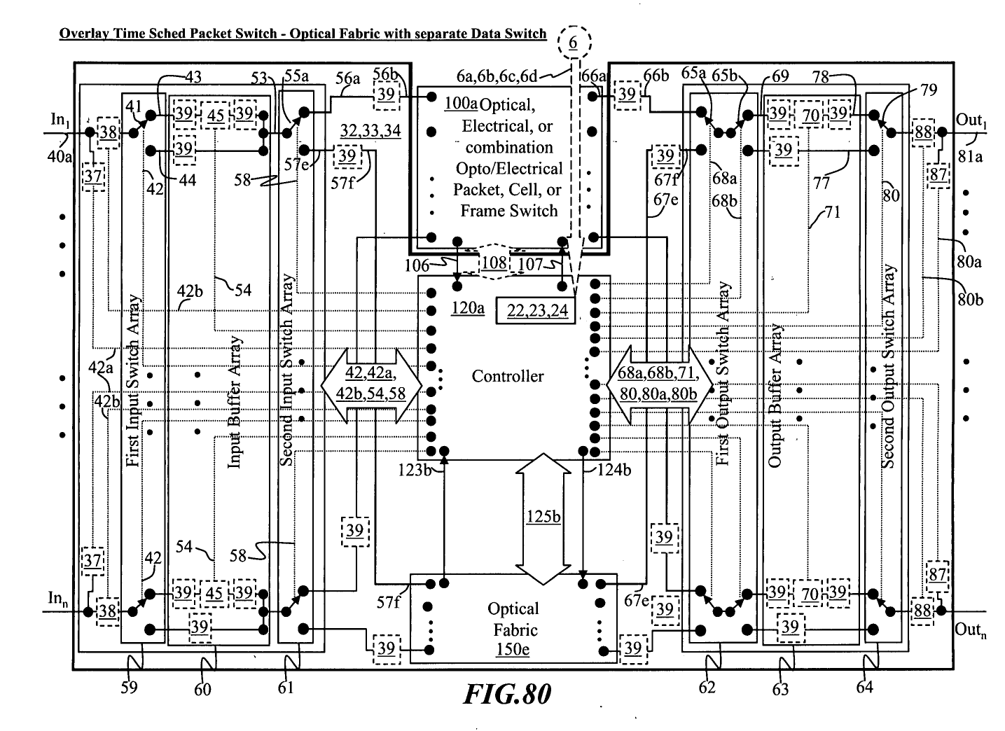

FIG. 80 is a high level schematic diagram of an Overlay Time Scheduled Packet Switch—Optical Fabric with separate Data Switch.

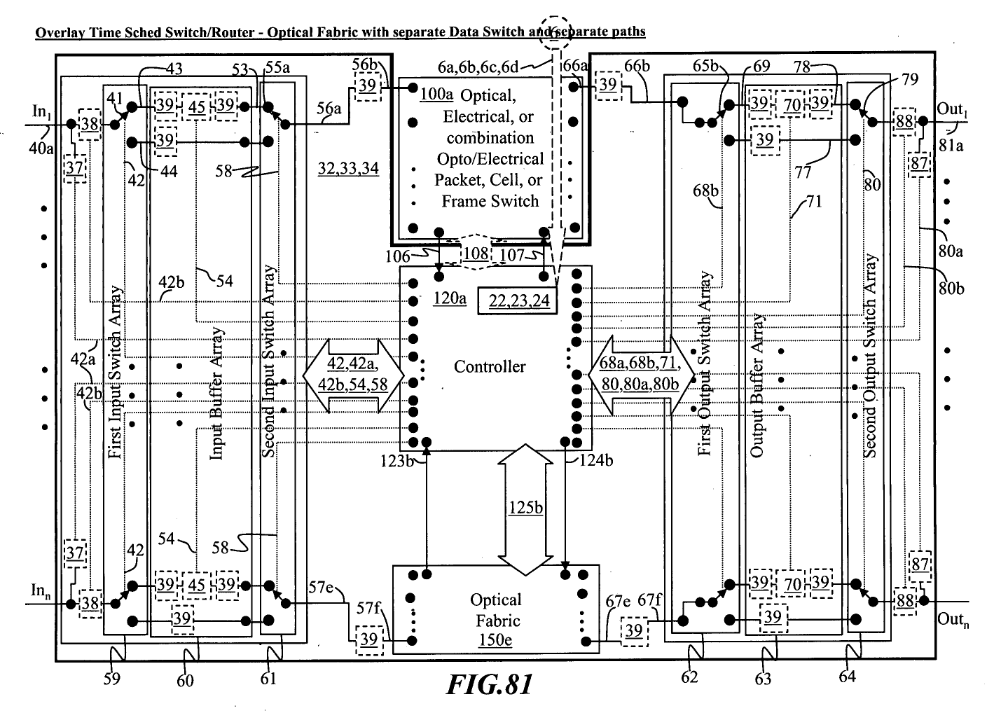

FIG. 81 is a high level schematic diagram of an Overlay Time Scheduled Switch/Router—Optical Fabric with separate Data Switch and separate paths.

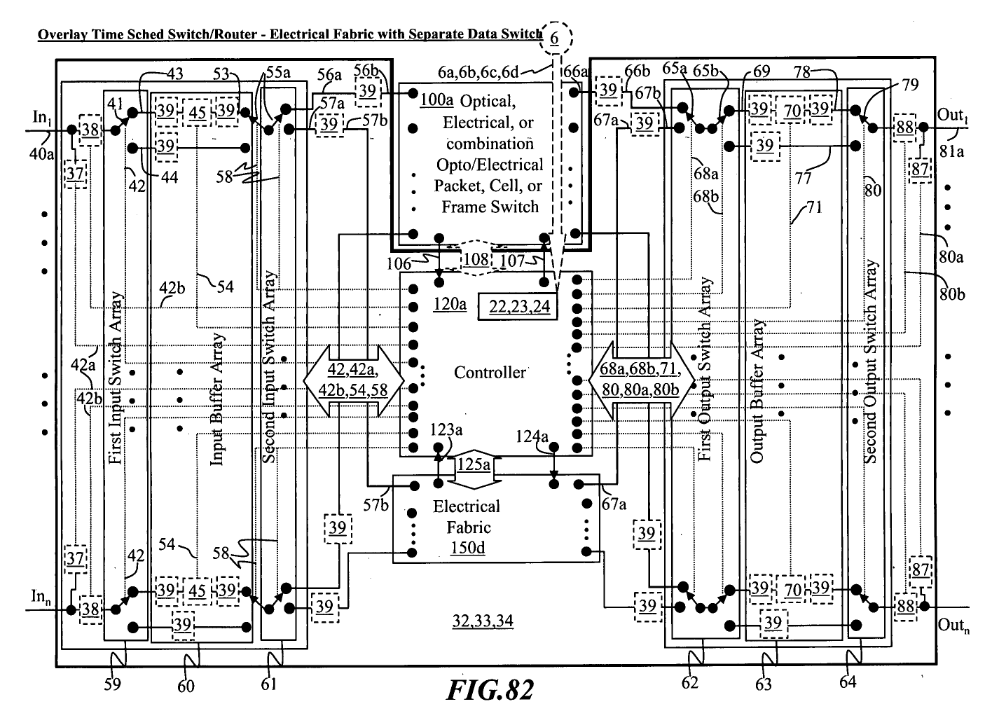

FIG. 82 is a high level schematic diagram of an Overlay Time Scheduled Switch/Router—Electrical Fabric with Separate Data Switch.

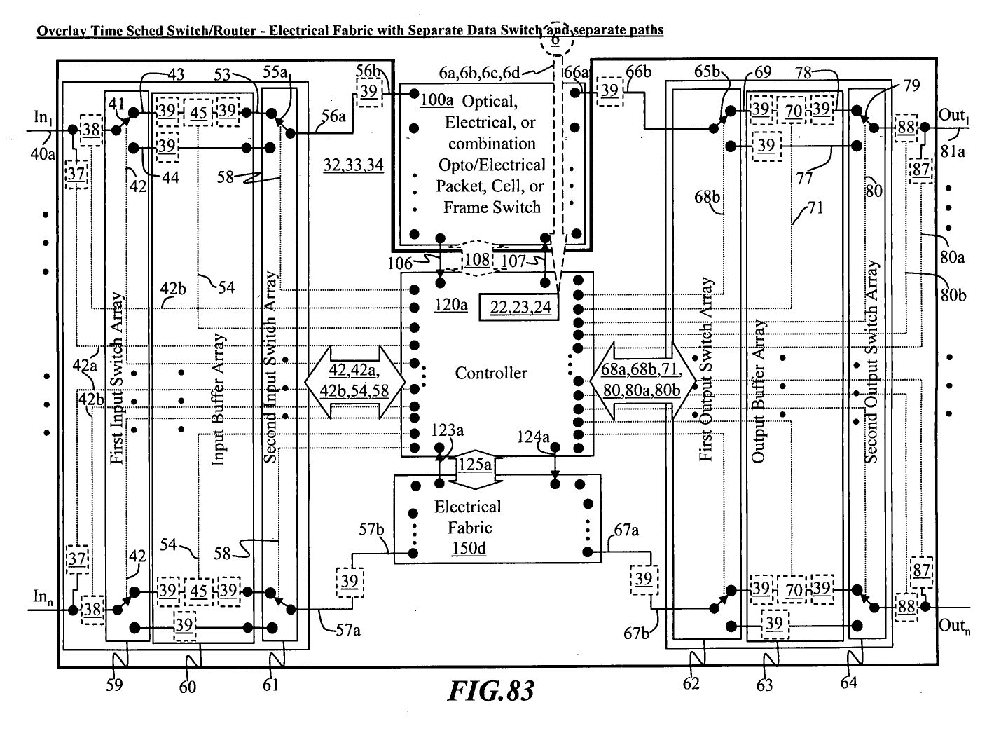

FIG. 83 is a high level schematic diagram of an Overlay Time Scheduled Switch/Router—Electrical Fabric with Separate Data Switch and separate paths.

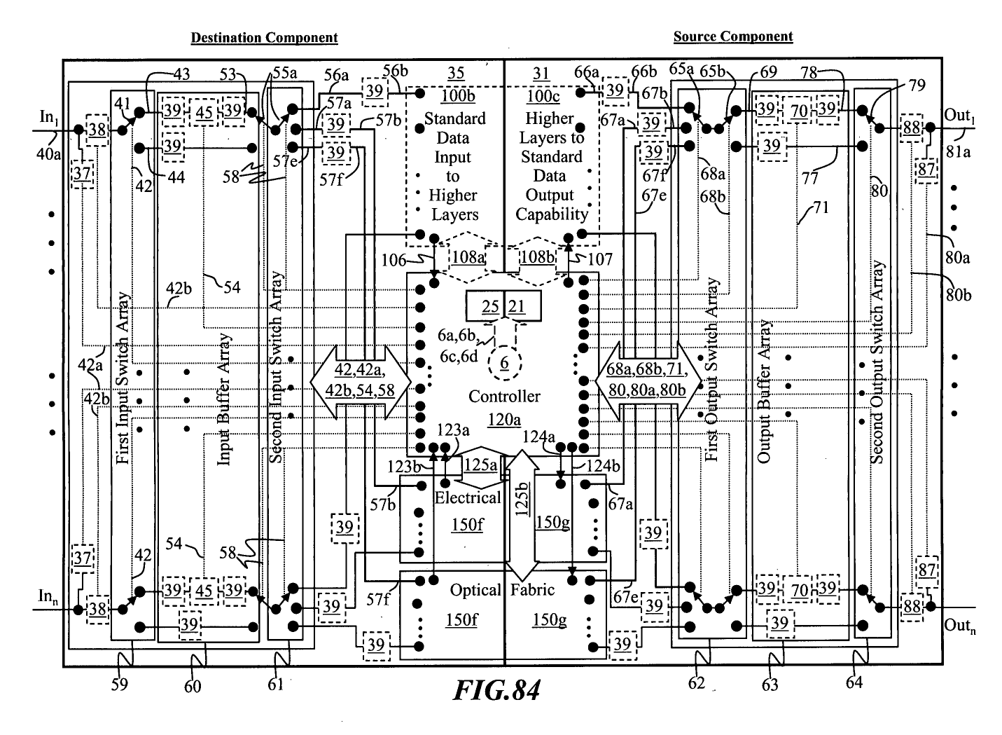

FIG. 84 is an illustrative example of the time-scheduled, and/or time-reserved datagram/packet network showing a fifth embodiment of the device, descriptively entitled the “source and destination” or “end-user” embodiment, wherein the time-scheduled, and/or time-reserved datagram/packet system functionality has been moved outside of the network boundaries into the source and destination devices themselves. In this fifth embodiment of the device, synchronization means 21 is using the same master clock 6 to synchronize the time-scheduled and/or time-reserved datagram/packet system 31 in the source device 1. In the same manner, synchronization means 25 is using the same master clock 6 to synchronize the time-scheduled and/or time-reserved datagram/packet system 35 in the destination device 5. Since all of the time-scheduled and/or time-reserved datagram/packet devices 31, 32, 33, 34, and 35 are synchronized to the same master clock 6, the entire chain can easily implement time-scheduled and/or time-reserved datagram/packet switching functionality end-to-end. The purpose of this “end-user” embodiment includes being able to decrease delay time, response time, and jitter even further by not requiring real-time or high-priority packets to have to be buffered by the originating node 32 while waiting for the scheduling time. In this way, the time-scheduled and/or time-reserved datagram/packet enabled end-user devices 1 and 5 will know what the time-scheduled and/or time-reserved datagram/packet schedule is and can deliver their real-time or high-priority application data in a more knowledgeable and hence efficient manner. Although FIG. 6 shows these end-user device embodiments outside of the network boundaries, they also could be considered network elements, as they can now function as part of the time-scheduled and/or time-reserved datagram/packet network since they move some network functionality to the end-user device.

FIG. 84 is an illustrative example of a fifth embodiment of the device according to the present invention, descriptively entitled the “end-user” embodiment, wherein the time-scheduled and/or time-reserved datagram/packet system functionality has been moved outside of the network boundaries into the source and destination devices. As discussed previously in FIG. 3, each of devices has a source and a destination component. Both the source and destination components are shown in FIG. 84. Note that for purposes of drawing similarity and clarity, the destination component is on the left and the source component is on the right in FIG. 84. The “end-user” embodiment of the device according to the present invention is very much like the first embodiment, i.e., the integrated device embodiment, except that the packet, cell, or frame based switch 100 has been replaced in the end-user device by industry standard packet-based device input capability 5 and industry standard source packet-based output capability 1. This capability includes various software,and hardware means which are used to apply and strip off the layers of protocol required to communicate in a store-and-forward network, such that the end user is presented with the application layer information as is well known to those skilled in the art. All of these capabilities for standard input and output exist today in hardware and software communications applications, e.g., Outlook™ e-mail software from Microsoft®, Explorer™ web browser from Microsoft®.

The other change in the “end-user” embodiment from the first embodiment of the present invention is the replacement of the switching means which may be non-blocking, non-delaying switch 150 with real-time packet-oriented input capability 35 and real-time packet-oriented output capability 31. An example of this would be software and hardware necessary to communicate in a real-time application such as Internet Phone. With Internet Phone, the real-time packet-oriented input capability 35 comprises various hardware and software means to get the voice input, sample it, digitize it, compress it, and put it in regular, periodic packets suitable for time-scheduled and/or time-reserved datagram/packet transmission. Real-time source output capability 31 in the example of Internet Phone comprises various hardware and software means to receive time-scheduled and/or time-reserved datagram/packet packets, assemble them, deliver them to the application in a usable way, convert them from digital to analog and play the audio out on a speaker. All of these capabilities for real-time input and output exist today in hardware and software applications like video conferencing hardware and software from Intel®, Internet Phone™ from VocalTec®, and Netshow™ from Microsoft®, and streaming audio/video from RealAudio®.

All of the other capabilities of the “end-user” embodiment are the same as the previous embodiments. The controller controls when packets would be shipped and received. For a single user, the capabilities might include only one input buffer 45 and only one output buffer 70, but for shared end-user devices there may be multiple lines and buffers as shown in FIG. 84.

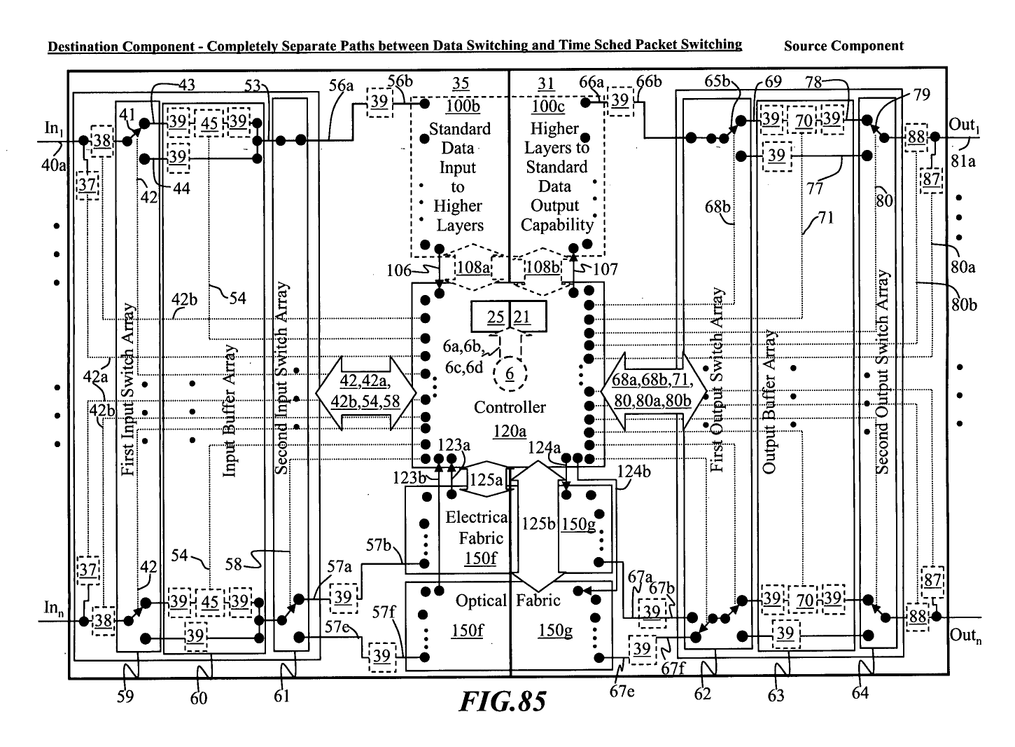

FIG. 85 is a high level schematic diagram of a “source and destination” embodiment or “end-user” embodiment of a time-scheduled and/or time-reserved datagram/packet network switch or router device with a Destination Component—Completely Separate Paths between Data Switching and Time Scheduled Packet Switching.

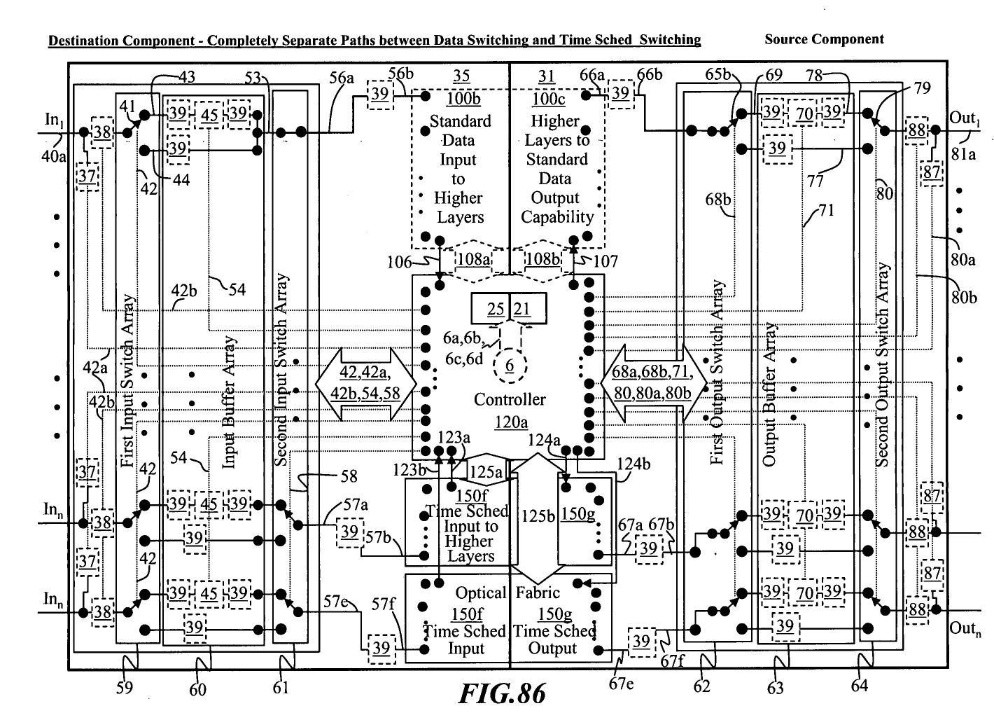

FIG. 86 is a high level schematic diagram of a “source and destination” embodiment or “end-user” embodiment of a time-scheduled and/or time-reserved datagram/packet network switch or router device with a Destination Component—Completely Separate Paths between Data Switching and Time Scheduled Switching.

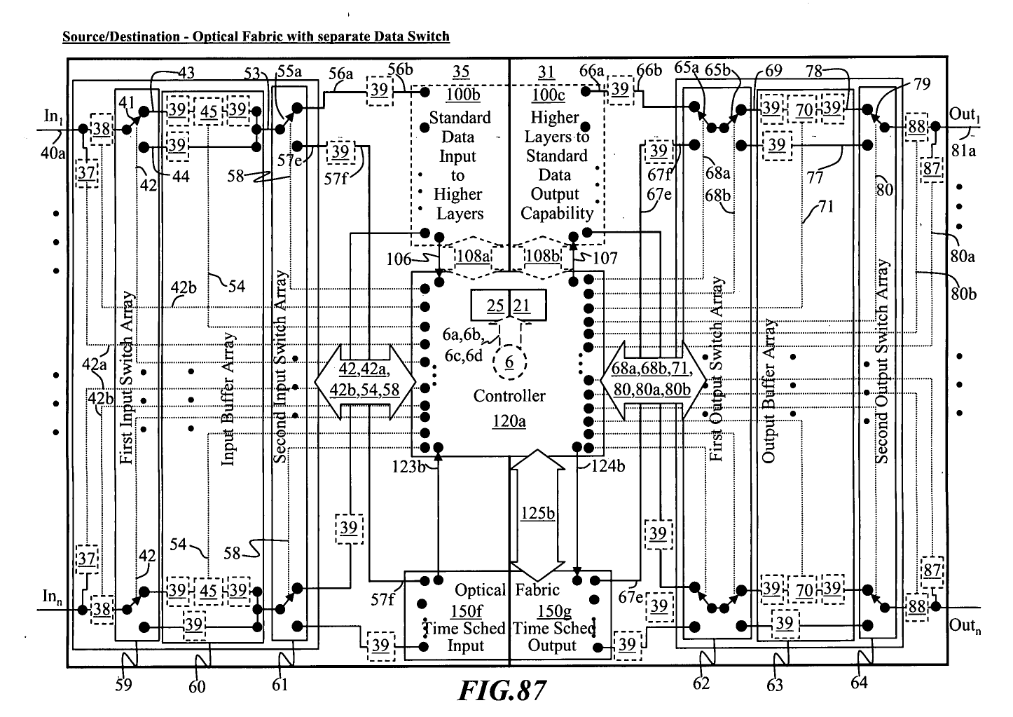

FIG. 87 is a high level schematic diagram of a “source and destination” embodiment or “end-user” embodiment of a time-scheduled and/or time-reserved datagram/packet network switch or router device with a Source/Destination—Optical Fabric with separate Data Switch.

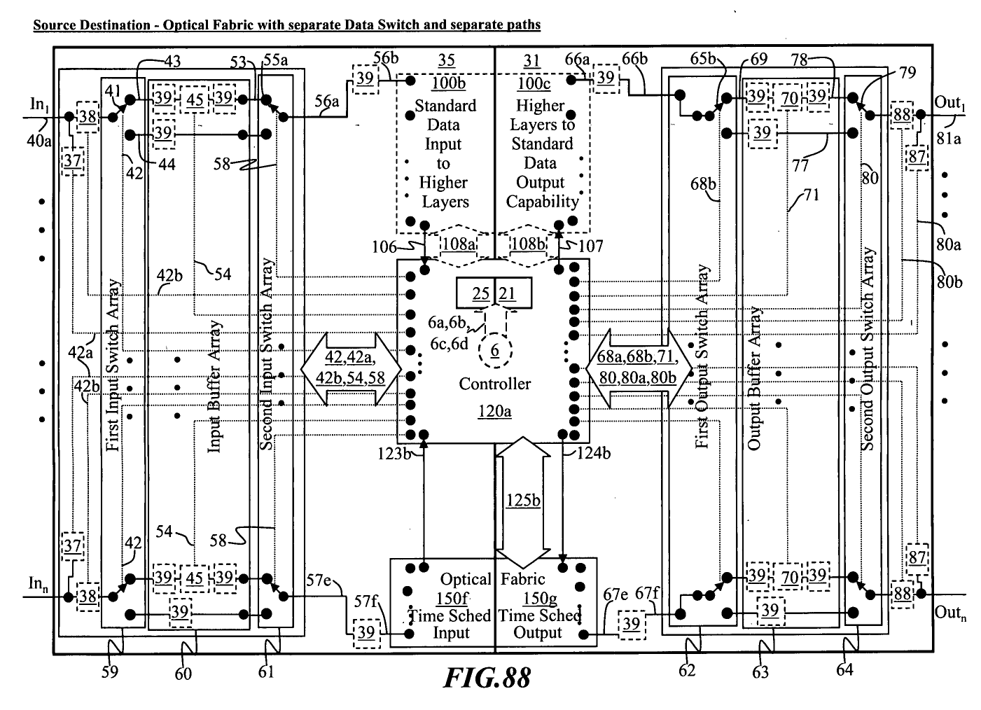

FIG. 88 is a high level schematic diagram of a “source and destination” embodiment or “end-user” embodiment of a time-scheduled and/or time-reserved datagram/packet network switch or router device with a Source Destination—Optical Fabric with separate Data Switch and separate paths.

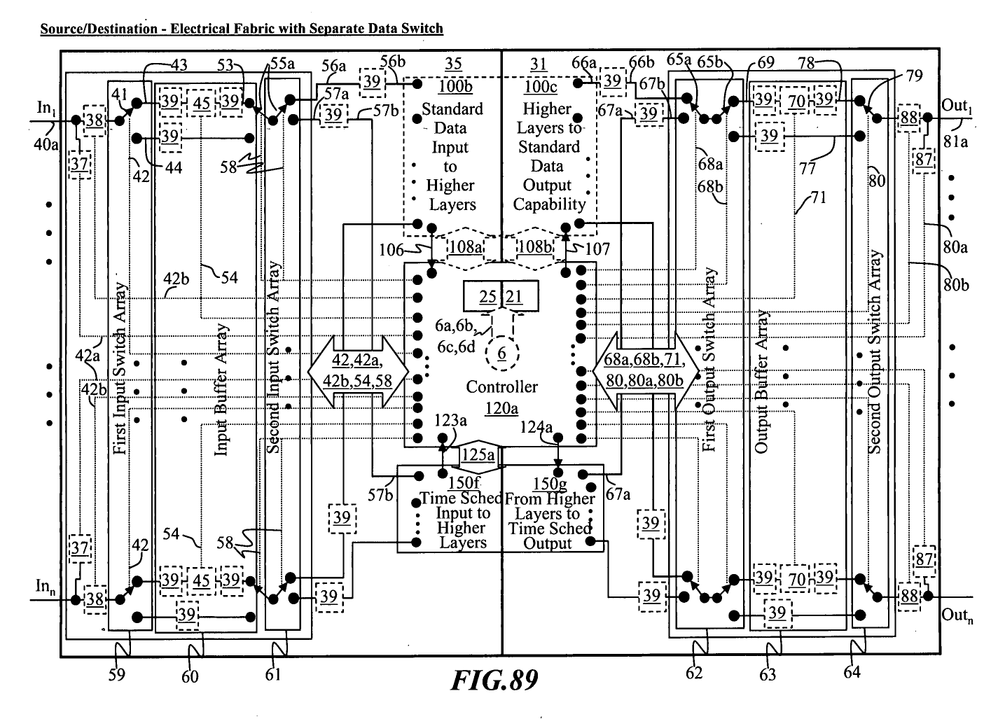

FIG. 89 is a high level schematic diagram of a “source and destination” embodiment or “end-user” embodiment of a time-scheduled and/or time-reserved datagram/packet network switch or router device with a Source/Destination—Electrical Fabric with Separate Data Switch.

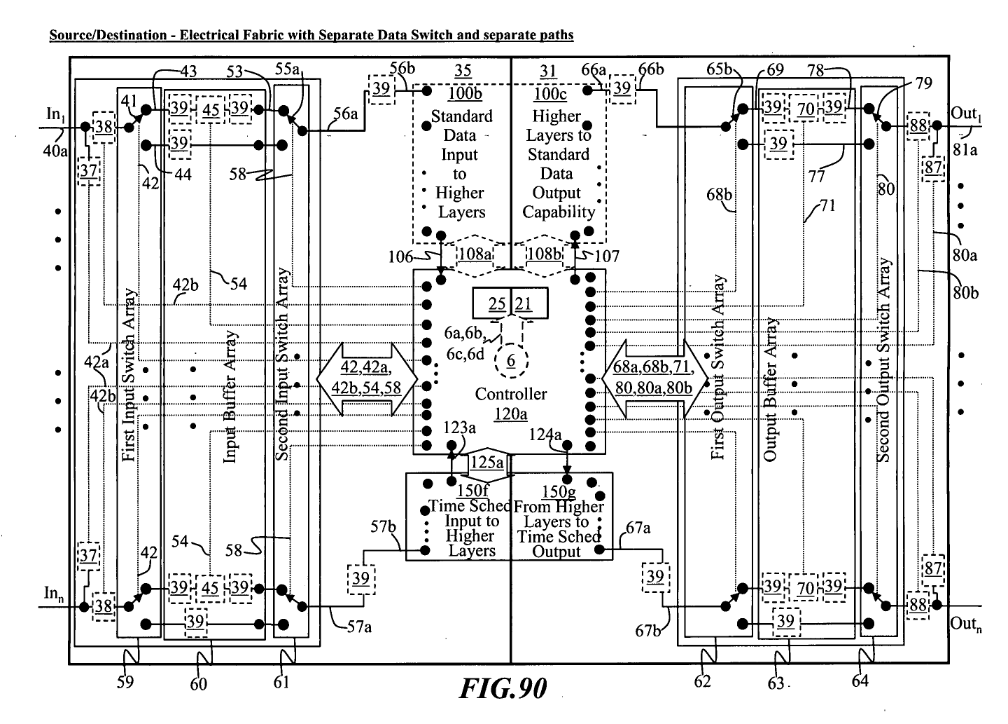

FIG. 90 is a high level schematic diagram of a “source and destination” embodiment or “end-user” embodiment of a time-scheduled and/or time-reserved datagram/packet network switch or router device with a Source/Destination—Electrical Fabric with Separate Data Switch and separate paths.

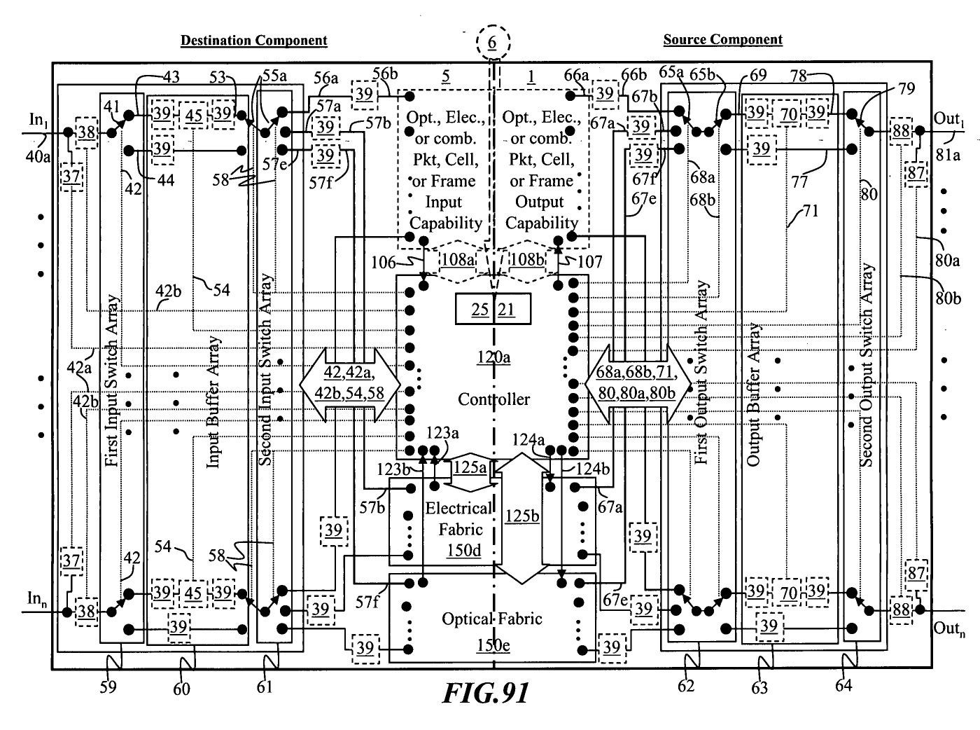

FIG. 91 is a high level schematic diagram of a “source and destination” embodiment or “end-user” embodiment of a time-scheduled and/or time-reserved datagram/packet network switch or router device with a Source/Destination—Optical and Electrical Fabric with Separate Data Switch and separate paths.

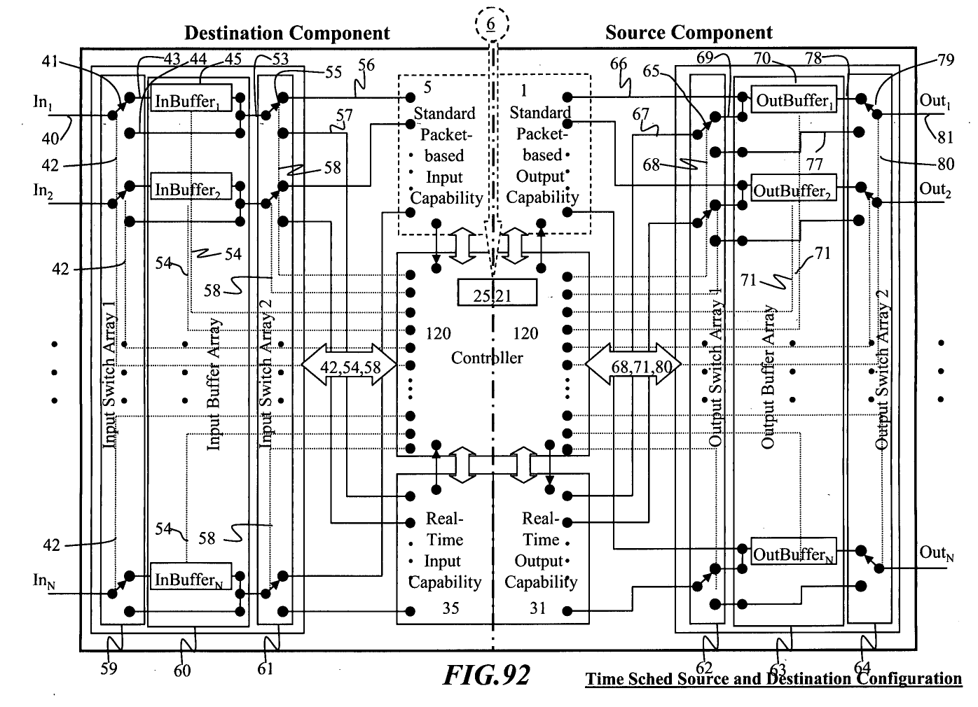

FIG. 92 is a high level schematic diagram of a generalized “source and destination” embodiment or “end-user” embodiment of a time-scheduled and/or time-reserved datagram/packet network element.

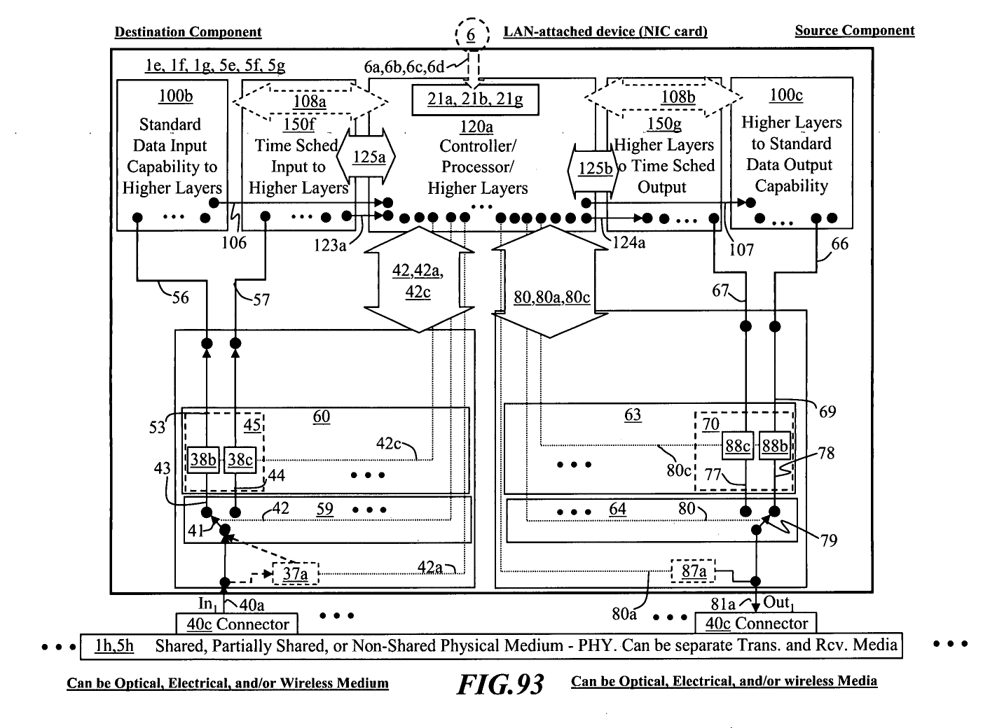

FIG. 93 is an illustrative examples of a more complex version of a time-scheduled and/or time-reserved datagram/packet network showing the previously described sources, destinations, and time-scheduled and/or time-reserved datagram/packet network elements interconnected. Master clock 6 is still used to synchronize all of the device embodiments.

In FIG. 93, Source 1a and Destination 5a are illustrative examples of the sixth device embodiment also termed the “LAN” embodiment. Source 1a exemplifies a time-scheduled and/or time-reserved datagram/packet-capable Ethernet-style LAN controller, bridge, or router. Destination 5a exemplifies a time-scheduled and/or time-reserved datagram/packet-capable Token Ring or other ring-style LAN controller, bridge, or router. Time-scheduled and/or time-reserved datagram/packet star-type LANs could also be implemented in the same manner.

In all of these “LAN” embodiments a Local Area Network or LAN is connected to the time-scheduled and/or time-reserved datagram/packet Network, such that the LAN controller, bridge, router and/or switch 1a includes time-scheduled and/or time-reserved datagram/packet functionality 31 and timing synchronization means 21, and is connected to a time-scheduled and/or time-reserved datagram/packet switch 32 in the network. In this way time-scheduled and/or time-reserved datagram/packet LANs can be connected to time-scheduled and/or time-reserved datagram/packet networks. “LAN” device embodiments may consist of the LAN controller 1 a having time-scheduled and/or time-reserved datagram/packet functionality 31 and timing synchronization 21 either with or without the LAN-attached devices having time-scheduled and/or time-reserved datagram/packet functionality. If the LAN-attached devices do not have time-scheduled and/or time-reserved datagram/packet functionality, they can still send real-time or high-priority messages by sending them via the normal LAN protocols to the time-scheduled and/or time-reserved datagram/packet enabled LAN controller 1a, 31, and 21, which then acts as an edge node, stores the packets, sets up the layer path to the destination and then schedules the release of the packets.

Alternatively, FIG. 93 shows that the “LAN” device embodiment can comprise the LAN controller 1a, 21, 31, with LAN-attached devices 1e, 21a, 31a; If, 21b, 31b; and 1g, 21c, 31c representing a time-scheduled and/or time-reserved datagram/packet synchronized LAN, with said devices attached to the LAN having time-scheduled and/or time-reserved datagram/packet functionality as well as the LAN controller 1a.

In this configuration, the LAN controller, bridge, router, and/or switching device 1a with time-scheduled and/or time-reserved datagram/packet functionality means 31 could synchronize with the network's master clock 6, such as a GPS system using synchronization means 21. The devices on the LAN 1e, 1f, and 1g with time-scheduled and/or time-reserved datagram/packet capability 31a, 31b, and 31c respectively, could then synchronize off of the LAN controller 1a using timing synchronization means 21a, 21b, and 21c, respectively. This method of synchronization could be similar to the NTP method cited in the TrueTime reference. Alternatively, the devices on the LAN 1e, 1f, and 1g could use timing synchronization means 21a, 21b, and 21c respectively with other timing synchronization methods such as the two-way time transfer method cited in the U.S. Naval observatory reference, or they could each synchronize directly with the GPS system.

FIG. 93 also shows destination 5a as an illustrative example of a ring-style “LAN” embodiment of the device, wherein a Local Area Network or LAN is connected to the time-scheduled and/or time-reserved datagram/packet Network. In this example the LAN controller, router, and/or destination switch 5a includes time-scheduled and/or time-reserved datagram/packet functionality 35 with timing synchronization means 25 and is connected to time-scheduled and/or time-reserved datagram/packet switch 34 in the network. In this way time-scheduled and/or time-reserved datagram/packet switching can be connected to LANs as well as other devices. “LAN” device embodiments may consist of the LAN controller 5a having time-scheduled and/or time-reserved datagram/packet functionality 35 and timing synchronization 25 either with or without the LAN-attached devices having time-scheduled and/or time-reserved datagram/packet functionality. If the LAN-attached devices do not have time-scheduled and/or time-reserved datagram/packet functionality, they can still send real-time or high-priority messages by sending them via the normal LAN protocols to the time-scheduled and/or time-reserved datagram/packet enabled LAN controller 5a, 35, and 25, which then acts as an edge node, stores the packets, sets up the layer path to the destination and then schedules the release of the packets.

Alternatively, FIG. 93 shows that the “LAN” device embodiment can comprise the LAN controller 5a, 25, 35, with LAN-attached devices 5e, 25a, 35a; 5f, 25b, 35b; and 5g, 25c, 35c in a token ring style configuration, representing a time-scheduled and/or time-reserved datagram/packet synchronized LAN, with said devices attached to the LAN having time-scheduled and/or time-reserved datagram/packet functionality as well as the LAN controller 5a.

In this configuration, the LAN controller, bridge, router, and/or switching device 5a with time-scheduled and/or time-reserved datagram/packet functionality means 35 could synchronize with the network's master clock 6, such as a GPS system using synchronization means 25. The devices on the LAN 5e, 5f, and 5g with time-scheduled and/or time-reserved datagram/packet capability 35a, 35b, and 35c respectively, could then synchronize off of the LAN controller 5a using timing synchronization means 25a, 25b, and 25c, respectively. This method of synchronization could be similar to the NTP method cited in the TrueTime reference. Alternatively, the devices on the LAN 5e, 5f, and 5g could use timing synchronization means 25a, 25b, and 25c respectively with other timing synchronization methods such as the two-way time transfer method cited in the U.S. Naval observatory reference, or they could each synchronize directly with the GPS system.

In time-scheduled and/or time-reserved datagram/packet “LAN” embodiments, the LAN software in all of the LAN devices would be upgraded to include the capability to suspend normal LAN contention or action during scheduled time-scheduled and/or time-reserved datagram/packet events. Each LAN device would listen for scheduled time-scheduled and/or time-reserved datagram/packet events and not transmit during those times. When scheduled time-scheduled and/or time-reserved datagram/packet events were not occurring, LAN contention would resume as normal. Since all of the LAN devices would be synchronized, they could easily perform these capabilities and could communicate at a time-scheduled and/or time-reserved datagram/packet level to other devices on the same time-scheduled and/or time-reserved datagram/packet enabled LAN, to devices on adjoining time-scheduled and/or time-reserved datagram/packet enabled LANs, and/or to devices in other interconnected time-scheduled networks. This means that applications such as the integration of voice mail and email could be consolidated or integrated onto a single platform and in a single networking environment, even though email arrives at the application by standard store-and-forward networking, while voice mail arrives using time-scheduled and/or time-reserved datagram/packet networking.

In FIG. 93, Source 1b exemplifies a source connected directly to the time-scheduled and/or time-reserved datagram/packet network through transmission line 11. Source 1c exemplifies a host system with time-scheduled and/or time-reserved datagram/packet switching capability.

Source 1d in FIG. 93 exemplifies a time-scheduled and/or time-reserved datagram/packet network that is connected to a separate time-scheduled and/or time-reserved datagram/packet network. In this case, the time-scheduled and/or time-reserved datagram/packet networks can establish seamless time-scheduled and/or time-reserved datagram/packet sessions and route seamless time-scheduled and/or time-reserved datagram/packet switching end-to-end across both time-scheduled and/or time-reserved datagram/packet networks. Even when these interconnected time-scheduled and/or time-reserved datagram/packet networks are not synchronized off of the same master clock 6, there are methods which will be explained subsequently, whereby the time-scheduled and/or time-reserved datagram/packet nodes in different networks can determine very accurately the differences in times between their clocks and the clocks of adjacent time-scheduled and/or time-reserved datagram/packet nodes, and the propagation delay between the nodes. With this information, they can calculate and use offsets to adjust for their timing differences and propagation delays such that the time-scheduled and/or time-reserved datagram/packet scheduling between adjacent nodes is highly accurate, highly efficient, and error-free.

Destination 5b exemplifies a time-scheduled and/or time-reserved datagram/packet enabled end-user destination receiving time-scheduled and/or time-reserved datagram/packet routing directly to its internal time-scheduled and/or time-reserved datagram/packet system 35 through transmission line 14. Destination 5c exemplifies a host system with time-scheduled and/or time-reserved datagram/packet switching capability.

Destination 5d in FIG. 93 exemplifies a time-scheduled and/or time-reserved datagram/packet network that is connected to a different time-scheduled and/or time-reserved datagram/packet network as already discussed. A plurality of time-scheduled and/or time-reserved datagram/packet networks can be interconnected for extremely rapid transfer of data through all of the networks.

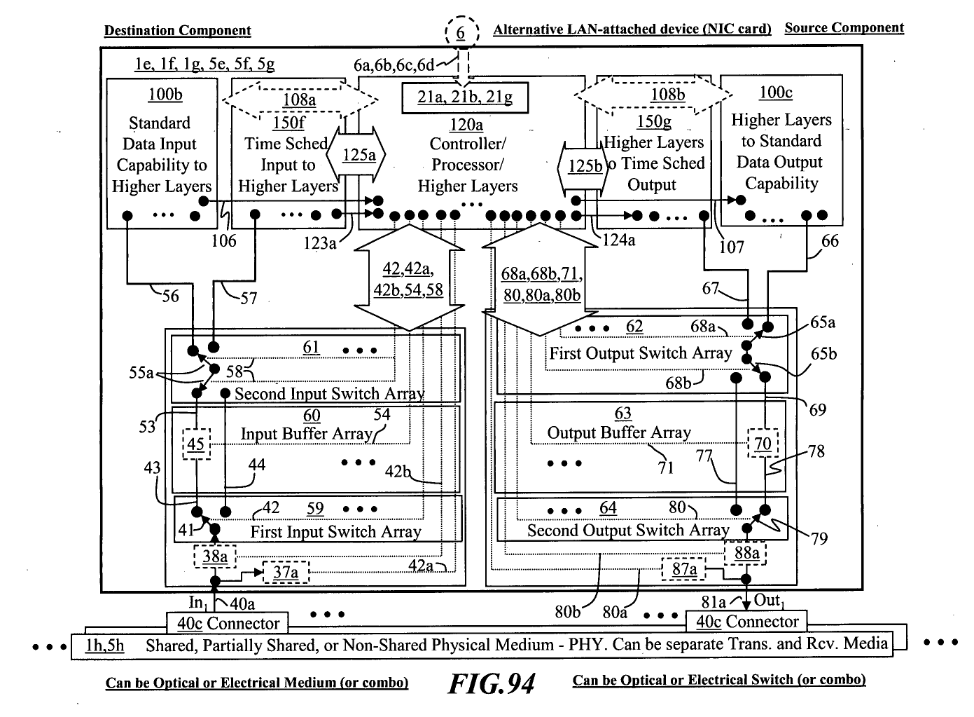

FIG. 94 is a high level schematic diagram of a “source and destination” embodiment or “end-user” embodiment of a time-scheduled and/or time-reserved datagram/packet network element for a Shared, Partially Shared, or Non-Shared Physical Medium—PHY 1h, 5h, such as an Alternative LAN-attached device (NIC card. Can be separate Transmission and Receive Media, such as an Ethernet LAN and/or wireless LAN. Can be optical, electrical, and/or wireless media.

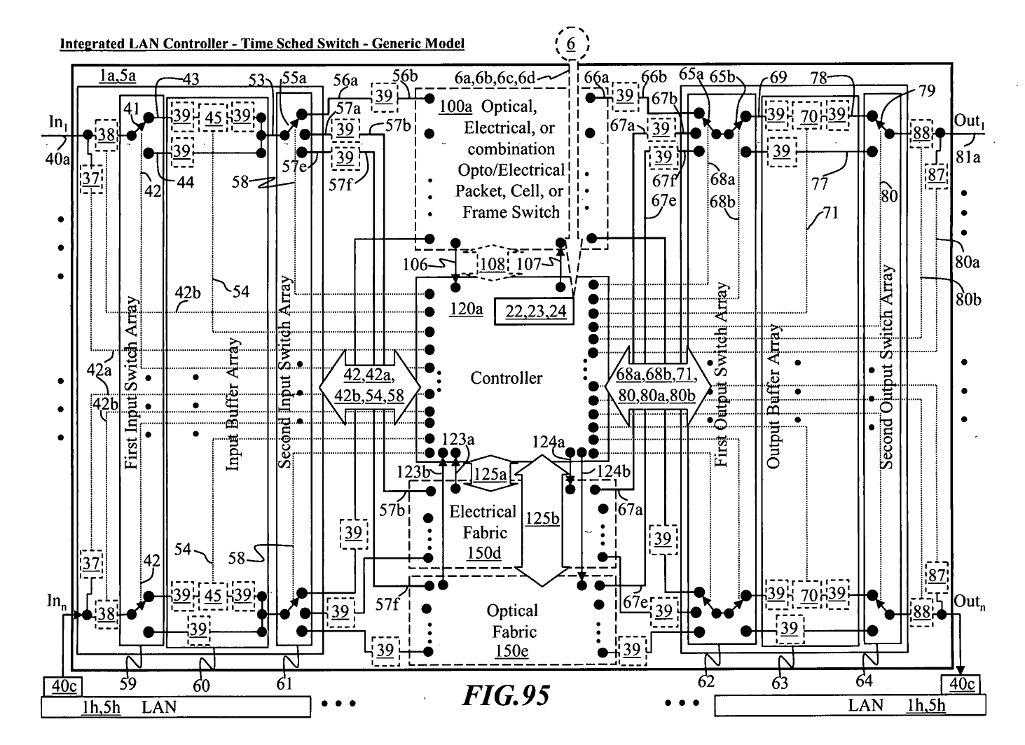

FIG. 95 is a high level schematic diagram of a “source and destination” embodiment or “end-user” embodiment of a time-scheduled and/or time-reserved datagram/packet network element for a Shared, Partially Shared, or Non-Shared Physical Medium—PHY 1h, 5h, such as an Integrated LAN Controller—Time ScheduledSwitch—Generic Model. Can be separate Transmission and Receive Media, such as an Ethernet LAN and/or wireless LAN. Can be optical, electrical, and/or wireless media.

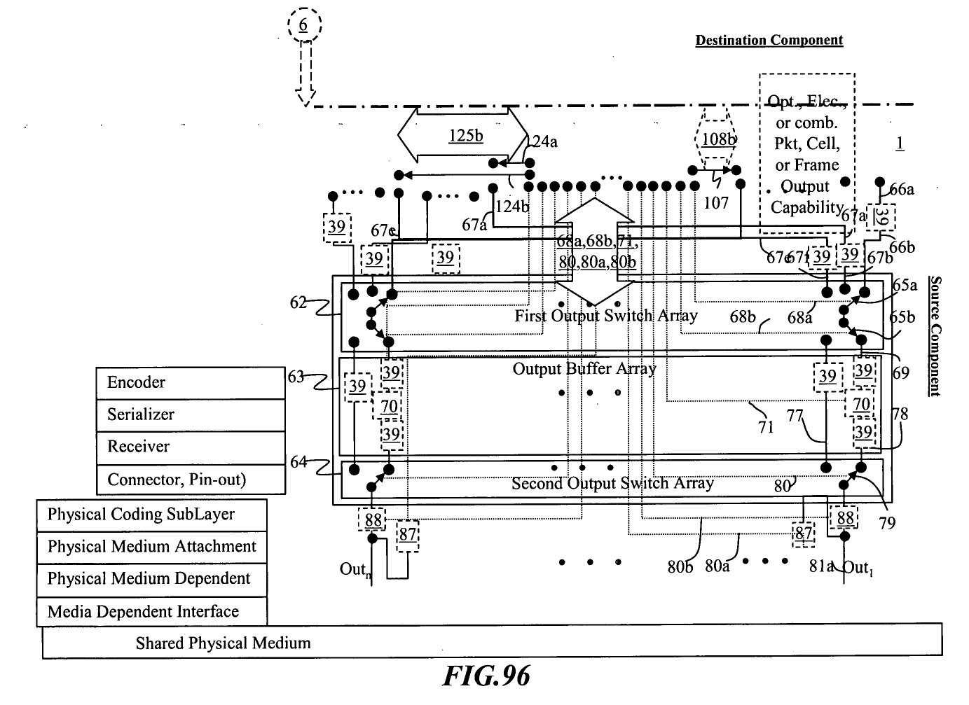

FIG. 96 is a high level schematic diagram of a “source and destination” embodiment or “end-user” embodiment of a time-scheduled and/or time-reserved datagram/packet network element for a Shared, Partially Shared, or Non-Shared Physical Medium—PHY 1h, 5h, with various stacks and elements for connectivity to the shared physical medium. This can be separate Transmission and Receive Media, such as an Ethernet LAN and/or wireless LAN. Can be optical, electrical, and/or wireless media.

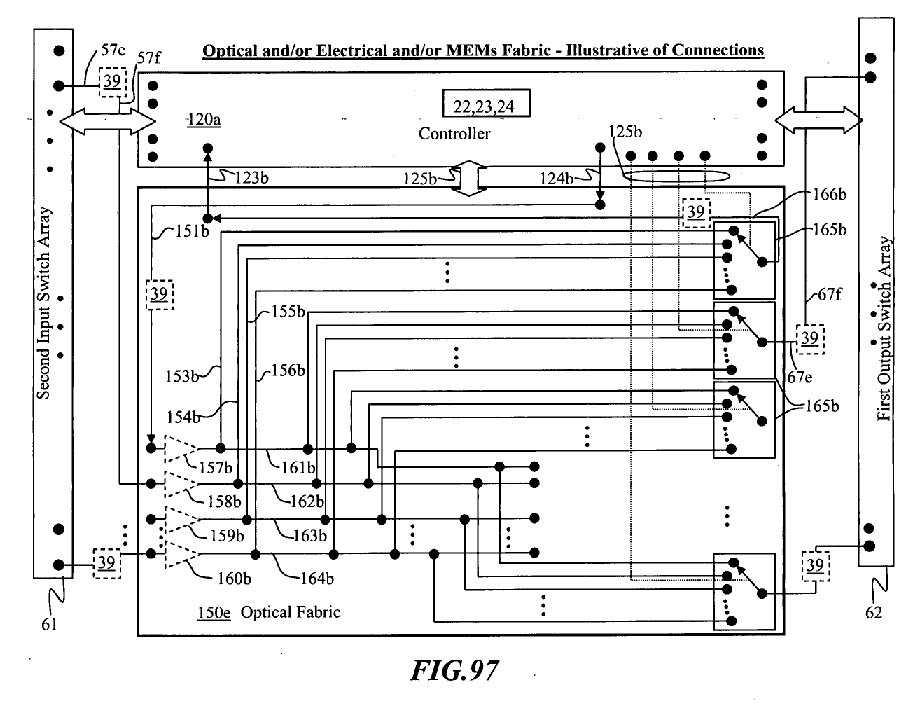

FIG. 97 to FIG. 101 shows an illustrative example at the logical level of pluralities of ways that this switching circuit might be implemented. Binary control lines 125a, 125b, and 125c with a binary numbering scheme are used to select the specific sequential control line 125 which then switches on the correct output line 153, 154, 155, or 156. A triggering control line may also be used as well as other logic devices which are well known in the art. In this example, it is clear that sequential control line that is made high will switch the corresponding output line 153, 154, 155, or 156 to the output line 166. FIG. 97 shows a detailed view of exemplary logic circuitry for the input switches 41 and 55 in the input switch arrays 59 and 61 of the device according to the present invention. FIG. 97 shows just one of a plurality of means of implementing this switching capability. As explained previously, standard store and forward packets coming in on input 40 are switched to the input buffer 45 to await being switched through switch 55 to store-and-forward switch 100. time-scheduled and/or time-reserved datagram/packet packets coming in on input 40 are switched through switch 41 to bypass line 44 and on through switch 55 to output line 57 and into switching means which may be non-blocking, non-delaying switch 150. FIG. 97 clearly shows that when the controller 120 makes the control line 42 high for switch 41, the top AND gate turns on and switches whatever is on input line 40 through to line 43 and the input buffer. At the same time, this turns the lower AND gate off and prevents any input on line 40 from being switched through to line 44. Conversely, when the controller 120 makes the control line 42 low for switch 41, the top AND gate turns off and prevents whatever is on input line 40 from being passed through to line 43 and the input buffer. At the same time, this turns the lower AND gate on and switches any input on line 40 through to line 44. The rest of the logic is the same, and is very clear to those skilled in the art. Thus, it will not be explained further.

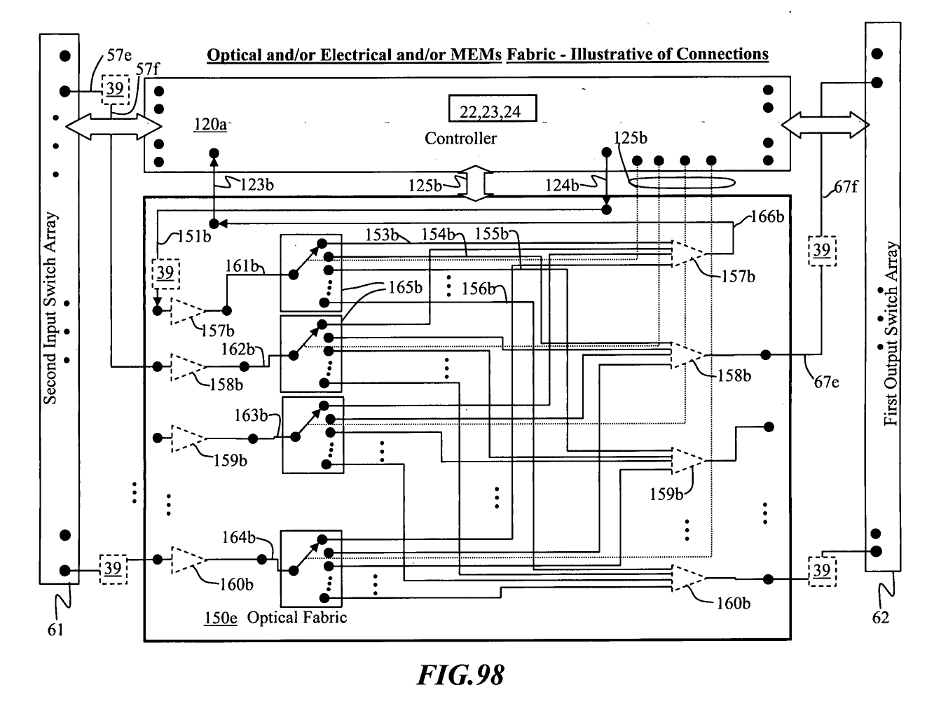

FIG. 97 shows a detailed view of exemplary hardware and software circuitry and functionality for the switching means which may be non-blocking, non-delaying time-scheduled and/or time-reserved datagram/packet switch of the device according to the present invention. As known to those skilled in the art, there are pluralities of methods to implement these switching means which may be non-blocking, non-delaying switching methods according to the present invention. This is just one example of a plurality of possible designs that could be used. FIG. 98 shows a detailed illustrative example of one input to output path for the switching means which may be non-blocking, non-delaying time-scheduled and/or time-reserved datagram/packet switch of the device according to the present invention.

In FIG. 97, scheduled time-scheduled and/or time-reserved datagram/packet packets are switched from the second input switch array into the amplifiers 157, 158, 159, and 160 which may also act as repeaters and clean up the signal. Input line 151 feeding amplifier 157 is a means whereby the controller 120 can send scheduled time-scheduled and/or time-reserved datagram/packet packets.

Once the time-scheduled and/or time-reserved datagram/packet packets exit amplifiers 157, 158, 159, and 160, each input signal is sent down its respective bus 161, 162, 163, and 164. Output buses 153, 154, 155, and 156, which are tapped on to these input buses 161, 162, 163, and 164, respectively, are configured such that every possible output receives every possible input, thus the switch is non-blocking. The switch is also configured such that all inputs 161, 162, 163, and 164 are immediately available at all outputs 153, 154, 155, and 156, resulting in no time switching nor space switching delays, thus the switch is non-delaying. Although there are very small propagation delays, even these have been minimized. This is an important aspect of the invention, as the efficiency of the invention is dependent upon the timing involved.

FIG. 97 illustrates how messages are received by the controller 120 from the non-delaying non-blocking switch 150, through output line 166 and 123. Other output lines 67 are routed to the first output buffer switch array 62.

FIG. 98 shows an illustrative functional example of how output switch 165 is configured such that only one of the output buses 153, 154, 155, or 156 is switched to the output line 166.

FIG. 98 is a detailed functional block diagram of an illustrative embodiment of switching means which may be non-blocking, non-delaying switching means according to the present invention, including input amplifying and limiting means, input matrix means, output matrix means, output switching means, output switching control means, and output means.

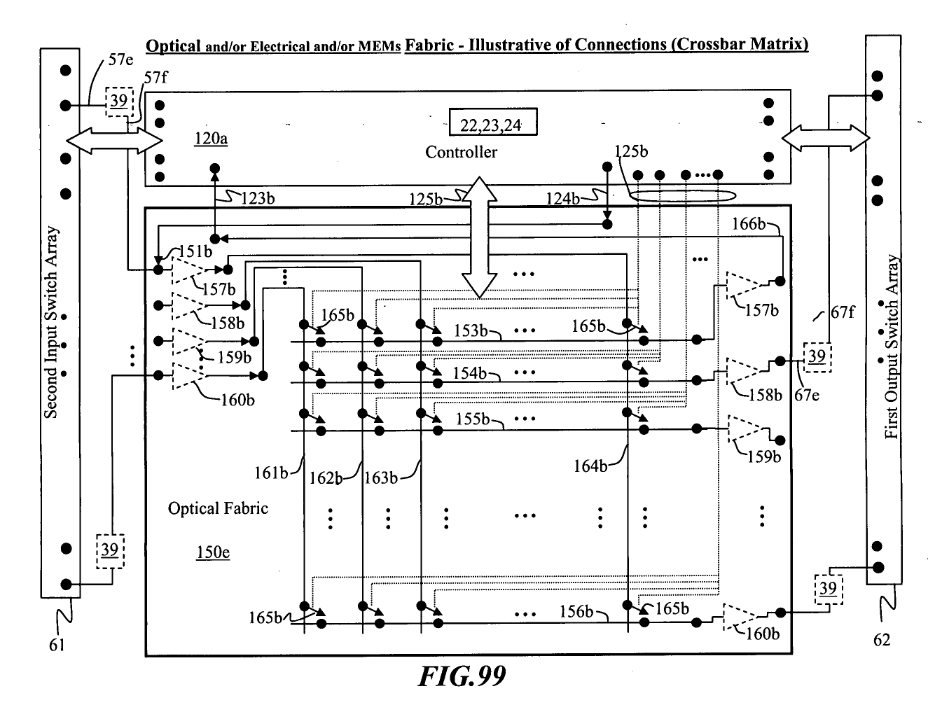

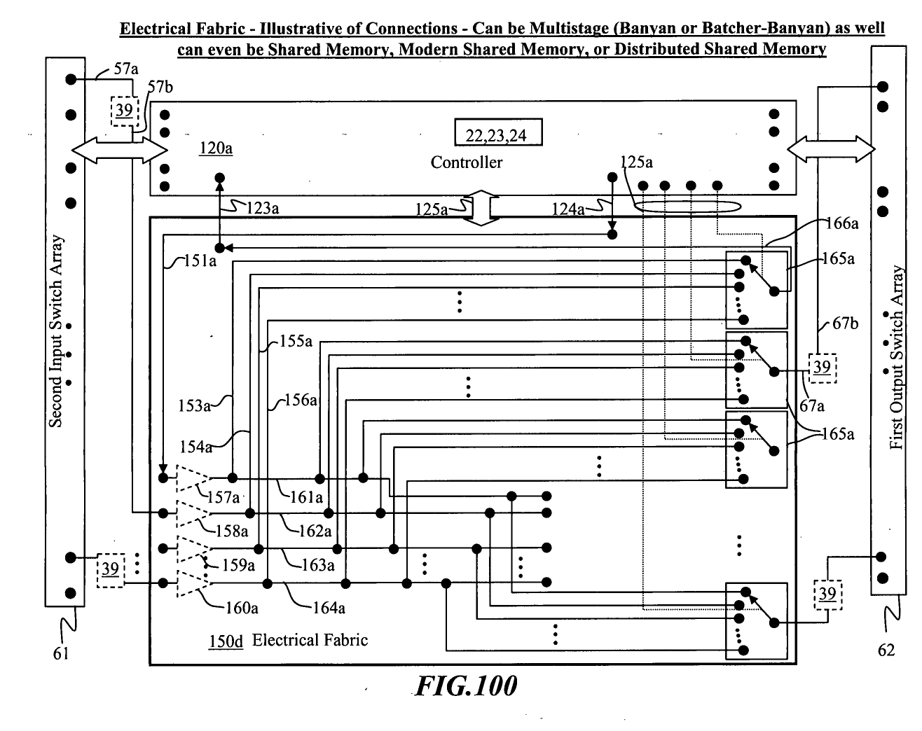

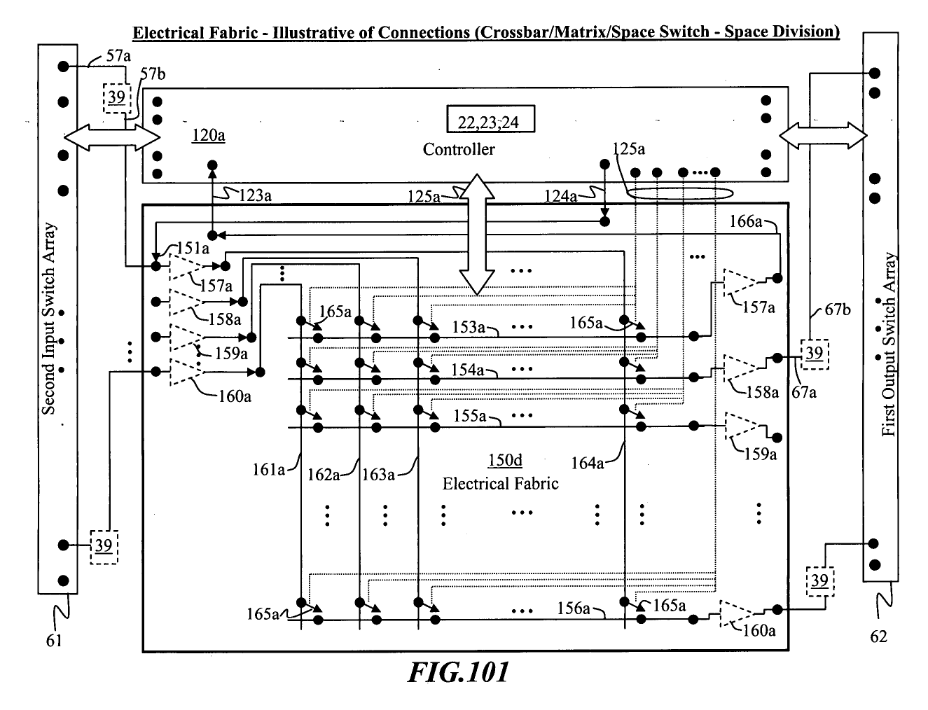

FIG. 99, FIG. 100, and FIG. 101 are detailed schematic diagrams of illustrative embodiments of control means for selecting the output of the optical, electrical, electro-optical, or MEMS (Micro-Electro-Mechanical Switch, e.g., mirroring system, bubble switching, etc.) switching means which may be non-blocking, non-delaying switching means according to the present invention.

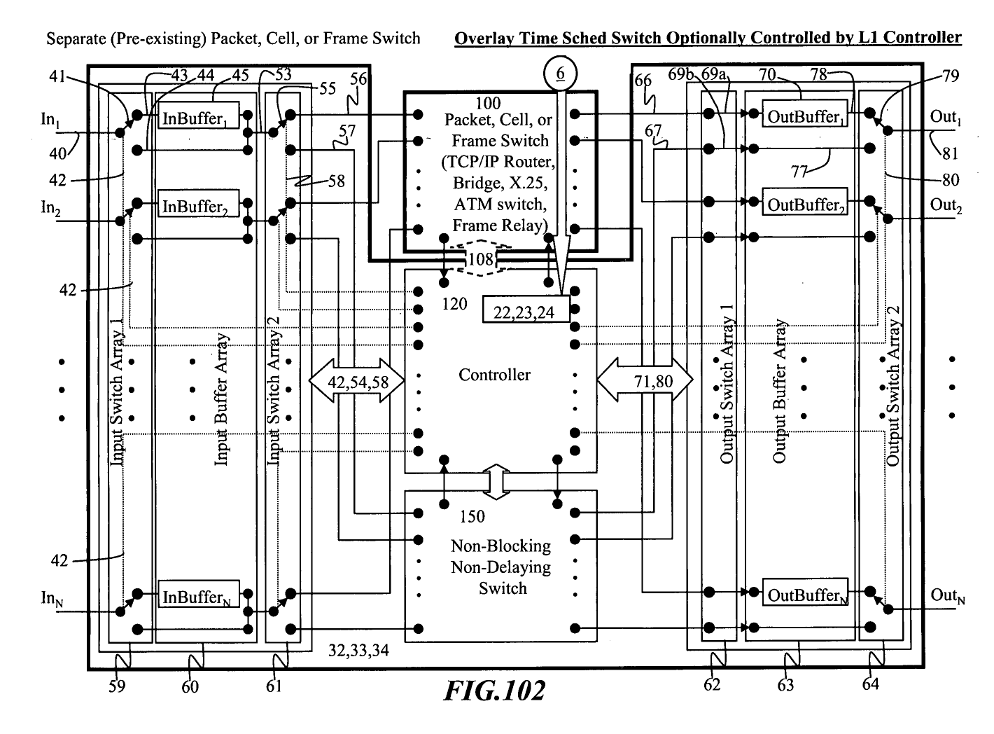

FIG. 102 is an exemplary diagram of a generic Overlay Time ScheduledSwitch Optionally Controlled by a Time-Scheduled Controller 120.

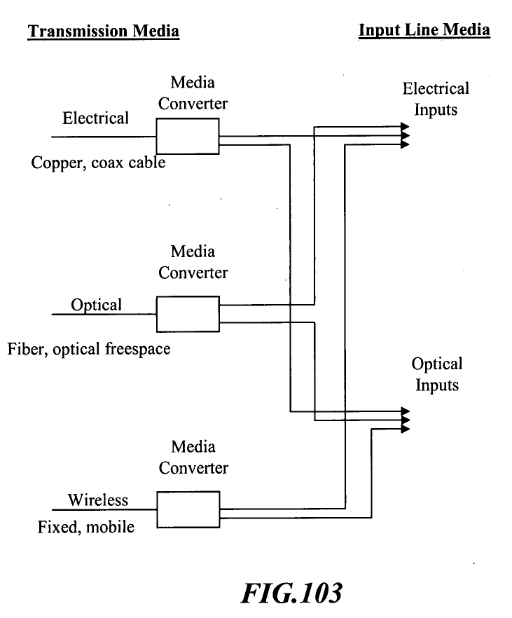

FIG. 103 illustrates the optional transmission media and input line media connections with optional media converter to connect to the time-scheduled packet switching network element.

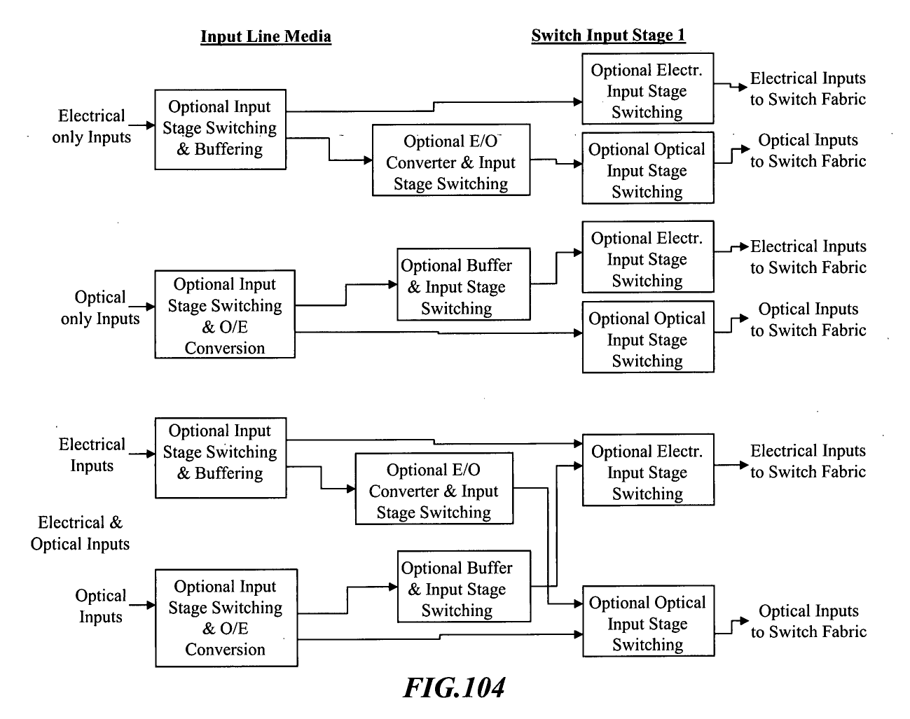

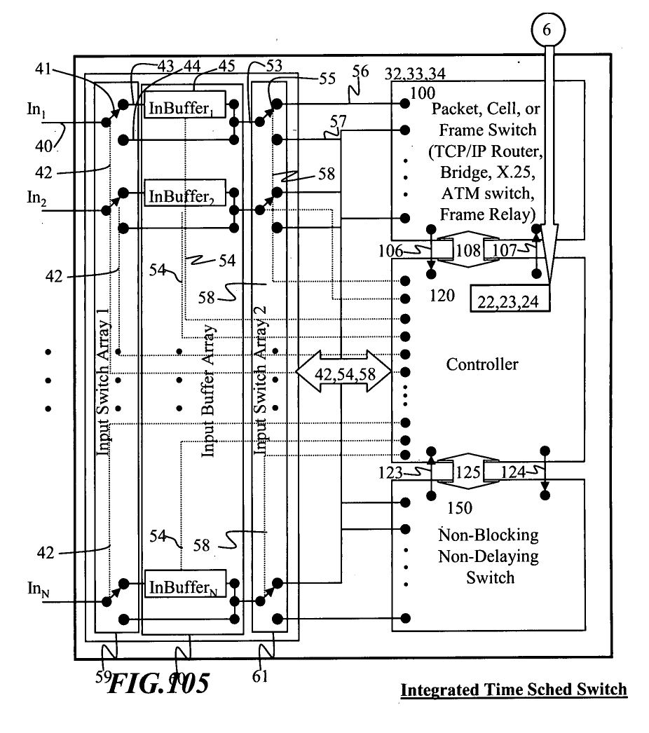

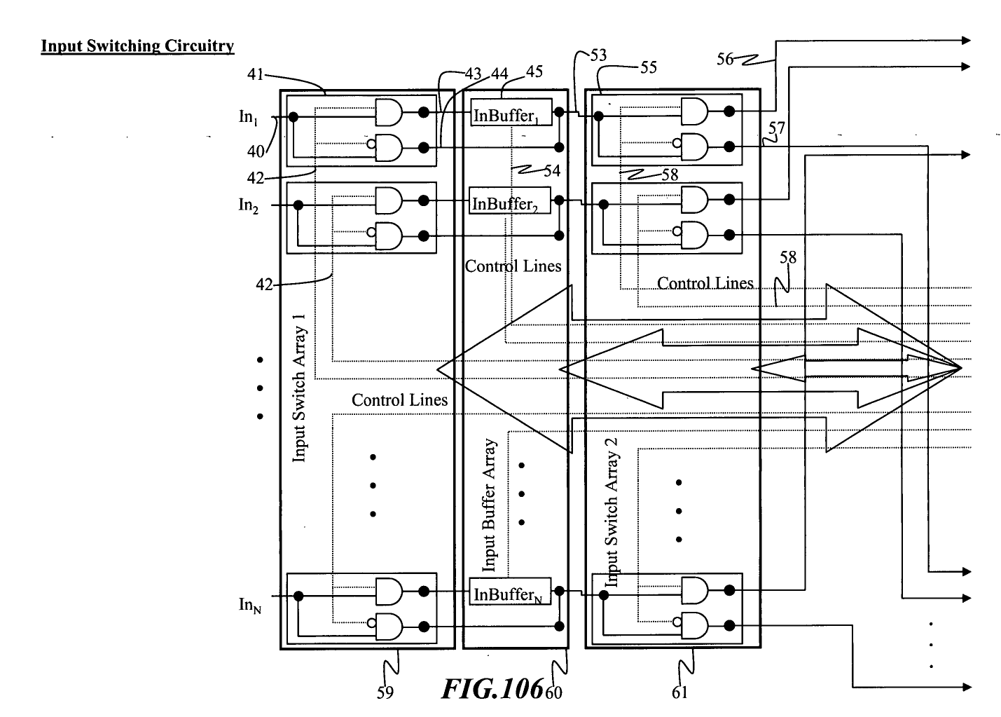

FIG. 104 illustrates the optional input line media and time-scheduled packet switch input stage with optional input switching and buffering and optional E/O and O/E conversion, and optional electrical and/or optical input stage switching.

FIG. 105 is a detailed functional block diagram of a preferred integrated embodiment of input means according to the present invention, including input switch means, input switch array means, input switch control means, input buffer means, input buffer array means, and input buffer control means.

FIG. 106 is a functional schematic diagram of a Input Switching Circuitry according to the present invention.

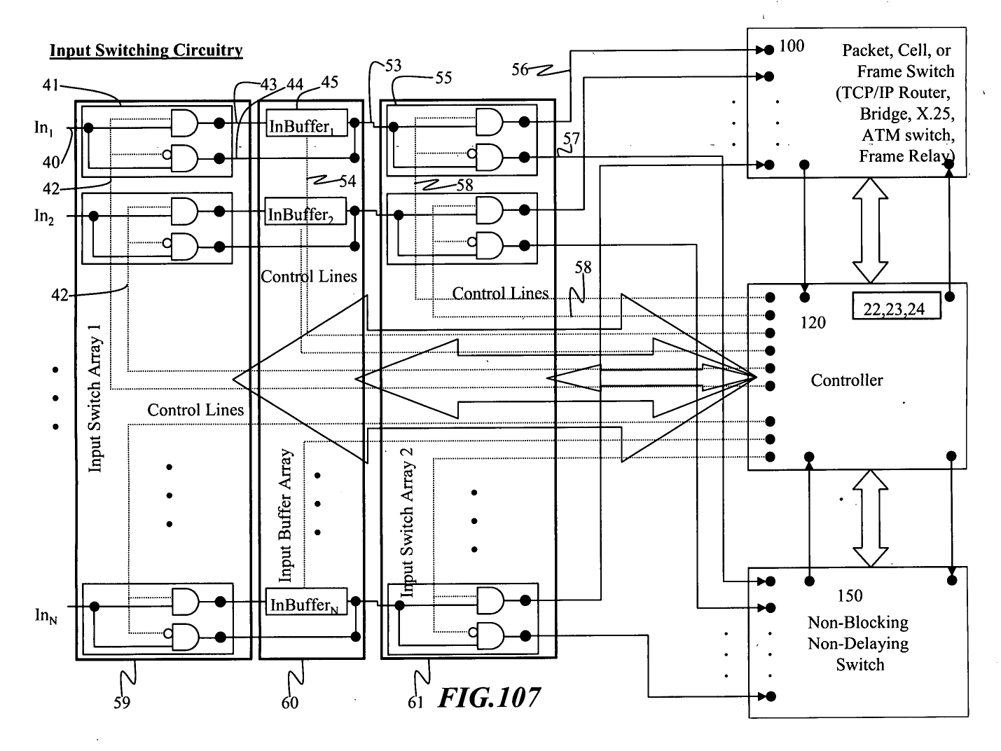

FIG. 107 is a more detailed functional schematic diagram of a Input Switching Circuitry according to the present invention.

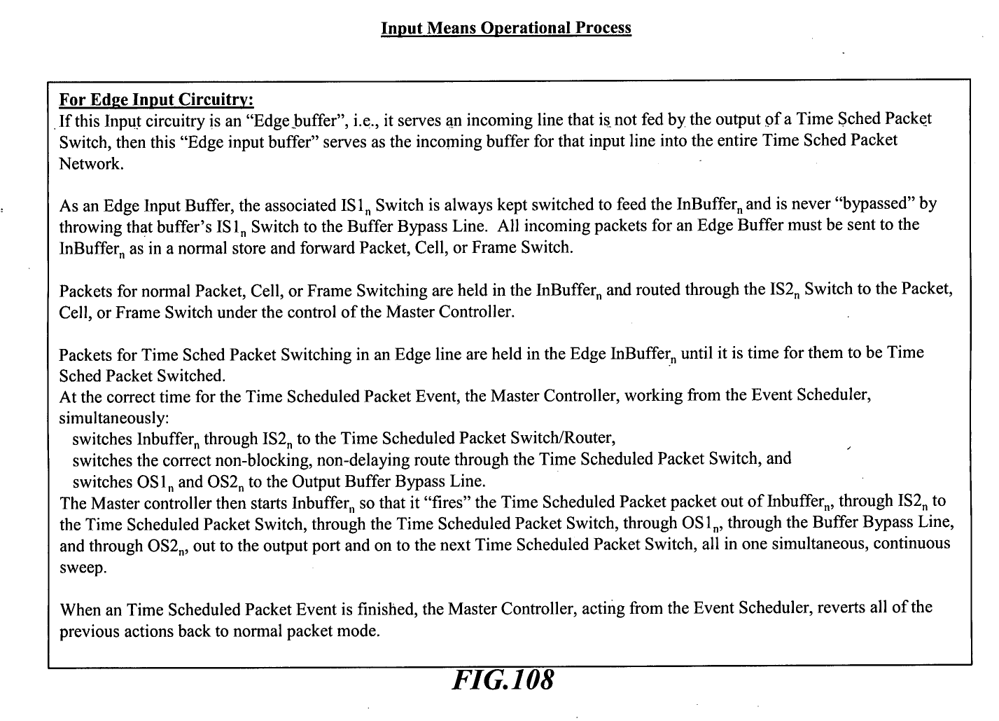

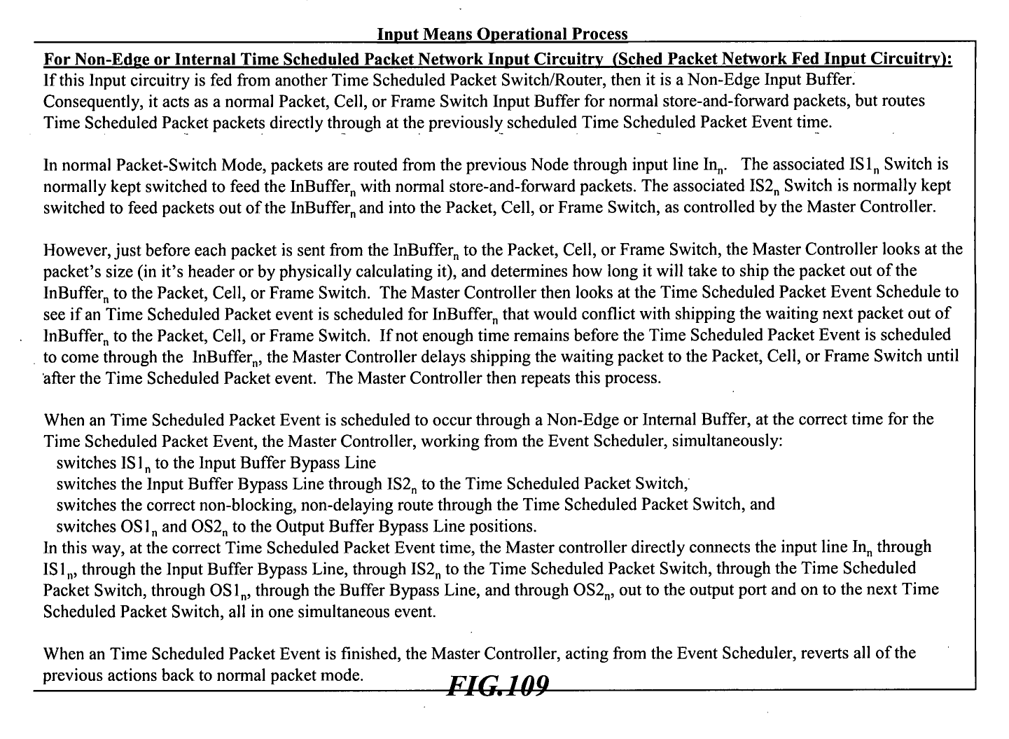

FIG. 108 details the input means or input circuitry operational process, specifically for when the input means are operating as “edge buffers” providing the initial buffering for the originating time-scheduled and/or time-reserved datagram/packet device or originating edge node in a network.

FIG. 109 details the input means or input circuitry operational process, specifically for when the input means are operating as “non-edge buffers”, i.e., internal to the network as middle nodes or terminating nodes.

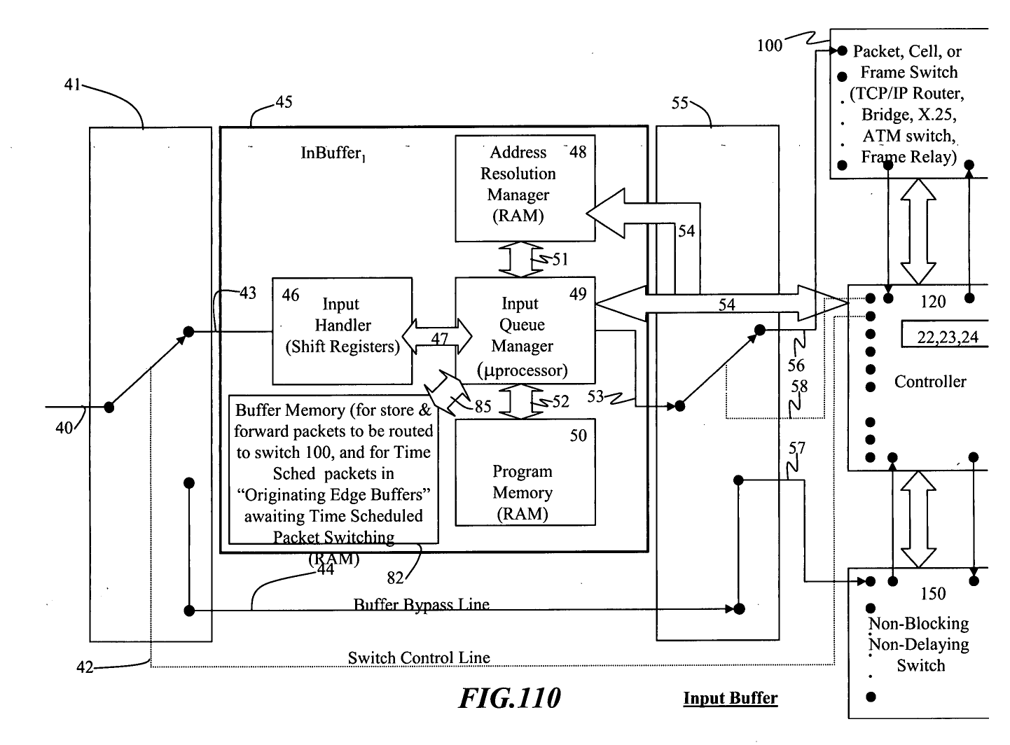

FIG. 110 shows a detailed view of exemplary hardware and software circuitry and functionality for the input buffer InBuffer₁ 45 of the device according to the present invention. As packets are routed to line 43, they are shifted into the input handler 46, which comprises several shift registers under the control of the input queue manager 49. Input queue manager 49 is a microprocessor running of a program stored in program memory 50 residing on a RAM storage device. Input queue manager 49 loads the shift registers 46 with packets and transfers them to buffer memory 82, a RAM storage device.

Input Queue Manager 49 then looks at the packets in buffer memory 82, pulls out the layer three or layer two address and detects if there is any priority scheduling required. It then looks at the address resolution manager 48 which resides on a RAM storage device, and which fundamentally stores routing tables for network address resolution. These routing tables are updated as needed by the main microprocessor on the controller 120. The input queue manager 49 uses the address resolution manager 48 to look up the address of the next destination for the packet, cell, or frame, and the output port for the switch 100 to switch the packet out to. When the input queue manager has a packet to ship to switch 100, it notifies controller 120 over bus 54 with the appropriate information such as the input and output lines, and the size of the packet. Controller 120 examines its time-scheduled and/or time-reserved datagram/packet event schedule to determine if any collisions with scheduled time-scheduled and/or time-reserved datagram/packet packets might occur on those input and output lines. If there is no problem, controller 120 triggers switch 55 using control line(s) 58 and notifies input queue manager 49 to send the packet to switch 100, which it does.

If the input buffer 45 acts as an originating edge node for the time-scheduled and/or time-reserved datagram/packet network, then controller 120 will use switch 41 to route time-scheduled and/or time-reserved datagram/packet packets into the input buffer 45. Controller 120 will tell input queue manager 49 to notify him when the time-scheduled and/or time-reserved datagram/packet packets arrive, based on source and destination addresses and priority level. When the time-scheduled and/or time-reserved datagram/packet packets arrive, they are transferred to a special location in buffer memory. Input queue manager 49 notifies controller 120 when these packets arrive. Controller 120 constantly checks the layer two event schedule and when an event is approaching he notifies input queue manager 49 to have them ready. At the designated scheduled time-scheduled and/or time-reserved datagram/packet time, controller 120 throws all the required switches as described previously for direct time-scheduled and/or time-reserved datagram/packet switching and notifies input queue manager 49 to ship the time-scheduled and/or time-reserved datagram/packet packet(s).

If the input buffer 45 is not acting as an originating edge node, then it does not see any time-scheduled and/or time-reserved datagram/packet switches, since the controller 120 bypasses the input buffer 45 at the scheduled times by switching the time-scheduled and/or time-reserved datagram/packet packets around the buffer by means of the input switches 41 and 55, and buffer bypass line 44.

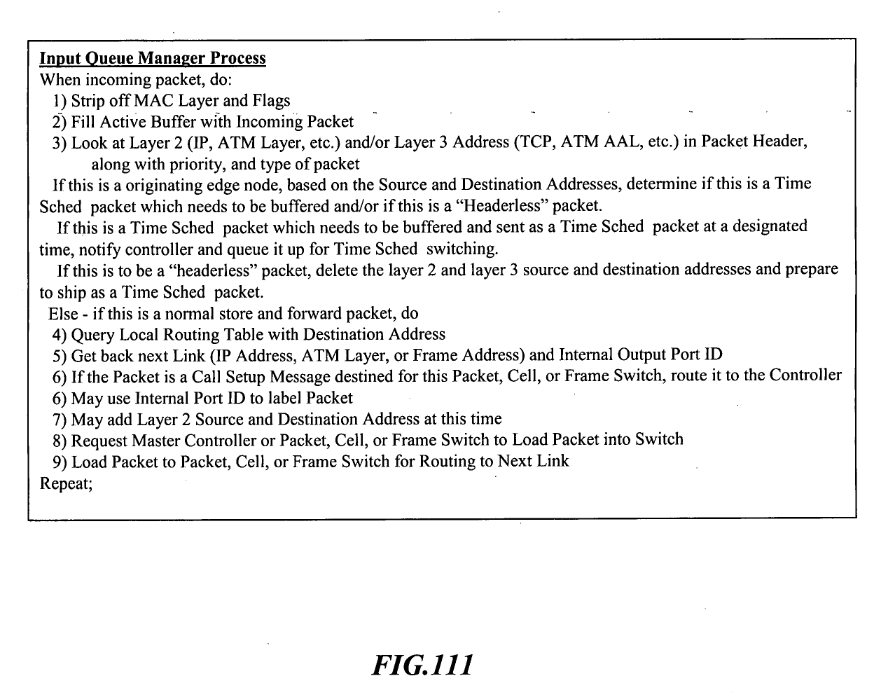

FIG. 111 shows an example of the detailed program process which the input queue manager 49 performs in the input buffer shown in FIG. 110.

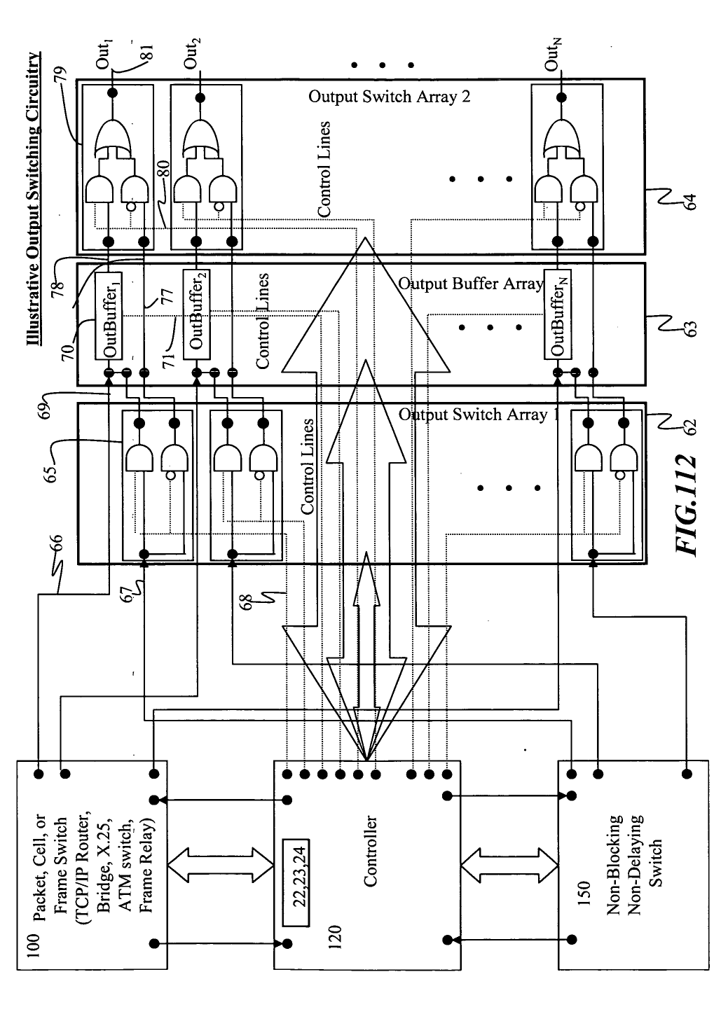

FIG. 112 shows a detailed view of exemplary logic circuitry for the output switches 65 and 79 in the output switch arrays 62 and 64 of the device according to the present invention. FIG. 112 shows just one of a plurality of means of implementing this switching capability. As explained previously, standard store and forward packets coming out of switch 100 on line 66 are sent by line 69 to the output buffer 70 to await being transmitted out on output line 81. Time-scheduled and/or time-reserved datagram/packet packets coming from switching means which may be non-blocking, non-delaying switch 150 are passed through line 67 and through switch 65 to output buffer bypass line 77 and are switched through switch 79 to output line 81. FIG. 112 clearly shows that when the controller 120 makes the control line 68 high for switch 65, the top AND gate turns on and switches the time-scheduled and/or time-reserved datagram/packet packets on line 67 through to output buffer 70. At the same time, this turns the lower AND gate off and prevents any input from the time-scheduled and/or time-reserved datagram/packet packets on line 67 from being switched through to the buffer bypass line 77. Conversely, when the controller 120 makes the control line 68 low for switch 65, the top AND gate turns off and prevents time-scheduled and/or time-reserved datagram/packet packets on line 67 from being passed through to the output buffer 70. At the same time, this turns the lower AND gate on and switches any time-scheduled and/or time-reserved datagram/packet packets through to the buffer bypass line 77.

The logic in switch 79 then switches between the output buffer 70 and the time-scheduled and/or time-reserved datagram/packet packets on output buffer bypass line 77. The controller 120 by making the control line(s) 80 high switches packets through switch 79 to output line 81 and turns off any packets being fed from line 77. Conversely, by making the control line(s) 80 low, the controller 120 switches time-scheduled and/or time-reserved datagram/packet packets on buffer bypass line 77 through switch 79 to output line 81, while blocking any data from output buffer 70.

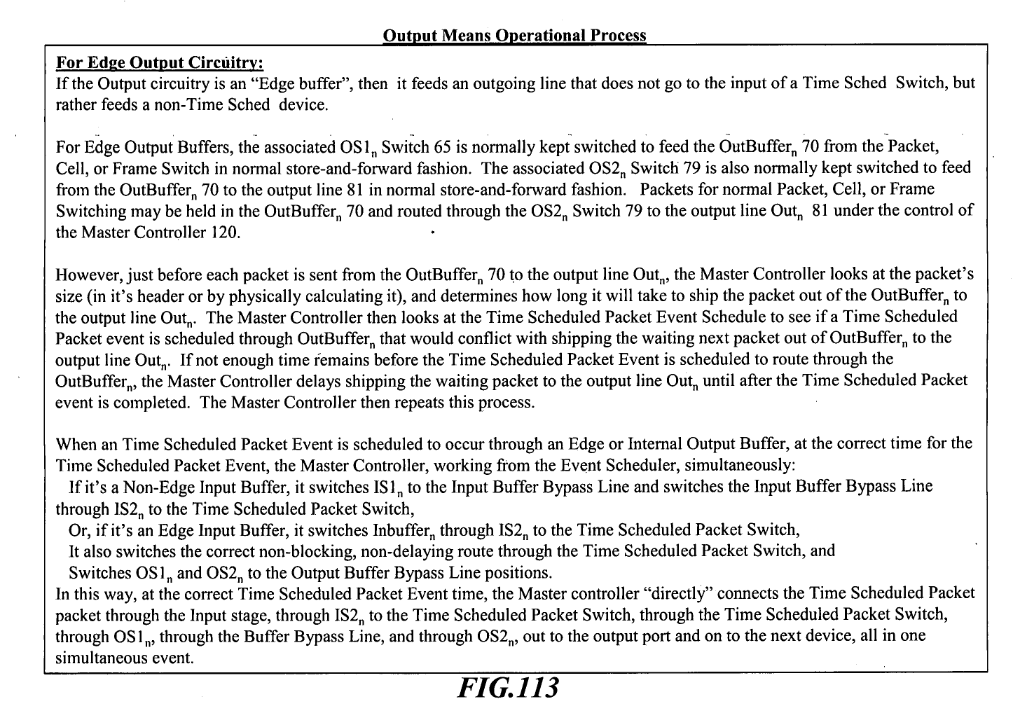

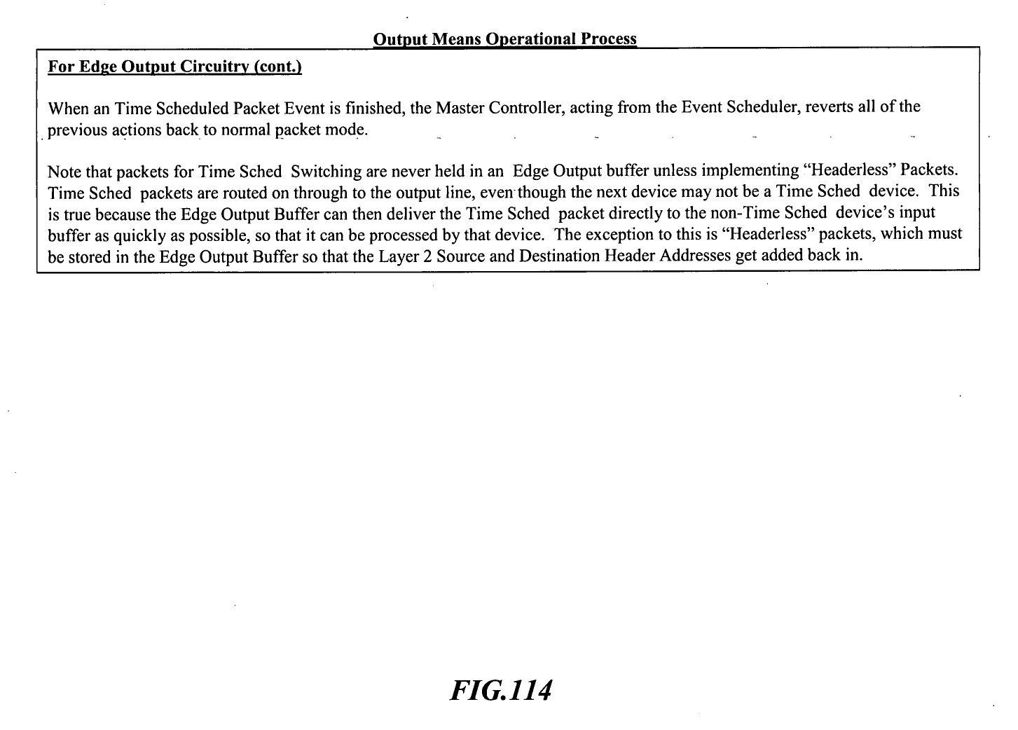

FIG. 113 and FIG. 114 detail the output means or output circuitry operational process, specifically for when the output means are operating as “edge buffers” providing the final buffering for the terminating time-scheduled and/or time-reserved datagram/packet device or terminating edge node in a network.

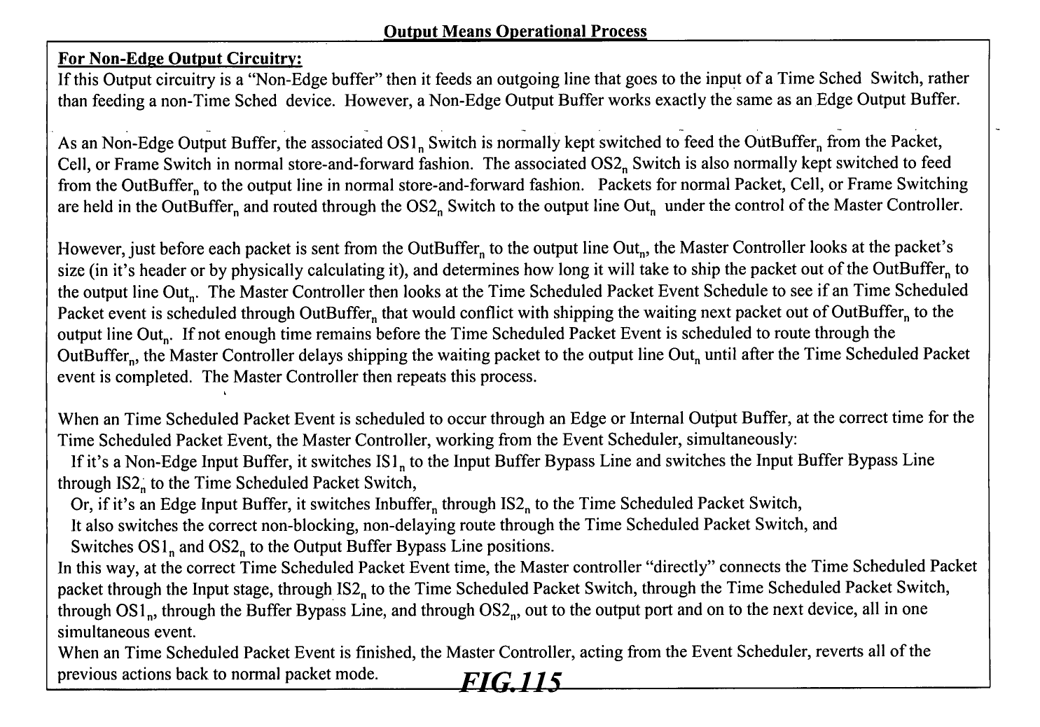

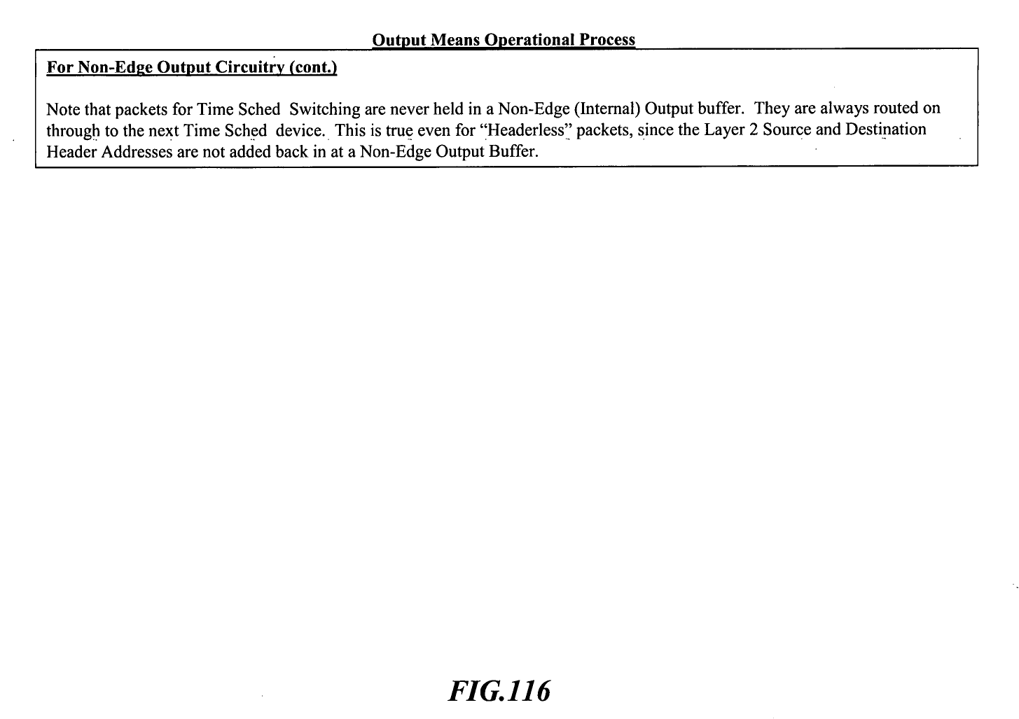

FIG. 115 and FIG. 116 detail the output means or output circuitry operational process, specifically for when the output means are operating as “non-edge buffers”, i.e., internal to the network as middle nodes or originating nodes.

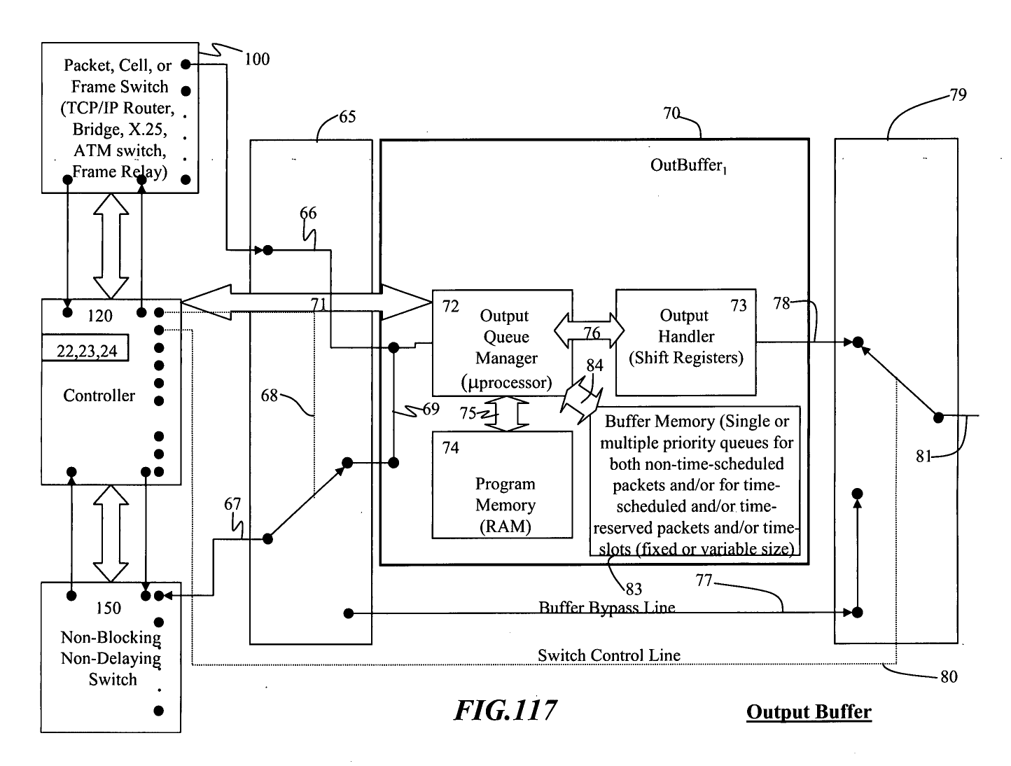

FIG. 117 shows a detailed view of exemplary hardware and software circuitry and functionality for the output buffer OutBuffer₁ 70 of the device according to the present invention. As packets are routed out of switch 100 to line 65, they are sent to the output queue manager 72.

Output queue manager 72 is a microprocessor running a program stored in program memory 74 residing on a RAM storage device. Output queue manager 72 receives the packets and transfers them to buffer memory 83, a RAM storage device.

Output queue manager 72 then looks at the packets in buffer memory 83, to see if there is any priority scheduling required. When the output queue manager 72 has a selected a packet to send to output line 81, it transfers the packet from buffer memory 83 to the output handler 73, which comprises a plurality of shift registers under the control of the output queue manager 73.

Output queue manager 72 then notifies controller 120 over bus 71 that the packet is ready to transmit, and tells it other appropriate information such as the output line, the priority, and the size of the packet. Controller 120 examines its time-scheduled and/or time-reserved datagram/packet event schedule to determine if any collisions with scheduled time-scheduled and/or time-reserved datagram/packet packets might occur on those input and output lines. If there is no problem, controller 120 triggers switch 79 using control line(s) 80 and notifies output queue manager 72 to send the packet out line 81.

Headerless packet switching is a time-scheduled and/or time-reserved datagram/packet switching technique that extracts the layer two and layer three source and destination addresses for time-scheduled and/or time-reserved datagram/packet scheduled packets. If headerless packet switching is being implemented in the network, then time-scheduled and/or time-reserved datagram/packet packets without their layer two and layer three source and destination addresses must be have these addresses reinserted at the terminating edge node prior to leaving the time-scheduled and/or time-reserved datagram/packet network. If this output buffer acts as an terminating edge node, then the controller 120 alerts the output queue manager 72 of the upcoming time-scheduled and/or time-reserved datagram/packet “headerless” packet. Since time-scheduled and/or time-reserved datagram/packet's event scheduler knows the correct source and destination addresses based on its scheduling, the controller 120 will also give the correct source and destination address(es). When the packet arrives, the controller actuates switch 65 to route the packet to the output queue manager 72. The controller 120 then signals the output queue manager that this is a “headerless” packet. The output queue manager 72 stores the headerless packet in buffer memory 83. Next the output queue manager inserts the correct source and destination address(es) into the packet headers and then, with the permission of controller 120, routes the packet out line 81.

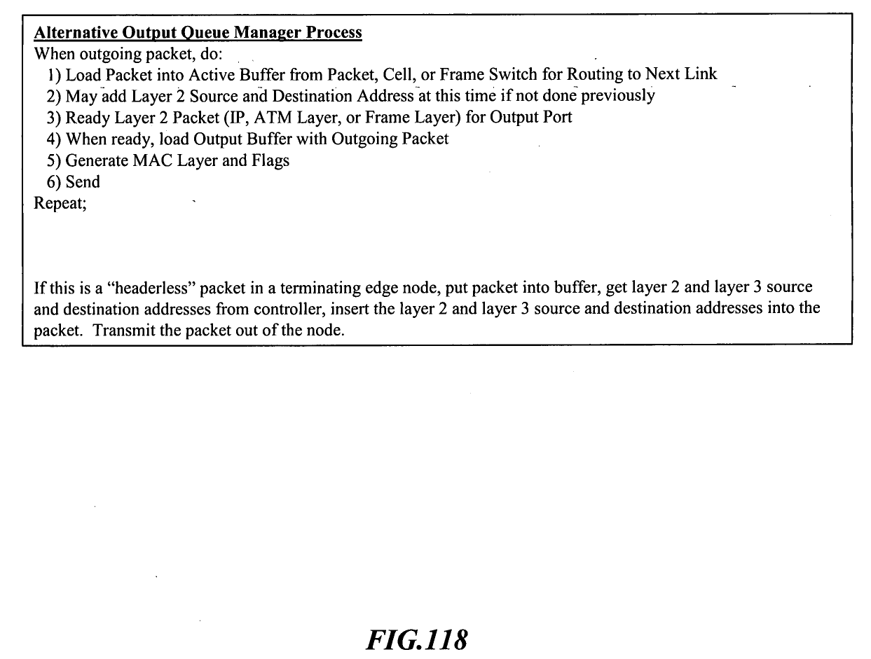

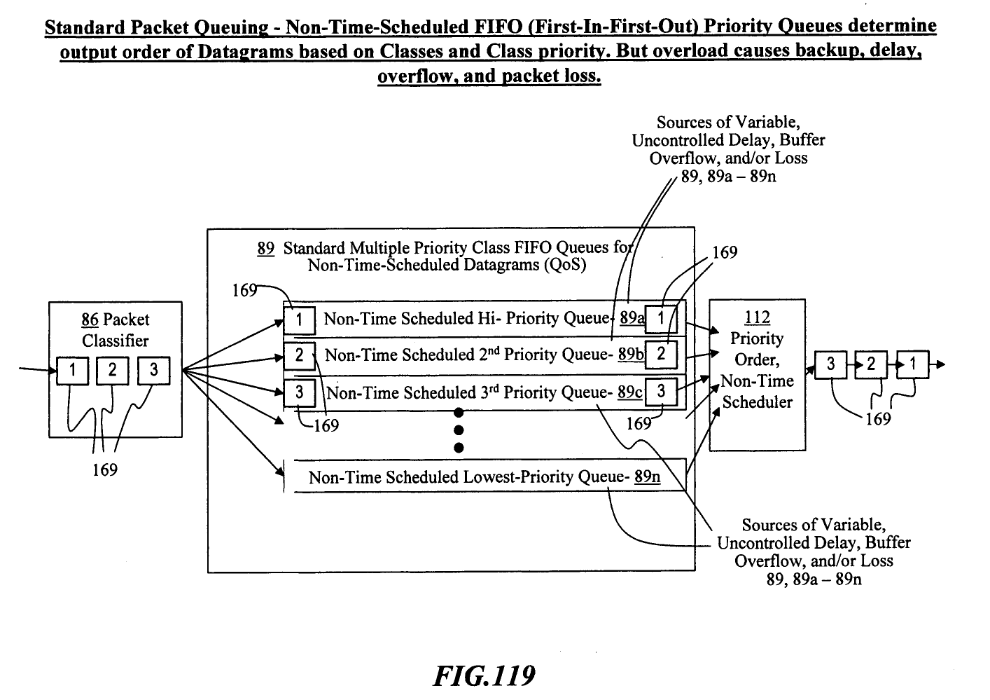

FIG. 118 shows an example of a detailed program process which the output queue manager 72 performs in the output buffer shown in FIG. 117.

FIG. 119 shows a functional block diagram for Standard Packet Queuing using Packet Classifier 86 which classifies and feeds Non-Time-Scheduled packets 169 to Priority Queues 89, 89a through 89n to store, based on Classes and Class priority. Datagrams are then Scheduled by priority Order Scheduler 112 according to Weighted Fair Queuing or some other non-time-reservation scheduling algorithm.

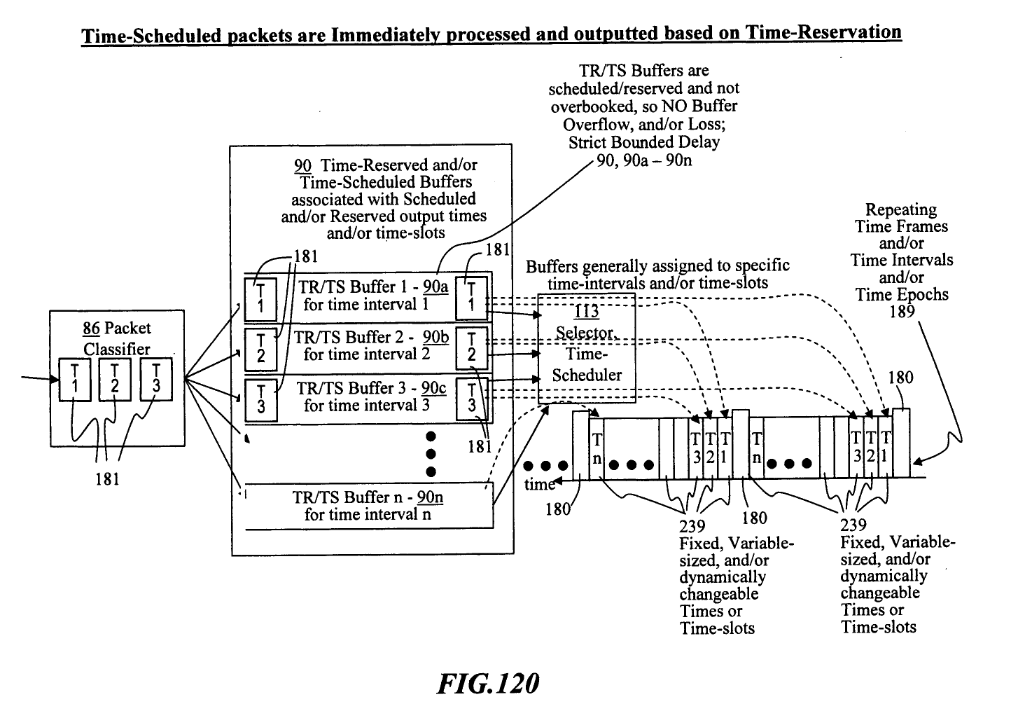

FIG. 120 shows a functional block diagram showing how Time-Scheduled packets have output order of Datagrams determined based on Time-Reservation. Packet Classifier 86 looks at time schedule for time-scheduled packets 181. Packet Classifier places time-scheduled packets 181 into associated Time-Reserved and/or Time-Scheduled Buffers 90, (90a through 90n) associated with Scheduled and/or Reserved output times and/or time-slots 239. Datagrams are selected by Selector Time-Scheduler 113 and transmitted in time/time-slots 239 according to their reservation-schedule 129 (see FIG. 132). Time-slots 239 may be fixed, variable-sized, and/or dynamically changeable. This forces time-scheduled packets to be almost immediately sent and prevents packet loss from buffer overflow, or delay from queuing wait.

FIG. 121 shows a functional block diagram showing both standard packet queuing and time-scheduled packet buffering in output buffer 70. FIG. 121 shows how Time Reserved Packets bypass Non-Time-Scheduled Priority Queues in output section and go directly into time slots (with bounded buffering delay).

In FIG. 121, Standard Packet Queuing using Packet Classifier 86 classifies and feeds Non-Time-Scheduled packets 169 to Priority Queues 89, 89a through 89n to store, based on Classes and Class priority. Datagrams are then scheduled by priority Order Scheduler 112 according to some non-time-reservation scheduling algorithm and sent to time selector 113. However, non-time-schedule packets even in highest priority queues must wait behind time-scheduled packets in buffers 90a to 90n, which get immediately sent. Time-Scheduled packets have output order of Datagrams determined based on Time-Reservation. Packet Classifier 86 looks at time schedule 129 (see FIG. 132) for time-scheduled packets 181. Packet Classifier places time-scheduled packets 181 into associated Time-Reserved and/or Time-Scheduled Buffers 90, (90a through 90n) associated with Scheduled and/or Reserved output times and/or time-slots 239. Datagrams are transmitted in time/time-slots 239 according to their reservation-schedule. Time-slots 239 may be fixed, variable-sized, and/or dynamically changeable. This forces time-scheduled packets to be almost immediately sent and prevents packet loss from buffer overflow, or delay from queuing wait.

In FIG. 121, Time Slot Buffers 90 (90a through 90n) are (may be) higher priority than the highest priority Non-time-scheduled priority queue (QoS) 89a. Time Slots may be established on a per session, per hop, per transaction, per call, per message, per priority level, and/or per flow basis. Time Slot buffers may be one or more packets deep.

FIG. 122 illustrates how Time-Scheduled Buffers 90 and Non-Time-Scheduled Priority Queues 89 may share the same Memory in output buffer 70.

FIG. 123 shows Alternative Output Queue Manager Processes for Time-Scheduled Datagrams to bypass Non-Time-Scheduled Priority Queues and go directly into Fixed, Variable-sized, and/or dynamically changeable Times and/or Time Slots in output buffer 70.

FIG. 124 provides an illustrative example of the packet, cell, or frame switch 100. The specific details of the switch 100 shown are one of a plurality of store-and-forward switch implementations well known to those skilled in the art. These details are not the focus of this invention and will not be covered here. Virtually any store-and-forward switch may be used for switch 100. The inputs and outputs for switch 100 have already been discussed. Controller 120 uses control lines 108 to route packets through the packet switch. Lines 106 and 107 are input and output lines which enable controller 120 to receive and transmit standard packets through the packet switch 100 for various communication purposes such as call setup. FIG. 127 is a Logic Diagram for controller 120 showing a flow chart of the various aspects of the logic process. FIG. 128 and FIG. 129 show the process that the controller 120 uses to operate the switch. Together, these figures provide the workings of the controller 120.

FIG. 125 shows controller 120 comprising the master controller 134, the master packet switch controller 127, the clock synchronization system 128, the master clock receiver 22, 23,or 24, the time-scheduled and/or time-reserved datagram/packet event database 129, the reservation manager 130, the output queue manager 136, the master L1 switch controller 132, the input queue manager 133, node manager 126, input lines 106, 120, and 123, output lines 124, 122, and 107, and control lines 135 for internal communication, control lines 108 for communication with switch 100, control lines 125 for communication with switch 150, control lines 42 for communication with input switch array 59, control lines 54 for communication with input buffer array 60, control lines 58 for communication with input switch array 61, control lines 68 for communication with output switch array 62, control lines 71 for communication with output buffer array 63, and control lines 80 for communication with output switch array 62.

FIG. 126 shows the hardware layer of controller 120. At this level, controller 120 comprises master controller microprocessor 134a for running the master controller program stored in shared memory controller 134b; shared memory 134c for routing tables; input buffer 133 for getting external network input from switch 100 and switch 150; output buffer 136 for transmitting messages externally through switches 100 and 150; master clock receiver 22, 23, 24; clock synchronization mechanism 128; local clock 138; packet, cell, or frame switch controller 127a for controlling switch 100; packet, cell, or frame switch microprocessor 127b for running the control program for switch 100 store in memory 127c; and time-scheduled and/or time-reserved datagram/packet switch controller 132c for controlling switch 150; time-scheduled and/or time-reserved datagram/packet switch microprocessor 132b for running the control program for switch 150 stored in memory 132a, which also includes the time-scheduled and/or time-reserved datagram/packet reservation schedule.

FIG. 127 shows the functional and relational diagram for controller 120, wherein the input queue manager gets input from packet, cell, or frame switch 100 or time-scheduled and/or time-reserved datagram/packet switch 150. The input queue manager strips off the flags and sends the packets to the routing manager. The routing manager determines what type of message it is and sends it to the appropriate function. If the message is a time-scheduled and/or time-reserved datagram/packet message, such as a call setup reservation request, an accept message, or a reject message, the routing manager sends the message to the reservation scheduler. If the message contains network routing update information, the routing manager sends the message to the network routing process to update the network routing tables. If the message is an administrative message, the routing manager sends it to the node manager.

When the time-scheduled and/or time-reserved datagram/packet reservation scheduler gets a reservation message, it checks the routing table to determine which input and output lines may be affected. Then it looks at the time-scheduled and/or time-reserved datagram/packet event schedule to determine whether the event can be scheduled. This entire time-scheduled and/or time-reserved datagram/packet event scheduling process is detailed in FIG. 130 and FIG. 131, with the time-scheduled and/or time-reserved datagram/packet event schedule illustrated in FIG. 132. Based on the time-scheduled and/or time-reserved datagram/packet event schedule it either schedules the event, tentatively schedules the event, makes the event available again, or does nothing. It then tells the message generator which message to send as a response. The message generator generates a message, checks the network routing table for addressing information and sends the message to the output queue manager to transmit over switch 100 or switch 150. The time-scheduled and/or time-reserved datagram/packet reservation scheduler may also check the mode selection to determine how the system administrator through the node manager wishes for it to respond to a rejection message. This process is described in FIG. 131.

As events are scheduled in the time-scheduled and/or time-reserved datagram/packet Event schedule (see FIG. 132) by the time-scheduled and/or time-reserved datagram/packet event scheduler (see process in FIG. 130 and FIG. 131), the time-scheduled and/or time-reserved datagram/packet reservation executor continuously looks at the event schedule to determine which time-scheduled and/or time-reserved datagram/packet events are approaching execution. It alerts the master controller 134 regarding these events in enough time for the master controller to execute the appropriate action at the correct time, specifically enabling time-scheduled and/or time-reserved datagram/packet switching.

The node manager handles input and output from the a user console, to enable the system administrator to control the system.

FIG. 128 and FIG. 129 further explain the master controller 134 process, step by step.

FIG. 130 and FIG. 131 are flowcharts which detail the entire time-scheduled and/or time-reserved datagram/packet event scheduling process as explained previously.

FIG. 132 exemplifies the time-scheduled and/or time-reserved datagram/packet event schedule. This is just one illustrative representation, as it could be represented and managed in a plurality of ways. It includes a column representing the time in day (dd), hour (hh), minutes (mm), seconds (ss), thousandths of seconds (mmm), millionths of seconds or microseconds (μμμ) and hundreds of nanoseconds (n), although it could be even more precise if the synchronization accuracy supported it. Next are shown the input line and output line that could be potentially scheduled for a potential path through the node. Next to the input and output lines is an indication of whether the line acts as an edge buffer or edge node, i.e., is it the originating or terminating line into or out of the time-scheduled network. If so, it may act slightly differently as described in FIG. 108, FIG. 109, FIG. 113, FIG. 114, FIG. 115, and FIG. 116. Next is shown the status of the path through the node, whether this path is scheduled, tentatively scheduled, available, or reserved specifically for standard packets, cells, or frames. Times reserved for standard packet, cell, or frame switching are shown below the dashed line. The next column is a “Time to Kill” column in which a timer is set for a scheduled session. If there is no time-scheduled and/or time-reserved datagram/packet activity during that time-scheduled and/or time-reserved datagram/packet interval on that path for a certain period of time, the “Time to Kill” timer will expire and tear down the session. The next two columns, “Time Offset to Next Node” and “Propagation Delay to Next Node” indicate the difference in clock synchronization time and propagation delay between this node and the next node connected to that incoming line as measured by the two-way time reference method discussed in FIG. 134 and FIG. 135. This event schedule could add additional elements as well and be represented in a plurality of ways.

FIG. 133 and FIG. 134, are timing diagrams used to clarify the timing synchronization processes outlined in FIG. 135 and FIG. 136, and used by the present invention for time synchronization purposes. FIG. 133 shows an illustrative example to calculate the range of all possible errors for all time-scheduled and/or time-reserved datagram/packet switches in a time-scheduled and/or time-reserved datagram/packet network. FIG. 133 shows a timing diagram at the top of the page, beginning with a master clock reference accuracy down to the hundreds of nanoseconds. The clock itself is shown incrementing from left to right and shows minutes (mm), seconds (ss), thousandths of seconds (mmm), millionths of seconds or microseconds (μμμ), and hundreds of nanoseconds (n). Practically speaking, relatively inexpensive GPS enables timing systems are currently available offering accuracies of ±1 microsecond. Using ±1 microsecond as an illustrative accuracy number, FIG. 133 shows that if all time-scheduled and/or time-reserved datagram/packet switches in the time-scheduled and/or time-reserved datagram/packet network were accurate to within ±1 μsecond, then the maximum leading error of switch 1 versus the maximum lagging error of switch 2 would result in a total possible range of errors for all the nodes of only 2 μseconds. Temporarily ignoring propagation delay, this means that if a time-scheduled and/or time-reserved datagram/packet packet were to be sent across a time-scheduled and/or time-reserved datagram/packet network according to the present invention, every node in the network would be able to predict that packet's arrival time to within ±2 microseconds such that the total possible error range for a node awaiting the packet's arrival is ±2 microseconds or 4 microseconds. In other words, all nodes will receive all expected time-scheduled and/or time-reserved datagram/packet signals in this 4 microsecond window.

Illustratively, if the time-scheduled and/or time-reserved datagram/packet switch was operating at DS-1 speeds of 1.544 Megabits per second, 4 microseconds would be the equivalent of 6.176 bits. Thus, waiting for the time-scheduled and/or time-reserved datagram/packet packets on that input or output line would result in a maximum loss of 7 bits. This is not even the size of an address header. Alternatively, if the time-scheduled and/or time-reserved datagram/packet switch was operating at 1 Gigabits per second, 4 microseconds would be the equivalent of 4000 bits or 500 octets, about the size of several address headers.

If the timing synchronization system was made accurate to within ±100 nanoseconds, as some GPS systems are, then the range of all possible timing errors would be 400 nanoseconds or ±200 nanoseconds. Illustratively, if the time-scheduled and/or time-reserved datagram/packet switch was operating at DS-1 speeds of 1.544 Megabits per second, 400 nanoseconds would be the equivalent of 0.6176 bits, or less than 1 bit. Alternatively, if the time-scheduled and/or time-reserved datagram/packet switch was operating at 1 Gigabits per second, 400 nanoseconds would be the equivalent of 400 bits or 50 octets, about the size of an address header. Consequently, this system would work well with headerless packets as shown in FIG. 147, in which the address headers and other repetitive information is removed, thus leaving a margin for timing errors.

FIG. 134 and FIG. 135 illustrate the two-way time transfer technique for determining very precisely the differences in timing between two nodes and the propagation time between the nodes. This is very similar to the two-way transfer technique as shown in the U.S. Naval Observatory reference. Using the same numbers as in the previous illustrative example, FIG. 134 shows on a timing diagram a graphical illustration of the two-way time transfer technique, in which switch 1 has a maximum leading error of +1 microseconds from the master clock reference, while switch 2 has a maximum trailing error of −1 microseconds from the master clock reference, resulting in a total one-way propagation time of 2+some variable x microseconds.

FIG. 135 describes and explains how the two-way time transfer process works, specifically as it relates to FIG. 134 wherein each node timestamps a packet and immediately sends it to the other node, who then timestamps it immediately upon receipt. When both nodes do this, even if their clocks are not accurately aligned, they can send each other their results, such that with the timestamps on both packets, it is easy to compute very precisely both the difference error between the 2 nodes' clocks and the propagation time between their nodes. The differences in clock times and the knowledge of propagation delay enable each node to calculate time offsets for each input and output line, and then to either adjust their clocks and relative timing or compensate for the known difference in timing. Illustrative examples of these offsets are shown on the Event Schedule in FIG. 132.

In addition to the previous time synchronization techniques, FIG. 136 illustrates an additional process that could be used by the time-scheduled and/or time-reserved datagram/packet network to self-synchronize. In this way, the entire time-scheduled and/or time-reserved datagram/packet network could operate by having a non-Global Positioning System master clock. This approach would serve to start up and maintain the time-scheduled and/or time-reserved datagram/packet network in self-synchrony or could be used if the GPS system failed.

FIG. 137 shows the parameters used to set up a time-scheduled and/or time-reserved datagram/packet Call Setup Request Message. The value of these parameters would generally be sent from the Source 1 to the first time-scheduled and/or time-reserved datagram/packet node. However, they may be negotiated between the source and the time-scheduled and/or time-reserved datagram/packet node, or negotiated between the nodes. This could occur as part of the various reject modes (see FIG. 131). This time-scheduled and/or time-reserved datagram/packet Call Setup Request could be implemented as a modified Call or Session Setup Request that exists today in various protocols such as TCP/IP, ATM, X.25, etc. All other packets could be borrowed from standard protocol sets of the systems that the time-scheduled and/or time-reserved datagram/packet devices are operating on, such as TCP/IP, ATM, X.25, etc

FIG. 138, FIG. 139, FIG. 140, and FIG. 141 illustrate the signaling and message processes between the elements of the time-scheduled and/or time-reserved datagram/packet network. FIG. 138 shows the details of the time-scheduled and/or time-reserved datagram/packet Call Setup Process throughout the time-scheduled and/or time-reserved datagram/packet network. FIG. 139 shows the time-scheduled and/or time-reserved datagram/packet Call TearDown Process throughout the time-scheduled and/or time-reserved datagram/packet network. FIG. 140 shows the time-scheduled and/or time-reserved datagram/packet Switching Process throughout the time-scheduled and/or time-reserved datagram/packet network. FIG. 141 shows the time-scheduled and/or time-reserved datagram/packet Inter-Node Call Setup Process throughout the time-scheduled and/or time-reserved datagram/packet network, for purposes such as emergency messages, timing synchronization, and administration.

FIG. 142 shows an Alternative Recursive Time Scheduled Packet Call Setup Process—No Pre-set Path; Works in Each Individual Node using the Same Process at each node, which may use separate Request/Call Setup for Time-Scheduled Reservation Packets.

FIG. 143 shows an Alternative Recursive Time Scheduled Packet Transfer Process with No Pre-set Path, using the Same Process at each node.

FIG. 144 shows an Alternative Time Scheduled Packet Teardown Process with No Pre-set Path;, using the Same Process at each node.

FIG. 145 shows an Alternative Time Scheduled Process in which the Signal Fades and/or dies, in which the Time-Scheduled Process reroutes the Time-Scheduled packets over another path. This uses no Pre-set Path and the same Process at each node.

FIG. 146 shows another Alternative Recursive Time Scheduled Packet Call Setup Process with No Pre-set Path (works for IP), that works in Each Individual Node, and uses the same Process at each node, with NO separate Request/Call Setup for Time-Scheduled Reservation Packet. This process is backward compatible to existing IP using Classes of Service such as DSCP—DiffServ Code Points. No Discrete Setup or Teardown Packets required.

FIG. 147 shows the added efficiency of the “headerless” packet. In this embodiment, the time-scheduled and/or time-reserved datagram/packet network originating node strips off the layer two and layer three source and destination addresses. It may also strip off any information that the terminating edge knows due to the Call Setup Process, which it could then reinsert as the packet exits the network. In this manner, the time-scheduled and/or time-reserved datagram/packet packets through the network eliminate the inefficiencies of retransmitting this repetitive information. FIG. 147 shows the traditional information packet with its various elements. The “headerless” packet is then shown with the layer two source and destination addresses removed by the originating edge node, such that it is a smaller packet as it is time-scheduled and/or time-reserved datagram/packet switched through the network. The packet is then shown with the layer two source and destination addresses reinserted by the terminating edge node as the time-scheduled and/or time-reserved datagram/packet packet exits the system. Not shown, but part of the present invention is the ability to remove any part of the packet in any of the layers, including all of the headers, any repetitive information, or any information which the terminating edge knows which it could reinsert to replicate the packet as it exits the node.

FIG. 148 uses a timing diagram to illustrate how scheduled time-scheduled and/or time-reserved datagram/packet events might work in practice. In this example, time-scheduled and/or time-reserved datagram/packet packet 3-1 has been scheduled to be sent through this time-scheduled and/or time-reserved datagram/packet node at time t₁, while time-scheduled and/or time-reserved datagram/packet packet 1-2 has been scheduled to be sent through this time-scheduled and/or time-reserved datagram/packet node at time tₓ. Prior to time t₁, the time-scheduled and/or time-reserved datagram/packet event scheduler, using the black “Safety Zone” stops standard packets on input 3 and output 1, and switches input 3 and output 1 to be directly connected to each other. At time t₁± some marginal error less than the safety zone, time-scheduled and/or time-reserved datagram/packet packet 3-1 enters input 3 and gets “hardwire” routed directly through to output 1 with no more delay than the propagation delay. At the end of the safety zone time, the node converts input 3 and output 1 back into standard packet mode configuration. At time tₓ, the node does the same thing for time-scheduled and/or time-reserved datagram/packet packet 1-2, but this time it routes it from input 1 to output 2.

FIG. 149 shows the same scenario, except that this time it shows how standard packets interact with the time-scheduled and/or time-reserved datagram/packet packets. Shortly after time t₀, standard packet 1 gets shipped into Input 1. Since there is no contention, packet 1 gets store in input buffer 1, gets routed onto the standard packet, cell, or frame switch and then to output buffer 3 where it appears from output 3 a short time later. The same thing happens to standard packet 2 on input 2, except that the time-scheduled and/or time-reserved datagram/packet controller detects a potential time-scheduled and/or time-reserved datagram/packet collision with time-scheduled and/or time-reserved datagram/packet packet 1-2 scheduled to be coming out of output 2 at that time. Because standard packet 2 would have overlapped the black safety zone, the controller holds packet 2 in the output buffer 2 until after time-scheduled and/or time-reserved datagram/packet packet 1-2 has been transmitted. Standard packet 2 then is shipped out immediately following the black final safety zone for time-scheduled and/or time-reserved datagram/packet packet 1-2. Standard packet 3 on input 3 has the same problem, but on an input buffer. Standard packet 3 arrives in time to be stored in the input buffer 3, but cannot be switched to the packet switch due to time-scheduled and/or time-reserved datagram/packet packet 3-1's schedule arrival. As soon as time-scheduled and/or time-reserved datagram/packet packet 3-1's scheduled time is complete, including safety zones, standard packet 3 gets sent to the standard packet switch and emerges from output 4 sometime later. Standard packet 4 comes into input 2 and encounters no contention with time-scheduled and/or time-reserved datagram/packet scheduled packets, so it is routed to the standard packet switch and emerges from output 1 a short while later.

FIG. 150 shows some timing comparisons between different types of packet, cell, or frame switch technologies and time-scheduled and/or time-reserved datagram/packet switching in one node or switch. As can be clearly seen, time-scheduled and/or time-reserved datagram/packet switching is significantly faster than standard packet, cell, or frame switching, and is noticeably faster than layer two or layer three fast packet switching with high priority QOS/COS (quality of service, class of service). This is because in time-scheduled and/or time-reserved datagram/packet there is no storing, no switching, and no possibilities of collision at any point in the node.

FIG. 151 shows some timing comparisons between different types of packet, cell, or frame switch technologies and time-scheduled and/or time-reserved datagram/packet switching over a full network of three nodes. Again, as can be clearly seen, time-scheduled and/or time-reserved datagram/packet switching is significantly faster than standard packet, cell, or frame switching, and is noticeably faster than layer two or layer three fast packet switching with high priority QOS/COS (quality of service, class of service). Although there is some small propagation delay in the transmission and in the switch, the “hardwire” scheduled approach results in no storing, no switching, and no possibilities of collision at any point in the network. The result is fast, reliable, guaranteed, on-time, non-blocking, and non-delaying packet, cell, or frame switching.

1. A method for switching information through one or more of network elements, comprising the steps of:
receiving one or more particular priority datagrams;
determining one or more special identifiers associated with said particular priority datagrams;
assigning one or more reserved times in one or more time-reservation schedules for said particular priority datagrams in accordance with said one or more special identifiers;
transmitting said one or more particular priority datagrams with said one or more special identifiers at said one or more reserved times according to said one or more time-reservation schedules.

2. The method of claim 1 wherein, if a datagram which is not of said one or more particular priority datagrams is received, then place said datagram which is not of said one or more particular priority datagrams in a first-in-first-out queue to be transmitted after said one or more particular priority datagrams have been transmitted.

3. A method for transferring information through one or more network elements, comprising the steps of:
synchronizing said one or more network elements;
scheduling one or more scheduled transfer times for one or more datagrams from said one or more network elements;
transferring said one or more datagrams from said one or more network elements in accordance with said one or more scheduled transfer times.

4. The method of claim 3 wherein said information comprises data selected from the group consisting of real-time data, high-priority data, and time sensitive data.

5. The method of claim 3 wherein said information comprises data selected from the group consisting of cell-oriented, frame-oriented, and packet-oriented data.

6. The method of claim 3 wherein said step of synchronizing comprises associating one or more clocks in said one or more network elements.

7. The method of claim 6 wherein said one or more clocks associated with each of said network elements is synchronized in accordance with a master clock.

8. The method of claim 7 wherein said master clock is one or more global positioning systems.

9. The method of claim 3 wherein one or more of said one or more network elements is a store-and-forward network element.

10. The method of claim 3 further comprising the step of resetting said one or more scheduled transfer times in said one or more network elements.

11. The method of claim 10 wherein the step of resetting said one or more scheduled transfer times is initiated by a non-final-destination network element.

12. The method of claim 10 wherein the step of resetting said one or more scheduled transfer times is initiated by a final destination network element.

13. The method of claim 10 wherein the step of resetting said one or more scheduled transfer times is initiated by a network management control system.

14. A network element for transferring data comprising:
one or more first-in-first-out buffers associated with non-time-reserved data;
one or more buffers associated with time-reserved data;
circuitry for transferring data wherein said circuitry transfers said time-reserved data from said one or more buffers associated with said time-reserved data before transferring said non-time-reserved data from said one or more first-in-first-out buffers associated with said non-time-reserved data.

15. The network element of claim 14, wherein said circuitry for transferring data transfers said time-reserved data at previously scheduled times.

16. The network element of claim 15, wherein said previously scheduled times comprise time slots.

17. The network element of claim 16, wherein said time slots comprise time slots selected from the group consisting of fixed size time slots, variable size time slots, and dynamically variable time slots.

18. The network element of claim 14 wherein said one or more first-in-first-out buffers associated with non-time-reserved data is integrated with said one or more buffers associated with said time-reserved data.

19. The network element of claim 14 wherein said one or more buffers are selected from the group consisting of input buffers and output buffers.

20. The network element of claim 14 wherein said data is selected from the group consisting of cell-oriented data, frame-oriented data, packet-oriented data, time sensitive data, and time insensitive data.
